(19) United States
(12) Patent Application Publication
(10) Pub. No.: US 2011/0071861 A1
(43) Pub. Date: Mar. 24, 2011

(54) Online nationalized & localized ads (text, image and video) self-creation solutions; online nationalized and localized store set up and shop solutions; and online shop together and network solutions

(75) Inventor: Qiuhang Qian, Doraville, GA (US)

(73) Assignee: Qiuhang Richard Qian, Doraville, GA (US)

(21) Appl. No.: 12/803,111

(22) Filed: Jun. 18, 2010

Related U.S. Application Data
(60) Provisional application No. 61/245,660, filed on Sep. 24, 2009.

(51) Int. Cl. G06Q 30/00; G06Q 10/00

(52) U.S. Cl. 705/5; 705/27.1; 705/26.3; 705/14.72; 705/1.1; 705/14.14

(57) ABSTRACT

Revolutionary online shopping together; online nationalization and localization commercial text, image and video advertising; online nationalization and localization shopping and others have been invented.

Shop together is a module developed by Java. It is embedded at each different level. It involves the steps of loading personal image contents and other several different steps. When the module is initiated, it goes through inviting, accepting, confirming, location selection, communicating and shopping etc. The process ends when shopping together online is over.

Nationalization and localization advertising and shopping are the modules that are developed by java for businesses to create ads or open online stores at either the national level or local levels. There are design tools, templates and different programs developed and provided for the business to complete various different tasks. The programs are made up of procedures, functions, triggers or packages. The business picks service, creates and posts advertisement or opens a store at any level he or she selects.

www.postadsyourself.com is a website invented for users to set up stores, create and post ads by themselves using the free online tools, and invite their friends to shop and converse together online.

Users can either create text, banner and video commercial advertisement by utilizing the tools Ad Express provides or they can create ads on their own and upload them to the website at different locations at different levels. They can also set up online stores too. The users can pick a retail or wholesale location at different levels and set up stores using the free tools. There are nine levels on the website. See table below for description:

| Level | Description |
|---|---|
| Level 1 | The national level |
| Level 2 | The state level |
| Level 3 | The metro area level |
| Level 4 | The city level |
| Level 5 | The business listing level |
| Level 6 | The industrial national level |
| Level 7 | The industrial first level |
| Level 8 | The industrial second level |
| Level 9 | The industrial business listing level |

Through shopping together online, the users create fun shopping experience, view different deals, and buy the products they like while discussing the experience and bantering with others at all time. At the same time the users can market their businesses and sell more products online.

The non-provisional patent application is written for protecting not only the ideas which include a). online retail and wholesale stores nationalization and localization methods including the malls, outlets, shopping centers and non shopping center area stores; b). online retail and wholesale space rental; c). how to set up online retail and wholesale stores including the stores in the malls, outlets, shopping centers and non-shopping center areas; d). how to reserve online retail and wholesale space including the space in the malls, outlets and other online stores; e). how to bid online reserved retail and wholesale space including the space in the malls, outlets and other online stores; f). online retail and wholesale space auction including the space in the malls, outlets and other online stores; g). online commercial text, banner and video ads nationalization and localization methods; h). self-creation and posting commercial advertising methods at the national and local levels including the selection of states, metro areas, cities, space advertising spots, and types of ads (text, banner and video); i). online commercial ads self-creation methods; j). online video shopping method; k). online window shopping method; l). method for people shopping together online; m). online animation 3D shopping together method; n). billboards; o). holiday shopping; p). contest to win and sweepstakes etc. but also describes how the platform is technically created. All of the claims listed above are included in the provisional filing except that contest to win, sweepstakes and some others are added with this filing as part of the whole invention. The substitute specification contains no new matter. Following is the description for each claim.

The website platform consists of two modules “My City” and “My Industry”. FIGS. 1, 2, 3, 4, 5 and 6 demonstrate how the platform is designed from users' perspective. Front page is where users register and log into their accounts. They can also search and choose which module to walkthrough from here.

There are two designs for the front page. See Appendix 1 and 2. Design 1, there are six tabs on the front page. “Create Account”, “Login”, “Search”, “Demo” are placed at the upper right corner of the page. “My City” and “My Industry” are placed at the right bottom part.

A cross bar banner ad spot is put on the top of the screen below “Create Account” for image advertisement. The other one is for video advertisement. The video advertisement drops down and is displayed for 5 seconds before disappearing in the middle of the screen after the window opens. Or the video spot is placed in the middle of the screen with close function. It won't be closed until the close tab is hit. The U.S. map links to the front page of each state.

Design 2, the difference between Design 1 and 2 is that the tabs of “My City” and “My Industry” are placed at the upper left side of the page. There are four advertising spots put in the middle. One is for video advertisement put at the left side. Other two are placed at the right side for image advertisement. At the bottom there is a cross bar banner ad spot.

The patent application consists of three parts. Part one illustrates the process flow of the website. Part two illustrates how the website is designed for business' use. Part three describes how the platform is technically built.

### Part 1 Process Flow of the Website

### My City Module:

1. National Level. Click My City shows the second page at the national level. There are 24 advertising spots on the second page. The top 16 ones are for video advertisement. The bottom eight are for banner ads. Those advertising spots flip once each 8 seconds. In the middle there are seventeen different advertising text categories scrolling from right to left. Each title of these categories is put on the left side of the screen one by one vertically. They are on sale, special deals, early bird specials, clearance, closeout, overstock, liquidation sales, business opportunities, finance/investment, franchises, national tent events, events, trade shows-conventions, workshops-seminars, auctions, announcements and products and services promotion. See Appendix 3.

There are 21 sub-titled categories under on sale, special deals, clearance, closeout and overstock. They are automotive, baby & children, collectibles & art, clothing & accessories, computers, credit card, education & degree program, electronics, grocery, gifts, health & beauty, home garden, insurance, internet & TV, legal, lending, office products, restaurants, software, travel and others. The links for the sub-titled categories are invisible unless the tabs of on sale, special deals, clearance, closeout and overstock are pointed. There is a small tab on each of the 17 categories on the left side providing links to the static pages where all the text ads are displayed. See Appendix 4.

Page three at the national level has the same format as page two except that it has different ad categories on the left side (Appendix 5).

At the right bottom side of the two pages there are arrows for navigation (Appendix 6). Click the navigation tab goes to the fourth page at the national level. There are 5 designs of the fourth page (Appendix 7 to 11).

First design. There are total 65 service link tabs on the top of the page. They are: Home, Login, Switch to My Industry, Select My State, Shop Together, American Mall, Paradise Shopping Mall, Premium Outlet Center, Atlas Factory Outlet, Luxury Shopping Plan, Country Club Shopping Center, Retail Village, Service Source Place, Flea Market, Billboards, Department Stores & Warehouse Clubs, Gift Ideas, Saturday Market, Holiday Shopping, Christmas Shopping, After Christmas Sale, Window Shopping, Video Shopping, Expose My Business, Contest to Win, Sweepstakes, Community, On Sale, Special Deals, Clearance, Closeouts, Overstocks, Liquidation Sales, National Tent Events, New & Unique Products, Quality Products, Hot Products, Products Shown on TV, Products & Services Promotion, Business Opportunities, Finance-Investment, Franchises, Coupons, Coupon Books, Weekly Ads Catalog, Monthly Ads Catalog, Quarterly Products Brochure, VIP Ads Show Room, Events, Trade Shows-Conventions, Workshops-Seminars, Auctions, Announcements, Import Products, Export Products, Office Space-Suites, Warehouses-Distribution Centers, All Text Ads, My Stuff, Membership, Publishers' Classified Ads, Authorized Agents, Marketing Tools, Stock Today and Business News.

At the bottom, there are eight banner ad spots. They flip once every 8 seconds. In the middle, Mall of America is set as default.

Second design. American Mall, Paradise Shopping Mall, Premium Outlet Center, Atlas Factory Outlet, Luxury Shopping Plaza, Country Club Shopping Center, Retail Village, Service Source Place, Flea Market, Billboards, Department Stores & Warehouse Clubs, Gift Ideas, Saturday Market, Holiday Shopping, Christmas Shopping, After Christmas Sale, Window Shopping, Video Shopping are put under one tab called “Shop Together”. With this design there are 47 tabs showing on the top of the screen.

At the bottom, there are eight banner ad spots. They flip once every 8 seconds. In the middle, Mall of America is set as default.

Third design. On Sale, Special Deals, Clearance, Closeouts, Overstocks, Liquidation Sales, National Tent Events, New & Unique Products, Quality Products, Hot Products, Products Shown on TV, Products & Services Promotion, Business Opportunities, Finance-Investment, Franchises, Coupons, Coupon Books, Weekly Ads Catalog, Monthly Ads Catalog, Quarterly Products Brochure, and VIP Ads Show Room are put under one tab called Amazing Deals. With this design there are 45 tabs on the top of the page.

At the bottom, there are eight banner ad spots. They flip once every 8 seconds. In the middle, Mall of America is set as default.

Fourth design. All the tabs are put at the bottom of the screen. On the top there are eight advertising spots. In the middle, Mall of America is set as default.

Fifth design. The tab links to shopping: American Mall, Outlet Center, Shopping Plaza, Retail Village, Service Source Place, Flea Market, Billboards, Department Stores & Warehouse Clubs, Brand Name Shopping, Saturday Market, Holiday Shopping, Window Shopping, Video Shopping are vertically put on the right side of the screen. The rest tab links are put at the bottom below the advertising spots.

Clicking Home goes to the front page; Clicking Switch to My Industry goes to the second page of My Industry module; Clicking “Select My State” goes to the fifth page at the national level. On the top of the fifth page there are four spots for image and video ads. At the bottom there are eight image and video ad spots. There are fifty states listed in the middle of the page. Clicking one of the states goes to the state level front page (Appendix 12).

American Mall, Paradise Shopping Mall, Premium Outlet Center, Atlas Factory Outlet, Luxury Shopping Plaza, Country Club Shopping Center, Retail Village, Service Source Place, Flea Market, Billboards, Department Stores & Warehouse Clubs, Gift Ideas, Saturday Market, Holiday Shopping, Christmas Shopping, After Christmas Sale, Window Shopping, Video Shopping are the service categories where users can shop. These service modules are graphically designed. Many of them have 3D shopping environment. Claims of 1,2,3,4,5,6,8,9,10,11,12,13,14,15,16,17,21,22,23,24,25,26 and 27 apply here (Appendix 13).

The tabs of On Sale, Special Deals, Clearance, Closeouts, Overstocks, Liquidation Sales, National Tent Events, New & Unique Products, Quality Products, Hot Products, Products & Services Promotion, Business Opportunities, Finance-Investment, Franchises, Coupons, Coupon Books, Weekly Ads Catalog, Monthly Ads Catalog, Quarterly Products Brochure, VIP Ads Show Room, Events, Trade Shows, Seminars, Auctions, Import Products, Export Products, Office Space-Suites, Warehouses-Distribution Centers, Stock Today and Business Information on the top are the categories provided for users to select. Users can select any category to see what is inside it. Some categories even provide shopping (Appendix 14).

“Expose Business” is designed for the purpose of helping businesses to increase the chance of exposing their businesses. “Contest to Win” and “Sweepstakes” provide opportunities for users to win cash and prizes quarterly. “Shop together” is a module where users can invite their friends to shop together online. When shopping, they can see each other, talk and text with each other (Appendix 15).

There are three community groups under the “Community”. They share online shopping, business and travel related experiences. “My Stuff” lists the history of a user's activities which includes what products he or she has bought, where he or she went and how much and where he spent, the status of sweep and contest to win, the favorite sites etc. They can also check what their friends bought if allowed. “Authorized Agents” is created for the advertising agents to create and post ads for their clients through the agreement. “Membership” is for members to save money if they use the services regularly. “Marketing Tools” is created for businesses to help them market their companies and products. “Publishers' Classified Ads” is a module designed for users to see publishers' classified ads.

2. State Level. On the state level page there are fifteen tabs on the top. They are Home, Switch to My Industry, Shop Together, Select My City, View Ads, Malls, E-Mall, Outlets, Flea Markets, Metro Areas, Brag Board, Bulletin Board, Text Ads, Search, and Login (Appendix 16).

There are eight ad spots at the bottom for either image or video type. On the right side of the page there are three advertising spots for image ads. In the middle of the space there are two columns for text commercial ads scrolling from bottom to top with different colors.

Clicking Home goes to the front page. Clicking “Switch to My Industry” goes to the second page of My Industry at the national level. Shop Together is a module for users to invite their friend(s) to shop online together. Clicking Select My City goes to the state level second page where it lists all the cities. On the top and at the bottom there are each 8 video and banner ad spots. Clicking one of the cities goes to that city page (Appendix 17).

View Ads is to view all the different types of ads in image and video formats. The image and video ads are placed on the top and the bottom of the page. In the middle is the display area. The video or image ad is shown in the display area. The ad categories include business opportunities, finance-investment, franchise, events, trade shows-conventions, seminars, services and products promotion. These categories are put at the bottom of the page.

Malls, Outlets, Flea Markets and E-Malls are created for businesses to set up store, sell products and run promotions at the state level. Users come and visit these stores, view the ads and shop. Claims of 1,2,3,4,5,6,8,9,10,11,12,16,17,24,25 and 26 apply here.

Clicking Metro Areas goes to the metro area level first page. Brag and bulletin boards are designed for posting personal and business information. Text Ads lists all the text ads during the post period. Search is to search any information within the website.

Login is for users to access to their accounts to set up stores, post ads, edit their ad contents and shop if they choose to login at this level.

3. Metro Area Level. Clicking Metro Areas on the first page of the state level goes to the metro area level first page.

There are 24 advertising spots on the page. The top 16 ones are for video advertisement. The bottom eight are for banner ads. Those advertising spots flip once each 8 seconds. In the middle there are sixteen different text category advertisements scrolling from right to left. Each title of these categories is put on the left side of the screen one by one vertically. They are on sale, special deals, clearance, closeout, overstock, liquidation sales, business opportunities, finance/investment, franchises, tent events, events, trade shows-conventions, workshops-seminars, auctions, announcements and products and services promotion (Appendix 18).

There are 21 sub-titled categories under on sale, special deals, clearance, closeout and overstock. They are automotive, baby & children, collectibles & art, clothing & accessories, computers, credit card, education & degree program, electronics, grocery, gifts, health & beauty, home garden, insurance, Internet & TV, legal, lending, office products, restaurants, software, travel and others. The links for the sub-titled categories are invisible unless the tabs of on sale, special deals, clearance, closeout and overstock are pointed. There is a small tab on each of the 17 categories on the left side to provide links to the static pages where all the text ads are displayed (Appendix 19).

Page two at the metro area level has the same format as page one except that it has different ad categories on the left side (Appendix 20).

At the right bottom side of the two pages there are tabs for navigation. Click the navigation tab goes to the third page (Appendix 21).

On the third page there are 42 tabs listed on the top of the screen. They are Home, Switch to My Industry, Select My City, Shopping Together, Lenox Shopping Plaza, Perimeter Market Center, Hispanic Town, Asian Square, European Market, Video Shopping, Window Shopping, Holiday Shopping, On Sale, Special Deals, Clearance, Closeouts, Overstocks, Tent Events, Products & Services Promotion, Business Opportunities, Entertainment-Restaurants, Finance-Investment, Franchises, Coupons, Coupon Books, Announcements, Monthly Ads Catalog, Quarterly Products Brochure, VIP Ads Showroom, Events, Trade Shows-Conventions, Workshops-Seminars, Auctions, Office Space & Suites, Warehouses-Distribution Centers, Brag Board, Bulletin Board, Search, Login, Text Ads, Local Community and Publishers' Classified Ads. At the bottom there are eight advertising spots for video and banner ads. Between the top and the bottom ad spots Perimeter Market Center is set as default (Appendix 22).

Clicking Home goes back to the home page. Clicking Switch to My Industry goes to the second page of My Industry at the national level. Clicking Select My City goes to the state level second page. Lenox Shopping Plaza, Perimeter Market Center, Video Shopping, Window Shopping, Holiday Shopping provide users with shopping experience. Under Asian Square, Hispanic Town and European Market there are text, image and video types of advertisement. Businesses can create ads in different languages. They can also list their businesses' information. Minorities can search information through search function. Claims of 1,2,3,4,5,6,8,9,10,11,12,18,24,25,26 and 27 apply here.

On Sale, Special Deals, Clearance, Closeouts, Overstocks, Tent Events, Products & Services Promotion, Business Opportunities, Finance-Investment, Entertainment-Restaurants, Franchises, Coupons, Coupon Books, Announcements, Monthly Ads Catalog, Quarterly Products Brochure, VIP Ads Showroom, Events, Trade Shows-Conventions, Workshops-Seminars, Auctions, Office Space & Suites, Warehouses-Distribution Centers are the service categories where the advertising contents and business related information are displayed.

Brag Board and Bulletin Board are designed for posting personal and business information. Search is to search information within the website. Login is for users to log into their accounts to set up store, create and post ads, edit their ad contents and shop at this level. Text Ads list all the text ads statically during the post period. Local Community provides the services for the local community.

Publishers' Classified Ads is created for users to look at all the publishers' classified ads on the website.

4. City Level. Selecting a city on the state level second page or the third page of the metro area level goes to the first page at the city level.

There are 13 tabs on the top of the page. They are: Home, Switch to My Industry, Select My Business, Shop Together, Deals Zone, Shopping Centers, Non-Shopping Centers, Local Online Stores, Brag Board, Bulletin Board, Text Ads, Search and Login.

There are three tower ad spots on the right side and eight video and image spots at the bottom on the first page of the city. In the middle of the space there are three columns for text ads scrolling from bottom to top with different colors (Appendix 23).

Clicking Home goes back to the front page. Clicking Switch to My Industry goes to the second page of My Industry at the national level. Shop Together is a module for users to invite their friend(s) to shop online together. Clicking Select My Business goes to the second page of my city. Deals Zone is where all the image and video ads are displayed. The ad categories include On Sale, Special Deals, Clearance, Overstock, Closeouts, Business Opportunities, Finance-Investment, Coupons, Coupon Books, Events, and Products & Services Promotion. Shopping Centers and Non-Shopping Center provide users opportunities to look and shop in the stores in the shopping centers and non-shopping center areas without leaving at home. Claims of 1,2,3,4,5,6,8,9,10,11,12,19,20,24,25 and 26 apply here.

Search is to search any information within the website. Login is for users to access to their accounts to set up stores, create and post ads, edit their ad contents and shop at this level. Text Ads list all the text ads statically on separate pages after clicking it.

On the second page of the city they are 8 advertising spots on the top and at the bottom. In the middle the titled business categories are listed starting from A. Letters from A to Z are shown at the bottom above advertising spots. Advertisement is shown on each page on the top and the bottom related to the titled business. There are navigation tabs at right bottom part on each page. See Appendix 24 for example.

5. Business Listing. Choose a titled business category from A-Z listed in the middle area from the second page of the city goes to the business listing level first page. There are six tabs at the upper right corner on the page. They are Home, Switch to My Industry, Shop Together, View Ads, Search and Login.

On the top there are six ad spots for video advertisement. The rest are for image ads. If they are occupied, new page will be created automatically (Appendix 25).

Clicking Home goes back to the front page. Clicking Switch to My City goes back to the second page of My City at the national level. Shop Together is a module where users can invite their friend(s) to shop online together. Clicking View Ads show all the video, banner and text ads. On the top below the ad spots text ads scroll from right to left. Video ad spots are put on the top and banner ad spots are placed at the bottom of the page. In the middle there is a display spot for displaying video or banner ad if one of the video or banner ads is clicked. Ad category is placed at the left side vertically. There are two small links at the bottom of the ad category. Clicking the first one displays all the text ads statically on another page. Clicking the second one one time shows another ad category; clicking twice shows next ad category. Keep clicking until the right one the user likes to see (Appendix 26).

Search is to search any information within the website.

In the middle lists businesses and companies' listing information. Beside each company there are two ad spots. One is for video. The other is for image. There is rating function under the businesses and companies' list information for users to rate the business.

Login is for users to access to their accounts to create and post ads, edit their ad contents and shop at this level.

My Industry Module:

1. National Level. Clicking My Industry shows the national industrial level second page.

There are 24 advertising spots on the second page. The top 16 ones are for video advertisement. The bottom eight are for banner ads. Those advertising spots flip once each 8 seconds. In the middle there are 16 different text category advertisements scrolling from right to left. Each title of these categories is put on the left side of the screen one by one vertically. They are on sale, special deals, clearance, closeout, overstock, liquidation sales, business opportunities, finance/investment, franchises, national tent events, events, trade shows-conventions, workshops-seminars, auctions, announcements and products and services promotion (Appendix 27).

There are 23 sub-titled categories under on sale, special deals, clearance, closeout and overstock. They are agriculture products, apparel & textile products, auto parts & tires, chemicals & allied products, construction & material products, educational products, fishing & hunting products, food & beverage products, industrial supplies, instruments & related products, leather products, lumber & wood products, medical equipment and supplies, metals, minerals, oil & gas products, paper & allied products, rubber & plastics products, services, software, stone & glass products, tobacco & wines, and others (Appendix 28).

The links to the sub-titled categories are invisible unless the tabs of on sale, special deals, clearance, closeout and overstock are pointed. There is a small tab on each of the 16 categories on the left side providing links to the static pages where all the text ads are displayed (Appendix 29).

Page three at the national level has the same format as page two except that it has different ad categories on the left side (Appendix 30).

At the right bottom side of the two pages there are navigation tabs for navigation. See Appendix 31 for example.

Clicking the navigation tab on the third page goes to the fourth page at the industrial national level. There are 5 designs for this page (Appendix 32 to 36).

First design. On the top there are total 57 tabs. These tabs serve as navigation and display functions. They are: Home, Switch to My City, Select My Industry, Shop Together, Industrial Marketplace Mall, Four Seasons Expo, Wholesale Distributors, International Trade Show, My Showroom, Wholesale to The Public, Business Park, Technology Hub, Services Source Place, Fortune Companies, Window Shopping, Video Shopping, Expose Business, Partners, Contest to Win, Sweepstakes, Community, Authorized Agents, On Sale, Special Deals, Clearance, Closeouts, Overstocks, National Tent Events, Liquidation Sales, New & Unique Products, Quality Products, Hot Products, Refurbished Items, Products & Services Promotion, Business Opportunities, Finance-Investment, Franchises, Coupons, Coupon Books, Monthly Ads Catalog, Quarterly Products Brochure, VIP Ads Showroom, Events, Trade Shows-Conventions, Workshops-Seminars, Auctions, Announcements, Import Products, Export Products, Office Space-Suites, Warehouses-Distribution Centers, Text Ads, Membership, My Stuff, Marketing Tools, Stock Today and Business News.

At the bottom, there are eight banner ad spots. They flip once every 8 seconds. In the middle, Industrial Marketplace Mall is set as default.

Second design. Industrial Marketplace Mall, Four Seasons Expo, Wholesale Distributors, International Trade Show, My Showroom, Wholesale to The Public, Business Park, Technology Hub, Services Source Place, Fortune Companies, Window Shopping, and Video Shopping are put under one tab called Industrial Hall. There are total 46 tabs showing on the top of the screen.

At the bottom, there are eight banner ad spots. They flip once every 8 seconds. In the middle, Industrial Marketplace Mall is set as default.

Third design. On Sale, Special Deals, Clearance, Closeouts, Overstocks, National Tent Events, Liquidation Sales, New & Unique Products, Quality Products, Hot Products, Refurbished Items, Products & Services Promotion, Business Opportunities, Finance-Investment, Franchises, Coupons, Coupon Books, Monthly Ads Catalog, Quarterly Products Brochure, VIP Ads Show Room, Import Products and Export Products are put under one tab called Amazing Deals. There are total 26 tabs on the top of the page.

At the bottom, there are eight banner ad spots. They flip once every 8 seconds. In the middle, Industrial Marketplace Mall is set as default:

Fourth design. All the tabs are put at the bottom of the screen. On the top there are eight advertising spots. In the middle, Industrial Marketplace Mall is set as default:

Fifth design. Navigation and shopping related tabs are put on the right side of the screen. These tabs include: Home, Login, Switch to My City, Select My Industry, Shop Together, Industrial Marketplace Mall, Wholesale Distributors, International Trade Show, My Showroom, Business Park, Technology Hub, Service Source Place, Fortune Companies, Window Shopping, and Video Shopping. The rest are put at the bottom.

Clicking Home goes back to the front page; Clicking Switch to My City goes to the second page of My City module; Shop Together is the module where users can invite their friend(s) to shop together online; Clicking Select My Industry goes to the fifth page at national level. Currently there are total 56 different industries listed in the middle of the page. If more industries are added, a second page will be created. On the top of the page there are six ad spots each on the top and at the bottom. The top ones are for video ads and the bottom ones are for banner ads. They flip once every 8 seconds (Appendix 37).

Industrial Marketplace Mall, Four Seasons Expo, Wholesale Distributors, My Showroom, Wholesale to The Public, Business Park, Technology Hub, Fortune companies, Window Shopping, Video Shopping, and Services Source Place are service categories where users can shop. Claims of 1,2,3,4,5,6,8,9,10,11,12, 13,14,15,16,17,21,22,23,24,25,26 and 27 apply here. These service modules are graphically designed. Many of them have 3D shopping environment.

The tabs of On Sale, Special Deals, Clearance, Closeouts, Overstocks, National Tent Events, Liquidation Sales, New & Unique Products, Quality Products, Hot Products, Refurbished Items, Products & Services Promotion, Business Opportunities, Finance-Investment, Franchises, Coupons, Coupon Books, Monthly Ads Catalog, Quarterly Products Brochure, VIP Ads Show Room, Events, Trade Shows, Seminars, Auctions, Announcements, Import Products, Export Products, Office Space-Suites, Warehouses-Distribution Centers, Stock Today and Business Information are the service modules where the users can check what's inside.

Expose Business is created for the purpose of helping businesses increase the chance of expose their businesses. Contest to Win and Sweepskakes provide opportunities for users to win cash and prizes quarterly. Shop together is the module where users can invite their friend(s) to shop together online. There are 3 different communities the in the Community. They share online shopping, business and travel experiences.

My Stuff lists the history of a user's shopping activities which includes what products he or she has bought, where he or she went and how much and where he spent, the status of sweep and contest, the favorite sites etc. He or she can check what his or her friends bought if allowed. Authorized agents is designed for the advertising agents to create ads for their clients through the agreement. Membership is for members to save money if they regularly use the services. Text Ads display all the text ads during the post period.

Search is to search anything within the website. Login is for users to access to their accounts to create and post ads, edit and update ad contents and shop at this level. Marketing Tools is created for businesses to help market their companies and products.

2. Industrial First Level. Clicking one of the industry categories on the fourth page goes to the industrial first level. On the page there are four advertising spots. One video spot is placed on the right side of the screen. Two other banner ad spots are put on the right and left side of the screen. There is a cross bar banner advertising spot on the top. A navigation tab is placed at the right bottom part linking to the industrial second level (Appendix 38).

3. Industry Second Level. Clicking the navigation tab on the industry first page goes to the industry second level. On the first page there are 16 video ad spots on the top. At the bottom there are eight spots for banner ads. Text ads scroll from right to left on the screen (Appendix 39).

Clicking the navigation tab goes to the second page at this level. The format of the second page is similar to the format of the first page. However the ad categories on the left side are different.

On the top of the third page at the industrial second level there are tabs of Home, Switch to My City, Select My Business, Login, Shop Together, My Booth, Trade Center, Wholesale Suppliers, On Sale, Special Deals, Clearance, Access Inventory, Bulk Lots, Discount Products, New Products, Refurbished Products, OEM Products, OEM Parts, Aftermarket Products, Aftermarket Parts, Business Opportunities, Trade-Shows/Conventions, Quarterly Products Brochure, Announcements, Message Board, Bulletin Board, Fresh Produce, Search and Text Ads (Appendix 40).

Clicking Home goes back to the home page. Login is for users to access to their accounts to create, post ads, edit ad contents, set up stores and shop at this level. Clicking Switch to My City goes to the second page of My City at the national level. Shop Together is a module where users can invite their friend(s) to shop together online; Clicking My Business goes to the fourth page at industrial second level. If there are many sub-titled industries, these industries are put in the middle of the screen. Custom advertising spots are built around them. If there are not many sub-titled industries, the sub-titled industries are put on the top of the page. And custom ad spots are built under them. The custom ad spots are designed and built according to the sub-titled industries (Appendix 41).

If there are many sub-titled industries, the sub-titled industries are put in the middle. Customs ad spots are built around them.

Shop Together is a module where users can invite their friends to shop together online. My Booth, Trade Center, Wholesale Suppliers are created for business trading purpose. They are graphically designed. Businesses can set up store, sell products, and run promotions etc. Claims of 1,2,3,4,5,6,8,9,10,11,12,24,25, and 26 apply here.

On Sale, Special Deals, Clearance, Access Inventory, Bulk Lots, Discount Products, New Products, Refurbished Products, OEM Products, OEM Parts, Aftermarket Products, Aftermarket Parts, Business Opportunities, Trade-Shows/Conventions, Quarterly Products Brochure, Announcements, Message Board, Bulletin Board and Fresh Produce show all the deals and information of each category. Some of them have shopping function.

Search is to search information within the website. Text Ads displays all the text ads on separate pages statically. There are eight banner advertising spots at the bottom. In the middle Trade Center is set as default.

4. Industrial Business Listing.

Choosing a sub-titled business category on the fourth page at industry second level goes to the business listing level page. On the page there are six tabs at the upper right corner. They are Home, Switch to My City, Shop Together, View Ads, Search and Login.

On the top there are six ad spots for video advertisement. The rest are for image ads. If they are occupied, new page are created automatically. See Appendix 42 for example.

Clicking Home goes back to the front page. Clicking Switch to My City goes back to the second page of My City at the national level. Shop Together is a module where users can invite their friend(s) to shop online together. Clicking View Ads show all video, banner and text ads. On the top below the ad spots text ads scroll from right to left. Video ad spots are put on the top and banner ad spots are placed at the bottom of the page. In the middle there is a display spot for displaying video or banner ad if one of the video or banner ads is clicked. Ad category is placed at the left side vertically. There are two small links at the bottom of the ad category. Clicking the first one displays all the text ads statically on another page. Clicking the second one one time shows another ad category; clicking twice shows next ad category. Keep clicking until the right one the user likes to see (Appendix 43).

Search is to search any information within the website.

In the middle lists businesses and companies' listing information. Beside each company there are two ad spots. One is for video advertisement. The other is for image advertisement. There is rating function under the businesses and companies' list information for users to rate the business.

Login is for users to access to their accounts to create and post ads, edit their ad contents and shop at this level.

### Part 2 User's Flow (for Businesses)

The second part of the application mainly illustrates how the platform is designed for users' to use the tools to finish all the service work mentioned in Part 1 online by themselves including setting up store; booking, reserving, bidding and auctioning store space and ad spots; creating 3D storefront and store inside; uploading products; creating and posting ads in text, image and video formats at the different levels; and editing, updating account information and ad contents etc.

### My City Module:

1. Set Up Store. The user chooses business account under Login to access to the account on the front page. After logging in, there are three choices to choose from: Set Up Store; Post Ads, and My Account. Clicking Set Up Store lists National Level, State Level, Metro Area Level and City Level (Appendix 44).

A). Selecting National Level shows the fourth page of national level. On the top American Mall, Paradise Shopping Mall, Premium Outlet Center, Atlas Factory Outlet, Luxury Shopping Plaza, Country Club Shopping Center, Retail Village, Service Source Place, Flea Market, Billboards, Department Stores & Warehouse Clubs, Gift Ideas, Saturday Market, Holiday Shopping, Christmas Shopping, After Christmas Sale, Window Shopping, and Video Shopping are put there. These are the only tabs that are linked to the shopping areas. They show different colors (Appendix 45).

Selecting one of the shopping areas shows all the inside stores. Stores are programmed for setting up, reserving, bidding and auctioning. The ones with green color are ready for setting up. Red ones are occupied but can be reserved. Yellow ones can be bid if they have been reserved. Grey ones are for auction (Appendix 46).

Clicking a store space begins to set up. The user follows each step until all steps are finished. After the user makes online payment, the business is ready to open to the public.

B). Selecting State Level shows the first page at the state level. All the tabs are placed on the top including Malls, Outlets, E-Mall and Flea Markets

The shopping, area tabs are the only links that can be accessed to. They show different colors. See following screenshot (Appendix 47).

Selecting E-Mall shows all the inside stores. Stores are programmed for setting up, reserving, bidding and auctioning. The ones with green color are ready for setting up. Red ones are occupied but can be reserved. Yellow ones can be bid if they have been reserved. Grey ones are for auction. See Appendix 48 for example.

Clicking a store space begins to set up. The user follows each step until all the steps are finished. After the user makes online payment, the business is ready to open to the public.

Selecting Malls, Outlets or Flea Markets lists the names of the malls, outlets or flea markets in the state. Clicking one of them shows the floor directory map. The user chooses where the business is located, clicks the spot and begins to set up store. After the user finishes all the steps and makes online payment, the business is ready to open to the public.

C). Selecting Metro Area Level shows the third page of the metro area level. The tabs of Lenox Shopping Plaza, Perimeter Market Center, Hispanic Town, Asian Square, European Market, Video Shopping, Window Shopping, Holiday Shopping, Christmas Shopping, and After Christmas Sale are placed on the top of the paged. These tabs are the only links that can be accessed to. They show different colors.

Selecting one of the tabs displays the floor plan layout. Stores are programmed for setting up, reservation, bid and auction. The ones with green color are ready for setting up. Red ones are occupied but can be reserved. Yellow ones can be bid if they have been reserved. Grey ones are for auction.

Clicking a store space begins to set up store. The user follows each step until all the steps are finished. After the user makes online payment, the business is ready to open to the public.

D). Selecting City Level shows the first page of the city level. Tabs including Local Online Store, Shopping Centers and Non-Shopping Centers are placed on the top of the page.

Selecting Local Online Stores displays the floor plan layout. Stores are programmed for setting up, reservation, bid and auction. The ones with green color are ready for setting up. Red ones are occupied but can be reserved. Yellow ones can be bid if they have been reserved. Grey ones are for auction.

Clicking a store space begins to set up. The user follows each step until all the steps are finished. After the user makes online payment, the business is ready to open to the public.

Selecting Shopping Centers lists the names of shopping centers in the city. The user selects which shopping center the business is located. After the user follows each step and makes online payment, the business is ready to open to the public.

The user at non-shopping center areas chooses where the business is located. After he or she follows each step and makes online payment, the business is ready to open to the public.

2. Post Ads. The user chooses the business account under Login to access to the account on the front page. After logging in, the user has three choices to choose from: Set Up Store; Post Ads, and My Account. Clicking Post Ads lists Text, Banner and Video three ad type choices.

A). Selecting Text lists National Level, State Level, Metro Area Level, City Level and Business Listing Level. Each level provides its own service categories. The user selects a level and a service where he or she would like to post text advertisement. After the user follows each step and makes the payment, the text advertisement scrolls on the screen and are shown statically on separate pages (Appendix 49).

B). Selecting Banner or Video lists National, State, Metro Area, City and Business Listing five levels.

1). If the user chooses National Level, five reduced size pages are shows on the screen. Any page becomes normal size if it is clicked. See following screenshots for example. On the first page there are a). one video advertising spot and one banner ad spot. b). one video advertising spot and three advertising spots. The user selects a spot and uses the tools Ad Express provides. After he or she finishes each step and makes the payment, the ad is shown immediately on the spot (Appendix 50).

There are 16 video spots on the top and 8 banner ad spots at the bottom each on the second and third page. These spots flip once. So there are total 64 video and 32 banner spots on these two pages. The user selects a spot and uses the tools Ad Express provides. Seeing following online tools for example. After the user finishes each step and makes the payment, the ad is shown immediately on the ad spot (Appendix 51).

There are 8 banner ad spots at the bottom of the fourth page. They flip once. So there are total 16 available spots. All the tabs are put on the top of the page. Only the tabs with banner and video ad services can be accessed to with different color. They are On Sale, Special Deals, Clearance, Closeouts, Overstocks, Liquidation Sales, National Tent Events, New & Unique Products, Quality Products, Hot Products, Products & Services Promotion, Business Opportunities, Finance-Investment, Franchises, Coupons, Coupon Books, Weekly Ads Catalog, Monthly Ads Catalog, Quarterly Products Brochure, VIP Ads Show Room, Events, Trade Shows, Seminars, Auctions, Import Products, Export Products, Office Space-Suites, Warehouses-Distribution Centers, Expose My Business, Contest to Win, Sweep Steaks, Community, My Stuff, Membership, Authorized Agents, and Marketing Tools. The user chooses one of the categories and follows each step. After the user selects the payment method, or makes the payment online, the banner or video ad is displayed under the category (Appendix 52).

On the fifth page at the national level, there are four and eight banner ad spots on the top and at the bottom. The user chooses one of the available spots and follows each step. After the user selects the payment method, or makes the payment online, the ad is displayed on the spot immediately. Claims 24, 25, and 26 apply on the all ad spots on all the five pages. The user can reserve any spot if it is occupied. If it has been reserved, the users can bid it. See Appendix 53 for example.

2). If the user chooses the state level, two reduced size pages show on the screen. Either one becomes normal size if it is clicked. On the first page there are eight ad spots at the bottom four for video and four for banner ads. On the right side there are three banner ad spots. They flip once. So there are total 22 available spots on the page. The user chooses one of the available spots and follows each step. After the user selects the payment method, or makes the payment online, the ad is displayed on the spot immediately (Appendix 54).

All the tabs are placed on the top of the page, but only the tabs of “Post Ads”, “Brag Board” and “Bulletin Board” can be accessed to with different color. Under the “Post Ads”, it lists choices of business opportunities, finance-investment, franchise, events, trade shows-conventions, seminars, services and products promotion. The user chooses one of the categories and follows each step. After the user selects the payment method, or makes the payment online. The banner or video ad shows under the category immediately (Appendix 55).

On the second page all the cities are put in the middle of the screen. Third page and fourth page are created if one page cannot hold all the cities in a state. On the top and at the bottom there are each 8 video and banner ad spots. They flip once. So there are total 32 available spots on the second page. The user chooses one of the available spots and follows each step. After the user selects the payment method or makes the payment online, the ad is displayed on the spot immediately. Claims 24, 25 and 26 apply on all the ad spots on the two pages. The user can reserve any spot if it is occupied. If it has been reserved, the user can bid it (Appendix 56).

3). If the user chooses the metro area level to post ads, he or she selects a metro area in a state and three reduced size pages are shown on the screen (Appendix 57). On the top of the first two pages there are 16 video ad spots each. At the bottom there are 8 banner ad spots each. They flop once. So there are total 64 video spots and 32 banner ad spots on these two pages. The user chooses one of the available spots and follows each step before the advertisement is created. After the user selects the payment method, or makes payment online, the ad is shown on the spot immediately.

On the third page there are 8 banner ad spots at the bottom of the fourth page. They flip once. So there are total 16 available spots. Claims 24, 25 and 26 apply on all the ad spots on the three pages. The user can reserve any spot if it is occupied. If it has been reserved, the user can bid it.

All the tabs are placed on the top of the page, but only the tabs linked to On Sale, Special Deals, Clearance, Closeouts, Overstocks, Tent Events, Products & Services Promotion, Business Opportunities, Entertainment-Restaurants, Finance-Investment, Franchises, Coupons, Coupon Books, Announcements, Monthly Ads Catalog, Quarterly Products Brochure, VIP Ads Showroom, Events, Trade Shows-Conventions, Workshops-Seminars, Auctions, Office Space & Suites, Warehouses-Distribution Centers, Brag Board, Bulletin Board, Local Community and Publishers' Classified Ads can be accessed to. They show different color (Appendix 58). The user chooses one of the categories and follows each step before the advertisement is created. After the user selects the payment method or makes the payment online. The banner or video ad is shown under the category.

4). If the user chooses the city level, he or she selects a city from a state and two reduced size pages shown on the screen. Either page becomes normal sized page if it is clicked.

On the first page there are eight ad spots at the bottom four for video and four for banner ads. On the right side there are three banner ad spots. They flip once. So there are total 22 available spots on the page. The user chooses one of the available spots and follows each step. After the user selects the payment method or makes payment online, the ad is displayed on the spot immediately.

All the tabs are placed on the top of the page, but only the tabs of “Post Ads”, “Brag Board” and “Bulletin Board” can be accessed to. Under Post Ads there are On Sale, Special Deals, Clearance, Closeout, Overstock, Business opportunities, events, services and products promotion and Announcements. The user chooses one of the categories and follows each step. After the user selects the payment method or makes the payment online. The banner or video ad is shown under the category (Appendix 59).

On the second page there are each 8 video and banner ad spots on the top and at the bottom. There are two tower banner ad spots on the right side. More pages will be created if titled business categories have more than one page. On each page there are 18 ad spots. The user chooses one of the available spots and follows each step. After the user selects the payment method or makes the payment online, their ad is displayed on the spot immediately (Appendix 60).

5). If the user chooses Business Listing level, one reduced size page is shown on the screen. The page becomes normal size after it is clicked. Sub-titled businesses that can be accessed to are put in the middle. The user can pick a spot on the page, create and post ad. If the user chooses one of the sub-titled, it goes to the business listing level page. On the top of the page there are six ad spots for video advertising. The rest are for image advertising. The user chooses one of the available spots and follows each step. After the user selects the payment method or makes online payment, the ad is shown on the spot immediately.

Advertising spots at the business listing level can be reserved. If they have been reversed, they can be bid out.

All the tabs are put on the upper right side of the page, but only “Post Ads” can be accessed to with different color. Clicking “Post Ads” shows service categories including On Sale, Special Deals, Clearance, Closeout, Overstock, Products and Services Promotion, and Listing. The user chooses one of the categories and follows each step. After the user selects the payment method or makes payment online, the ad is displayed under the category (Appendix 61).

3. Manage Account. Clicking Manage Account enters the account. Each account includes modules like basic information; my store and products; my advertisement; sweep steaks; my stuff; membership; marketing tools etc. The user can look, check, create post, modify, update, renew, make payment, reserve, and bid etc. in their accounts.

### My Industry Module:

1. Set Up Store. The user chooses business account under Login to access to the account on the front page. After logging in, the user selects My Industry. The user has three choices to choose from: Set Up Store; Post Ads; and My Account. Clicking Set Up Store lists National Level and Industrial Second Level (Appendix 62).

A). Selecting National Level shows the fourth page of the national level. All the tabs are put on the top of the page including Industrial Marketplace Mall, Four Seasons Expo, Wholesale Distributors, International Trade Show, My Showroom, Wholesale to The Public, Business Park, Technology Hub, Services Source. Place, Fortune Companies, Window Shopping and Video Shopping. These shopping area tabs are the only tab links that can be accessed to. They display in different color (Appendix 63).

Selecting one of the shopping areas shows the floor plan layout. The stores are programmed for setting up, reservation, bid and auction. The ones with green color are ready for setting up. Red ones are occupied but can be reserved. Yellow ones can be bid if they have been reserved. Grey ones are for auction (Appendix 64).

Clicking a store space begins to set up. The user follows each step until all the steps are finished. After the user makes the payment, the business is ready to open to the public.

B). Selecting Industrial Second Level shows the third page at the industrial second level. All the tabs including shopping areas which are My Booth, Trade Center and Wholesale Suppliers are placed on the top of the page. These shopping area tabs are the only links that can be accessed to. They show in different color.

Selecting either one of them shows the floor plan layout. The stores are programmed for setting up, reservation, bid and auction. The ones with green color are ready for setting up. Red ones are occupied but can be reserved. Yellow ones can be bid if they have been reserved. Grey ones are for auction.

Clicking a store space begins to set up. The user follows each step until all the steps are finished. After the user makes the payment, the business is ready to open to the public.

2. Post Ads.

The user chooses business account under Login to access to the account on the front page. After logging in and selecting industry module, the user has three options to choose from: Set Up Store; Post Ads; or My Account. Click Post Ads lists Text, Banner and Video three ad type choices.

A). Selecting Text lists Industrial National Level, Industrial Level and Business Listing level. Each level provides its own service categories. The user selects a service and a level he or she would like to post text advertisement. After the user follows each step and makes the payment, the text advertisement scrolls on the screen and shown statically on separate pages (Appendix 65).

B). Selecting Banner or Video lists Industrial National Level, Industrial First Level, Industrial Second Level and Industrial Business Listing level.

1). If the user chooses Industrial National level, five reduced size pages are shown on the screen. Any page becomes normal size if it is clicked. On the first page there are a). one video advertising spot and one banner ad spot. b). one video advertising spot and three advertising spots. The user selects a spot and uses the tools Ad Express provides. After the user finishes each step and makes the payment, the ad shows on the spot immediately (Appendix 66).

There are 16 video spots on the top and 8 banner ad spots at the bottom each on the second and third page. These spots flip once. So there are total 64 video and 32 banner spots on these two pages. The user selects a spot and uses the tools Ad Express provides. After the business finishes each step and makes the payment, the ad is shown immediately. There are 8 banner ad spots at the bottom of the fourth page. They flip once. So there are 16 available spots on the page. See Appendix 67 for example:

All the tabs are put on the top of the page, but only the tabs with banner and video ad services can be accessed to in different color. They are On Sale, Special Deals, Clearance, Closeouts, Overstocks, National Tent Events, Liquidation Sales, New & Unique Products, Quality Products, Hot Products, Refurbished Items, Products & Services Promotion, Business Opportunities, Finance-Investment, Franchises, Coupons, Coupon Books, Monthly Ads Catalog, Quarterly Products Brochure, VIP Ads Showroom, Events, Trade Shows-Conventions, Workshops-Seminars, Auctions, Announcements, Import Products, Export Products, Office Space-Suites, Warehouses-Distribution Centers, Membership, My Stuff, Marketing Tools, Expose Business, Partners, Contest to Win, Sweepstakes, Community, and Authorized Agents. The user chooses one of the categories and follows each step. After the user selects the payment method or makes online payment, the ad is displayed under the category (Appendix 68).

On the fifth page at the national level, there are four and eight banner ad spots on the top and at the bottom. The user chooses one of the available spots and follows each step. After the user selects the payment method or makes payment online, the ad is displayed on the spot immediately. Claims 24, 25 and 26 apply on all the ad spots on all the five pages. The user can reserve any spot if it is occupied. If it has been reserved, the user can bid it (Appendix 69).

2). If the user selects Industry First Level from the industry, the page of the industry shows on the screen. There are four spots on the page, one for video and three others for banner ads. The user selects any spot and follows each step. After the user makes the payment selection or makes the payment, the ad is shown on the screen immediately. Claims 24, 25 and 26 apply here. The user can reserve any spot if it is occupied. If it has been reserved, the user can bid it (Appendix 70).

3). If the user selects Industry Second Level, three reduced size pages are shown on the screen (Appendix 71). Any page becomes normal size if it is clicked. On the top of the first two pages there are each 16 video ad spots and 8 banner ad spots. They flip once. So there are total 64 video and 32 banner ad spots on these two pages. The user selects any spot and follows each step. After the user makes the payment selection or makes payment online, the ad is shown on the spot on the screen immediately. Claim 17 applies here. The user can reserve any spot if it is occupied. If it has been reserved, the user can bid it.

On the third page of the industrial second level, there are 8 banner ad spots at the bottom. They flip once. So there are total 16 banner ad spots on the third page. All the tabs are placed on the top, but only the tabs with banner and video ad services can be accessed to in different color. They are On Sale, Special Deals, Clearance, Access Inventory, Bulk Lots, Discount Products, New Products, Refurbished Products, OEM Products, OEM Parts, Aftermarket Products, Aftermarket Parts, Business Opportunities, Trade-Shows/Conventions, Quarterly Products Brochure, Announcements, Message Board, Bulletin Board, and Fresh Produce. The user chooses one of the categories and follows each step. After the user selects the payment method or makes the payment online, the ad is displayed under the category immediately.

4). If the user chooses Industrial Business Listing level, one reduced size page is shown on the screen. Sub-titled industries that can be accessed to are put on the right, left side, in the middle or on the top. Custom design ad spots are built around them. The user can select any spot to create and post ads. If the user chooses one of the sub-titled industries, it goes to the listing level page. On the top of the page there are six video ad spots. The rest are for image advertising. The user chooses one of the available spots and follows each step. After the user selects the payment method or makes the payment online, the ad is displayed on the spot immediately.

Advertising spots at the business listing level can be reserved. If they have been reversed, they can be bid out. All the tabs are placed at the upper right corner. Only “Post Ads” can be accessed to with different color (Appendix 72). Clicking “Post Ads” shows categories. They are On Sale, Special Deals, Clearance, Closeout, Overstock, Products and Services Promotion, and Listing. The user chooses one of the categories and follows each step. After the user selects the payment method or makes the payment online, the ad is displayed under the category immediately.

3. Manage Account. Clicking Manage Account enters the account. The account includes modules like basic information; my store and products; my advertisement; sweep steaks; my stuff; membership; marketing tools etc. The user can look, check, create, post, modify, update, renew, make payment, reserve, and bid etc. in the account.

The website process flows and business rules for the users have been illustrated. The patent claims applied for have been discussed. Custom designed online ad creation packages are embedded in the website. Different web pages and ad layout designs have been decided. Users can shop in 3D animation graphic environment. They can do video and window shopping and invite friends to shop together online. They can also participate to contest and sweep steaks to win cash and prizes.

The user can create ads in the format of text; banner and video by themselves using Ad Express' custom design tools and post them anywhere nationally or locally. The user can sell products in all the shopping areas at different levels such as Holiday Shopping, Billboards, Skyways, Street Vendors, Shopping Centers and Non-Shopping Centers etc. nationally and locally. The user can set up store, rent, reserve, bid ad spots and store space. Some vacant ad spots and store space are put for auction.

Following is the discussion of the website from architecture standpoint of view and how the platform is technically built.

### Part 3 Building the Platform

### Technical Field

The present invention relates to website and computer server systems that are capable of running and support web application and programs. More particularly, the present invention relates to systems that capable of running web application to provide online advertising, store and social shopping network solutions.

### BACKGROUND OF THE INVENTION

The Internet has grown up. Broadband connections now have reached more than half of American households. It will reach 77% of the US households by 2012, according to a new Gartner study.

Although the Internet still takes in about 10% of U.S. advertising revenue, surveys indicate that it accounts for over 30% of America's media time. And that's not including those who are Web-surfing at work.

Smitten by the growing reach and power of the Internet, blue-chip advertisers are stretching far beyond the cramped text ads on search engines into a global sensation. Now advertisers are packing online ads with music and color video, just like those on TV. They're looking to the Web to build brands.

The result is a surge in growth that's extending from Madison Ave. to the West Coast campuses of Yahoo and MSN. While the overall ad industry grows at a respectable 7.7% a year, Internet ads are galloping ahead at a 29.7% clip for the last three years.

In 2005 the amount of money spent on Internet advertising was $12.5 billion rose by 30 percent than 2004. In 2006 there was another 34 percent increase of online advertising spending than 2005, reaching at $16.8 billion. According to research by the IAB and PWC, 2007 saw a 25 percent rise in online advertising spending. They referred to the U.S. as a “healthy environment” for online ads, quoting 2007 revenues at $21 billion, a record high.

As the internet grabs an ever increasing share of eyeballs, marketers are shifting more of their budgets online. It is estimated that U.S. online advertising will reach $42 billion in 2011.

For anyone who recalls the soaring expectations that preceded the Internet advertising crash earlier in the decade, even a touch of euphoria is grounds for serious heebie-jeebies. Last time around, many of the most enthusiastic advertisers—the cash-happy dot-corns themselves—dropped dead. From 2000 to 2002, Internet advertising plummeted 25%. But something is decidedly different this time. Since the bust, the industry has pieced together the technology—from video delivery to user tracking—to make good on the shining predictions of the boom. The Internet is winning over mainstream advertisers with its computational precision. It delivers hard, quantifiable results measured in clicks and sales down to the penny. In the process, it's turning advertising from an art into a science.

### SUMMARY OF THE INVENTION

The present invention creates a platform that provides the solutions for the aforementioned concepts of online retail and wholesale stores nationalization and localization; solutions for online store setting up including store front design, inside design, products uploading and how to run promotions inside and outside the stores; online space rental; online space reservation; online store space bid; online store space auction; online commercial text, banner and video ads nationalization and localization; online commercial ads (text, image and video) self-creation methods; video shopping; window shopping; shop together; virtual 3D animation shop; billboards; skyways; street vendors; shopping centers; non-shopping centers; contest to win; sweep stakes; holiday shopping; online advertising spots posting, reservation, bid and auction; programs for media publishers to create and transfer classified ad contents on the website.

The online platform contains 300,000 retail and wholesale stores up from national down to local level. Many of retail and wholesale locations have virtual 3D animation effects. The user can set up stores, upload and sell products and run promotional ads inside and outside stores using the free online tools. The user can also select and use services like On Sale, Special Deals, Clearance, Overstock, Products and Services Promotion, Products Shown on TV, New and Unique Products; Weekly & Monthly Ads catalogs etc. to create text, image or video ads anywhere anytime they want. Users can invite friends to shop online together. There are three communities plus a local community in each metro area where users can socialize with each other.

The website has nine different levels up from the national level down to the local levels. It covers 50 states, 363 metro areas, 2103 cities and close to 1000 industries in the US. It has millions of advertising spots for image and video advertisement. There are more than 100 services throughout the website.

### BRIEF DESCRIPTION OF THE DRAWINGS

FIG. 1 is a block diagram of client server computer system that provides the exemplary operating environment for the user in module 1.

FIG. 2 is a block diagram of client server computer system that provides the exemplary operating environment for the user in module 2.

FIG. 3 is a block diagram of client server computer system that provides the exemplary operating environment for the client (business) in module 1.

FIG. 4 is a block diagram of client server computer system that provides the exemplary operating environment for the client (business) in module 2.

FIG. 5 is a block diagram of client server computer system that provides the exemplary operating environment for ad contents creation in module 1.

FIG. 6 is a block diagram of client server computer system that provides the exemplary operating environment for ad contents creation in module 2.

FIG. 7 is a logic flow diagram illustrating an exemplary sub-process to Interface Design 1 at the first level for posting video and image ads in module 1.

FIG. 8 is a logic flow diagram illustrating an exemplary sub-process to Interface Design 2 at the first level for posting video and image ads in module 1.

FIG. 9 is a logic flow diagram illustrating an exemplary sub-process to Interface Design 3 at the first level for posting video and image ads in module 1.

FIG. 10 is a logic flow diagram illustrating an exemplary sub-process to Interface Design 3, Content Design 4 at the first level for shop together in module 1.

FIG. 11 is a logic flow diagram illustrating an exemplary sub-process to Interface Design 3, Content Design 5 at the first level for store set up solution, service group 2, in module 1.

FIG. 12 is a logic flow diagram illustrating an exemplary sub-process to Interface Design 3, Content Design 6 at the first level for billboards, skyways and street vendors in module 1.

FIG. 13 is a logic flow diagram illustrating an exemplary sub-process to Interface Design 3, Content Design 7 at the first level for service group 1 in module 1.

FIG. 14 is a logic flow diagram illustrating an exemplary sub-process to Interface Design 3, Content Design 8 at the first level for VIP ads showroom in module 1.

FIG. 15 is a logic flow diagram illustrating an exemplary sub-process to Interface Design 3, Content Design 9 at the first level for products shown on TV in module 1.

FIG. 16 is a logic flow diagram illustrating an exemplary sub-process to Interface Design 3, Content Design 10 at the first level for service group 3 in module 1.

FIG. 17 is a logic flow diagram illustrating an exemplary sub-process to Interface Design 3, Content Design 11 at the first level for service group 4 in module 1.

FIG. 18 is a logic flow diagram illustrating an exemplary sub-process to Interface Design 3, Content Design 12 at the first level for expose business in module 1.

FIG. 19 is a logic flow diagram illustrating an exemplary sub-process to Interface Design 3, Content Design 13 at the first level for contest to win in module 1.

FIG. 20 is a logic flow diagram illustrating an exemplary sub-process to Interface Design 3, Content Design 14 at the first level for Sweepstakes in module 1.

FIG. 21 is a logic flow diagram illustrating an exemplary sub-process to Interface Design 3, Content Design 15 at the first level for my stuff in module 1.

FIG. 22 is a logic flow diagram illustrating an exemplary sub-process to Interface Design 3, Content Design 16 at the first level for membership in module 1.

FIG. 23 is a logic flow diagram illustrating an exemplary sub-process to Interface Design 3, Content Design 17 at the first level for marketing tools in module 1.

FIG. 24 is a logic flow diagram illustrating an exemplary sub-process to Interface Design 3, Content Design 18 at the first level for authorized agents in module 1.

FIG. 25 is a logic flow diagram illustrating an exemplary sub-process to Interface Design 3, Content Design 19 at the first level for community in module 1.

FIG. 26 is a logic flow diagram illustrating an exemplary sub-process to Interface Design 3, Content Design 20 at the first level community, our friends group in module 1.

FIG. 27 is a logic flow diagram illustrating an exemplary sub-process to Interface Design 3, Content Design 21 at the first level for community, chat room in module 1.

FIG. 28 is a logic flow diagram illustrating an exemplary sub-process to Interface Design 3, Content Design 22 at the first level for community, become friends in module 1.

FIG. 29 is a logic flow diagram illustrating an exemplary sub-process to Interface Design 3, Content Design 23 at the first level for business community in module 1.

FIG. 30 is a logic flow diagram illustrating an exemplary sub-process to Interface Design 3, Content Design 24 at the first level for U.S. travel in module 1.

FIG. 31 is a logic flow diagram illustrating an exemplary sub-process to Interface Design 3, Content Design 25 at the first level for publisher classified ads in module 1.

FIG. 32 is a logic flow diagram illustrating an exemplary sub-process to Interface Design 4 at the first level for posting video and image ads in module 1.

FIG. 33 is a logic flow diagram illustrating an exemplary sub-process to Interface Design 5 at the second level for posting video and image ads in module 1.

FIG. 34 is a logic flow diagram illustrating an exemplary sub-process to Interface Design 5, Content Design 15 at the second level for service group 1 in module 1.

FIG. 35 is a logic flow diagram illustrating an exemplary sub-process to Interface Design 5, Content Design 4 at the second level for shop together.

FIG. 36 is a logic flow diagram illustrating an exemplary sub-process to Interface Design 5, Content Design 5 at the second level for store set up solution, service group 2, in module 1.

FIG. 37 is a logic flow diagram illustrating an exemplary sub-process to Interface Design 6 at the second level for posting video and image ads in module 1.

FIG. 38 is a logic flow diagram illustrating an exemplary sub-process to Interface Design 2, Content Design 2 at the third level for posting video and image ads in module 1.

FIG. 39 is a logic flow diagram illustrating an exemplary sub-process to Interface Design 2, Content Design 3 at the third level for posting video and image ads in module 1.

FIG. 40 is a logic flow diagram illustrating an exemplary sub-process to Interface Design 3, Content Design 4 at the third level for shop together.

FIG. 41 is a logic flow diagram illustrating an exemplary sub-process to Interface Design 3, Content Design 5 at the third level for store set up solution, service group 2, in module 1.

FIG. 42 is a logic flow diagram illustrating an exemplary sub-process to Interface Design 3, Content Design 7 at the third level for service group 1 in module 1.

FIG. 43 is a logic flow diagram illustrating an exemplary sub-process to Interface Design 3, Content Design 10 at the third level for service group 3 in module 1.

FIG. 44 is a logic flow diagram illustrating an exemplary sub-process to Interface Design 3, Content Design 8 at the third level for VIP ads showroom in module 1.

FIG. 45 is a logic flow diagram illustrating an exemplary sub-process to Interface Design 3, Content Design 30 at the third level for European Market, Hispanic Town and Asia Square in module 1.

FIG. 46 is a logic flow diagram illustrating an exemplary sub-process to Interface Design 3, Content Design 33 at the third level for local community in module 1.

FIG. 47 is a logic flow diagram illustrating an exemplary sub-process to Interface Design 3, Content Design 25 at the third level for publisher's classified ads in module 1.

FIG. 48 is a logic flow diagram illustrating an exemplary sub-process to Interface Design 5, Content Design 27 at the fourth level for posting banner and video ads in module 1.

FIG. 49 is a logic flow diagram illustrating an exemplary sub-process to Interface Design 5, Content Design 4 at the fourth level for shop together in module 1.

FIG. 50 is a logic flow diagram illustrating an exemplary sub-process to Interface Design 5, Content Design 7 at the fourth level for service group 1 in module 1.

FIG. 51 is a logic flow diagram illustrating an exemplary sub-process to Interface Design 5, Content Design 4 at the fourth level for store set up solution, service group 2, in module 1.

FIG. 52 is a logic flow diagram illustrating an exemplary sub-process to Interface Design 5, Content Design 10 at the fourth level for service group 3 in module 1.

FIG. 53 is a logic flow diagram illustrating an exemplary sub-process to Interface Design 5, Content Design 34 at the fourth level for shopping centers in module 1.

FIG. 54 is a logic flow diagram illustrating an exemplary sub-process to Interface Design 5, Content Design 35 at the fourth level for non-shopping centers in module 1.

FIG. 55 is a logic flow diagram illustrating an exemplary sub-process to Interface Design 7, Content Design 31 at the fourth level for banner and video ads in module 1.

FIG. 56 is a logic flow diagram illustrating an exemplary sub-process to Interface Design 8, Content Design 32 at the fifth level for banner and video ads in module 1.

FIG. 57 is a logic flow diagram illustrating an exemplary sub-process to Interface Design 8, Content Design 4 at the fifth level for shop together in module 1.

FIG. 58 is a logic flow diagram illustrating an exemplary sub-process to Interface Design 8, Content Design 7 at the fifth level for service group 1 and listing in module 1.

FIG. 59 is a logic flow diagram illustrating an exemplary sub-process to Interface Design 8, Content Design 10 at the fifth level for service group 3 in module 1.

FIG. 60 is a logic flow diagram illustrating an exemplary sub-process to User Interface Design 1 at the sixth level for posting video and image ads in module 2.

FIG. 61 is a logic flow diagram illustrating an exemplary sub-process to User Interface Design 2 at the sixth level for posting video and image ads in module 2.

FIG. 62 is a logic flow diagram illustrating an exemplary sub-process to User Interface Design 3 at the sixth level for posting video and image ads in module 2.

FIG. 63 is a logic flow diagram illustrating an exemplary sub-process to Interface Design 3, Content Design 4 at the sixth level for shop together in module 2.

FIG. 64 is a logic flow diagram illustrating an exemplary sub-process to Interface Design 3, Content Design 5 at the sixth level for store set up solution, service group 2, in module 2.

FIG. 65 is a logic flow diagram illustrating an exemplary sub-process to Interface Design 3, Content Design 7 at the sixth level for service group 1 in module 2.

FIG. 66 is a logic flow diagram illustrating an exemplary sub-process to Interface Design 3, Content Design 8 at the sixth level for VIP ads showroom in module 2.

FIG. 67 is a logic flow diagram illustrating an exemplary sub-process to Interface Design 3, Content Design 9 at the sixth level for products shown on TV in module 2.

FIG. 68 is a logic flow diagram illustrating an exemplary sub-process to Interface Design 3, Content Design 10 at the sixth level for service group 3 in module 2.

FIG. 69 is a logic flow diagram illustrating an exemplary sub-process to Interface Design 3, Content Design 11 at the sixth level for service group 4 in module 2.

FIG. 70 is a logic flow diagram illustrating an exemplary sub-process to Interface Design 3, Content Design 12 at the six level for expose business in module 2.

FIG. 71 is a logic flow diagram illustrating an exemplary sub-process to Interface Design 3, Content Design 13 at the sixth level for contest to win in module 2.

FIG. 72 is a logic flow diagram illustrating an exemplary sub-process to Interface Design 3, Content Design 14 at the sixth level for sweepstakes in module 2.

FIG. 73 is a logic flow diagram illustrating an exemplary sub-process to Interface Design 3, Content Design 15 at the sixth level for my stuff in module 2.

FIG. 74 is a logic flow diagram illustrating an exemplary sub-process to Interface Design 3, Content Design 16 at the sixth level for membership in module 2.

FIG. 75 is a logic flow diagram illustrating an exemplary sub-process to Interface Design 3, Content Design 17 at the sixth level for marketing tools in module 2.

FIG. 76 is a logic flow diagram illustrating an exemplary sub-process to Interface Design 3, Content Design 18 at the sixth level for authorized agents in module 2.

FIG. 77 is a logic flow diagram illustrating an exemplary sub-process to Interface Design 3, Content Design 19 at the sixth level for community in module 2.

FIG. 78 is a logic flow diagram illustrating an exemplary sub-process to Interface Design 3, Content Design 20 at the sixth level for community, our friends group, in module 2.

FIG. 79 is a logic flow diagram illustrating an exemplary sub-process to Interface Design 3, Content Design 21 at the sixth level for community, chat room, in module 2.

FIG. 80 is a logic flow diagram illustrating an exemplary sub-process to Interface Design 3, Content Design 22 at the sixth level for community, become friends, in module 2.

FIG. 81 is a logic flow diagram illustrating an exemplary sub-process to Interface Design 3, Content Design 23 at the sixth level for business community in module 2.

FIG. 82 is a logic flow diagram illustrating an exemplary sub-process to Interface Design 4 at the sixth level for posting video and image ads in module 2.

FIG. 83 is a logic flow diagram illustrating an exemplary sub-process to Interface Design 9 at the seventh level for posting video and image ads in module 2.

FIG. 84 is a logic flow diagram illustrating an exemplary sub-process to Interface Design 2 at the eighth level for posting video and image ads in module 2.

FIG. 85 is a logic flow diagram illustrating an exemplary sub-process to Interface Design 2 at the eighth level for posting video and image ads in module 2.

FIG. 86 is a logic flow diagram illustrating an exemplary sub-process to Interface Design 3 at the eighth level for shop together in module 2.

FIG. 87 is a logic flow diagram illustrating an exemplary sub-process to Interface Design 3 at the eighth level for service group 1 in module 2.

FIG. 88 is a logic flow diagram illustrating an exemplary sub-process to Interface Design 3 at the eighth level for store set up solution in module 2.

FIG. 89 is a logic flow diagram illustrating an exemplary sub-process to Interface Design 10 at the eighth level for posting video and image ads in module 2.

FIG. 90 is a logic flow diagram illustrating an exemplary sub-process to Interface Design 8, Content Design 32 at the ninth level for banner and video ads in module 2.

FIG. 91 is a logic flow diagram illustrating an exemplary sub-process to Interface Design 8, Content Design 4 at the ninth level for shop together in module 2.

FIG. 92 is a logic flow diagram illustrating an exemplary sub-process to Interface Design 8, Content Design 7 at the ninth level for service group 1 and listing in module 2.

FIG. 93 is a logic flow diagram illustrating an exemplary sub-process to Interface Design 8, Content Design 10 at the ninth level for service group 3 in module 2.

FIG. 94 is a logic flow diagram illustrating an exemplary sub-process to Content Design 36 at all levels for store space and ad spot reservation, bid, and auction in module 1 and 2.

### DETAILED DESCRIPTION OF EXEMPLARY EMBODIMENTS

The present invention provides the solutions for online store setting up, ads-self creation and post, and shopping online together solutions. Users are required to have accounts to do activities on the website such as shopping, creating and posting ads, and managing the accounts etc. Having an account is for the purpose of keeping records, tracing activities, creating and updating contents, and checking status etc. Once an account is established, all the information related to the account will be saved in the database files. The user can access to their accounts to create, renew, modify, delete, turn it on and off, and check status etc. There are over 100 different services that they can select under the two major modules. When a service is selected, the steps toward completing the service job are initiated, triggers are fired and the results happen. The data created needs to be verified, dispatched and saved.

Although the preferred embodiment will be generally described in the context of a program and an operating system running on a personal computer, those skilled in the art will recognize that the present invention also can be implemented in conjunction with other program modules for other types of computers. Furthermore, those skilled in the art will recognize that the present invention may be implemented in different network environments.

For example, in a two-tier network, a user communicates directly with a server. This is also known as a client-server architecture. A client-server network is an architecture that involves user processes that request service from server processes. The user and server communicate over a network using a given protocol, which must be installed on both the user and the server. In an N-tier architecture, the role of the middle-tier agent can be manifold. It can provide: translation services (as in adapting a legacy application on a mainframe to a user-server environment or acting as a bridge between protocols); scalability services (as in acting as a transaction-processing monitor to balance the load of requests between servers); intelligent agent services (as in mapping a request to a number of different servers, collating the results, and returning a single response to a user). In a complex network environment, different hardware platforms run different operating systems; multiple protocols are used on these platforms; variable syntax exist between the different but connected applications; run on different geographical locations in which the connected applications reside. It supports a large-scale distributed system.

In a distributed computing environment, program modules may be physically located in different local and remote memory storage devices. Execution of the program modules many occur locally in a stand-alone manner or remotely in a user server manner. Examples of such distributed computing environments include local area networks of an office, enterprise-wide computer networks and the global interne.

The detailed description which follows is represented largely in terms of processes and symbolic representations of operations by conventional computer components, including a central processing unit (CPU), memory storage devices for the CPU, display devices, and input devices. Furthermore, these processes and operations may utilize conventional computer components in a heterogeneous distributed computing environment, including remote file servers, remote computer servers, and remote memory storage devices. Each of these conventional distributed computing components is accessible by the CPU via a communication network.

The processes and operations performed by the computer include the manipulation of signals by a CPU or remote server and the maintenance of these signals within data structures resident in one or more of the local or remote memory storage devices.

For the purpose of this discussion, a process is generally conceived to be a sequence of computer-executed steps leading to a desired result. These steps usually require physical manipulation of physical quantities. Usually, though not necessarily, these quantities take the form of electrical, magnetic, or optical signals capable of being stored, transferred, combined, compared, or otherwise manipulated. It is convention for those skilled in the art to refer to representation of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as creating, adding, changing, modifying, saving, calculating, comparing, moving, receiving, determining, identifying, populating, loading, executing, etc. that are often associated with manual operations performed by a human operator. The operations described herein can be machine operations performed in conjunction with various input provided by a human operator or a user that interacts with the computer.

In addition, it should be understood that the programs, processes, methods, etc. described herein are not related or limited to any particular computer or apparatus. Rather various types of general purpose machines may be used with the program modules constructed in accordance with the teachings described herein. Similarly, it may prove advantageous to construct a specialized apparatus to perform the method steps described herein by the way of dedicated computer systems in specific network architecture with hardwired logic or programs stored in nonvolatile memory, such as ready-only memory.

Such data structures impose a physical organization upon the collection of data stored within a memory storage device and represent specific electrical or magnetic elements. These symbolic representations are the means used by those skilled in the art of computer programming and computer construction to most effectively convey teachings and discoveries to other skilled in the art.

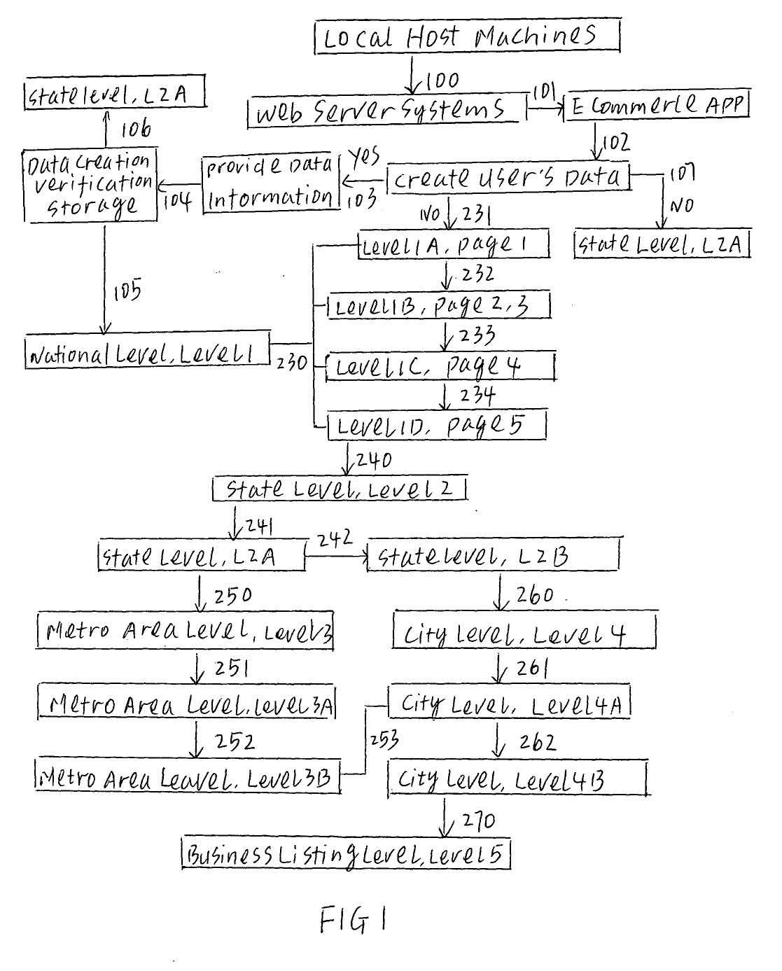

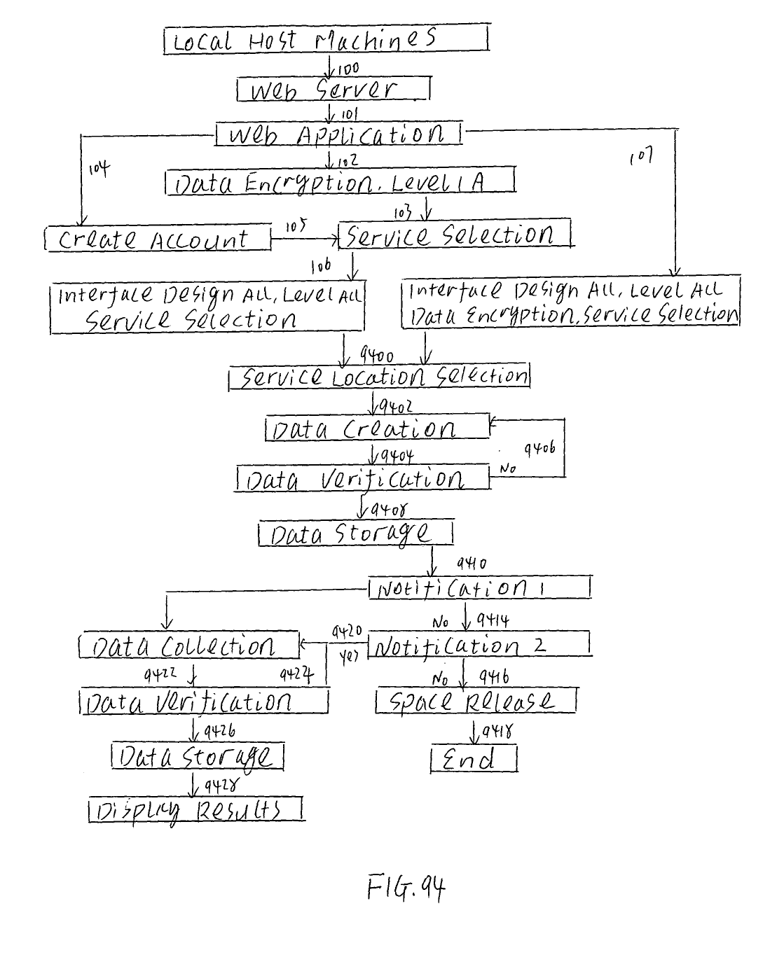

Description and illustration of how to navigate and use the website have been discussed in Part 1 from page 7 to page 20. How to set up store, post ads and update contents in accounts have been illustrated from page 20 to page 29 in Part 2. Following detailed description of each FIG. 1-94 will explain technically how the platform is built. (Page 29-207).

Referring now to the drawings, in which like numerals represent like elements throughout the Figures, aspects of the present invention and the illustrative operating environment will be described.

Referring now to FIG. 1, this figure is a functional block diagram illustrating exemplary system architecture according to one exemplary embodiment of the present invention. The exemplary system architecture comprises a computer system and a web application with databases. The computer system consists of a stand-alone user local machine and a computer server. The web applications with databases are stored on the hard disk within the computer server. The computer system is operated within networks and internet.

The local user connects to the internet (Step 100). The connection is a communication pathway between a user process and a server process. The user logs on to the operating system on a local computer and connects over a network to the computer running web applications. The user originates the request. A process is created on the client. The process is called user process. The server listens, receives, parses and executes the request sent from the user process. This process is called a server process. The process communicates with the server on behalf of the user process. The server process executes the request. After the process finishes, the returned result is sent back to the user.

The web application displays graphic interface which is the first page of the website (Step 101). The interface is made up of items. Items are used to present information from the database or to act as control. The web application is event-driven. An event occurs and the application responds to it. An event is either an interface event, which corresponds to a user action, or an internal processing event, which corresponds to a system action.

Step 101 provides the option for the user to create account (Step 102). If the user chooses to create account, he or she is required to provide information (Step 103). After the information is provided, the account is created (Step 104). The account information is saved on the server. The user can either choose to go to the first level (National Level, Step 105) or the second level (State Level, Step 106). Going to the national level takes the route 230.

If the user chooses not to create account in the step 102, he or she can continue with either the step 107 which goes directly to the state level or takes the route 230 which goes to the national level. Route 230 consists of Step 231, 232, 233 and 234. They are the steps leading to each page at the national level. The user reaches the second level (State Level, Route 240) followed by taking the step 234.

Route 240 consists of Step 241 and 242. They are the steps leading to each page at the second level. From the step 241, the user takes the route 250 to the third level which is the metro area level or the route 260 through the step 242 to the fourth level which is the city level.

Route 250 consists of Step 251 and 252. They are the steps leading to all the pages at the third level. The user accesses to the fourth level by taking the step 253.

Route 260 consists of Step 261 and 262. They are the steps leading to each page at the fourth level. The user takes the route 270 to the last level (Level 5) of module 1 which is the business listing level through the step 262.

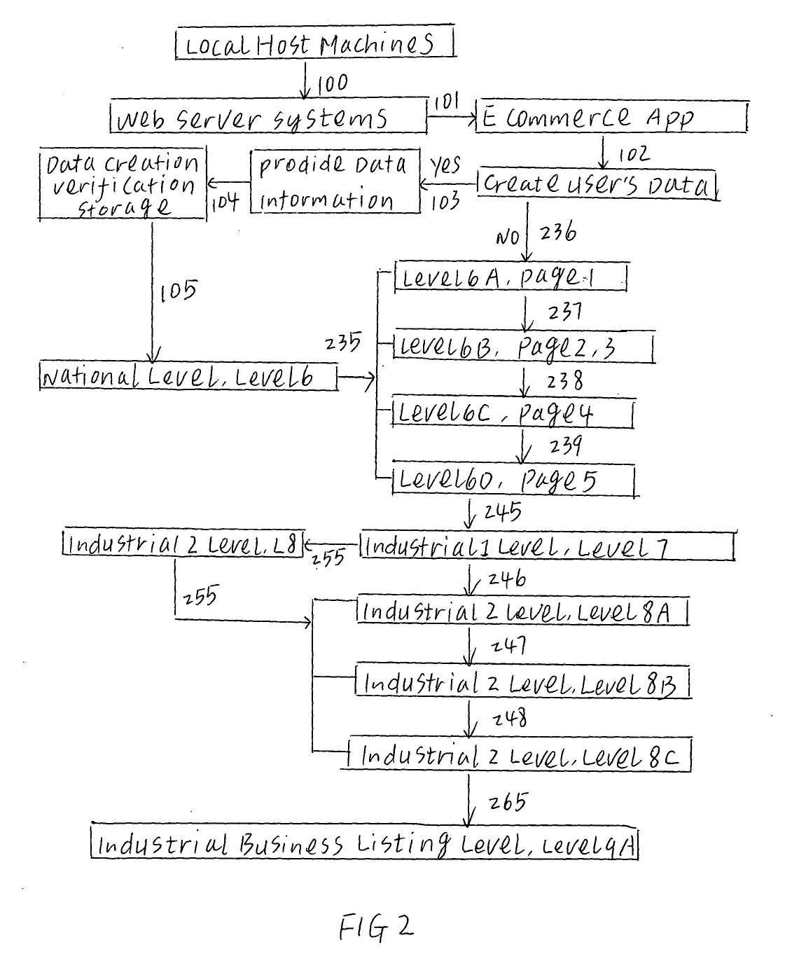

Referring now to FIG. 2, this figure has the similar architect structure as described in FIG. 1. It occurs in the module 2. The local user connects to the internet (Step 100). The web application displays graphic interface which is the first page of the website (Step 101). In 101 it provides the option for the user to create account (Step 102). If the user creates account here, he or she is required to provide information (Step 103). The information of an account contains personal or company information such as name, address, city, state, zip code, home phone number, cell phone number, fax number, website, gender, age and industry etc. After the information is provided, the account is created (Step 104). The account information is saved on the server. The user goes to the sixth level (Industrial National Level, Step 105) by taking the route 235.

If the user chooses not to create account in the step 102, he or she continues with the route 235 which goes to the industrial national level. Route 235 consists of Step 236, 237, 238 and 239. They are the steps leading to each page at the industrial national level.

The user goes to the seventh level (Industrial First Level, Route 245) followed by taking the step 239. From the step 245, the user takes the route 255 to the eighth level which is the industrial second level through the step 246.

Route 255 consists of Step 246, 247 and 248. They are the steps leading to all the pages at the eighth level. From the step 248, the user accesses to the last level (Level 9) of the module 2 which is the business listing level.

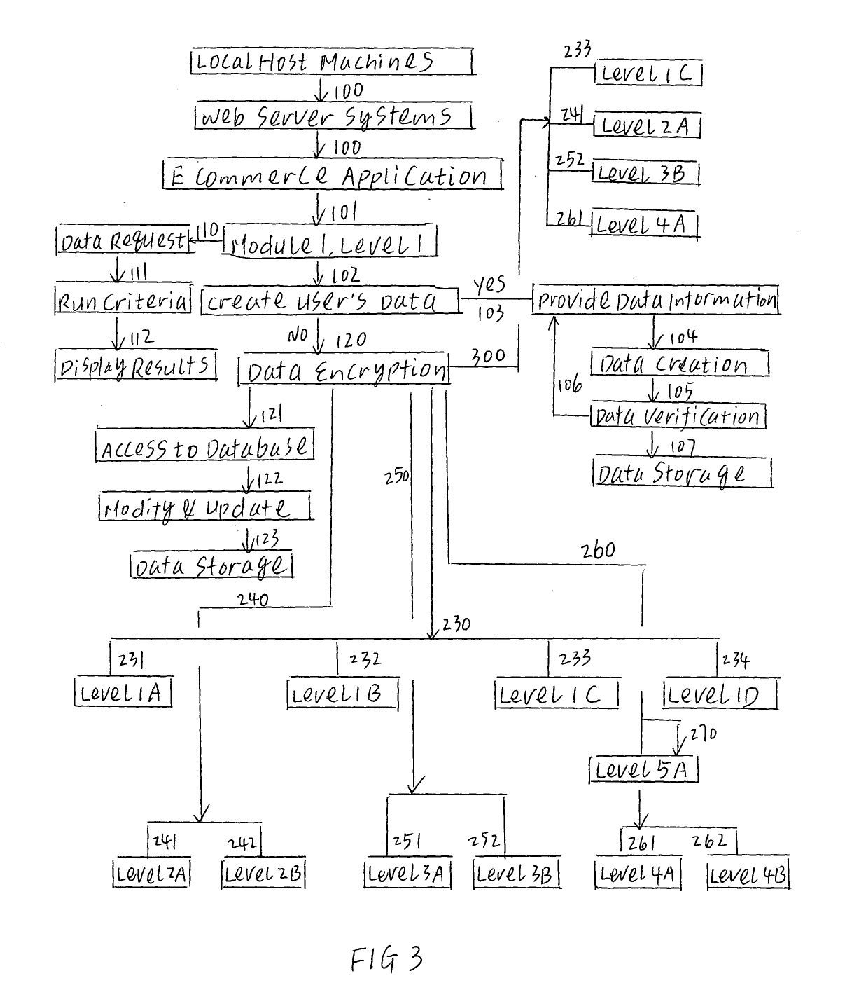

Referring to FIG. 3, this is the process flow diagram illustrating what happens when events occur on the first page at the first level in Module 1. The local user connects to the internet (Step 100). The web application displays graphic interface which is the first page of the website (Step 101). In 101 it provides the option for the user to create account (Step 102); search (Step 110); authentication for the user to access to the account (Step 121); shop at different levels (Route 300); and goes to other different levels (Step 231,232,233,234,241, 242,251,252,261 and 270).

If the user chooses to create account in the step 101, he or she is required to provide information (Step 103). The information includes personal or company information like name, address, city, state, zip code, home phone number, cell phone number, fax number, website, gender, age and industry etc. All the information is saved once it is created and verified (Step 104,105, 106 and 107). The user uses the username and password to login to the account and do activities. Taking the route 110, the user goes to Search. In this step data needs to be provided in order to run criteria (Step 111). When the process finishes, the result(s) are displayed (Step 112).

If the user chooses not to create account, he or she A). visits the website without the account being authenticated. B). logs into the account (Step 121) to a). check, create, modify, delete and update the contents etc (Step 122). The updated data is stored in the database (Step 123). b). go shopping (Route 300, Step 233, 241,252 and 261). All the data generated during shopping is saved. c). go to Level 1, 2, 3, 4 or 5 to look, check and participate etc. (Step 231, 232, 233, 234, 241, 242, 251, 252, 261, 262 and 270). All the created data during the process is saved in the data files on the server.

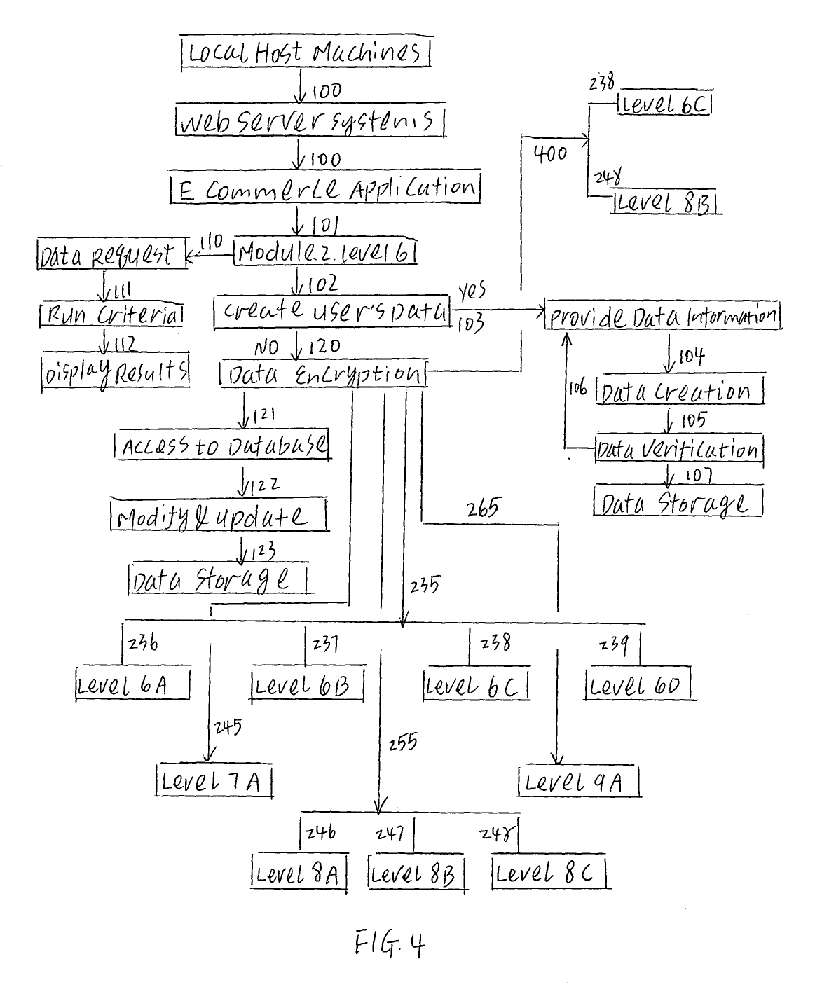

Referring to FIG. 4, this is the process flow diagram illustrating what happens when events occur on the first page at the sixth level in Module 2. The local user connects to the internet (Step 100). The web application displays graphic interface which is the first page of the website (Step 101). In 101 it provides the option for the user to create account (Step 102); search (Step 110); authentication for the user to access to the account (Step 121); shop at different levels (Route 400); and go to other different levels (Step 236,237,238,239,245,246,247,248 and 265).

If the user chooses to create account in the step 101, he or she is required to provide information (Step 103). The information include personal or company information like name, address, city, state, zip code, home phone number, cell phone number, fax number, website, gender, age and industry etc. All the information is saved once it is created and verified (Step 104,105, 106 and 107). The user uses the username and password to login into the account and do other activities. The user takes the route 110 to search. Data needs to be provided in order to run criteria (Step 111). When the process finishes, the result(s) are displayed (Step 112).

If the user chooses not to create account, he or she can A). visit the website without the account being authenticated. B). login into the account (Step 121) to a). check, create, modify, delete and update etc (Step 122). The updated data is stored in the database (Step 123). b). go shopping (Route 400, Step 238 and 248). All the data generated during shopping is saved. c). go to Level 6, 7, 8, or 9 to look, check and participate etc. (Step 236, 237, 238, 239, 245, 246, 247, 248, and 265). All the data created is saved in the data files on the server.

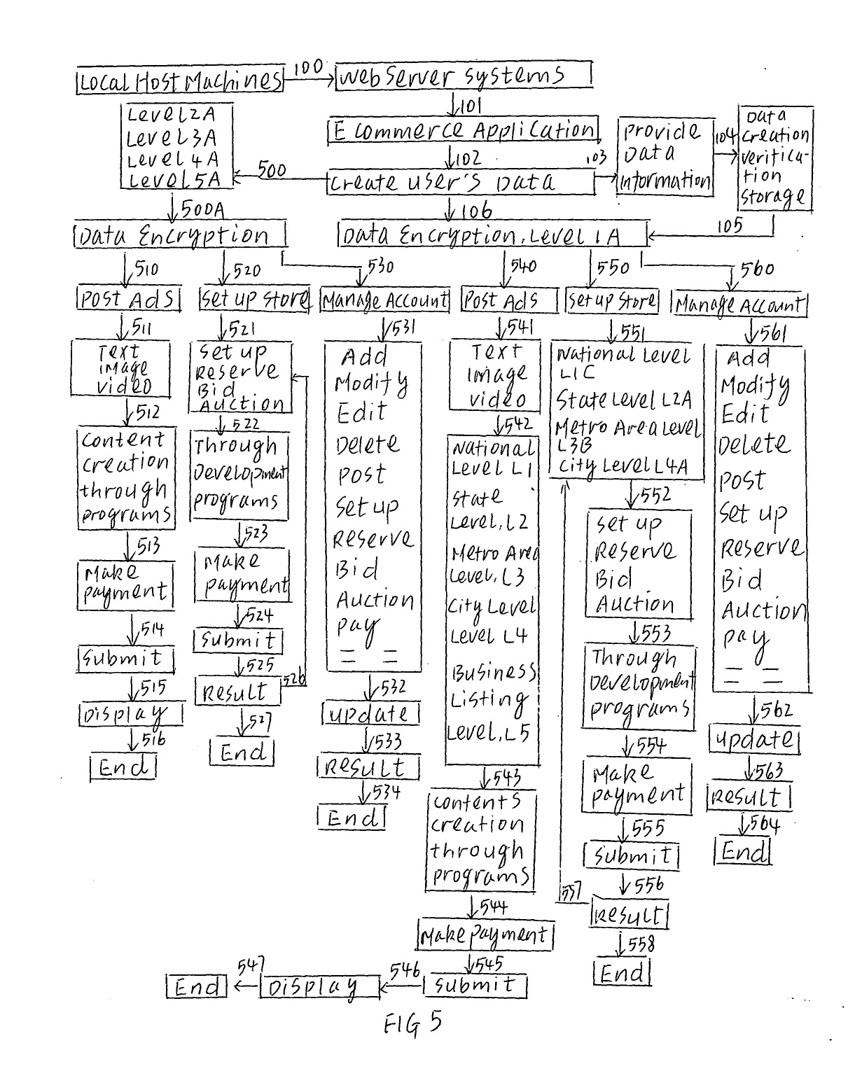

Referring to FIG. 5, this is the process flow diagram illustrating what the user can do at different levels in Module 1. The local user connects to the internet (Step 100). The web application displays graphic interface which is the first page of the website (Step 101). In 101 it provides the option for the user to create account (Step 102). The user needs to provide necessary information (Step 103). After the information is provided, the account is created and the account information is saved on the server (Step 104). The user can set up store, create and post ad or visit the website.

If the user has an account, he or she can set up store, create and post ads, and update the account at any level after logging into the account.

A). Selecting a service category at different levels. Taking the route 500 the user can go to Level 2A, Level 3A, Level 4A, or Level 5A. The account needs to be authenticated at the level that the user chooses. After the authentication is done, the user has three choices: a). Post Ads (Step 510); b). Set Up Store (Step 520); or c). Manage Account (Step 530).

a). If the user selects Post Ads (Step 510), there are three advertising choices: Text; Banner and Video. The user selects one of them (Step 511). The user follows each step before the advertisement is created. The data created needs to be verified and saved (Step 512). The user selects the payment method or makes the payment online (Step 513) before submitting the advertisement (Step 514). The result is displayed (Step 515). The process ends at either the advertisement being taken offline or a new process beginning by renewal (Step 516).

b). If the user selects Set Up Store (Step 520), he or she chooses a location and picks a choice from: Set Up; Reserve; Bid and Auction. The user chooses one of them and follows each step (Step 521) before the data is created, verified and saved (Step 522). The user selects the payment method or makes the payment online (Step 523) before finishing the process (Step 524). The results are display after the payment is made (Step 525). The process ends at the store being set up; the store space with or without being reserved, bid and auctioned (Step 526, 527).

c). If the user selects Manage Account (Step 530), he or she accesses to the account after authentication. The user manipulates the data such as create, post, add, change, modify, delete, set up store, reserve, bid, auction, check, and make the payment etc. (Step 531). The new data is saved (Step 533) after the contents are updated (Step 532). The process ends when the user logs out of the account at the step 534.

B). Selecting a service category after the user logs into the account at the first level. Taking Route 106 leads to the first level. The user logs into the account through authentication. After the authentication is done, the user has three choices: a). Post Ads (Step 540); b). Set Up Store (Step 550); c). Manage Account (Step 560).

a). If the user selects Post Ads (Step 540), there are three advertising choices: Text; Banner and Video. The user chooses one of them (Step 541). It lists all the levels under module 1 (Step 542). After the user selects one of the levels, picks a service and follows each step, the advertisement is created. The created advertisement data needs to be verified before saving (Step 543). The user selects the payment method or makes the payment online (Step 544). And the advertisement is submitted and shown (Step 545, 546). The process ends at either the advertisement being taken offline or a new process beginning after renewal (Step 547).

b). If the user selects Set Up Store (Step 550), he or she selects where the store he or she wants to open (Step 551). After the selection is made, the user has four choices: set up; reserve; bid and auction. The user chooses one of them (Step 552) and follows the steps before the store is set up. The created data need to verified. After the verification, it is saved (Step 553). The user selects the payment method or makes the payment online (Step 554) before finishing the process (Step 555). The store is ready to open (Step 556). The process ends at the store being set up; the store space with or without being reserved, bid and auctioned (Step 567, 568).

c). If the user selects Manage Account (Step 560), he or she accesses to the account after authentication. The user manipulates the data such as create, post, add, change, modify, delete, set up store, reserve, bid, auction, check, and make payment etc. (Step 561). The new data is saved (Step 563) after the contents are updated (Step 562). The process ends when the user logs out of the account at the step 564.

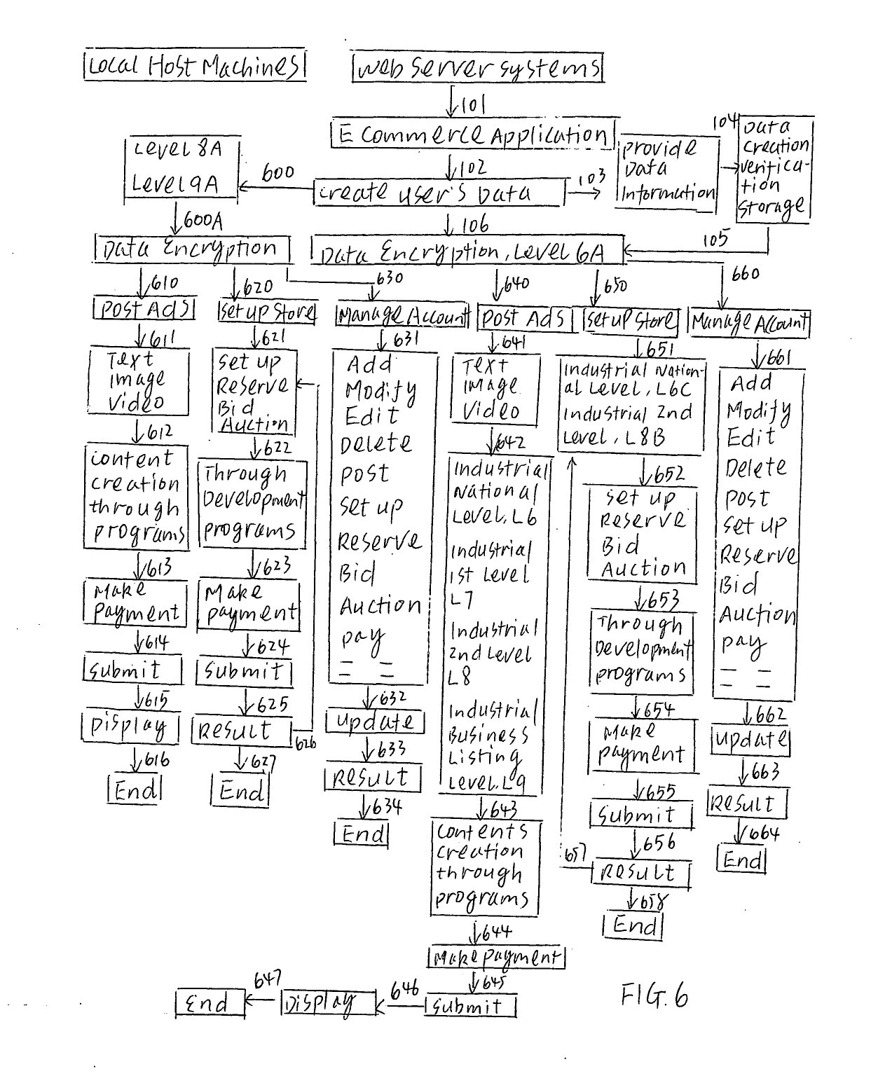

Referring to FIG. 6, this is the process flow diagram illustrating what the user can do at different levels in Module 2. The local user connects to the internet (Step 100). The web application displays graphic interface which is the first page of the website (Step 101). In the step 101 it provides the option for the user to create account (Step 102). The user needs to provide necessary information (Step 103). After the information is provided, the account is created and the account information is saved on the server (Step 104). The user can set up store, create and post ad or visit the website.

If the user has an account, he or she can set up store, create and post ads, and update the account at any level after logging into the account.

A). Selecting a service at different level. Taking the route 600 the user goes to Level 2A, Level 3A, Level 4A, or Level 5A. The account needs to be authenticated at the level that the user chooses. After the authentication is done, the user has three choices: a). Post Ads (Step 610); b). Set Up Store (Step 620); or c). Manage Account (Step 630).

a). If the user selects Post Ads (Step 610), there are three advertising choices: Text; Banner and Video. The user selects one of them (Step 611). The user follows each step before the advertisement is created. The data created needs to be verified and saved (Step 612). The user selects the payment method or makes the payment online (Step 613) before submitting the advertisement (Step 614). The result is displayed (Step 615). The process ends at either the advertisement being taken offline or a new process beginning after renewal (Step 616).

b). If the user selects Set Up Store (Step 620), he or she chooses a location and picks a choice from: Set Up; Reserve; Bid and Auction. The user chooses one of them and follows each step (Step 621) before the data is created, verified and saved (Step 622). The user selects the payment method or makes the payment online (Step 623) before finishing the process (Step 624). The results are displayed after the payment is made (Step 625). The process ends at the store being set up; the store space with or without being reserved, bid and auctioned (Step 626, 627).

c). If the user selects Manage Account (Step 630), he or she accesses to the account after authentication. The user manipulates the data such as create, post, add, change, modify, delete, set up store, reserve, bid, auction, check, and make payment etc. (Step 631). The new data is saved (Step 633) after the contents are updated (Step 632). The process ends when the user logs out of the account at the step 634.

B). Selecting a service after the user logs into the account at the first level. Taking Route 106 leads to the first level. The user logs into the account through authentication. After the authentication is done, the user has three choices: a). Post Ads (Step 640); b). Set Up Store (Step 650); c). Manage Account (Step 660).

a). If the user selects Post Ads (Step 640), there are three advertising choices: Text; Banner and Video. The user chooses one of them (Step 641). It lists all the levels under module 1 (Step 642). After the user selects one of the levels, picks a service and follows each step, the advertisement is created. The created advertisement data needs to be verified before saving (Step 643). After the user selects the payment method or makes the payment online (Step 644), the advertisement is submitted and shown (Step 645, 646). The process ends at either the advertisement being taken offline or a new process beginning after renewal (Step 647).

b). If the user selects Set Up Store (Step 650), he or she selects where the store he or she wants to open (Step 651). After the selection is made, the user has four choices: set up; reserve; bid and auction. The user chooses one of them (Step 652) and follows the steps before the store is set up. The created data need to be verified. After the verification, it is saved (Step 653). The user selects the payment method or makes the payment online (Step 654) before submitting the work (Step 655). The store is ready to open (Step 656). The process ends at the store being set up; the store space with or without being reserved, bid and auctioned (Step 667, 668).

c). If the user selects Manage Account (Step 660), he or she accesses to the account after authentication. The user manipulates the data such as create, post, add, change, modify, delete, set up store, reserve, bid, auction, check, and make payment etc. (Step 661). The new data is saved (Step 663) after the contents are updated (Step 662). The process ends when the user logs out of the account at the step 664.

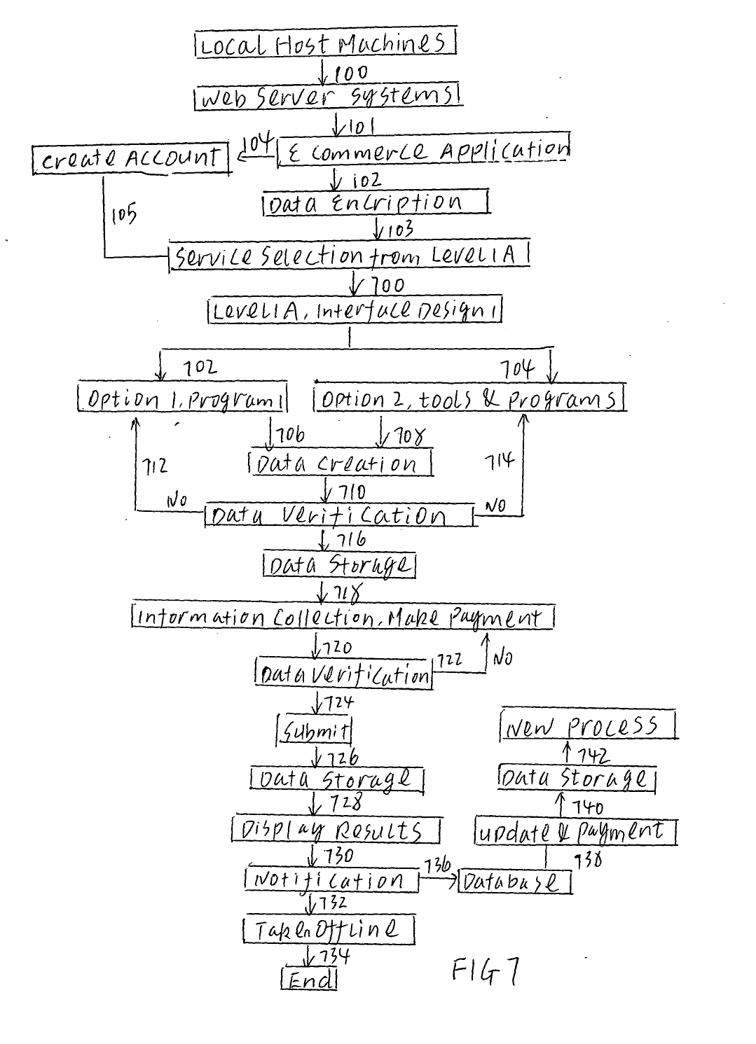

Referring to FIG. 7, this figure is a functional block diagram illustrating how the video and banner ads are created on the front page at the first level (National level). The user connects to the web server and access to the web application (Step 100,101). The connection is a communication pathway between a user process and a server process. The user logs onto the operating system on a local computer and connects over a network to the computer running web applications. The user originates the request. A process is created on the user. The process is called user process. The server listens, receives, parses and executes the request sent from the user process. This process is called a server process. The process communicates with the server on behalf of the user process. The server process executes the request. After the process finishes, the returned result is sent back to the user.

From the step 101, the user can create an account if he or she doesn't have one (Step 104). After creating an account, the user chooses a service at the first level (Step 105). If the user has an account, he or she provides data for encryption (Step 102). Data encryption is a process of authentication for users to start up and shut down a session. It is set up to be authenticated by the operating system. The data files are located in the database directory. When the data is encrypted, the user selects a service (Step 103). A service refers to either setting up store, creating advertisement or updating account. The next step is the step the user chooses a level, picks a page, selects a location and selects a service. A service refers to an advertising category such as on sale, special deals etc.

Text advertising solution is relatively easy. The user selects a level, chooses a service category and provides advertising contents. When it is done and the payment is made online, the text ad is saved and shown on the screen.

Step 700 is the step the user chooses to create banner or video ad on the front page, interface design 1. Interface Design 1 is made up of items. Items are used to present information from the database or to act as control. The web application is event-driven. An event occurs and the application responds to it. An event is either an interface event, which corresponds to a user action, or an internal processing event, which corresponds to a system action. The interface design 1 is compiled by java. It provides image and video solutions for displaying ads on the first page at the national level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are two advertising spots on the first page. One spot is for video advertisement. The other is for banner advertisement. The advertisement locations are pre-designed blocks. They are developed and stored with other programs on the server. When a spot is picked, the user is asked to make selections. ‘Selections’ are the decisions that the user needs to make to complete the advertisement work. The user has the option to take the step 702 or the step 704. Step 704 has more steps before getting the results, while the step 702 has fewer.

Step 704 contains tools and programs. The tools include custom designed advertising templates, background colors, patterns, canvas and editor. The programs are java stored program units. They help the user finish creating the advertisement. In the step 704 the user picks a template, chooses background color from Gallery 1 or Gallery 2, selects a canvas and a pattern, and uses the editor. The user follows the steps that are developed by java before getting the results (Step 708). The results refer to that the advertising location is picked; the advertisement is created; the data is created, verified and saved; and the payment is made etc. The data can be any image data types.

If the user chooses to go through the step 702, Program 1 initiates the server process. Program 1 is developed for video advertising. The server process parses the request and locates where the video is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed, the user process prepares to retrieve the data. C). Fetching, in the fetching stage, the file is selected and returned by the user to the server. One or more fetches may be required to transfer the result of a query to the user.

Once the result is returned (Step 706), it is brought up to the desktop for preview. Triggers are fired if functions like preview, upload, reset, submit and cancel are requested.

The data created from the step 706 and step 708 needs to be verified (Step 710). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 712 or the step 714 until the valid data is provided. If the data is good and complete, the server records the data and writes it to the data blocks in the database from database buffer cache (Step 716). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 718. After the data is collected, it needs to be verified (Step 720). The verification includes company or personal information such as company or personal name, company address, credit card number, expiration date, security code, bank route number and account number etc. If the data is not valid, the process takes the step 722 and goes back to the step 718 until the valid data is provided. If the data is valid, it is submitted and saved in the database (Step 724, 726), and the results is displayed (Step 728). The results refer to the advertising location being picked; the advertisement being created; the data being created, verified and saved; and the payment being made etc. The data can be any video data types.

Step 730 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 732 and 734). The second choice is waiting and taking action in the database (Step 736). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 738), the new data is saved in the database on the server (Step 740). A new process begins when the new advertisement is displayed for another period of time (Step 742).

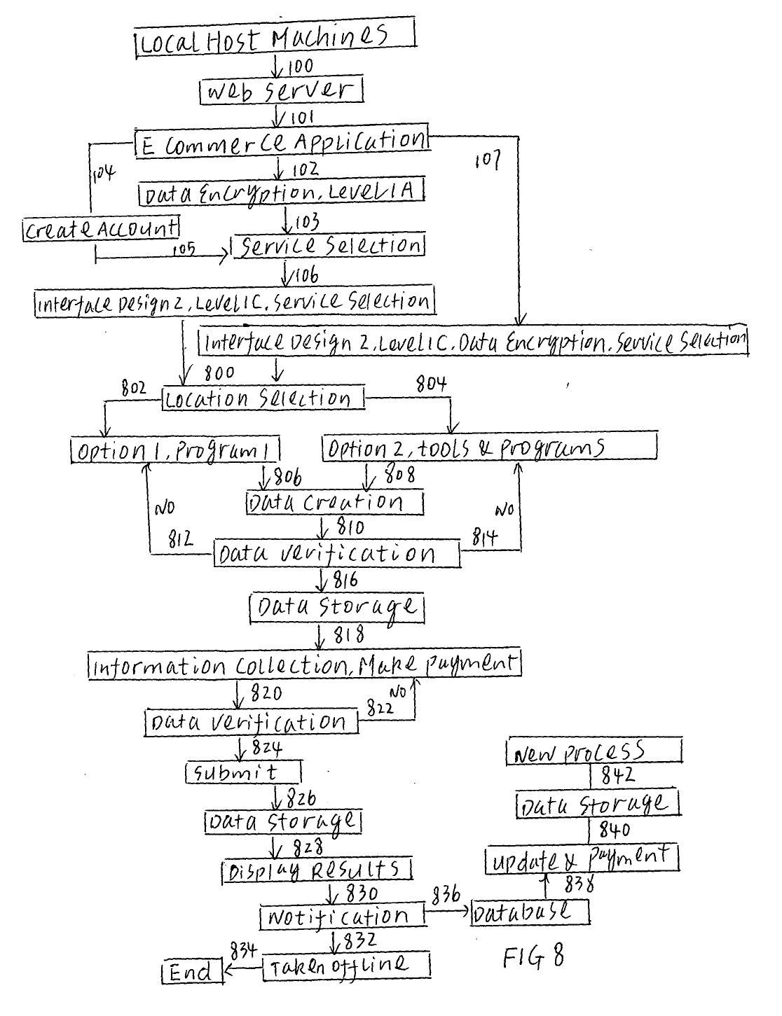

Referring to FIG. 8, this figure is a functional block diagram illustrating how the video and banner ads are created on the second and third page at the first level (National level). The user connects to the web server and access to the web application (Step 100,101). The connection is a communication pathway between a user process and a server process. The user logs onto the operating system on a local computer and connects over a network to the computer running web applications. The user originates the request. A process is created on the user. The process is called user process. The server listens, receives, parses and executes the request sent from the user process. This process is called a server process. The process communicates with the server on behalf of the user process. The server process executes the request. After the process finishes, the returned result is sent back to the user.

From the step 101, the user can create an account if he or she doesn't have one (Step 104). After creating an account, the user chooses a service at the first level (Step 105). If the user has an account, he or she provides data for encryption (Step 102). Data encryption is a process of authentication for users to start up and shut down a session. It is set up to be authenticated by the operating system. The data files are located in the database directory. When the data is encrypted, the user selects a service (Step 103). A service refers to either setting up store, creating advertisement or updating account. The next step is the step the user chooses a level, picks a page, selects a location or selects a service (Step 106). A service refers to an advertising category such as on sale, special deals etc.

Text advertising solution is relatively easy. The user selects a level, chooses a service category and provides advertising contents. When it is done and the payment is made online, the text ad is saved and shown on the screen.

Step 800 is the step that the user picks a spot and creates banner or video ad on the second and third page, interface design 2. Interface design 2 is made up of items. Items are used to present information from the database or to act as control. The web application is event-driven. An event occurs and the application responds to it. An event is either an interface event, which corresponds to a user action, or an internal processing event, which corresponds to a system action. The interface design 2 is compiled by java. It provides image and video solutions for displaying ads on the second and third page at the national level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 16 video and 8 image ad spots on each page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 802 or the step 804. Step 804 has more steps before getting the results, while the step 802 has fewer.

Step 804 contains tools and programs. The tools include custom designed advertising templates, background colors, patterns, canvas and editor. The programs are java stored program units. They help the user finish creating the advertisement. In the step 804 the user picks a template, chooses background color from Gallery 1 or Gallery 2, selects a canvas and a pattern, and uses the editor. The user follows the steps that are developed by java before getting the results (Step 808). The results refer to that the advertising location is picked; the advertisement is created; the data is created, verified and saved; and the payment is made etc. The data can be any image data types.

If the user chooses to go through the step 802, Program 1 initiates the server process. Program 1 is developed for helping the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 806), it is brought up to the desktop for preview. Triggers are fired if functions like preview, upload, reset, submit and cancel are requested.

The data created from the step 806 and step 808 need to be verified (Step 810). During the verification, a Java function is invoked. It provides a default verification routine to verify the validity of the data. The procedure returns the value TRUE for success and FALSE for failure. If the verification raises an exception, the data becomes invalid, an error is returned. The process goes back to the step 812 or the step 814 until the valid data is provided. If the data is good and complete, the server records the data and writes it to the data blocks in the database from database buffer cache (Step 816). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 818. After the data is collected, it needs to be verified (Step 820). The verification includes company or personal information such as company or personal name, company address, credit card number, expiration date, security code, bank route number and account number etc. If the data is not valid, the process takes the step 822 and goes back to the step 818 until valid the data is provided. If the data is valid, it is submitted and saved in the database (Step 824, 826), and the results is displayed (Step 828). The results refer to the advertising location being picked; the advertisement being created; the data being created, verified and saved; and the payment being made etc. The data can be any image and video data types.

Step 830 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 832 and 834). The second choice is waiting and taking action in the database (Step 836). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 838), the new data is saved in the database on the server (Step 840). A new process begins when the new advertisement is displayed for another period of time (Step 842).

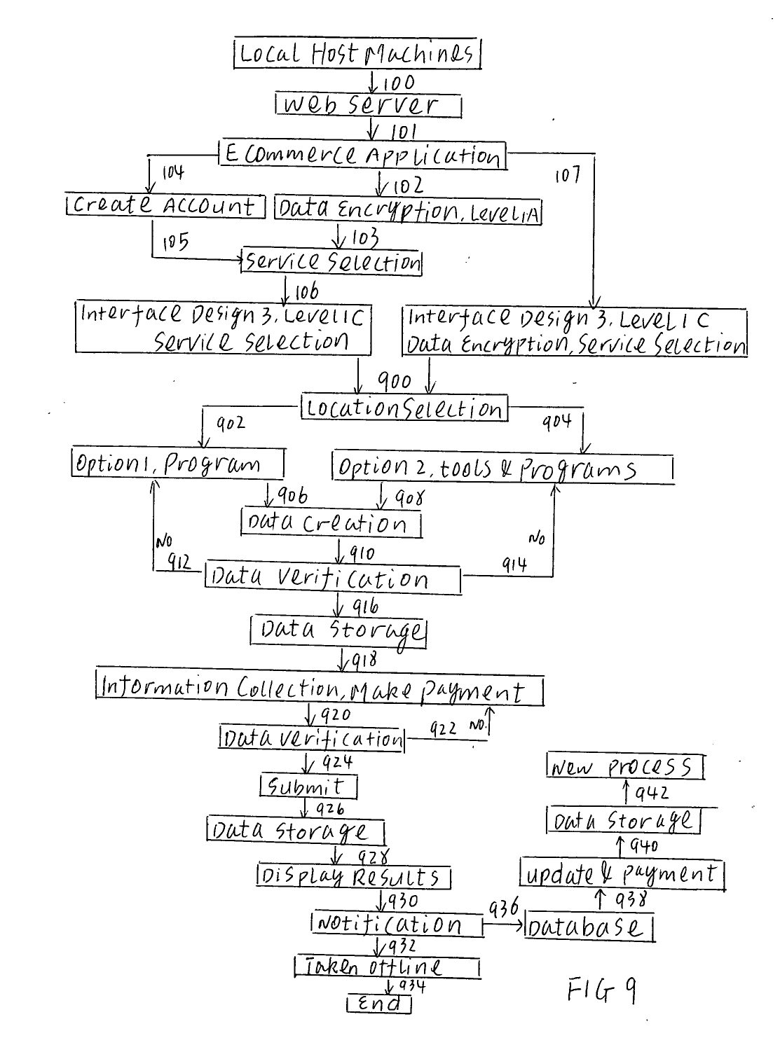

Referring to FIG. 9, the process communicates with the server on behalf of the user process. The server process executes the request. After the process finishes, the returned result is sent back to the user.

From the step 101, the user can create an account if he or she doesn't have one (Step 104). After creating an account, the user chooses a service at the first level (Step 105). If the user has an account, he or she provides data for encryption (Step 102). Data encryption is a process of authentication for users to start up and shut down a session. It is set up to be authenticated by the operating system. The data files are located in the database directory. When the data is encrypted, the user selects a service (Step 103). A service refers to either set up store, create advertisement or update account. The next step is the step the user chooses a level, picks a page, selects a location or selects a service (Step 106). A service refers to an advertising category such as on sale, special deals etc.

Text advertising solution is relatively easy. The user selects a level, chooses a service category and provides advertising contents. When it is done and the payment is made online, the text ad is saved and shown on the screen.

Step 900 is the step that the user selects a location or a service to create banner or video ad on the fourth page, interface design 3. Interface 3 is made up of items. Items are used to present information from the database or to act as control. The web application is event-driven. An event occurs and the application responds to it. An event is either an interface event, which corresponds to a user action, or an internal processing event, which corresponds to a system action. The interface design 3 is compiled by java. It provides image and video solutions for displaying ads on the fourth page.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 8 advertising spots and other service categories on the fourth page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 902 or the step 904. Step 904 has more steps before getting the results, while the step 902 has fewer.

Step 904 contains tools and programs. The tools include custom designed advertising templates, background colors, patterns, canvas and editor. The programs are java stored program units. They help the user finish creating the advertisement. In the step 904 the user picks a template, chooses background color from Gallery 1 or Gallery 2, selects a canvas and a pattern, and uses the editor. The user follows the steps that are developed by java before getting the results (Step 908). The results refer to that the advertising location is picked; the advertisement is created; the data is created, verified and saved; and the payment is made etc. The data can be any image data types.

If the user chooses to go through the step 902, Program 1 initiates the server process. Program 1 is developed for helping the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed, the user process prepares to retrieve the data. C). Fetching, in the fetching stage, the file is selected and returned by the user to the server. One or more fetches may be required to transfer the result of a query to the user.

Once the result is returned (Step 906), it is brought up to the desktop for preview. Triggers are fired if functions like preview, upload, reset, submit and cancel are requested.

The data created from the step 906 and step 908 need to be verified (Step 910). During the verification, a Java function is invoked. It provides a default verification routine to verify the validity of the data. The procedure returns the value TRUE for success and FALSE for failure. If the verification raises an exception, the data becomes invalid, an error is returned. The process goes back to the step 912 or the step 914 until the valid data is provided. If the data is good and complete, the server records the data and writes it to the data blocks in the database from database buffer cache (Step 916). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 918. After the data is collected, it needs to be verified (Step 920). The verification includes company or personal information such as company or personal name, company address, credit card number, expiration date, security code, bank route number and account number etc. If the data is not valid, the process takes the step 922 and goes back to the step 918 until the valid data is provided. If the data is valid, it is submitted and saved in the database (Step 924, 926), and the results is displayed (Step 928). The results refer to that the advertising location is picked; the advertisement is created; the data is created, verified and saved; and the payment is made etc. The data can be any image and video data types.

Step 930 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 932 and 934). The second choice is waiting and taking action in the database (Step 936). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 938), the new data is saved in the database on the server (Step 940). A new process begins when the new advertisement is displayed for another period of time (Step 942).

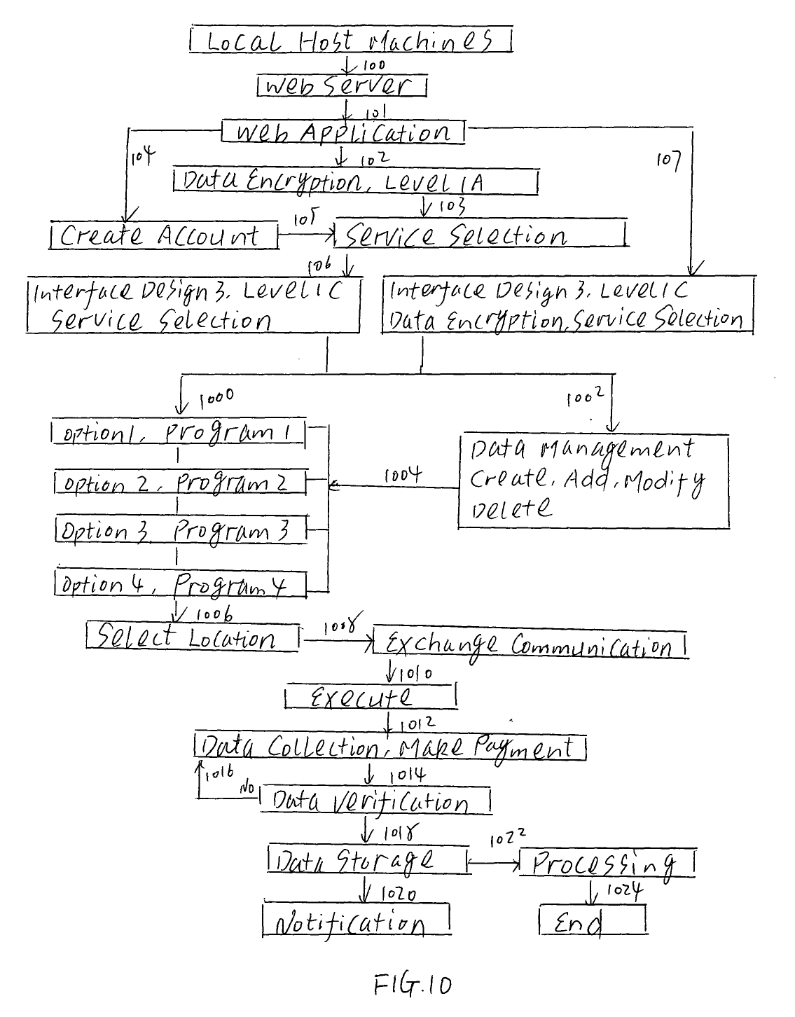

Referring to FIG. 10, this figure is a functional block diagram illustrating how the user invites his or her friend(s) to shop online together. The user connects to the web server and access to the web application (Step 100,101). The user can create an account if he or she doesn't have one. If the user has an account, he or she provides data for encryption through the route 102 (from the step 102) or the step 107 at the first level. When the data is encrypted, the user selects a service on the fourth page.

The user selects Shopping Together (Step 1000). Step 1000 is the step that the user invites his or her friend(s) to shop online together. There are several different ways to invite. The first way is inviting through online.

The second way is inviting through email. The third way is inviting through text message over the phone. The fourth way is inviting by voice communication. The methods of inviting are developed using java. The programs are stored in the data files on the server. They are launched when the triggers are pulled.

1002 is the step that the user manages the contact information. The user maintains the contact list including add, modify, delete, upload, preview, cancel, reset, and invite etc. He or she can invite his or her friend(s) from the contact list by taking the step 1004.

Step 1006 is the step to select a shopping area. Step 1008 is the step to communicate with each other through online texting or voice communication. The next step 1010 is the step to ‘Execute’. ‘Execute’ refers to a series of action related to online purchasing.

After the user and his or her friend(s) buy things online, the data needs to be collected (Step 1012). Once the data is collected, it needs to be verified (Step 1014). During the verification, a java function is invoked. It provides a default verification routine to verify the validity of the data. The procedure returns the value TRUE for success and FALSE for failure. If the verification raises an exception, the data becomes invalid, an error is returned.

Verified information includes company or personal information such as company or personal name, company address, credit card number, expiration date, security code, bank route number and account number etc. If the information is not valid, the process takes the step 1016 and goes back to the step 1012 until the information is valid. If the information is valid, it is submitted and saved in the database (Step 1018). The notification is sent out to the shoppers. Step 1010 ‘Execute’ needs to be processed (Step 1022). Shop together ends (Step 1024) when the user and his or her friend(s) finish shopping together session.

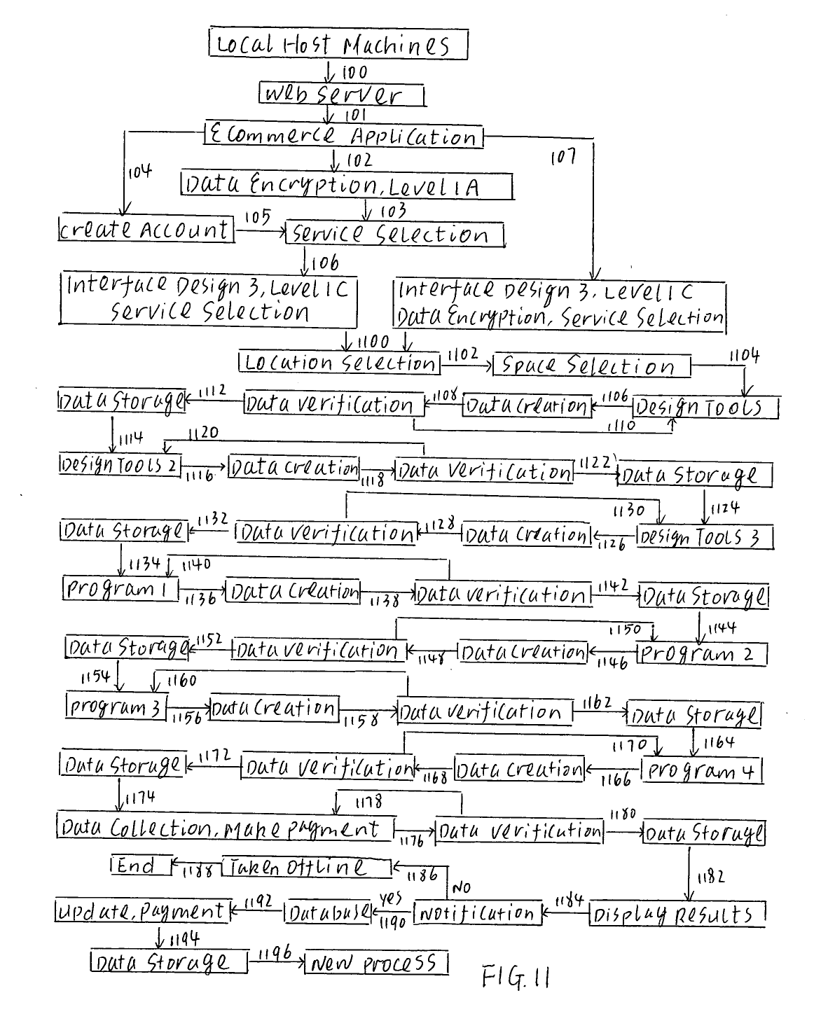

Referring to FIG. 11, this figure is a functional block diagram illustrating how the user sets up store at the national level under Service Group 2 in Module 1. Service group 2 includes Mall of America, Paradise Shopping Mall, Premium Outlet, Atlas Factory Outlet, Luxury Shopping Plaza, Country Club Shopping Center, Retail Village, Service Source Place, Flea Market, Saturday Market, Holiday Shopping, Window Shopping, Video Shopping, Department Stores & Warehouse Clubs, Gifts Ideas, Christmas Shopping, and After Christmas Sale. The user connects to the web server and accesses to the web application (Step 100,101).

1100 is the step that the user chooses to set up a store at the first level. The user selects a location and a space (Step 1102). The service locations and space are complied with Java. The java program units are stored in the data file on the server. There are many divided space in every service in the Service Group 2. Each service location is graphically designed by graphic program which is also stored within the computer server. When a space is selected, the user uses the design tools and programs to create storefront (Step 1104). The storefront can be either video or image format. The tools and programs include templates, editor, background colors patterns, canvas and Java developed program. In this step the user picks a template, chooses background color from the galleries, selects a canvas and a pattern or chooses to upload his or her own work from the local machine. The user provides necessary information before the data is created (Step 1106). Data information can be any information of a company like company's logo, website, address, video clip etc. After the date is created, it needs to be verified (Step 1108). If it is not valid, it goes back to the step 1104 for valid information (Step 1110). When the verification is done, the data is saved (Step 1112).

The next step 1114 is creating the exterior 3D storefront used in the virtual 3D animation shopping environment. The user uses the tools and programs developed by java. The tools include templates, editor, background colors, and canvas. In this step the user picks a template, chooses a background color from galleries, and selects a canvas. The user provides necessary information before the data is created (Step 1116). After the date is created, it needs to be verified (Step 1118). If it is not valid, it goes back to the step 1116 for valid information (Step 1120). When the verification is done, the data is saved (Step 1122).

The next step 1124 is creating 3D interior of the store used in the virtual 3D animation shopping environment. The user uses the tools and programs developed by java. The tools include templates, editor, background colors, and canvas. In this step the user picks a template, chooses a background color from the galleries, and selects a canvas. The user provides necessary information before the data is created (Step 1126). After the date is created, it needs to be verified (Step 1128). If it is not valid, it goes back to the step 1126 for valid information (Step 1130). When the verification is done, the data is saved in the database (Step 1132).

The user has the option to choose sell products in video or image format or both. If he or she chooses the image format to sell products, java compiled programs help set up (Step 1134). After the user follows each step which includes making selection, providing the products related information, uploading the products' images, and previewing etc., the data is created (Step 1136). The data created needs to be verified (Step 1138). If it is not valid, it goes back to the step 1134 for valid information (Step 1140). When the verification is done, the data is saved in the database (Step 1142).

If the user chooses the video format to sell products, he has the option to sell by clips or by one clip. One clip includes all the products. Clips consist of different product categories. Java compiled programs help set up (Step 1144). After the user follows each step which includes making selection, providing the products related information, uploading the products' images, and previewing etc, the data is created (Step 1146). The created data needs to be verified (Step 1148). If it is not valid, it goes back to the step 1144 for valid information (Step 1150). When the verification is done, the data is saved in the database (Step 1152).

If the user chooses to sell in both the video and image formats, he or she follows the steps developed by java before finishing setting up.

1154 is the next step that the user chooses to run promotion. The promotion module consists of text, image, video and coupons. It is compiled with java programs. These programs are stored in the data files on the server. The user follows each step before the data is created (Step 1156). The data created in the step 1156 needs to be verified (Step 1158). If it is not valid, it goes back to the step 1154 for valid information (Step 1160). When the verification is done, the data is saved in the database (Step 1162).

The user can introduce the business by video (Step 1164). The video needs to be uploaded for preview (Step 1166, 1168). If it is not good, the process goes back (Step 1170). If it is good, it is saved (Step 1172). The next step is collecting information and making payment (Step 1174). The collected information needs to be verified (Step 1176). If it is not good, it goes back to the step 1174 through the step 1178. The data is saved and the results are displayed (Step 1180, 1182) when the verification is done. The displayed results refer to that the design of the store is finished, the products are uploaded, the promotions are ready to be displayed, and the business video introduction is ready to be broadcasted etc.

Notification is sent to remind the user of renewing the lease before it expires (Step 1184). If the user ignores it, the store is closed when the lease expires (Step 1186), however all the contents created in the store remain in the account. The user can re-open the business anytime if the space is available or any other space is available. The process ends at the user without taking action (Step 1188). If the user chooses to renew the lease, he or she goes to the database (Step 1190), makes payment and updates the account information (Step 1192). The new data is saved (Step 1194) and a new process begins when the new lease begins (Step 1196).

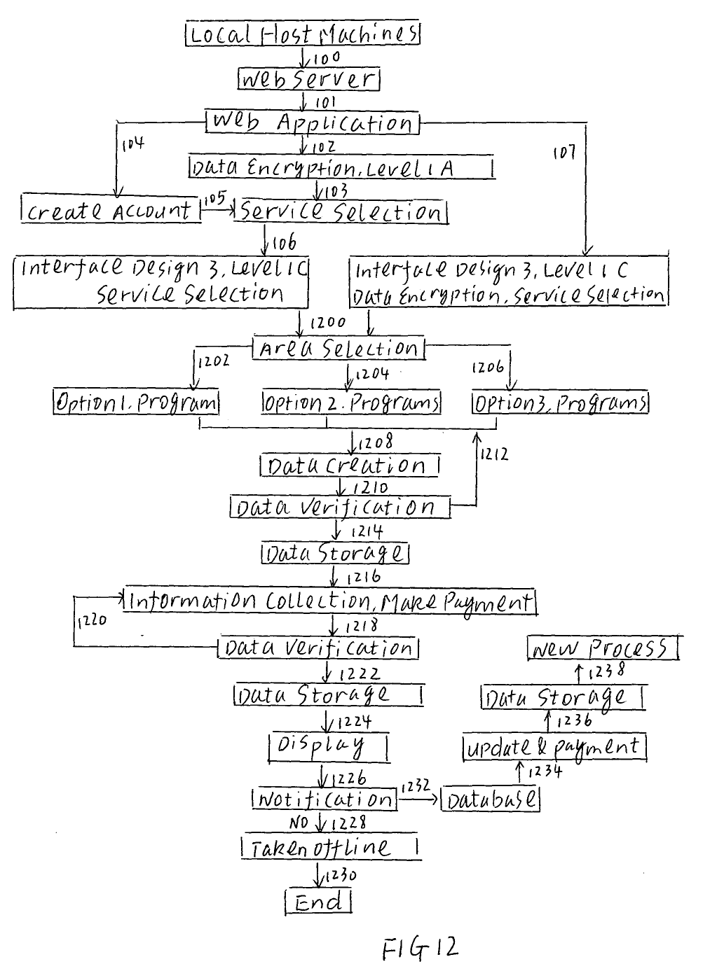

Referring FIG. 12, this figure is a functional block diagram illustrating how the Billboards, Skyways and Street Vendors are designed. The user connects to the web server and access to the web application (Step 100,101). The user can create an account if he or she doesn't have one. If the user has an account, he or she provides data for encryption through the route 102 (from the step 102) or the step 107 at the first level. When the data is encrypted, the user selects a service on the fourth page.

1200 is the step that the user selects a service category. The user selects either Billboards, Skyways or Street Vendors. There are three options, option 1 (Route 1202); option 2 (Route 1204); and option 3 (Route 1206).

Option 1 is related to image or video advertising and the user chooses to upload the advertisement by himself or herself on the local machine (Step 1206). A program is developed for help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

If the user selects Option 2 (Step 1204), it is related to creating image advertisement using the online tools. The user uses the tools and programs compiled using java. The tools include templates, background colors, patterns, editor and canvas etc. The java program units enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database for the as a unit. Packaged procedures and functions can be called explicitly the applications or users. The package usually has two parts stored separately in the database: A). The specification is the interface to the application and declares the types, variables, constraints, exceptions, cursors, and subprograms available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

If the user chooses Option 3 (Route 1206), it is about setting up store. The user walks through all the steps. The steps include designing the storefront, providing the products' information, uploading the products and selecting payment etc. Each step is developed by java.

The date created (Step 1208) from Option 1, 2 or 3 needs to be verified (Step 1210). During the verification, a java function is invoked. It provides a default verification routine to verify the validity of the data. The procedure returns the value TRUE for success and FALSE for failure. If the verification raises an exception, the data becomes invalid, an error is returned. The process goes back until the valid data is acquired (Step 1212). When the verification is done, the data is saved (Step 1214).

The next step is collecting information (Step 1216). It includes the payment information. The information needs to be verified. If it is not valid, it goes back to the step 1216 for valid information (Step 1220). The new data is saved in the database on the server (Step 1222) and the results are displayed (Step 1224). The results refer to that either the advertisement is created and posted, or the store is successfully set up.

Step 1226 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 1228 and 1230). The second choice is waiting and taking action in the database (Step 1232). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 1234), the new data is saved in the database on the server (Step 1236). A new process begins when the new advertisement is displayed for another period of time or the new lease begins (Step 1238).

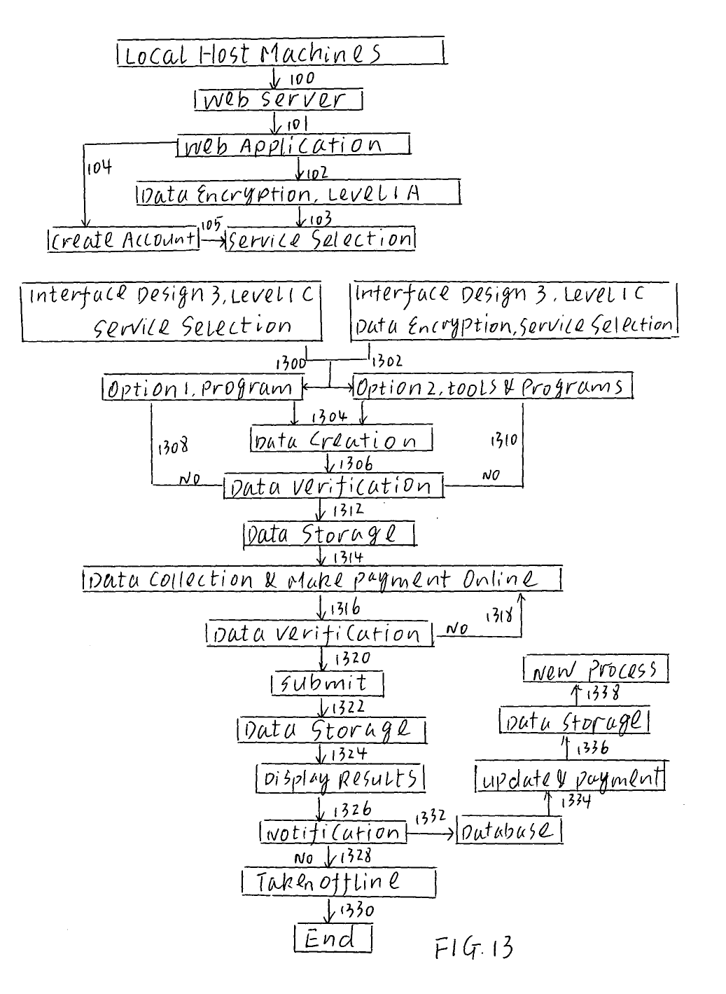

Referring FIG. 13, this figure is a functional block diagram illustrating how Service Group 1 is designed at the first level (National level). The service group 1 includes On Sale, Special Deals, Clearance, Closeouts, Overstocks, Liquidation Sales, National Tent Events, New & Unique Products, Quality Products, Hot Products, Products & Services Promotion, Business Opportunities, Finance-Investment, Franchises, Events, Trade Shows-Conventions, Workshops-Seminars, Auctions, and Announcements. The user connects to the web server and access to the web application. The user can create an account if he or she doesn't have one. If the user has an account, he or she provides data for encryption through the route 102 (from the step 102) or the step 107 at the first level. When the data is encrypted, the user selects a service on the fourth page.

1300 is the step that the user chooses Option 1. Option 1 is related to image and video ads and that the user chooses to upload the advertisement by himself or herself on the local machine. A program is developed to help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed, the user process prepares to retrieve the data. C). Fetching, in the fetching stage, the file is selected and returned by the user to the server. One or more fetches may be required to transfer the result of a query to the user.

1302 is the step that the user chooses Option 2. Option 2 is related to creating the image ads using the online tools. The user uses the tools and programs compiled by java. The tools include templates, background colors, patterns, editor and canvas etc. The java program units enable the user to access and manipulate database information using procedural schema objects. Stored program units are a logically related set of language statements that perform a specific task. They are called by triggering. They can be procedures, functions, triggers, or packages and are created and stored in the data dictionary as a schema object. The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database for the as a unit. Packaged procedures and functions can be called explicitly the applications or users. The package usually has two parts stored separately in the database: A). The specification is the interface to the application and declares the types, variables, constraints, exceptions, cursors, and subprograms available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

When the step 1300 and 1302 are done, the data is created (Step 1304). The created data needs to be verified (Step 1306). If the verification raises an exception, the data becomes invalid, an error is returned. The process goes back to the step 1300 and 1302 by taking the step 1308 and step 1310. After the verification is done, the data is saved in the database on the server (Step 1312).

The next step is collecting information (Step 1314). It includes the payment information. The information needs to be verified (1316). If it is not valid, it goes back to the step 1314 for valid information (Step 1318). The new data is submitted and saved in the database on the server (Step 1320, 1322) and the results are displayed (Step 1324). The results refer to the image or video advertisement being created and posted.

Step 1326 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 1328 and 1330). The second choice is waiting and taking action in the database (Step 1332). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 1334), the new data is saved in the database on the server (Step 1336). A new process begins when the new advertisement is displayed for another period of time (Step 1338).

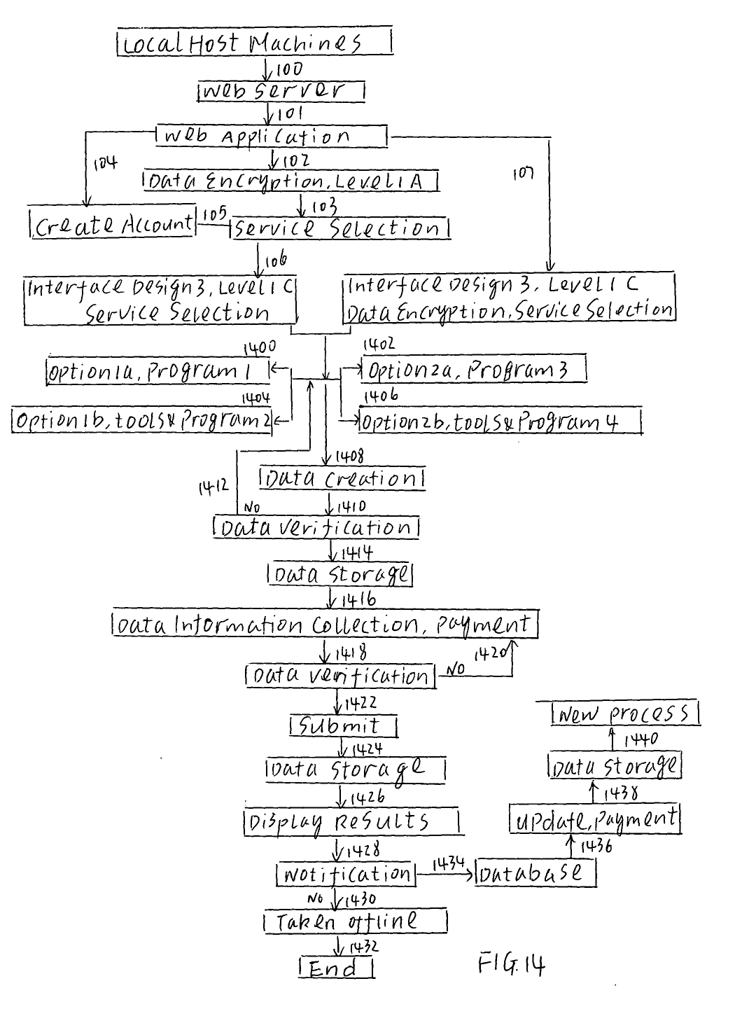

Referring to FIG. 14, this figure is a functional block diagram illustrating how VIP Ads Showroom is designed at the first level. The user connects to the web server and access to the web application. The user can create an account if he or she doesn't have one. If the user has an account, he or she provides data for encryption through the route 102 (from the step 102) or the step 107 at the first level. When the data is encrypted, the user selects VIP Ads Showroom.

Step 1400 is the step to create the front cover page. The front cover page can either be in video or image format. The tools include templates, editor, background colors, patterns, and canvas. The programs are java stored program units. The user picks a template, chooses background color from galleries, selects a canvas and a pattern and follow the steps before the front cover page is created. If the user chooses to use his or her own design work as the front cover page, a java function program is invoked to help him or her to locate the design work from the local machine. If the query is successful, the design work is brought up to the desktop for preview. It is submitted if the data is valid.

The next step 1402 is the step to create text and video advertisement. The user types the text ad contents in the block. Video advertisement is uploaded. The text and video advertisement need to be verified before they are submitted.

1404 is the step to create online image advertisement. The user uses the tools and programs. The tools include templates, background colors, patterns, editor and canvas etc. The programs include the steps and choices to help the user finish the advertisement. The user follows each step which includes providing ad content information, making selection, editing, previewing and correction etc. If the user chooses to provide his or her own image ad work, the java program helps search the data file from the local machine. The user originates the request. The server process parses the request and sends to the local machine. The local machine receives the request and begins to search. If the criteria is matched, the result is sent back. It is brought up to the desktop for preview. The advertisement is submitted if it is good. Or another process begins until the query is successfully returned.

If the user sells products (Step 1406), he or she chooses which format to sell: image, video or both. If the user chooses the image format to sell products, java compiled programs help him or her do it. The user follows each step which includes providing products' information, uploading products images, making payment and previewing etc. If the user chooses the video format to sell products, he or she has the option to sell by clips or one clip. One clip includes all products. Clips consist of different product categories. Java programs help the user do it. All the clips need to be viewed before they are submitted.

After the step 1400, 1402, 1404 and 1406 are taken, the data is created (Step 1408). The data needs to be verified (Step 1410). If it is not valid, it goes back until the valid data is provided (Step 1412). After the verification is done, the data is saved in the database on the server (Step 1414).

Step 1416 is collecting information. It includes the payment information. The collected information needs to be verified (Step 1418). If the information is not valid, the process goes back until the valid data is provided (1420). Data verified is submitted and saved in the database on the server (Step 1422, 1424). The results are displayed (Step 1426). The results refer to that the advertisement is created, the products are ready to be sold; and the sales module is implemented etc.

Step 1428 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 1430 and 1432). The second choice is waiting and taking action in the database (Step 1434). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 1436), the new data is saved in the database on the server (Step 1438). A new process begins when the contents under VIP Ads Showroom begin to be displayed for another period of time (Step 1440).

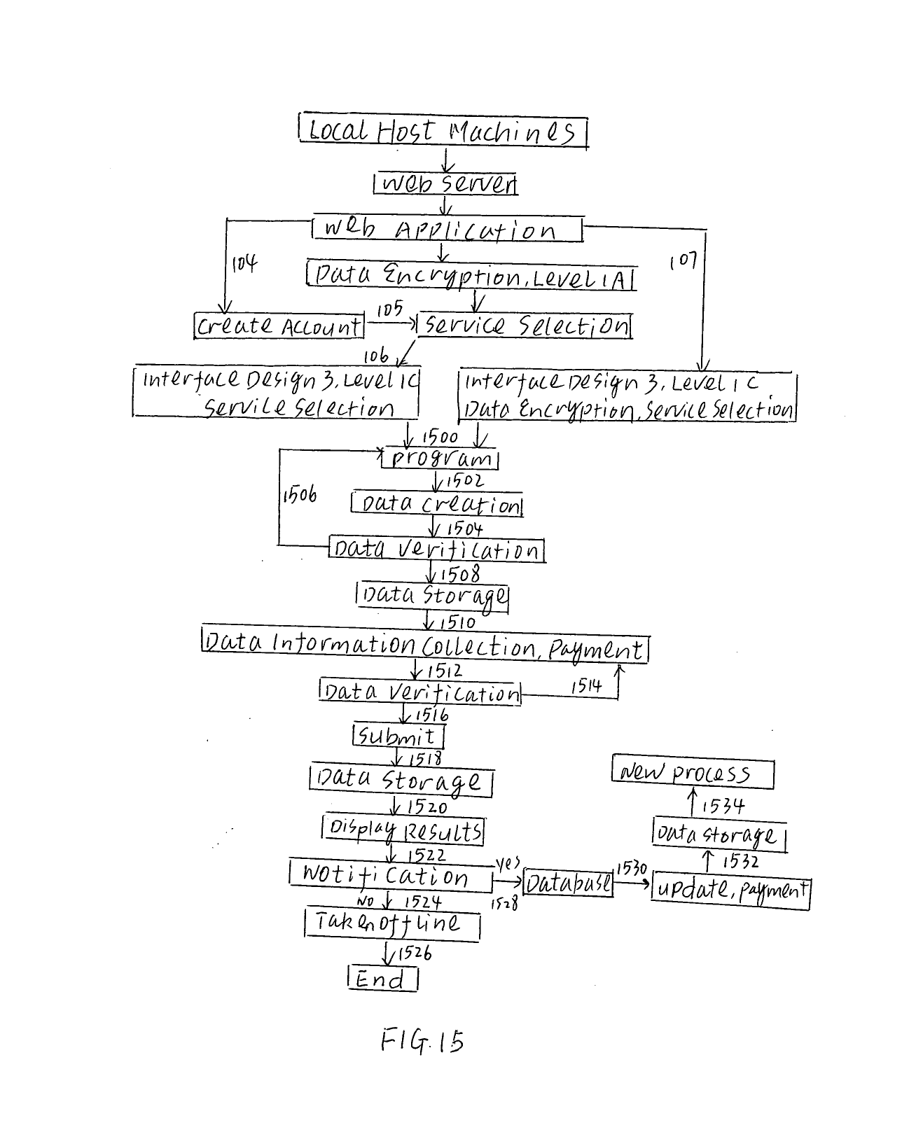

Referring to FIG. 15, this figure is a functional block diagram illustrating how Products Shown on TV is designed at the first level. The user connects to the web server and access to the web application. The user can create an account if he or she doesn't have one. If the user has an account, he or she provides data for encryption through the route 102 (from the step 102) or the step 107 at the first level. When the data is encrypted, the user selects Products Shown on TV.

1500 is the step that the java program helps the user upload the advertisement by himself or herself on the local machine. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed, the user process prepares to retrieve the data. C). Fetching, in the fetching stage, the file is selected and returned by the user to the server. One or more fetches may be required to transfer the result of a query to the user.

After the file is fetched, it is brought up to the desktop for preview (Step 1502) and verified (Step 1504). During the verification, a java function program is invoked. It provides a default verification routine to verify the validity of the data. The procedure returns the value TRUE for success and FALSE for failure. If the verification raises an exception, the data becomes invalid, an error is returned. It goes back the step 1500 until the data is good and valid (Step 1506). After the verification is done, the data is saved in the database on the server (Step 1508).

The next step is collecting information and data verification (Step 1510, 1512). If the information is good, it is submitted and saved (Step 1516, 1518). If the information is not good and valid, it goes back to the step 1510 through the step 1514 until the valid data is provided. The information refers to company, or personal information including the payment information. The results are displayed (Step 1520) after the steps are correctly taken.

Step 1522 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 1524 and 1526). The second choice is waiting and taking action in the database (Step 1528). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 1530), the new data is saved in the database on the server (Step 1532). A new process begins when the advertisement begins to be displayed for another period of time (Step 1534).

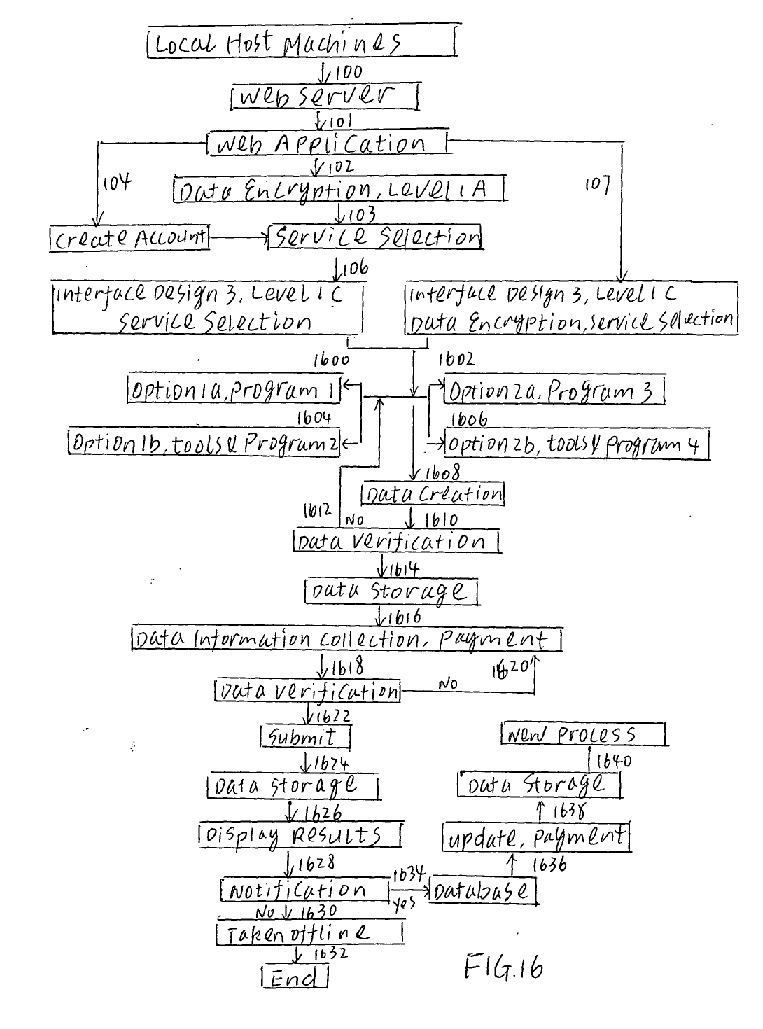

Referring to FIG. 16, this figure is a functional block diagram illustrating how Weekly, Monthly Ads Catalog, Quarterly Products Brochure, Coupons, Coupon Books, Export Products, and Import Products in Service Group 3 are designed. The user connects to the web server and access to the web application. The user can create an account if he or she doesn't have one. If the user has an account, he or she provides data for encryption through the route 102 (from the step 102) or the step 107 at the first level. When the data is encrypted, the user selects one of the services in the service group 3.

Option 1A (Step 1600) is the step that the user selects to use his or her own front cover page on the local machine. The user originates the request. The request is sent in the user process. The server parses the request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed, the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

Option 2A (Step 1602) followed by Option 1A is the step that the user selects to use his or her own catalog. The user initiates the query. If the query is successful, they return data as results. There are three main stages in the process of a query. A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched. After the data file is fetched, the data is brought up to the desktop for preview. If it is good, it is submitted. Or a new process begins until the valid data file is fetched.

Option 1B and 2B (Step 1604, 1606) are the steps that the user selects to create the front page and catalog using the free online tools. The user uses the tools and walks through the steps developed by java programs. The tools include templates, background colors, patterns, editor and canvas etc. The java programs are stored program units. They help the user finish the work and manipulate database information using procedural schema object. After each step is taken, the data is created (Step 1608). The created data needs to be verified (Step 1610).

During the verification, a java function program is invoked. It provides a default verification routine to verify the validity of the data. The procedure returns the value TRUE for success and FALSE for failure. If the verification raises an exception, the data becomes invalid, an error is returned. The process goes back until the data provided is good and valid (Step 1612). After the verification is done, the server records the data and writes it to the data blocks in the data files from database buffer cache (Step 1614).

The next step (Step 1616) is collecting information. The collected information needs to be verified (Step 1618). If it is not valid, it goes back to the step 1616 for valid information by taking the step 1620. Date verified is submitted and saved in the database on the server (Step 1622, 1624). And the results are displayed (Step 1626). The results refer to the advertisement being created and the sales module being implemented.

Step 1628 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 1630 and 1632). The second choice is waiting and taking action in the database (Step 1634). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 1636), the new data is saved in the database on the server (Step 1638). A new process begins when the advertisement begins to be displayed for another period of time (Step 1640).

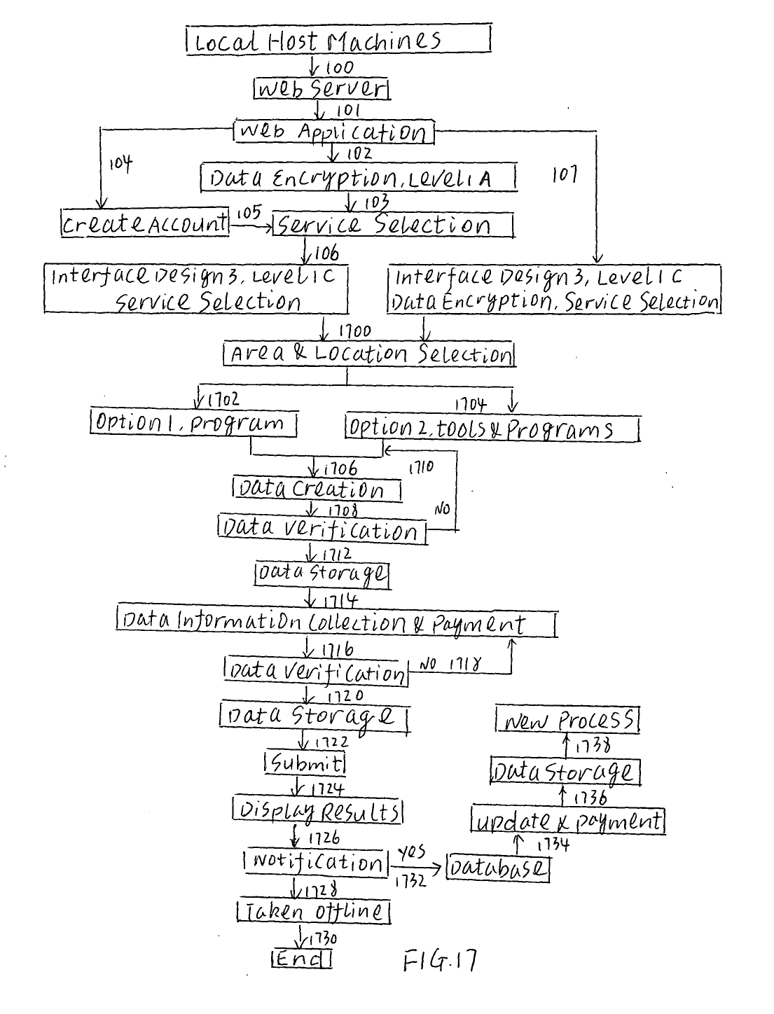

Referring to FIG. 17, this figure is a functional block diagram illustrating how Service Group 4 is designed. The service group 4 includes Office Space & Suites and Warehouses & Distribution Centers. The user connects to the web server and access to the web application. The user can create an account if he or she doesn't have one. If the user has an account, he or she provides data for encryption through the route 102 (from the step 102) or the step 107 at the first level. When the data is encrypted, the user selects one of the services in the service group 4.

1700 is the step that the user chooses an area. An area can be a city or a metro area in a state. If the user selects to upload the advertisement from the local machine (Step 1702), a Java program is invoked. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed, the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

If the user selects to create the commercial advertisement online (Step 1704), he or she uses the free online tools and programs. The tools include templates, background colors, patterns, editor and canvas etc. The programs are developed by Java. They are stored program units. They provide the steps and choices for the user to finish the advertisement and manipulate database information using procedural schema objects. The user follows each step including providing advertisement content information, making selection, creating, editing, preview and correction etc.

When the step 1702 and 1704 are done, the data is created (Step 1706). The created data needs to be verified (Step 1708). If the verification raises an exception, the data becomes invalid, an error is returned. The process goes back to the step 1702 and 1704 by taking the step 1710. After the verification is done, the data is saved in the database on the server (Step 1712).

The next step is collecting information (Step 1714). It includes the payment information. The information needs to be verified (1716). If it is not valid, it goes back to the step 1714 for valid information (Step 1718). The new data is submitted and saved in the database on the server (Step 1720, 1722) and the results are displayed (Step 1724). The results refer to the commercial advertisement being created and posted.

Step 1726 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 1728 and 1730). The second choice is waiting and taking action in the database (Step 1732). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 1734), the new data is saved in the database on the server (Step 1736). A new process begins when the advertisement begins to be displayed for another period of time (Step 1738).

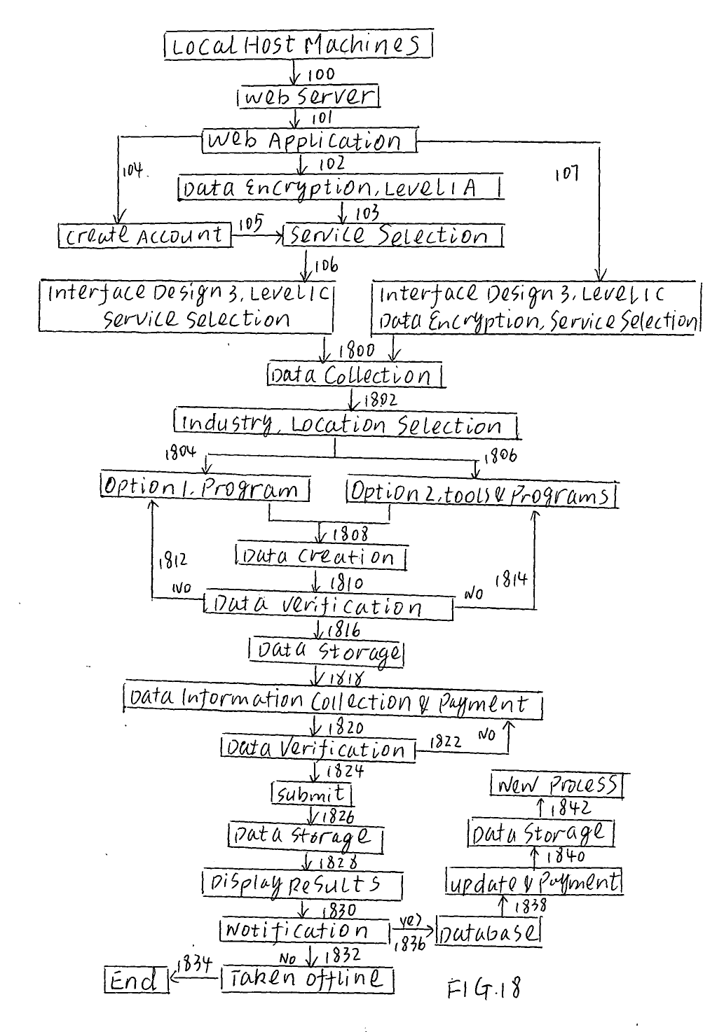

Referring to FIG. 18, this figure is a functional block diagram illustrating how Expose Business is designed. The user connects to the web server and access to the web application (Step 100, 101). The user can create an account if he or she doesn't have one. If the user has an account, he or she provides data for encryption through the route 102 (from the step 102) or the step 107 at the first level. When the data is encrypted, the user selects Expose Business.

Step 1800 is the step that the user provides data information of the business. The user selects an industry and a location in the step 1802. A location is a designated area where the user chooses to expose the business. If the user chooses the step 1804, he or she provides the design work by him or herself. Step 1804 invokes a program which helps the user locate the file on the local host machine. The user originates the request. The request is sent in the user process. The server parses the request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed, the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

If the user takes the step 1806, he or she creates the design work using the free online tools. The user uses the tools and walks through the steps developed by java. The tools include templates, background colors, patterns, editor and canvas etc. The programs are java stored program units. They help the user finish the work and manipulate database information using procedural schema object. After each step is taken, the data is created (Step 1808). The data needs to be verified (Step 1810).

During the verification, a java function is invoked. It provides a default verification routine to verify the validity of the data. The procedure returns the value TRUE for success and FALSE for failure. If the verification raises an exception, the data becomes invalid, an error is returned. The process goes back until the data provided is good and valid (Step 1812, 1814). After the verification is done, the server records the data and writes it to the data blocks in the data files from database buffer cache (Step 1816).

The next step (Step 1818) is collecting information. The collected information needs to be verified (Step 1820). If it is not valid, it goes back to the step 1818 for valid information by taking the step 1822. The verified data is submitted and saved in the database on the server (Step 1824, 1826). And the result is displayed (Step 1828). The result refers to the design work related to expose the business being created.

Step 1830 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 1832 and 1834). The second choice is waiting and taking action in the database (Step 1836). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 1838), the new data is saved in the database on the server (Step 1840). A new process begins when the advertisement begins to be displayed for another period of time (Step 1842).

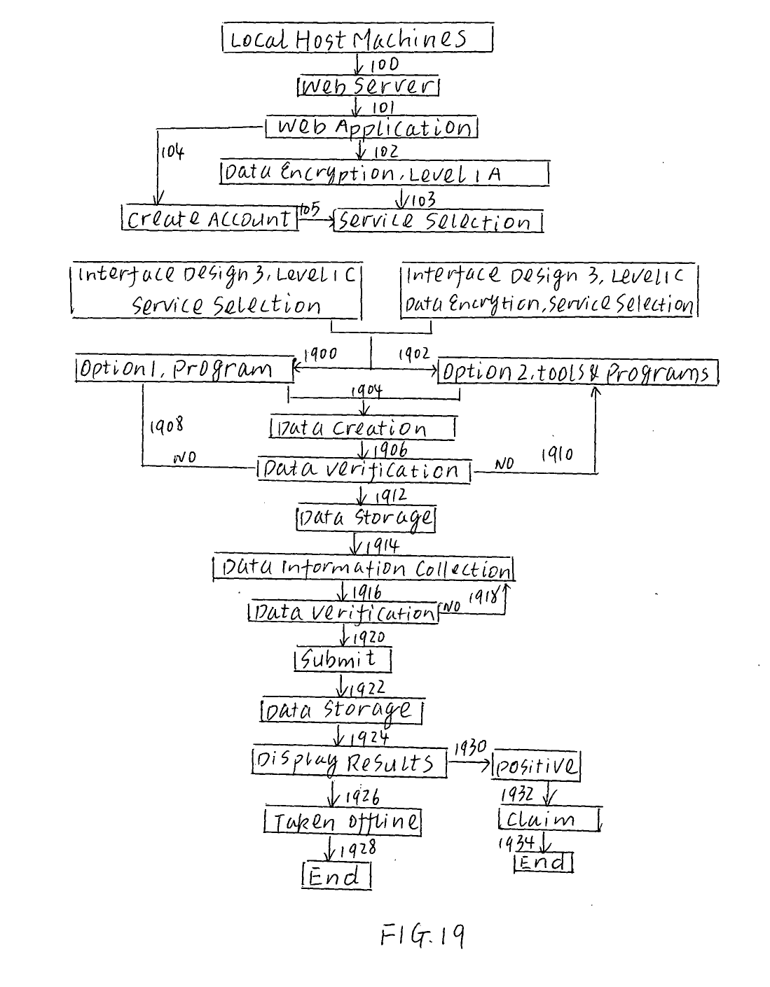

Referring to FIG. 19, this figure is a functional block diagram illustrating how Contest to Win is designed. The user connects to the web server and access to the web application. The user can create an account if he or she doesn't have one. If the user has an account, he or she provides data for encryption through the route 102 (from the step 102) or the step 107 at the first level. When the data is encrypted, the user selects Contest to Win on the fourth page.

Step 1900 is the step that the user chooses to upload the design work by himself or herself on the local machine. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed, the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

Step 1902 is the step the user uses the tools and programs to help finish the design work. The tools include templates, background colors, patterns, editor and canvas etc. The programs include steps developed to help the user finish the work. When the step 1900 and 1902 are done, the data is created (Step 1904). The created data needs to be verified (Step 1906). If the date is not good, the process goes back to the step 1900 and 1902 by taking the steps 1908 and 1910. After the verification is done, the data is saved on the server (Step 1912).

The next step is collecting information (Step 1914). The collected information needs to be verified (1916). If it is not valid, the process goes back to the step 1918. The new data is submitted and saved in the database on the server (Step 1920, 1922) and the result is displayed (Step 1924). The result refers to the art work being created and posted.

The art work is taken offline when contest posting time period expires and a new process begins (Step 1926, 1928). If the results show positive (Step 1930), the process moves to the claim step (Step 1932). The results refer to the votes that the art work gets. The process ends at the messages being sent out to the winners (Step 1934).

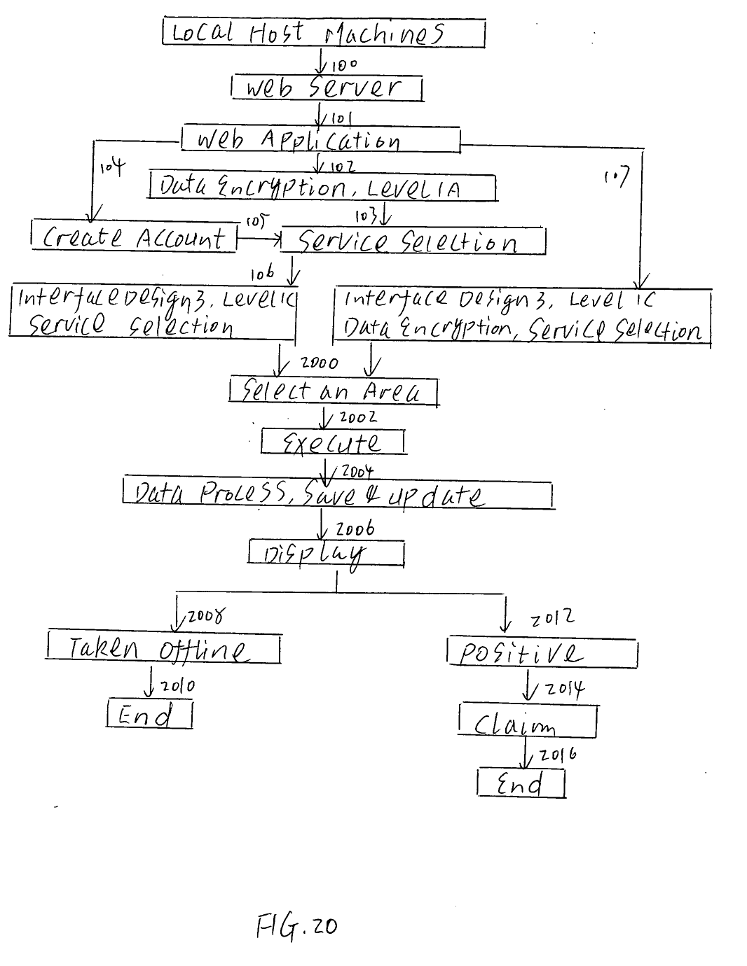

Referring to FIG. 20, this figure is a functional block diagram illustrating how Sweepstakes is designed. The user connects to the web server and access to the web application. The user needs to create account. After the account is created, he or she selects Sweepstakes on the fourth page at the first level.

Step 2000, the user chooses an area. An Area refers to a shopping area at different level. Step 2002 is the step the user executes. During the execution, the data is created and saved (Step 2004). Execute refers to activities that occur during shopping. Execute can be a repeat process. As long as ‘execute’ repeats, the data is created, saved and updated. The new date is displayed in the designated area for public view (Step 2006).

All the date is taken offline when Sweepskakes' time period expires and a new process begins (Step 2008, 2010). If the results show positive (Step 2012), the process moves to the claim step (Step 2014). The results refer to the chances of winning that the user gets. The process ends at the messages being sent out to the winners (Step 2016).

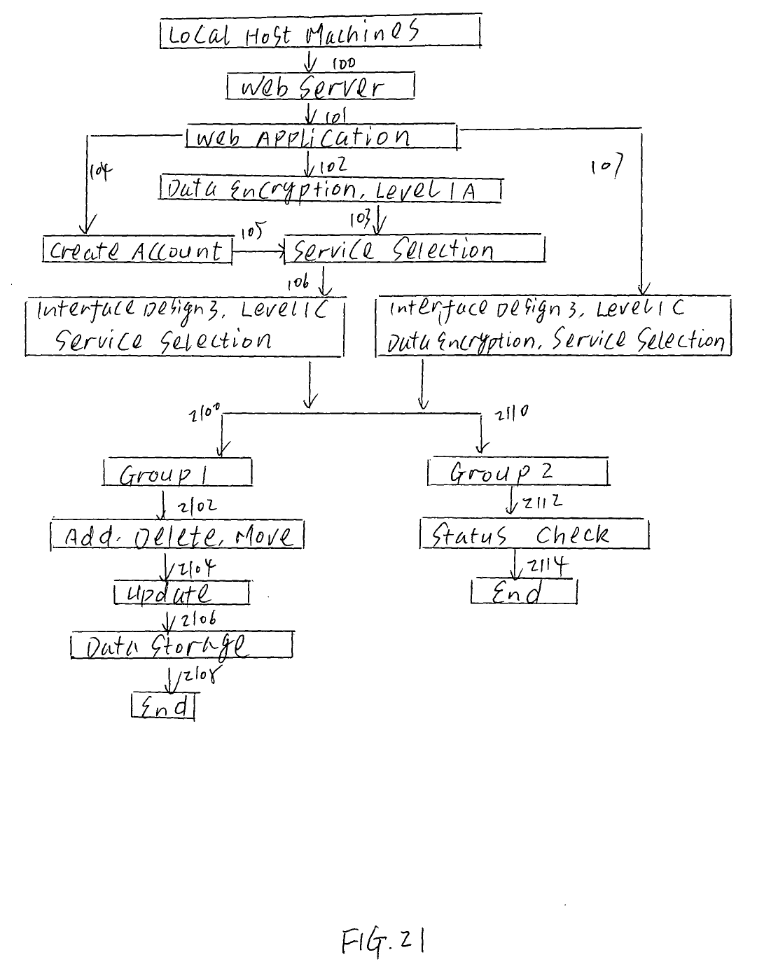

Referring to FIG. 21, this figure is a functional block diagram illustrating how My Stuff is designed. The user connects to the web server and access to the web application. The user needs to establish an account and have account activity history.

The user selects a service from the service group 1 (Step 2100). A service in the service group 1 is either a shopping area or a store that the user has the records in his or her account. If the user doesn't have one, he or she can create one anytime. The services in the group 1 are designed for the user to quickly access to the services he or she chooses. There is management function in the service group 1. The user can manipulate the records anytime (Step 2102). When it is done, the new records are updated and saved (Step 2104, 2106). The process ends at either the user choosing a service in the group 2 or exiting My Stuff (Step 2108).

Step 2110 is the step that the user selects a service in the service group 2. Group 2 consists of different information collected and stored in the user's account. The user selects a service and checks the status (Step 2112). The process ends at either the user choosing a service in the group 2 or exiting My Stuff (2114).

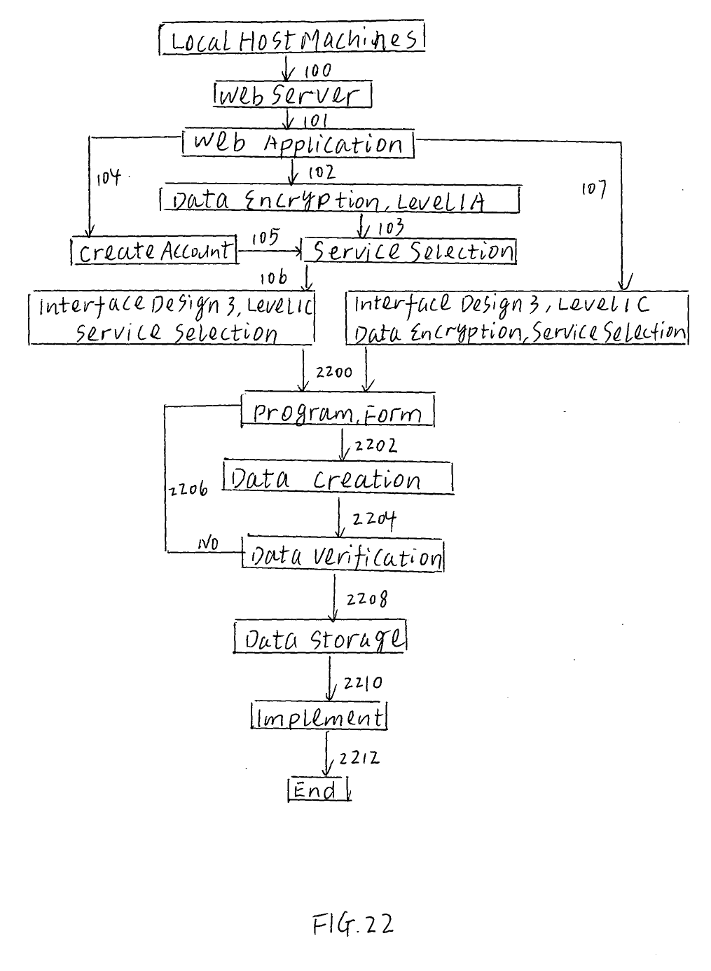

Referring to FIG. 22, this figure is a functional block diagram illustrating how Membership is implemented. The user provides all the necessary information and makes selection (Step 2200). After it is done, the data is created (Step 2202). The created data needs to be verified (Step 2204). If the data is not valid, it goes back until the valid data is provided (Step 2206). Membership data is saved in the database related to the user's account. When activities occur, membership is triggered. The process is implemented (Step 2210). The user takes the benefits of becoming a member. The process ends at the membership being expired without renewal.

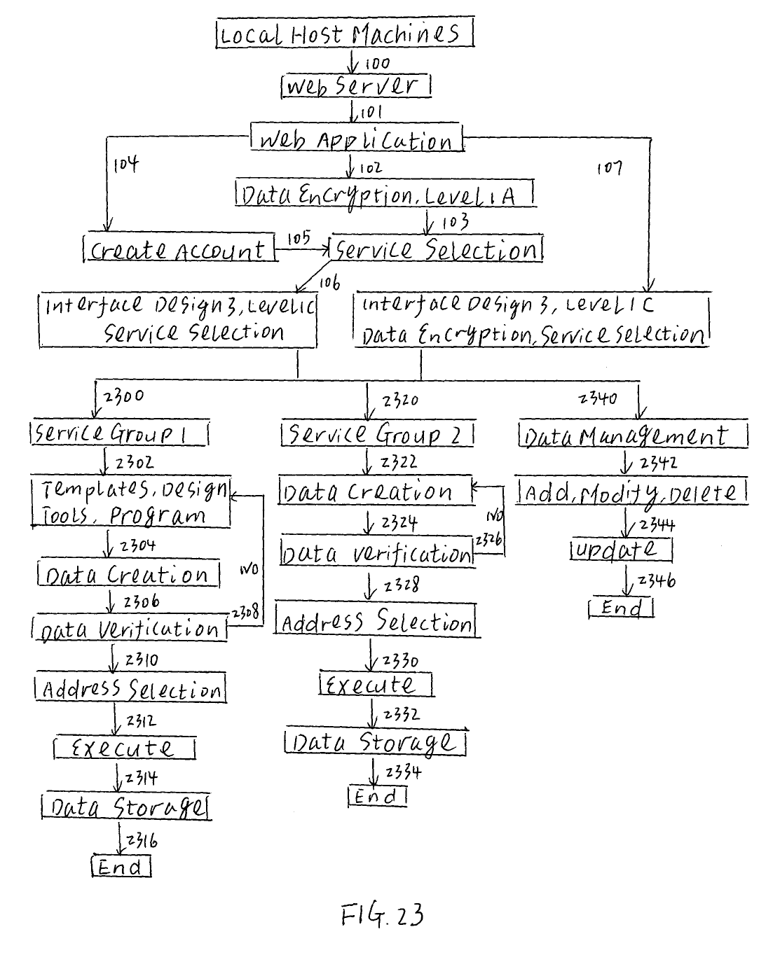

Referring to FIG. 23, this figure is a functional block diagram illustrating how the flow is designed for Market Tools. The user connects to the web server and access to the web application. The user can create an account if he or she doesn't have one. If the user has an account, he or she provides data for encryption through the route 102 (from the step 102) or the step 107 at the first level. When the data is encrypted, the user selects Marketing Tools on the fourth page.

There are three options. Option 1, Step 2300 is the step that the user selects a service from Service Group A. A service can be any type of promotion for a business in graphic format. The user needs to choose whether to create the service on line using the free design tools or upload the design work by him or herself on the local machine. If the user chooses to upload the design work by himself or herself (Step 2302), a program is developed to help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

If the user chooses to use the online free tools, java complied programs help the user finish the work. Java programs are stored program units. They are a logically related set of language statements that perform a specific task. After the user follows each step, the data is created (Step 2304). The created data needs to be verified (Step 2306). If it is not good, it goes back until the valid data is provided (Step 2308). The user selects the user contacts (Step 2310), and execute (Step 2312). Execute refers to all the business promotions are sent out. The data is stored in the database for future use (Step 2314). The process ends at the user picking another service or logging out (Step 2316).

Option 2 is similar to Option 1. The services are a little different. They are designed for businesses to build and keep relationship with their clients in text format. The user selects a service in the service group B and creates promotion contents (Step 2320). After it is done, the data is created (Step 2322). The new data needs to be verified (Step 2324). If the data is not valid, the process goes back to the step 2320 for correct data (Step 2326). The user selects the user contacts (Step 2328), and execute (Step 2330). Execute refers to all the contents created are sent out. The data is stored in the database for future use (Step 2332). The process ends at the user either picking another service or logging out (Step 2334).

Step 2340 is the step the user chooses to manage the user's accounts. The user can manipulate the records at anytime (Step 2342). When it is done, the new records are updated and saved (Step 2344). The process ends at either the user choosing another service in another group or exiting Marketing Tools (Step 2346).

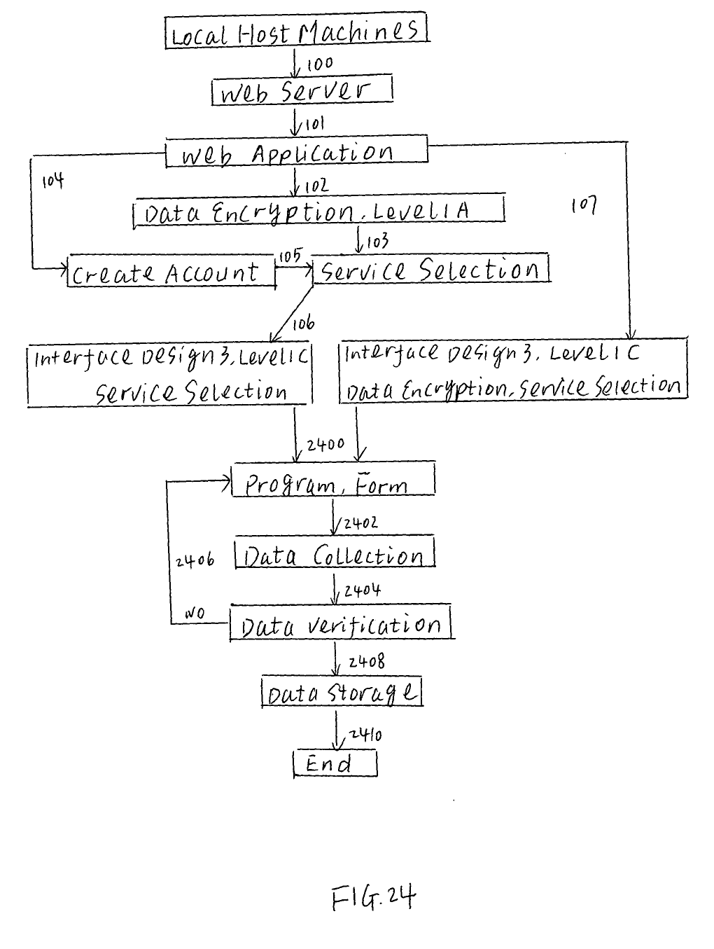

Referring to FIG. 24, this is a functional block diagram illustrating how Authorized Agents is designed. The user provides data information in the form (Step 2400). The form is created using java development tools. After the step 2400 is taken, the date is created (Step 2402). The date needs to be verified (Step 2404). If the data is not good, it goes back for correct data (Step 2406). If it is good, the data is saved on the server in the business's account (Step 2408). The process ends at the user picking another service (Step 2410).

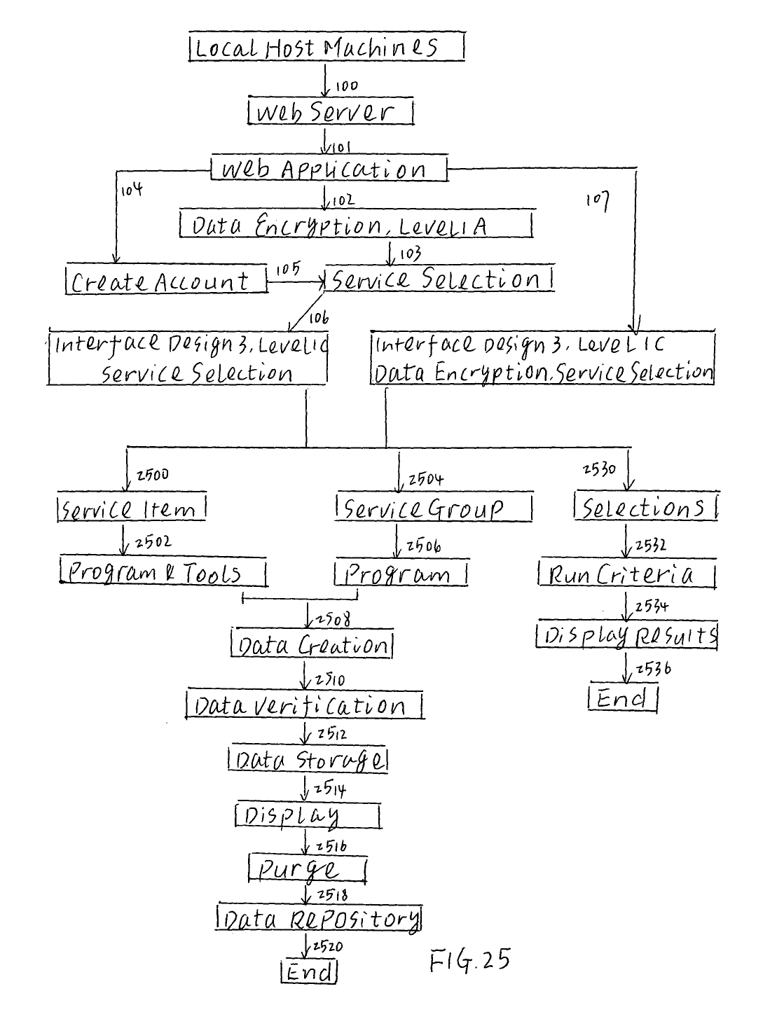

Referring to FIG. 25, this is a functional block diagram illustrating how Community is designed. The user connects to the Internet on the local host machine and access to the web application (Step 100, 101). The user can create an account if he or she doesn't have one. If the user has an account, he or she provides data for encryption through the route 102 (from the step 102) or the step 107 at the first level. When the data is encrypted, the user selects Community.

Step 2500 is the step that the user selects the service. The service is designed for the business to do online market in the community. The user needs to choose whether to create and use his or her own design work or the user creates the design work using the online tools (Step 2502).

If the user selects to use his or her own design work from the local machine, he or she initiates request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

If the user selects the tools and programs to create the design work, he or she needs to follow all the steps (Step 2502). The tools include templates, background colors, patterns, editor and canvas etc. The programs include steps developed to help the user finish the work.

Step 2504 is the step that the user selects the service in the service group. The categories in the service group are different. But the format for each service in the group is identical. The services are developed by java.

After the step 2502 and 2506 are done, the data is created (Step 2508). The created data needs to be verified until correct data is provided (2510). After the verification, the data is saved in the database on the server (Step 2512) and the results are displayed (Step 2514). The results refer to the contents being created and posted. The date will be purged in a period of time (Step 2516) but remain in the repository area for another period of time (Step 2518). The process ends at the user either picking another service or logging out (Step 2520).

In the step 2530, the user runs criteria to search people he or she likes to associate with. A java program is developed to define the criteria. The result(s) are displayed after the searching process is done (Step 2532, 2534). The process ends at the user either picking another service or logging out (Step 2536).

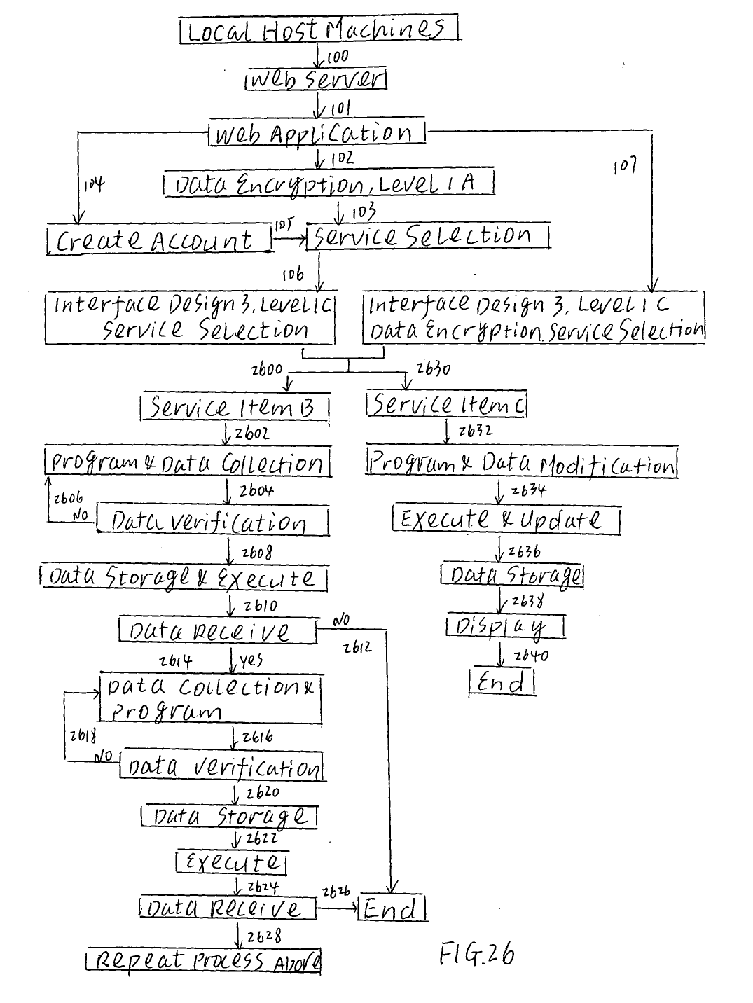

Referring to FIG. 26, this is a functional block diagram illustrating how Our Friends Group is designed. The user connects to the Internet on the local host machine and access to the web application (Step 100, 101). The user can create an account if he or she doesn't have one. If the user has an account, he or she provides data for encryption through the route 102 (from the step 102) or the step 107 at the first level. When the data is encrypted, the user selects Our Friends Group under the Community.

The host user creates the group by establishing a public username and password for the group (Step 2600). He or she chooses a design among templates for the front page. When the design work is done, the user provides all the necessary information (Step 2602) before moving to the next step. Step 2602 is developed using java. It contains java codes saved in the data files on the server. The created data is brought up for verification (Step 2604). If it is not good, the user takes the step 2606 back until the valid data is provided. The verified date is saved and submitted in the step 2608. When the data is received (Step 2610), another java program is invoked, the other user either ignores it or provides all the necessary information before continuing.

If the user ignores it, the process ends (Step 2612). If the user chooses to continue, he or she creates the data using the program invoked (Step 2614). The data could be any type. The created data needs to be verified (Step 2616). If the data is not valid, the user takes the step 2618 back until the valid data is provided. When this step is done, the data is saved (Step 2620). The user passes the data created to others (Step 2622). When the data is received (Step 2624), other users can choose to ignore it and the process ends (Step 2626). Or the other users repeats the process described above (Step 2628). The data refers to personal information including video and picture.

Step 2630 is the step that the user selects to communicate with each other and manages the account. The user creates data and posts it in the step 2632 for public view. The next step (Step 2634) is updating. The user updates his or her information at anytime. Once this step is done, the data is saved (Step 2636). The created data in the step 2632 is displayed in the designated area (Step 2638). The process ends at the new data being created (Step 2640).

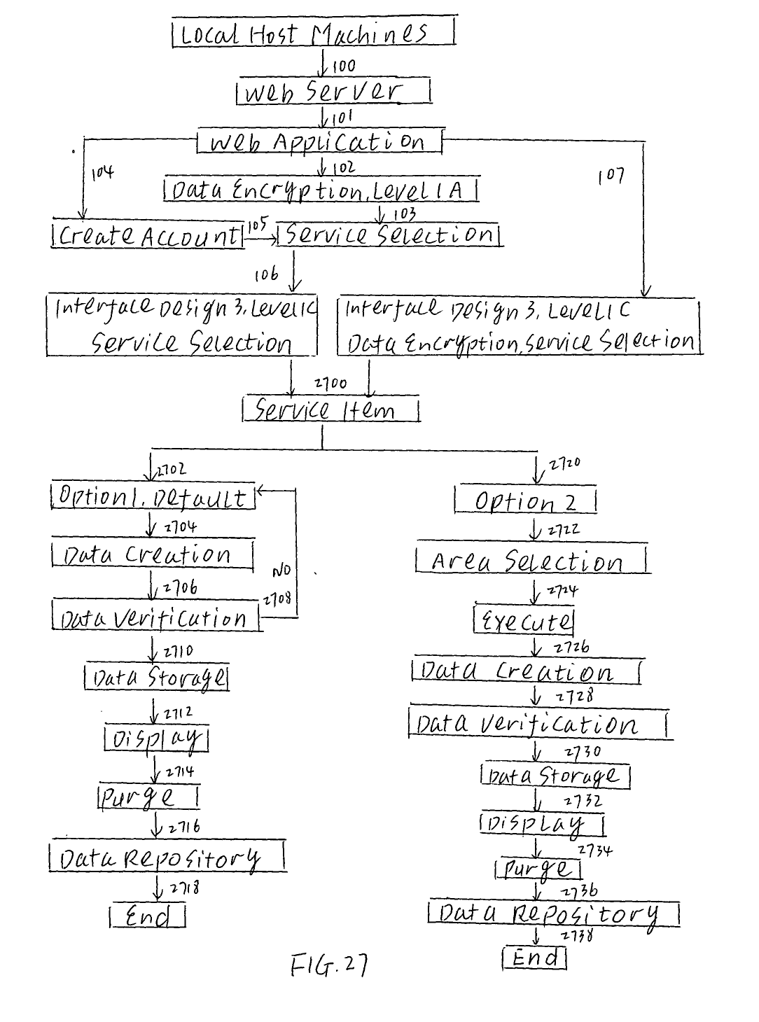

Referring to FIG. 27, this is a functional block diagram illustrating how Chatroom is designed under the Community. The user connects to the web server and access to the web application. The user needs to establish an account before entering the chat room (Step 2100). Step 2702 is the default setting for chatting in the public room. The chat room is designed using java for the user to create data communicating with each other. It is coded and stored in the data files on the server. The user creates the data in the chat room after the verification (Step 2704, 2706). If the data is not good, the process takes the step 2708 back until the valid data is provided. The verified data is stored and displayed (Step 2710, 2712). The data will be purged for a period of time but will remain in the repository area for another period of time. (Step 2714, 2716). The process ends at the new data being created (Step 2718).

If the user takes the step 2720, he or she picks a private room (Step 2722). Private rooms are auto extended if all are occupied. Only invited people can enter and chat in the private room. The private room is developed by java. The program is stored in the data file on the server. The user creates data communicating with each other (Step 2724). When the data is created, it needs to be verified before saving (Step 2726, 2728). The data is shown in the display area (Step 2732) after the verified data is saved (Step 2730). The data is purged and put in the repository area (Step 2734, 2736). The process ends at the new data being created (Step 2738).

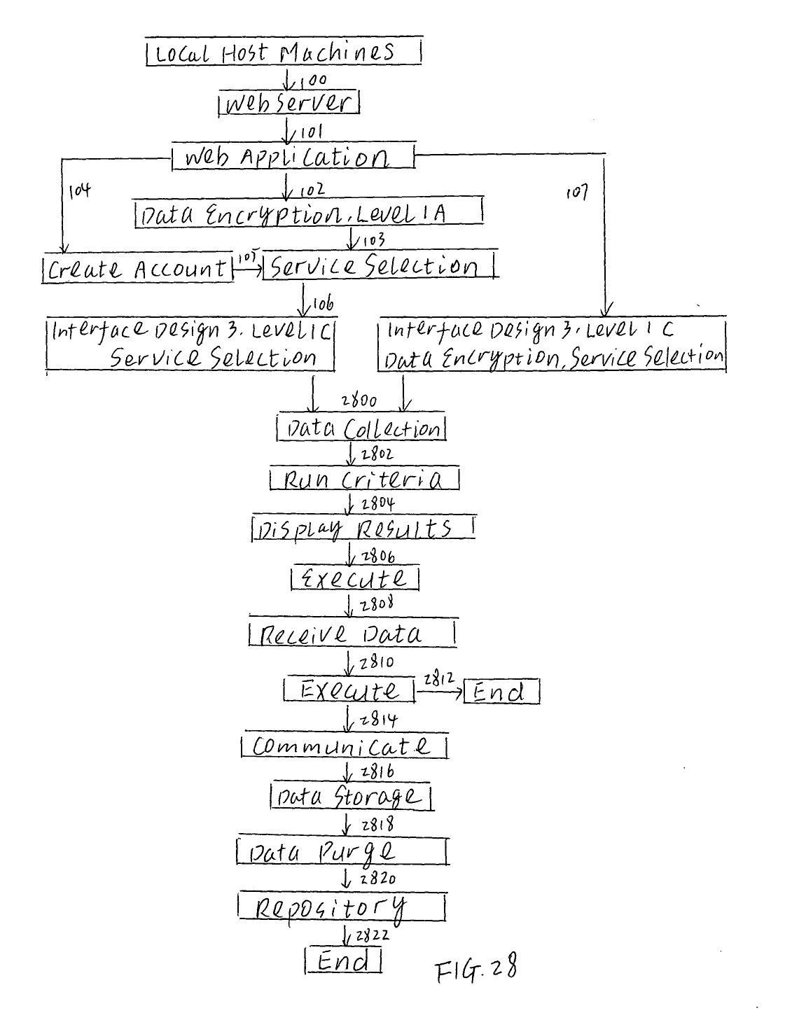

Referring to FIG. 28, this is a functional block diagram illustrating how people Become Friends under the Community. The user connects to the Internet on the local host machine and access to the web application (Step 100, 101). The user can create an account if he or she doesn't have one. If the user has an account, he or she provides data for encryption through the route 102 (from the step 102) or the step 107 at the first level. When the data is encrypted, the user selects Become Friends under the Community.

The user begins with the step 2800 by providing all the necessary information. The information includes personal information, image and video. Step 2802 is run criteria. There are four main stages involved. A) Select, during this stage, the user make selections. The selections include age, gender and area location etc. B). Parse, during the parse, the server process searches for the existing request copy of the user request; validates the user request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache. The parse stage includes processing the requirement that needs to be done only once no matter how many times the statement is executed. The server usually translates each requirement only once, re-executing that parsed during subsequent references to the request. C). Executing the requirement, at this point, the local computer has all the resources and necessary information, so the requirement is executed; the server process prepares to retrieve the data. D). Fetching, in the fetching stage, all the valid data is returned by the server to the user.

After the fetching is done, the results are displayed (Step 2804). The results refer to the data that the user needs to use and execute (Step 2806). During the execution, all the data created by the user is sent out. Step 2808 is the step when other people receive the data. The data is about invitation. Other people who receive the data respond (Step 2810). If other people ignore it, the process ends at the step 2812. Or the process continues with communication (Step 2814). During the communication, the data is created and saved (Step 2816). The saved data will be purged in a period of time but remain in the repository area (Step 2818, 2820). The process ends at the new communication occurring (Step 2822).

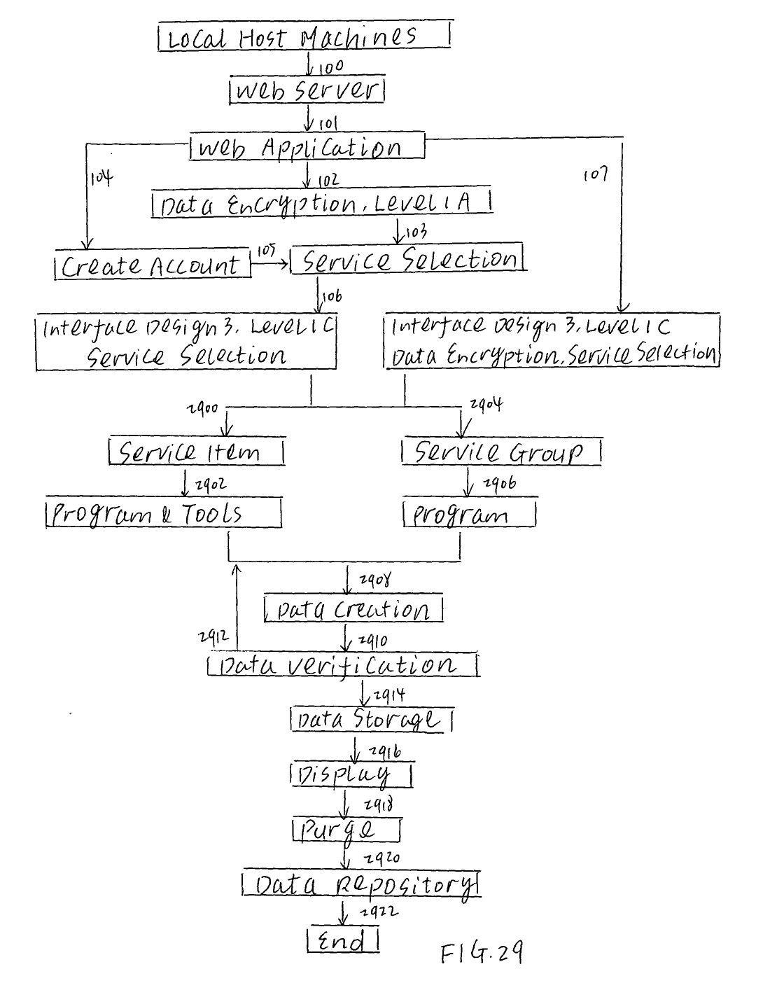

Referring to FIG. 29, this is a functional block diagram illustrating how Business Community is created. The user connects to the web server and access to the web application. The user can create an account if he or she doesn't have one. If the user has an account, he or she provides data for encryption through the route 102 (from the step 102) or the step 107 at the first level. When the data is encrypted, the user selects Business Community under the Community on the fourth page.

Step 2900 is the step that the user selects the service. The service is designed for the business to do online market in the business community. The user needs to choose whether to create and use his or her own design work or the user creates the design work using the online tools (Step 2902).

If the user selects to use his or her own design work from the local machine, he or she initiates request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

If the user selects the tools and programs to create the design work, he or she needs to follow all the steps (Step 2902). The tools include templates, background colors, patterns, editor and canvas etc. The programs include steps developed to help the user finish the work.

Step 2904 is the step that the user selects the service in the service group. The categories in the service group are different. But the format for each service in the group is identical. The services are developed by Java.

After the step 2902 and 2906 are done, the data is created (Step 2908). The created data needs to be verified until correct data is provided (2910). If the data is not good, the process goes back to get valid data (Step 2912). After the verification, the data is saved in the database on the server (Step 2914) and the results are displayed (Step 2916). The results refer to the contents being created and posted. The date will be purged in a period of time (Step 2918) but remain in the repository area for another period of time (Step 2920). The process ends at the user either picking another service or logging out (Step 2922).

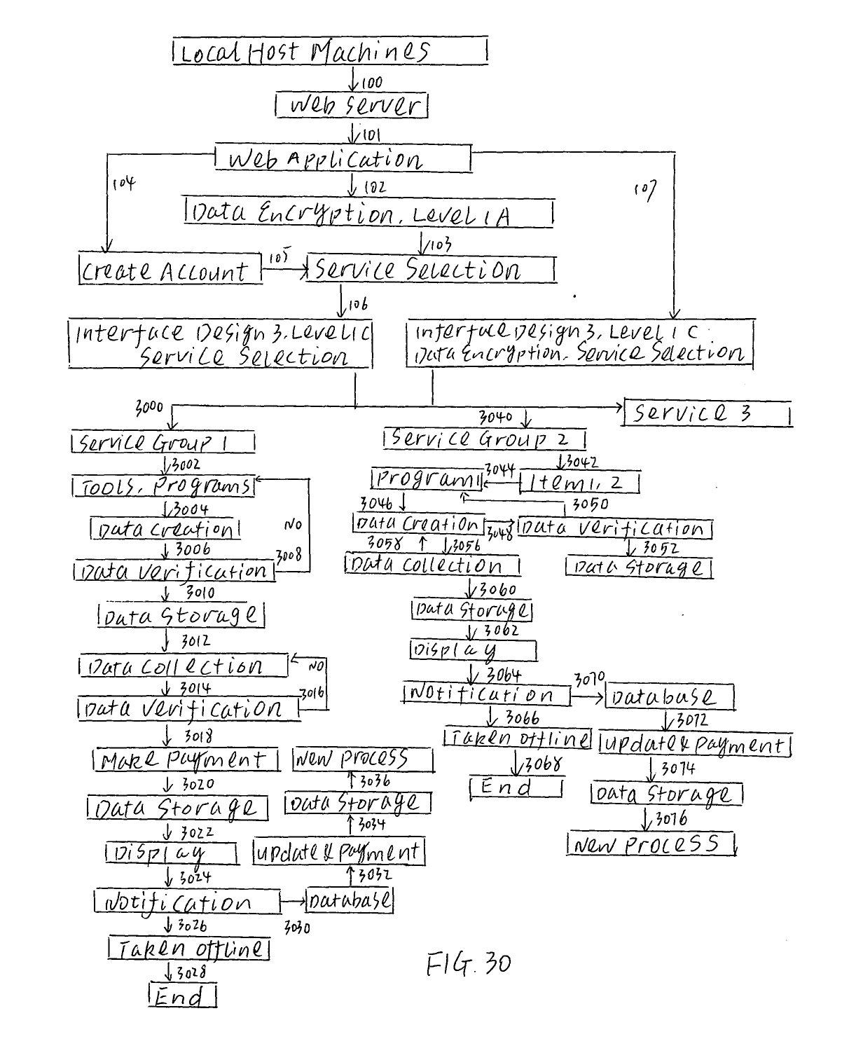

Referring to FIG. 30, this is a functional block diagram illustrating how U.S. travel is designed. The user connects to the interne on the local host machine and access to the web application (Step 100, 101). The user can create an account if he or she doesn't have one. If the user has an account, he or she provides data for encryption through the route 102 (from the step 102) or the step 107 at the first level. When the data is encrypted, the user selects U.S. Travel on the fourth page.

Step 3000 is designed for the user to choose the service in the service group 1. The services in the service group 1 include advertising types and stores for the user to choose. The user selects text, image, video format or a location to create ads, or a store to set up. Java compiled programs help the user to finish all the work (Step 3002).

After the ad is created (Step 3004), it is brought up to the desktop for preview. The created data needs to be verified (Step 3006). During the verification, a Java function program is invoked. It provides a default verification routine to verify the validity of the data. The procedure returns the value TRUE for success and FALSE for failure. If the verification raises an exception, the data becomes invalid, an error is returned. It goes back the step 3000 until the valid data is provided (Step 3008). After the verification is done, the data is saved in the database on the server (Step 3010).

The next step is collecting information and verification (Step 3012, 3014). The information includes the payment information. If the collected information is valid and the payment is made, the data is saved (Step 3018, 3020). If the information is not good and valid, the process goes back to the step 3012 through the step 3016 until the valid data is provided. The results are displayed (Step 3022). The results refer to the advertisement being created and posted; and the store being set up.

Step 3024 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 3026 and 3028). The second choice is waiting and taking action in the database (Step 3030). Action can be that the user modifies updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 3032), the new data is saved in the database on the server (Step 3034). A new process begins when the advertisement begins to be displayed for another period of time (Step 3036).

Step 3040 is designed for the user to use the services in the service group 2. Item 1 and 2 in the service group 2 are designed for the same purpose as those in the service group 1 (Step 3042). But the steps developed are different. The user starts with selecting an area. An area can be a city or a tourist attraction site. He or she selects a service and advertising format before moving to the next step. When it is done, the user chooses either to upload the design work by himself or herself, or create the design work using the free online tools. A java program helps achieve either of them (Step 3044).

When the step is done, the data is created (Step 3046). The data needs to be verified (Step 3048). If the verification raises an exception, the data becomes invalid, an error is returned. The process goes back to the step 3044 by taking the step 3050. After the verification is done, the data is saved in the database on the server (Step 3052).

The next step is collecting information (Step 3054). It includes payment information. The collected information needs to be verified (3056). If it is not valid, it goes back to the step 3054 until the valid data is provided (Step 3058). The new data is submitted and saved in the database on the server (Step 3060) and the results are displayed (Step 3062). The results refer to the advertisement being created and posted.

Notification is the next step (Step 3064). If the user ignores it, the advertisement is taken offline and the process ends (Step 3066, 3068). If the user takes action, he or she goes to the database to update (Step 3070, 3072). After these steps are taken, the new data is saved in the database on the server (Step 3074). A new process begins when the advertisement is displayed for another period of time (Step 3076).

Step 3080 is selecting the community. The format and layout are similar to Community. But the service categories inside are different between the two. See FIG. 25 for description.

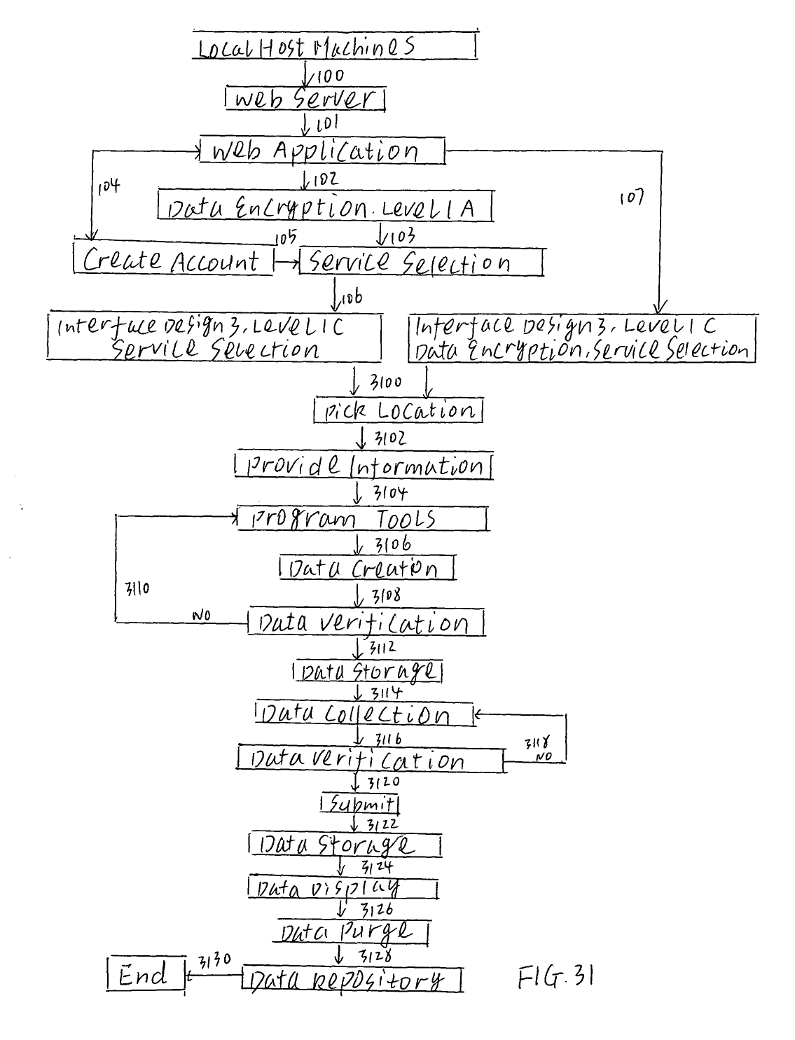

Referring to FIG. 31, this is a functional block diagram illustrating how Publisher's Classified Ads is designed. After the authentication is done through the step 102 or 107 at the first level, the user takes the step 3100. Step 3100 is the step that the user chooses an area. An area can be at national, metro area or a city level. The user provides information required before moving to the next step (Step 3102).

Step 3104 is a program developed for the user to create classified ads. The program is developed by java. It contains java codes stored on the server. The user follows each step until all the classified ads data is created (Step 3106). The created data needs to be verified (Step 3108). If it is not good, it goes back to the step 3104 through the step 3110. The data is saved after the verification (Step 3112). The next step is data collection (Step 3114). The data includes payment information. When it is done, the data needs to be verified. If it is not good, it takes the step 3118 until the valid data is provided. Verified data is submitted and stored in the database (Step 3120, 3122). The results are displayed (Step 3124). The results refer to ad contents being posted at the level the user selects. The data is purged when post time expires (Step 3126). It is put in the repository for the user to manipulate in his or her account for future use (Step 3128). The process ends at the new ad contents being created and posted (Step 3130).

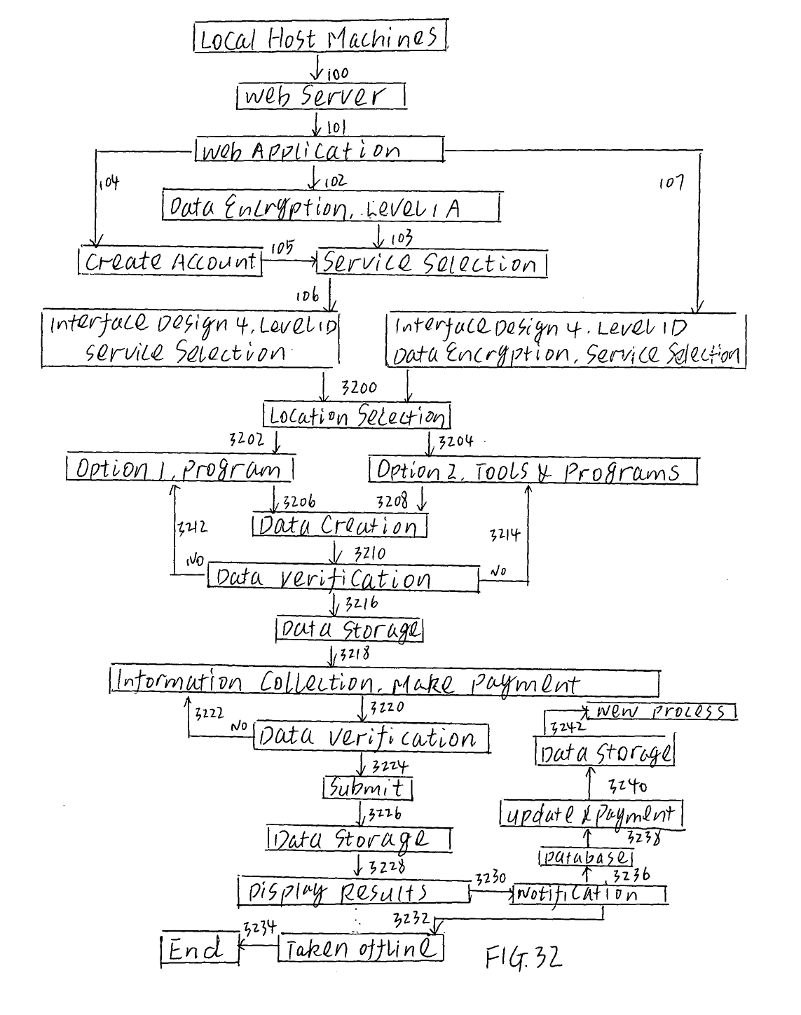

Referring to FIG. 32, this figure is a functional block diagram illustrating how the video and banner ads are created on the fifth page at the first level (National level). The user connects to the web server and access to the web application (Step 100,101). The user can create an account if he or she doesn't have one. If the user has an account, he or she provides data for encryption through the route 102 (from the step 102) or the step 107 at the first level. When the data is encrypted, the user selects an advertising spot.

Step 3200 is the step that the user creates banner or video ad on the fifth page, interface design 4. Interface 4 is made up of items. Items are used to present information from the database or to act as control. The web application is event-driven. An event occurs and the application responds to it. An event is either an interface event, which corresponds to a user action, or an internal processing event, which corresponds to a system action. The interface design 4 is compiled by java. It provides the image and video solutions for displaying the ads on the fifth page.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 12 advertising spots on the fifth page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 3202 or the step 3204. Step 3204 has more steps before getting the results, while the step 3202 has fewer.

Step 3204 contains tools and programs. The tools include custom designed advertising templates, background colors, patterns, canvas and editor. The programs are java stored program units. They help the user finish creating the advertisement. In the step 3204 the user picks a template, chooses background color from Gallery 1 or Gallery 2, selects a canvas and a pattern, and uses the editor. The user follows the steps that are developed by java before getting the results (Step 3208). The results refer to the advertising location being picked; the advertisement being created; the data being created, verified and saved; and the payment being made etc. The data can be any image data types.

If the user chooses to go through the step 3202, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 3206), it is brought up to the desktop for preview. Triggers are fired if functions like preview, upload, reset, submit and cancel are requested.

The data created from the step 3206 and step 3208 need to be verified (Step 3210). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 3212 or the step 3214 until the valid data is provided. If the data is good and complete, the server records the data and writes it to the data blocks in the database from database buffer cache (Step 3216). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 3218. After the data is collected, it needs to be verified (Step 3220). The verification includes company or personal information such as company or personal name, company address, credit card number, expiration date, security code, bank route number and account number etc. If the data is not valid, the process takes the step 3222 and goes back to the step 3218 until the valid data is provided. If the data is valid, it is submitted and saved in the database (Step 3224, 3226), and the results is displayed (Step 3228). The results refer to the advertising location being picked; the advertisement being created; the data being created, verified and saved; and the payment being made etc. The data can be any image and video data types.

Step 3230 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 3232 and 3234). The second choice is waiting and taking action in the database (Step 3236). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 3238), the new data is saved in the database on the server (Step 3240). A new process begins when the new advertisement is displayed for another period of time (Step 3242).

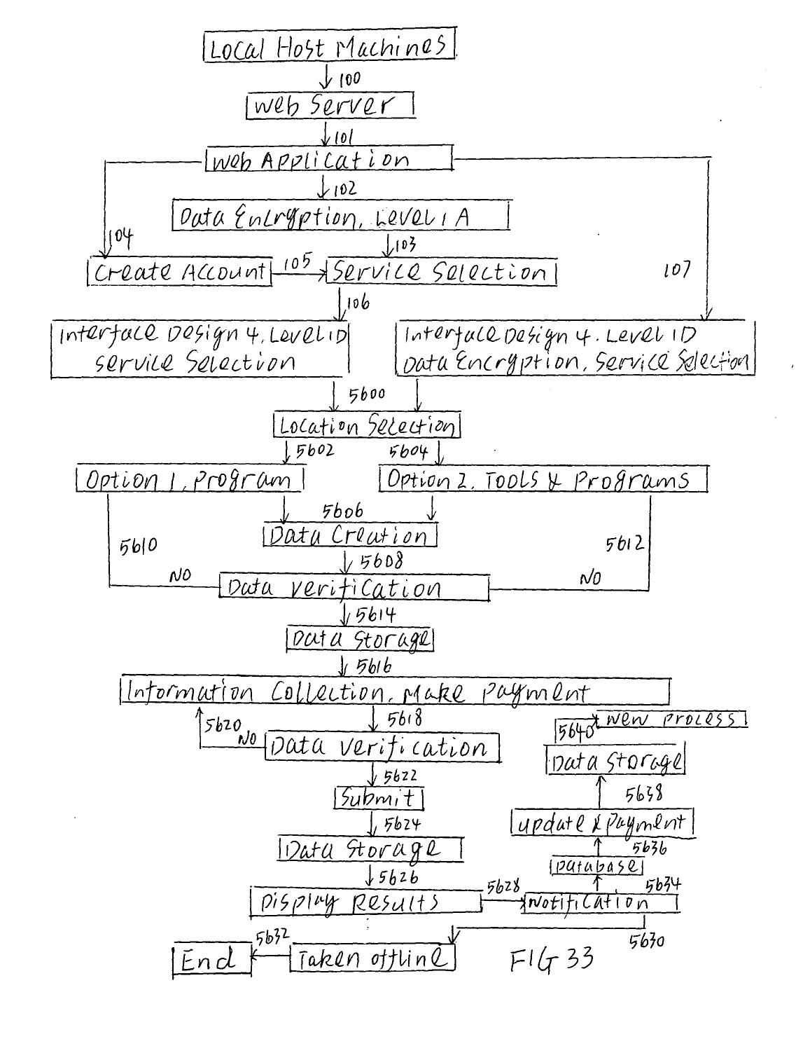

Referring to FIG. 33, this figure is a functional block diagram illustrating how video and banner ads are created on the first page at the second level (State level). The user connects to the web server and access to the web application (Step 100,101). The user can create an account if he or she doesn't have one. If the user has an account, he or she provides data for encryption through the route 102 (from the step 102) or the step 107 at the second level. When the data is encrypted, the user selects an advertising spot.

Step 5600 is the step that the user creates banner or video ad on the fifth page, interface design 5. Interface 5 is made up of items. Items are used to present information from the database or to act as control. The web application is event-driven. An event occurs and the application responds to it. An event is either an interface event, which corresponds to a user action, or an internal processing event, which corresponds to a system action. The interface design 5 is compiled by java. It provides the image and video solutions for displaying the ads on the first page on the second level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 10 advertising spots and other service categories on the first page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 5602 or the step 5604. Step 5604 has more steps before getting the results, while the step 5602 has fewer.

Step 5604 contains tools and programs. The tools include custom designed advertising templates, background colors, patterns, canvas and editor. The programs are java stored program units. They help the user finish creating the advertisement. In the step 5604 the user picks a template, chooses background color from Gallery 1 or Gallery 2, selects a canvas and a pattern, and uses the editor. The user follows the steps that are developed by java before getting the results (Step 5608). The results refer to the advertising location being picked; the advertisement being created; the data being created, verified and saved; and the payment being made etc. The data can be any image data types.

If the user chooses to go through the step 5602, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 5606), it is brought up to the desktop for preview. Triggers are fired if functions like preview, upload, reset, submit and cancel are requested.

The data created from the step 5606 need to be verified (Step 5608). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 5610 or the step 5612 until the valid data is provided. If the data is good and complete, the server records the data and writes it to the data blocks in the database from database buffer cache (Step 5614). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 5616. After the data is collected, it needs to be verified (Step 5618). The verification includes company or personal information such as company or personal name, company address, credit card number, expiration date, security code, bank route number and account number etc. If the data is not valid, the process takes the step 5620 and goes back to the step 5616 until the valid data is provided. If the data is valid, it is submitted and saved in the database (Step 5622, 5624), and the results is displayed (Step 5626). The results refer to the advertising location being picked; the advertisement being created; the data being created, verified and saved; and the payment being made etc. The data can be any image and video data types.

Step 5628 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 5630 and 5632). The second choice is waiting and taking action in the database (Step 5634). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 5636), the new data is saved in the database on the server (Step 5638). A new process begins when the new advertisement is displayed for another period of time (Step 5640).

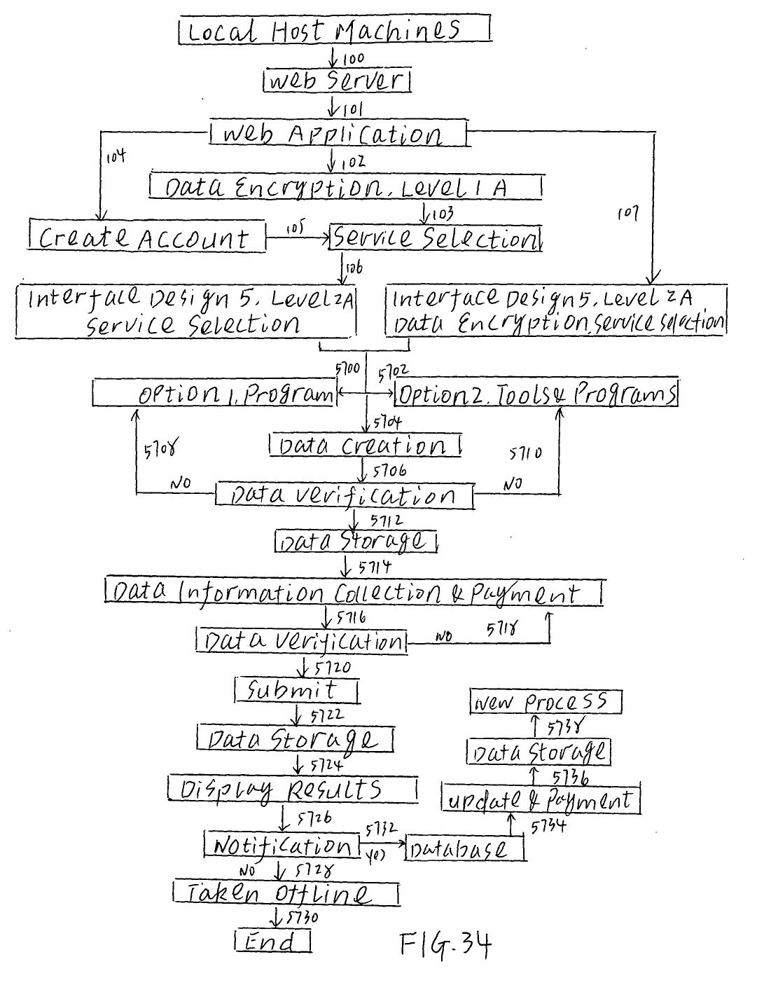

Referring FIG. 34, this figure is a functional block diagram illustrating how Service Group 1 are designed at the second level (State level). The service group 1 includes Wholesale to All, Business Opportunities, Finance-Investment, Franchises, Events, Auctions, and Announcements. The user connects to the web server and access to the web application. The user can create an account if he or she doesn't have one. If the user has an account, he or she provides data for encryption through the route 102 (from the step 102) or the step 107 at the first level. When the data is encrypted, the user selects a service on the first page.

5700 is the step that the user chooses Option 1. Option 1 is related to image and video ads and that the user chooses to upload the design work by himself or herself on the local machine. A program is developed to help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

5702 is the step that the user chooses Option 2. Option 2 is related to creating the image ads using the online tools. The user uses the tools and programs compiled by java. The tools include templates, background colors, patterns, editor and canvas etc. The java program units enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database for the as a unit. Packaged procedures and functions can be called explicitly the applications or users. The package usually has two parts stored separately in the database: A). The specification is the interface to the application and declares the types, variables, constraints, exceptions, cursors, and subprograms available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

When the step 5700 and 5702 are done, the data is created (Step 5704). The created data needs to be verified (Step 1306). If the verification raises an exception, the data becomes invalid, an error is returned. The process goes back to the step 5700 and 5702 by taking the step 5708 and step 5710. After the verification is done, the data is saved in the database on the server (Step 5712).

The next step is collecting information (Step 5714). It includes the payment information. The information needs to be verified (5716). If it is not valid, it goes back to the step 5714 for valid information (Step 5718). The new data is submitted and saved in the database on the server (Step 5720, 5722) and the results are displayed (Step 5724). The results refer to the image or video advertisement being created and posted.

Step 5726 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 5728 and 5730). The second choice is waiting and taking action in the database (Step 5732). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 5734), the new data is saved in the database on the server (Step 5736). A new process begins when the new advertisement is displayed for another period of time (Step 5738).

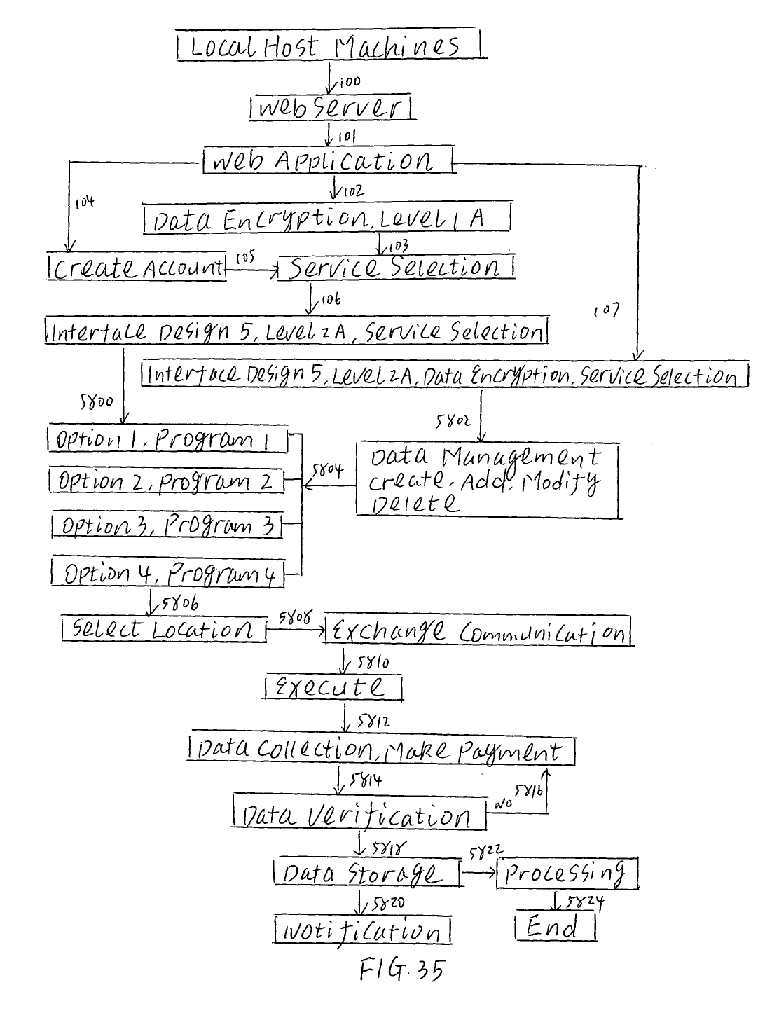

Referring to FIG. 35, this figure is a functional block diagram illustrating how the user invites his or her friend(s) to shop online together. The user connects to the web server and access to the web application (Step 100,101). The user can create an account if he or she doesn't have one. If the user has an account, he or she provides data for encryption through the route 102 (from the step 102) or the step 107 at the second level. When the data is encrypted, the user selects a service.

The user selects Shopping Together (Step 5800). Step 5800 is the step that the user invites his or her friend(s) to shop online together. There are several different ways to invite. The first way is inviting through online. The second way is inviting through email. The third way is inviting through text message over the phone. The fourth way is inviting by voice communication. The methods of inviting are developed using java. The programs are stored in the data files on the server. They are launched when the triggers are pulled.

5802 is the step that the user manages the contact information. The user maintains the contact list including add, modify, delete, upload, preview, cancel, reset, and invite etc. He or she can invite his or her friend(s) from the contact list by taking the step 5804.

Step 5806 is the step to select a shopping area. Step 5808 is the step to communicate with each other through online texting or voice communication. The next step 5810 is the step to ‘Execute’. ‘Execute’ refers to a series of action related to online purchasing.

After the user and his or her friend(s) buy things online, the data needs to be collected (Step 5812). Once the data is collected, it needs to be verified (Step 5814). During the verification, a java function is invoked. It provides a default verification routine to verify the validity of the data. The procedure returns the value TRUE for success and FALSE for failure. If the verification raises an exception, the data becomes invalid, an error is returned.

Verified information includes company or personal information such as company or personal name, company address, credit card number, expiration date, security code, bank route number and account number etc. If the information is not valid, the process takes the step 5816 and goes back to the step 5812 until the information is valid. If the information is valid, it is submitted and saved in the database (Step 1018). The notification is sent out to the shoppers. Step 5810 ‘Execute’ needs to be processed (Step 5822). Shop together ends (Step 5824) when the user and his or her friend(s) finish shopping together session.

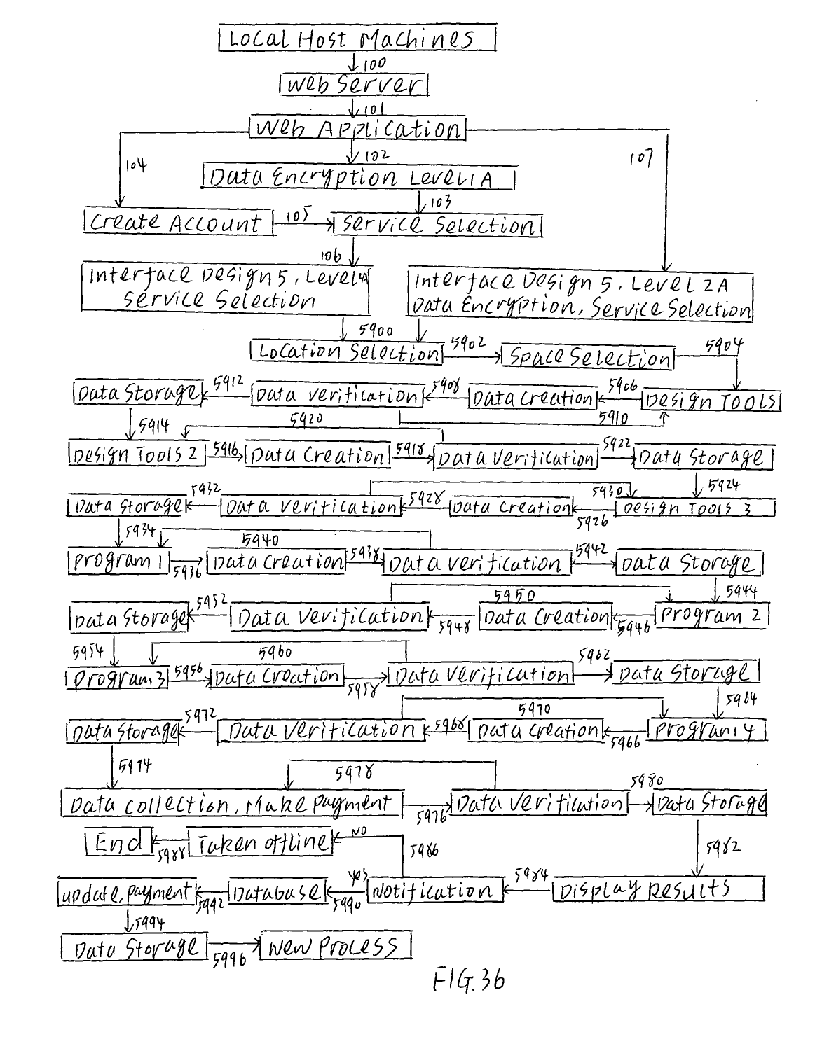

Referring to FIG. 36, this figure is a functional block diagram illustrating how the user sets up store at the state level under Service Group 2 in Module 1. Service Group 2 includes Malls, E-Mall, Outlet and Flea Markets. The user connects to the web server and accesses to the web application (Step 100,101). 5900 is the step that the user chooses to set up a store at the state level. The user selects a location and a space (Step 5902). The service locations and space are complied with Java. The java program units are stored in the data file on the server. There are many divided space in every service in the Service Group 2. Each service location is graphically designed by graphic program which is also stored within the computer server. When a space is selected, the user uses the design tools and programs to create storefront (Step 5904). The storefront can be either video or image format. The tools and programs include templates, editor, background colors patterns, canvas and Java developed program. In this step the user picks a template, chooses background color from the galleries, selects a canvas and a pattern or chooses to upload his or her own work from the local machine. The user provides necessary information before the data is created (Step 5906). Data information can be any information of a company like company's logo, website, address, video clip etc. After the date is created, it needs to be verified (Step 5908). If it is not valid, it goes back to the step 5904 for valid information (Step 5910). When the verification is done, the data is saved (Step 5912).

The next step 5914 is creating the exterior 3D storefront used in the virtual 3D animation shopping environment. The user uses the tools and programs developed by java. The tools include templates, editor, background colors, and canvas. In this step the user picks a template, chooses a background color from galleries, and selects a canvas. The user provides necessary information before the data is created (Step 5916). After the date is created, it needs to be verified (Step 5918). If it is not valid, it goes back to the step 1116 for valid information (Step 5920). When the verification is done, the data is saved (Step 5922).

The next step 5924 is creating 3D interior of the store used in the virtual 3D animation shopping environment. The user uses the tools and programs developed by java. The tools include templates, editor, background colors and canvas. In this step the user picks a template, chooses a background color from the galleries, and selects a canvas. The user provides necessary information before the data is created (Step 5926). After the date is created, it needs to be verified (Step 5928). If it is not valid, it goes back to the step 5926 for valid information (Step 5930). When the verification is done, the data is saved in the database (Step 5932).

The user has the option to choose sell products in video or image format or both. If he or she chooses the image format to sell products, java compiled programs help set up (Step 5934). After the user follows each step which includes making selection, providing the products related information, uploading the products' images, and previewing etc., the data is created (Step 5936). The data created needs to be verified (Step 5938). If it is not valid, it goes back to the step 5934 for valid information (Step 5940). When the verification is done, the data is saved in the database (Step 5942).

If the user chooses the video format to sell products, he has the option to sell by clips or by one clip. One clip includes all the products. Clips consist of different product categories. Java compiled programs help set up (Step 5944). After the user follows each step which includes making selection, providing the products related information, uploading the products' images, and previewing etc, the data is created (Step 5946). The created data needs to be verified (Step 5948). If it is not valid, it goes back to the step 1144 for valid information (Step 5950). When the verification is done, the data is saved in the database (Step 5952).

If the user chooses to sell in both the video and image formats, he or she follows the steps developed by java before finishing setting up.

5954 is the next step that the user chooses to run promotion. The promotion module consists of text, image, video and coupons. It is compiled with java programs. These programs are stored in the data files on the server. The user follows each step before the data is created (Step 5956). The data created in the step 5956 needs to be verified (Step 5958). If it is not valid, it goes back to the step 5954 for valid information (Step 5960). When the verification is done, the data is saved in the database (Step 5962).

The user can introduce the business by video (Step 1164). The video needs to be uploaded for preview (Step 1166, 1168). If it is not good, the process goes back (Step 1170). If it is good, it is saved (Step 1172). The next step is collecting information and making payment (Step 1174). The collected information needs to be verified (Step 1176). If it is not good, it goes back to the step 1174 through the step 1178. The data is saved and the results are displayed (Step 1180, 1182) when the verification is done. The displayed results refer to the design of the store being finished, the products being uploaded, the promotions being ready to be displayed, and the business video introduction being ready to be broadcasted etc.

Notification is sent to remind the user of renewing the lease before it expires (Step 5984). If the user ignores it, the store is closed when the lease expires (Step 5986), however all the contents created in the store remain in the account. The user can re-open the business anytime if the space is available or any other space is available. The process ends at the user without taking action (Step 5988). If the user chooses to renew the lease, he or she goes to the database (Step 5990), makes payment and updates the account information (Step 5992). The new data is saved (Step 5994) and a new process begins when the new lease begins (Step 5996).

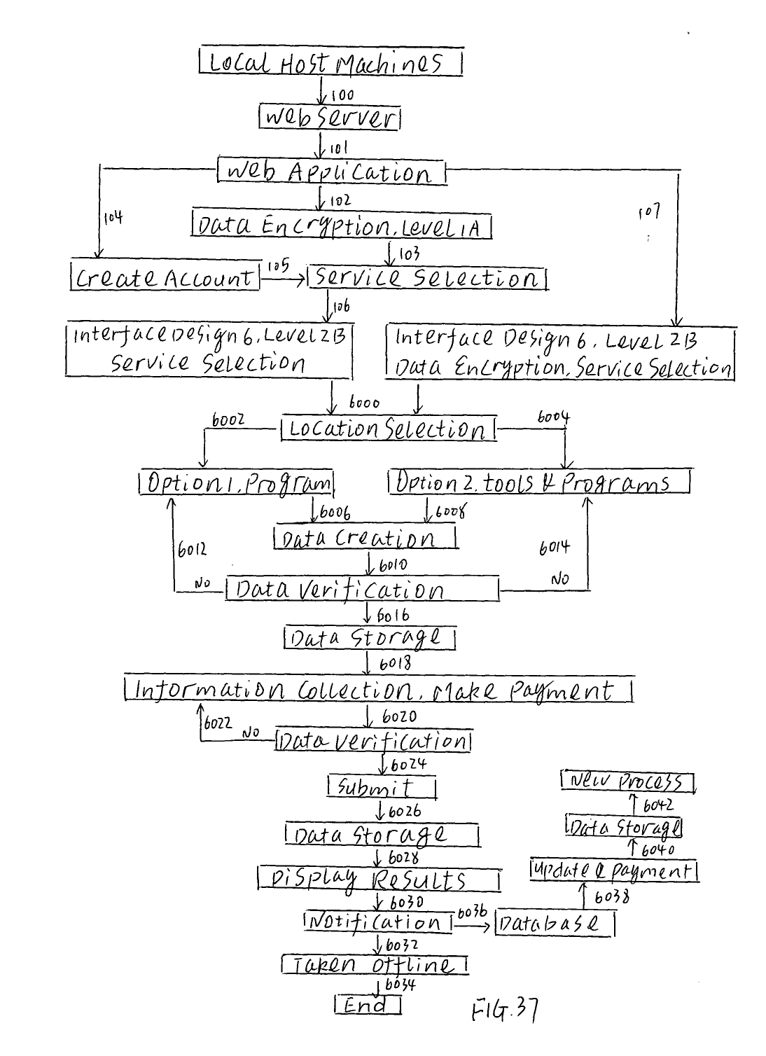

Referring to FIG. 37, this figure is a functional block diagram illustrating how the video and banner ads are created on the second page at the second level (State level). The user connects to the web server and access to the web application (Step 100,101). The user can create an account if he or she doesn't have one. If the user has an account, he or she provides data for encryption through the route 102 (from the step 102) or the step 107 at the second level. When the data is encrypted, the user selects an advertising spot.

Step 6000 is the step that the user selects a location to create banner or video ad on the second page, interface design 6. Interface 6 is made up of items. Items are used to present information from the database or to act as control. The web application is event-driven. An event occurs and the application responds to it. An event is either an interface event, which corresponds to a user action, or an internal processing event, which corresponds to a system action. The interface design 6 is compiled by java. It provides the image and video solutions for displaying the ads on the second page.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 16 advertising spots on the second page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 6002 or the step 6004. Step 6004 has more steps before getting the results, while the step 6002 has fewer. Step 6004 contains tools and programs. The tools include custom designed advertising templates, background colors, patterns, canvas and editor. The programs are java stored program units. They help the user finish creating the advertisement. In the step 6004 the user picks a template, chooses background color from Gallery 1 or Gallery 2, selects a canvas and a pattern, and uses the editor. The user follows the steps that are developed by java before getting the results (Step 6008). The results refer to the advertising location being picked; the advertisement being created; the data being created, verified and saved; and the payment being made etc. The data can be any image data types.

If the user chooses to go through the step 6002, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 6006), it is brought up to the desktop for preview. Triggers are fired if functions like preview, upload, reset, submit and cancel are requested.

The data created from the step 6006 and step 6008 need to be verified (Step 6010). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 6012 or the step 6014 until the valid data is provided. If the data is good and complete, the server records the data and writes it to the data blocks in the database from database buffer cache (Step 6016). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 6018. After the data is collected, it needs to be verified (Step 6020). The verification includes company or personal information such as company or personal name, company address, credit card number, expiration date, security code, bank route number and account number etc. If the data is not valid, the process takes the step 6022 and goes back to the step 6018 until the valid data is provided. If the data is valid, it is submitted and saved in the database (Step 6024, 6026), and the results is displayed (Step 6028). The results refer to that the advertising location being picked; the advertisement being created; the data being created, verified and saved; and the payment being made etc. The data can be any image and video data types.

Step 6030 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 6032 and 6034). The second choice is waiting and taking action in the database (Step 6036). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 6038), the new data is saved in the database on the server (Step 6040). A new process begins when the new advertisement is displayed for another period of time (Step 6042).

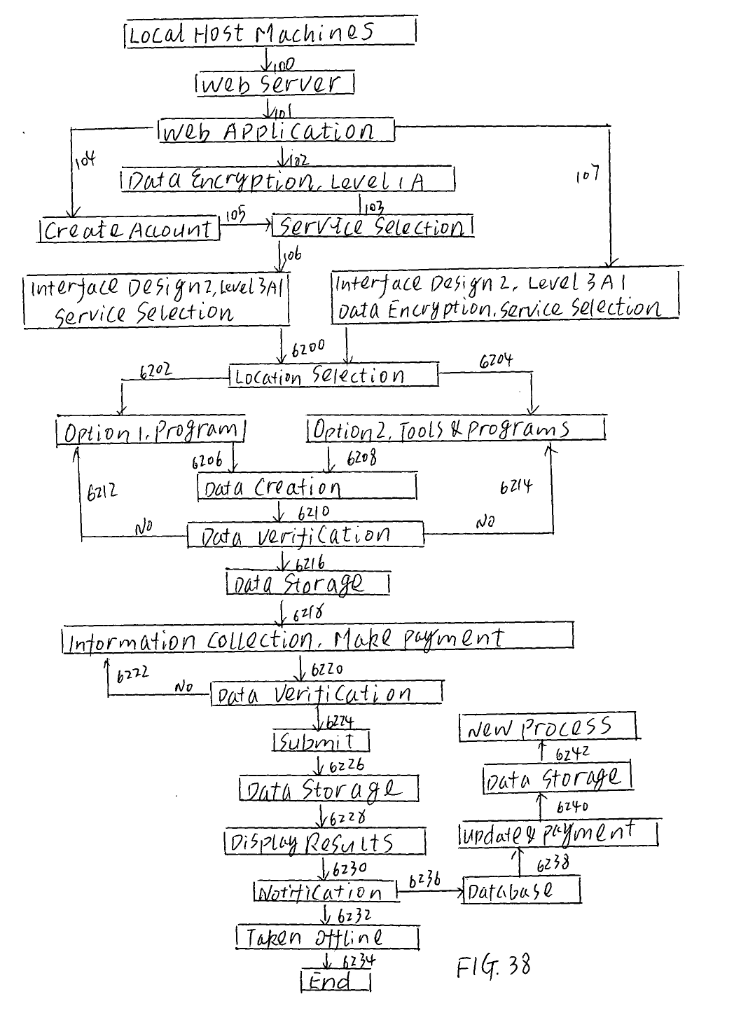

Referring to FIG. 38, this figure is a functional block diagram illustrating how the video and banner ads are created on the first and second page at the third level (Metro area level). The user connects to the web server and access to the web application (Step 100,101). The user can create an account if he or she doesn't have one. If the user has an account, he or she provides data for encryption through the route 102 (from the step 102) or the step 107 at the third level. When the data is encrypted, the user selects an advertising spot.

Step 6200 is the step that the user selects a location to create banner or video ad on the first page at the third level, interface design 2. Interface 2 is made up of items. Items are used to present information from the database or to act as control. The web application is event-driven. An event occurs and the application responds to it. An event is either an interface event, which corresponds to a user action, or an internal processing event, which corresponds to a system action. The interface design 2 is compiled by java. It provides the image and video solutions for displaying the ads on the first and second page at the third level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 24 advertising spots on each of the first and second page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 6202 or the step 6204. Step 6204 has more steps before getting the results, while the step 6202 has fewer.

Step 6204 contains tools and programs. The tools include custom designed advertising templates, background colors, patterns, canvas and editor. The programs are java stored program units. They help the user finish creating the advertisement. In the step 6204 the user picks a template, chooses background color from, Gallery 1 or Gallery 2, selects a canvas and a pattern, and uses the editor. The user follows the steps that are developed by java before getting the results (Step 6208). The results refer to the advertising location being picked; the advertisement being created; the data being created, verified and saved; and the payment being made etc. The data can be any image data types.

If the user chooses to go through the step 6202, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 6206), it is brought up to the desktop for preview. Triggers are fired if functions like preview, upload, reset, submit and cancel are requested.

The data created from the step 6206 and step 6208 need to be verified (Step 6210). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 6212 or the step 6214 until the valid data is provided. If the data is good and complete, the server records the data and writes it to the data blocks in the database from database buffer cache (Step 6216). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 6218. After the data is collected, it needs to be verified (Step 6220). The verification includes company or personal information such as company or personal name, company address, credit card number, expiration date, security code, bank route number and account number etc. If the data is not valid, the process takes the step 6222 and goes back to the step 6218 until the valid data is provided. If the data is valid, it is submitted and saved in the database (Step 6224, 6226), and the results is displayed (Step 6228). The results refer to that the advertising location being picked; the advertisement being created; the data being created, verified and saved; and the payment being made etc. The data can be any image and video data types.

Step 6230 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 6232 and 6234). The second choice is waiting and taking action in the database (Step 6236). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 6238), the new data is saved in the database on the server (Step 6240). A new process begins when the new advertisement is displayed for another period of time (Step 6242).

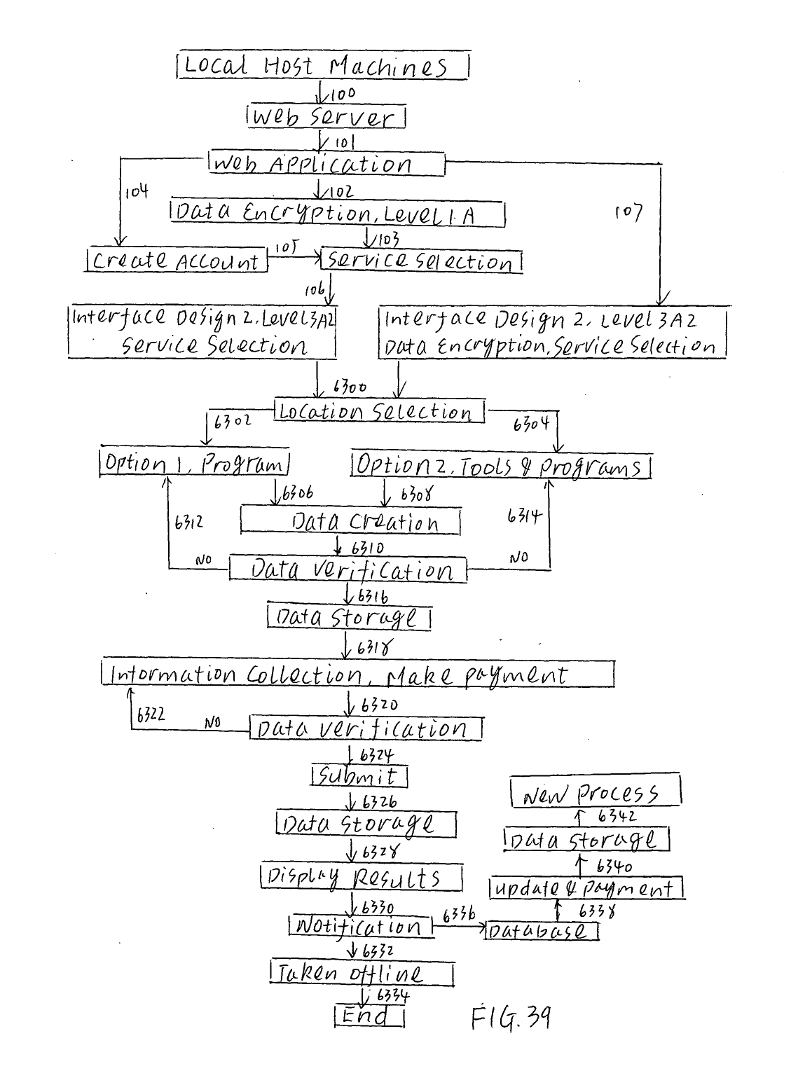

Referring to FIG. 39, this figure is a functional block diagram illustrating how the video and banner ads are created on the third page at the third level (Metro area level). The user connects to the web server and access to the web application (Step 100,101). The user can create an account if he or she doesn't have one. If the user has an account, he or she provides data for encryption through the route 102 (from the step 102) or the step 107 at the third level. When the data is encrypted, the user selects an advertising spot.

Step 6300 is the step that the user selects a location or a service to create banner or video ad on the first page at the third level, interface design 3. Interface 3 is made up of items. Items are used to present information from the database or to act as control. The web application is event-driven. An event occurs and the application responds to it. An event is either an interface event, which corresponds to a user action, or an internal processing event, which corresponds to a system action. The interface design 3 is compiled by java. It provides the image and video solutions for displaying the ads on the third page at the third level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 8 advertising spots on the third page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 6302 or the step 6304. Step 6304 has more steps before getting the results, while the step 6302 has fewer.

Step 6304 contains tools and programs. The tools include custom designed advertising templates, background colors, patterns, canvas and editor. The programs are java stored program units. They help the user finish creating the advertisement. In the step 6304 the user picks a template, chooses background color from Gallery 1 or Gallery 2, selects a canvas and a pattern, and uses the editor. The user follows the steps that are developed by java before getting the results (Step 6308). The results refer to the advertising location being picked; the advertisement being created; the data being created, verified and saved; and the payment being made etc. The data can be any image data types.

If the user chooses to go through the step 6302, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 6306), it is brought up to the desktop for preview. Triggers are fired if functions like preview, upload, reset, submit and cancel are requested.

The data created from the step 6306 and step 6308 need to be verified (Step 6310). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 6312 or the step 6314 until the valid data is provided. If the data is good and complete, the server records the data and writes it to the data blocks in the database from database buffer cache (Step 6316). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 6318. After the data is collected, it needs to be verified (Step 6320). The verification includes company or personal information such as company or personal name, company address, credit card number, expiration date, security code, bank route number and account number etc. If the data is not valid, the process takes the step 6322 and goes back to the step 6318 until the valid data is provided. If the data is valid, it is submitted and saved in the database (Step 6324, 6326), and the results is displayed (Step 6328). The results refer to that the advertising location being picked; the advertisement being created; the data being created, verified and saved; and the payment being made etc. The data can be any image and video data types.

Step 6330 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 6332 and 6334). The second choice is waiting and taking action in the database (Step 6336). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 6338), the new data is saved in the database on the server (Step 6340). A new process begins when the new advertisement is displayed for another period of time (Step 6342).

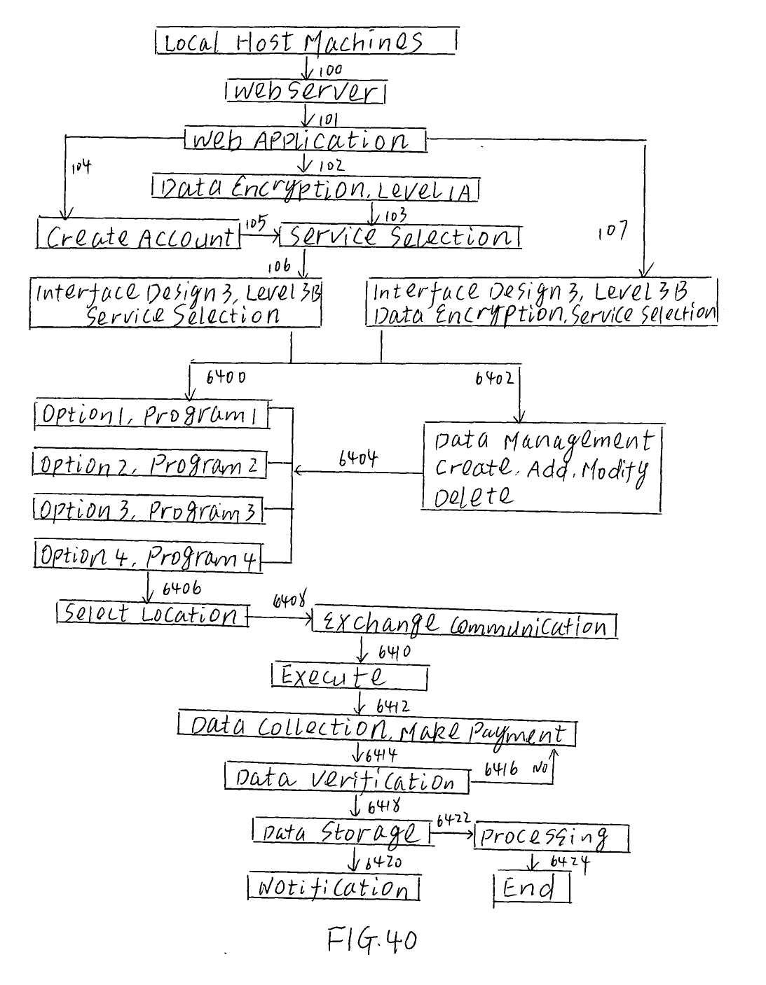

Referring to FIG. 40, this figure is a functional block diagram illustrating how the user invites his or her friend(s) to shop online together. The user connects to the web server and access to the web application (Step 100,101). The user can create an account if he or she doesn't have one. If the user has an account, he or she provides data for encryption through the route 102 (from the step 102) or the step 107 at the third level. When the data is encrypted, the user selects a service.

The user selects Shopping Together (Step 6400). Step 6400 is the step that the user invites his or her friend(s) to shop online together. There are several different ways to invite. The first way is inviting through online. The second way is inviting through email. The third way is inviting through text message over the phone. The fourth way is inviting by voice communication. The methods of inviting are developed using java. The programs are stored in the data files on the server. They are launched when the triggers are pulled.

6402 is the step that the user manages the contact information. The user maintains the contact list including add, modify, delete, upload, preview, cancel, reset, and invite etc. He or she can invite his or her friend(s) from the contact list by taking the step 6404.

Step 6406 is the step to select a shopping area. Step 6408 is the step to communicate with each other through online texting or voice communication. The next step 6410 is the step to ‘Execute’. ‘Execute’ refers to a series of action related to online purchasing.

After the user and his or her friend(s) buy things online, the data needs to be collected (Step 6412). Once the data is collected, it needs to be verified (Step 6414). During the verification, a java function is invoked. It provides a default verification routine to verify the validity of the data. The procedure returns the value TRUE for success and FALSE for failure. If the verification raises an exception, the data becomes invalid, an error is returned.

Verified information includes company or personal information such as company or personal name, company address, credit card number, expiration date, security code, bank route number and account number etc. If the information is not valid, the process takes the step 6416 and goes back to the step 6412 until the information is valid. If the information is valid, it is submitted and saved in the database (Step 6418). The notification is sent out to the shoppers. Step 6410 ‘Execute’ needs to be processed (Step 6422). Shop together ends (Step 6424) when the user and his or her friend(s) finish shopping together session.

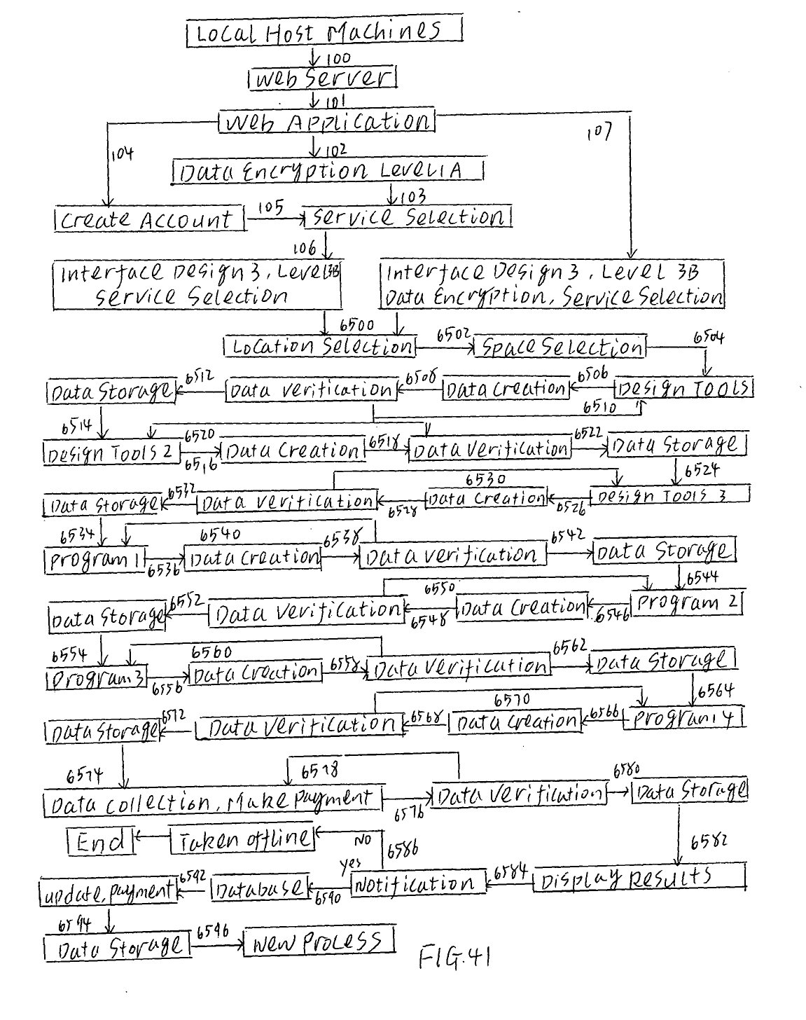

Referring to FIG. 41, this figure is a functional block diagram illustrating how the user sets up store at the metro area level under Service Group 2 in Module 1. Service Group 2 includes Lenox Shopping Plaza, Perimeter Marketing Center, Hispanic Town, Asian Square and European Market. The user connects to the web server and accesses to the web application (Step 100,101).

6500 is the step that the user chooses to set up a store at the metro area level. The user selects a location and a space (Step 6502). The service locations and space are complied with Java. The java program units are stored in the data file on the server. There are many divided space in every service in the Service Group 2. Each service location is graphically designed by graphic program which is also stored within the computer server. When a space is selected, the user uses the design tools and programs to create storefront (Step 6504). The storefront can be either video or image format. The tools and programs include templates, editor, background colors patterns, canvas and Java developed program. In this step the user picks a template, chooses background color from the galleries, selects a canvas and a pattern or chooses to upload his or her own work from the local machine. The user provides necessary information before the data is created (Step 6506). Data information can be any information of a company like company's logo, website, address, video clip etc. After the date is created, it needs to be verified (Step 6508). If it is not valid, it goes back to the step 6504 for valid information (Step 6510). When the verification is done, the data is saved (Step 6512).

The next step 6514 is creating the exterior 3D storefront used in the virtual 3D animation shopping environment. The user uses the tools and programs developed by java. The tools include templates, editor, background colors, and canvas. In this step the user picks a template, chooses a background color from galleries, and selects a canvas. The user provides necessary information before the data is created (Step 6516). After the date is created, it needs to be verified (Step 6518). If it is not valid, it goes back to the step 6516 for valid information (Step 6520). When the verification is done, the data is saved (Step 6522).

The next step 6524 is creating 3D interior of the store used in the virtual 3D animation shopping environment. The user uses the tools and programs developed by java. The tools include templates, editor, background colors, and canvas. In this step the user picks a template, chooses a background color from the galleries, and selects a canvas. The user provides necessary information before the data is created (Step 6526). After the date is created, it needs to be verified (Step 6528). If it is not valid, it goes back to the step 6526 for valid information (Step 6530). When the verification is done, the data is saved in the database (Step 6532).

The user has the option to choose sell products in video or image format or both. If he or she chooses the image format to sell products, java compiled programs help set up (Step 6534). After the user follows each step which includes making selection, providing the products related information, uploading the products' images, and previewing etc., the data is created (Step 6536). The created data needs to be verified (Step 6538). If it is not valid, it goes back to the step 6534 for valid information (Step 6540). When the verification is done, the data is saved in the database (Step 6542).

If the user chooses the video format to sell products, he has the option to sell by clips or by one clip. One clip includes all the products. Clips consist of different product categories. Java compiled programs help set up (Step 6544). After the user follows each step which includes making selection, providing the products related information, uploading the products' images, and previewing etc, the data is created (Step 6546). The data created needs to be verified (Step 6548). If it is not valid, it goes back to the step 1144 for valid information (Step 6550). When the verification is done, the data saved in the database (Step 6552).

If the user chooses to sell in both the video and image formats, he or she follows the steps developed by java before finishing setting up.

6554 is the next step that the user chooses to run promotion. The promotion module consists of text, image, video and coupons. It is compiled with java programs. These programs are stored in the data files on the server. The user follows each step before the data is created (Step 6556). The data created in the step 6556 needs to be verified (Step 6558). If it is not valid, it goes back to the step 6554 for valid information (Step 6560). When the verification is done, the data is saved in the database (Step 6562).

The user can introduce the business by video (Step 6564). The video needs to be uploaded for preview (Step 6566, 6568). If it is not good, the process goes back (Step 6570). If it is good, it is saved (Step 6572). The next step is collecting information and making payment (Step 6574). The collected information needs to be verified (Step 6576). If it is not good, it goes back to the step 1174 through the step 6578. The data is saved and the results are displayed (Step 6580, 6582) when the verification is done. The displayed results refer to the design of the store being finished, the products being uploaded, the promotions being ready to be displayed, and the business video introduction being ready to be broadcasted etc.

Notification is sent to remind the user of renewing the lease three times before it expires (Step 6584). The user selecting the sales commission model skips this step. If the user ignores it, the store is closed when the lease expires (Step 6586), however all the contents created in the store remain in the account. The user can re-open the business anytime if the space is available or any other space is available. The process ends at the user without taking action (Step 6588). If the user chooses to renew the lease, he or she goes to the database (Step 6590), makes payment and updates the account information (Step 6592). The new data is saved (Step 6594) and a new process begins when the new lease begins (Step 6596).

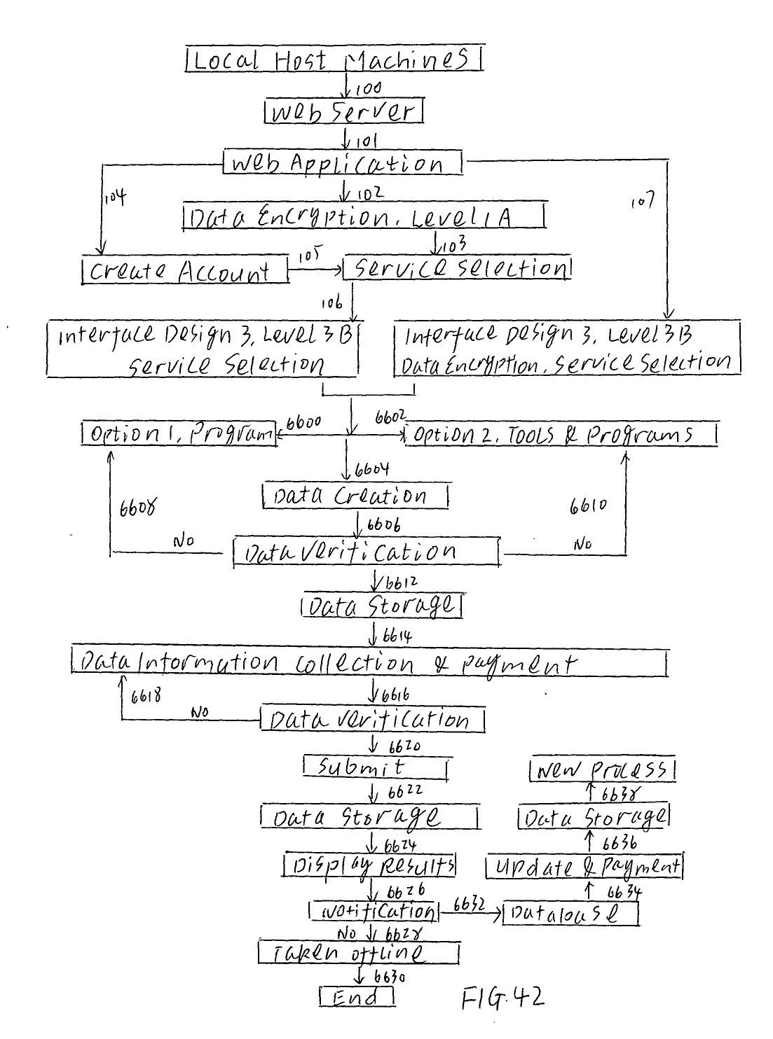

Referring FIG. 42, this figure is a functional block diagram illustrating how Service Group 1 is designed at the third level (Metro area level). The service group 1 includes Wholesale to All, On Sale, Special Deals, Clearance, Closeouts, Overstocks, Tent Events, Products & Services Promotion, Business Opportunities, Finance-Investment, Franchises, Events, Workshops-Seminars, Auctions, and Announcements. The user connects to the web server and access to the web application. The user can create an account if he or she doesn't have one. If the user has an account, he or she provides data for encryption through the route 102 (from the step 102) or the step 107 at the first level. When the data is encrypted, the user selects a service on the third page.

6600 is the step that the user chooses Option 1. Option 1 is related to image and video ads and that the user chooses to upload the advertisement himself or herself on the local machine. A program is developed to help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

6602 is the step that the user chooses Option 2. Option 2 is related to creating the image ads using the online tools. The user uses the tools and programs compiled by java. The tools include templates, background colors, patterns, editor and canvas etc. The java program units enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database for the as a unit. Packaged procedures and functions can be called explicitly the applications or users. The package usually has two parts stored separately in the database: A). The specification is the interface to the application and declares the types, variables, constraints, exceptions, cursors, and subprograms available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

When the step 6600 and 6602 are done, the data is created (Step 6604). The created data needs to be verified (Step 6606). If the verification raises an exception, the data becomes invalid, an error is returned. The process goes back to the step 6600 and 6602 by taking the step 6608 and step 6610. After the verification is done, the data is saved in the database on the server (Step 6612).

The next step is collecting information (Step 6614). It includes the payment information. The information needs to be verified (6616). If it is not valid, it goes back to the step 6614 for valid information (Step 6618). The new data is submitted and saved in the database on the server (Step 6620, 6622) and the results are displayed (Step 6624). The results refer to the image or video advertisement being created and posted.

Step 6626 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 6628 and 6630). The second choice is waiting and taking action in the database (Step 6632). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, create and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 6634), the new data is saved in the database on the server (Step 6636). A new process begins when the new advertisement is displayed for another period of time (Step 6638).

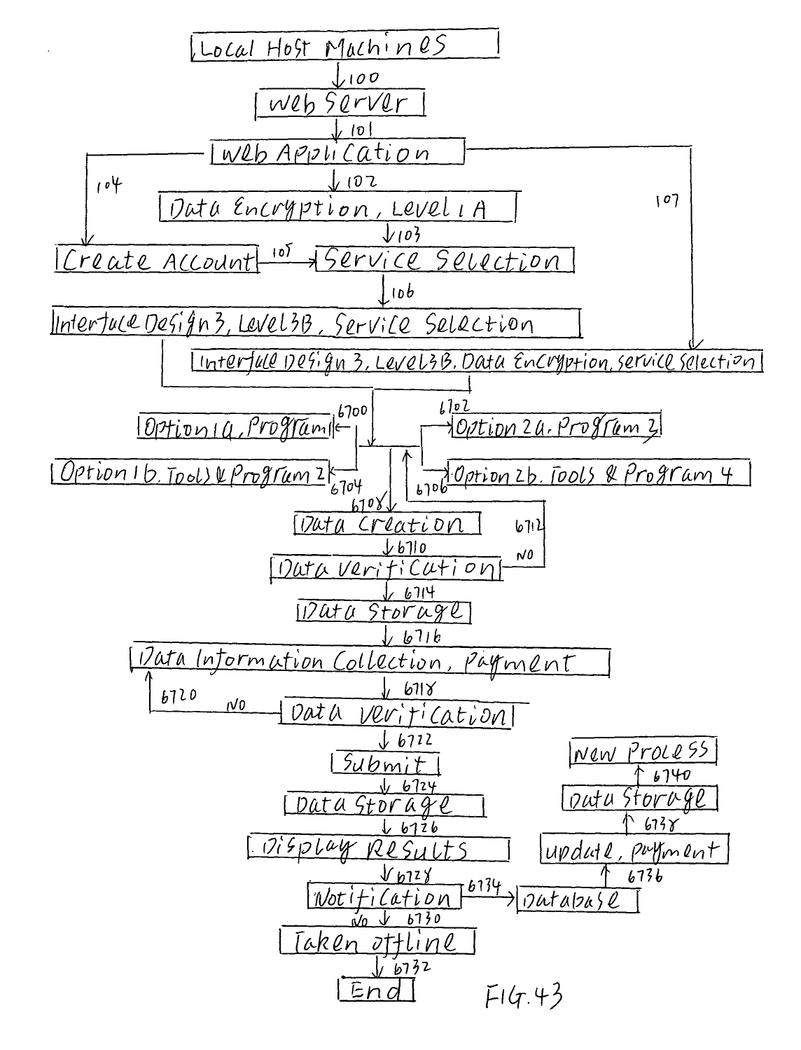

Referring to FIG. 43, this figure is a functional block diagram illustrating how Monthly Ads Catalog, Quarterly Products Brochure, Coupons, Coupon Books in Service Group 3 is designed. The user connects to the web server and access to the web application. The user can create an account if he or she doesn't have one. If the user has an account, he or she provides data for encryption through the route 102 (from the step 102) or the step 107 at the third level. When the data is encrypted, the user selects one of the services in the service group 3.

Option 1A (Step 6700) is the step that the user selects to use his or her own front cover page on the local machine. The user originates the request. The request is sent in the user process. The server parses the request. There are three main stages in the process A). Parse, during the parse stage, the request is passed from the user process, and a parsed representation of the request is loaded into the local computer. During the parse, the server process searches for the existing request copy of the request in the local computer; validates the iii request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

Option 2A (Step 6702) followed by Option 1A is the step that the user selects to use his or her own catalog. The user initiates the query. If the query is successful, they return data as results. There are three main stages in the process of a query. A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched. After the data file is fetched, the data is brought up to the desktop for preview. If it is good, it is submitted. Or a new process begins until the valid data file is fetched.

Option 1B and 2B (Step 6704, 6706) are the steps that the user selects to create the front page and catalog using the free online tools. The user uses the tools and walks through the steps developed by Java programs. The tools include templates, background colors, patterns, editor and canvas etc. The java programs are stored program units. They help the user finish the work and manipulate database information using procedural schema object. After each step is taken, the data is created Step (6708). The created data needs to be verified (Step 6710).

During the verification, a java function program is invoked. It provides a default verification routine to verify the validity of the data. The procedure returns the value TRUE for success and FALSE for failure. If the verification raises an exception, the data becomes invalid, an error is returned. The process goes back until the data provided is good and valid (Step 6712). After the verification is done, the server records the data and writes it to the data blocks in the data files from database buffer cache (Step 6714).

The next step (Step 6716) is collecting information. The collected information needs to be verified (Step 6718). If it is not valid, it goes back to the step 6716 for valid information by taking the step 6720. Date verified is submitted and saved in the database on the server (Step 6722, 6724). And the results are displayed (Step 6726). The results refer to the advertisement being created and the sales module being implemented. Step 6728 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 6730 and 6732). The second choice is waiting and taking action in the database (Step 6734). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 6736), the new data is saved in the database on the server (Step 6738). A new process begins when the advertisement begins to be displayed for another period of time (Step 6740).

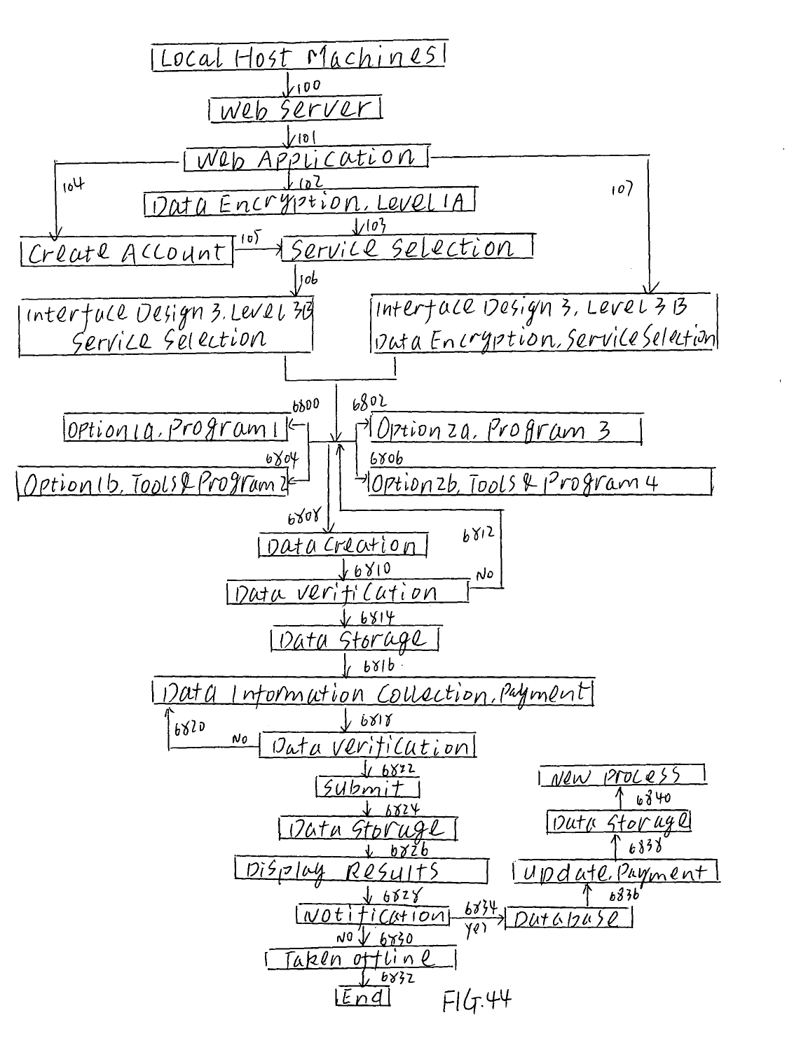

Referring to FIG. 44, this figure is a functional block diagram illustrating how VIP Ads Showroom is designed at the metro area level. The user connects to the web server and access to the web application. The user can create an account if he or she doesn't have one. If the user has an account, he or she provides data for encryption through the route 102 (from the step 102) or the step 107 at the third level. When the data is encrypted, the user selects VIP Ads Showroom.

Step 6800 is the step to create the front cover page. The front cover page can either be in video or image format. The tools include templates, editor, background colors, patterns and canvas. The programs are java stored program units. The user picks a template, chooses background color from galleries, selects a canvas and a pattern and follows the steps before the front cover page is created. If the user chooses to use his or her own design work as the front cover page, a java function program is invoked to help him or her to locate the design work from the local machine. If the query is successful, the design work is brought up to the desktop for preview. It is submitted if the data is valid.

The next step 6802 is the step to create text and video advertisement. The user types the text ad contents in the block. Video advertisement is uploaded. The text and video advertisement need to be verified before they are submitted.

6804 is the step to create online image advertisement. The user uses the tools and programs. The tools include templates, background colors, patterns, editor and canvas etc. The programs include the steps and choices to help the user finish the advertisement. The user follows each step which includes providing ad content information, making selection, editing, previewing and correction etc. If the user chooses to provide his or her own image ad work. The java program helps search the data file from the local machine. The user originates the request. The server process parses the request and sends to the local machine. The local machine receives the request and begins to search. If the criteria are matched, the result is sent back. It is brought up to the desktop for preview. The advertisement is submitted if it is good. Or another process begins until the query is successfully returned.

If the user sells products (Step 6806), he or she chooses which format to sell: image, video or both. If the user chooses the image format to sell products, java compiled programs help him or her do it. The user follows each step which includes providing products' information, uploading products images, making payment and previewing etc. If the user chooses the video format to sell products, he or she has the option to sell by clips or one clip. One clip includes all products. Clips consist of different product categories. Java programs help the user do it. All the clips need to be viewed before they are submitted.

After the step 6800, 6802, 6804 and 6806 are taken; the data is created (Step 6808). The data needs to be verified (Step 6810). If it is not valid, it goes back until the valid data is provided (Step 6812). After the verification is done, the data is saved in the database on the server (Step 6814).

Step 6816 is collecting information. It includes the payment information. The collected information needs to be verified (Step 6818). If the information is not valid, the process goes back until the valid data is provided (6820). Data verified is submitted and saved in the database on the server (Step 6822, 6824). The results are displayed (Step 6826). The results refer to the advertisement being created, the products being ready to be sold and the sales module being implemented etc.

Step 6828 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 6830 and 6832). The second choice is waiting and taking action in the database (Step 6834). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 6836), the new data is saved in the database on the server (Step 6838). A new process begins when the contents under VIP Ads Showroom begin to be displayed for another period of time (Step 6840).

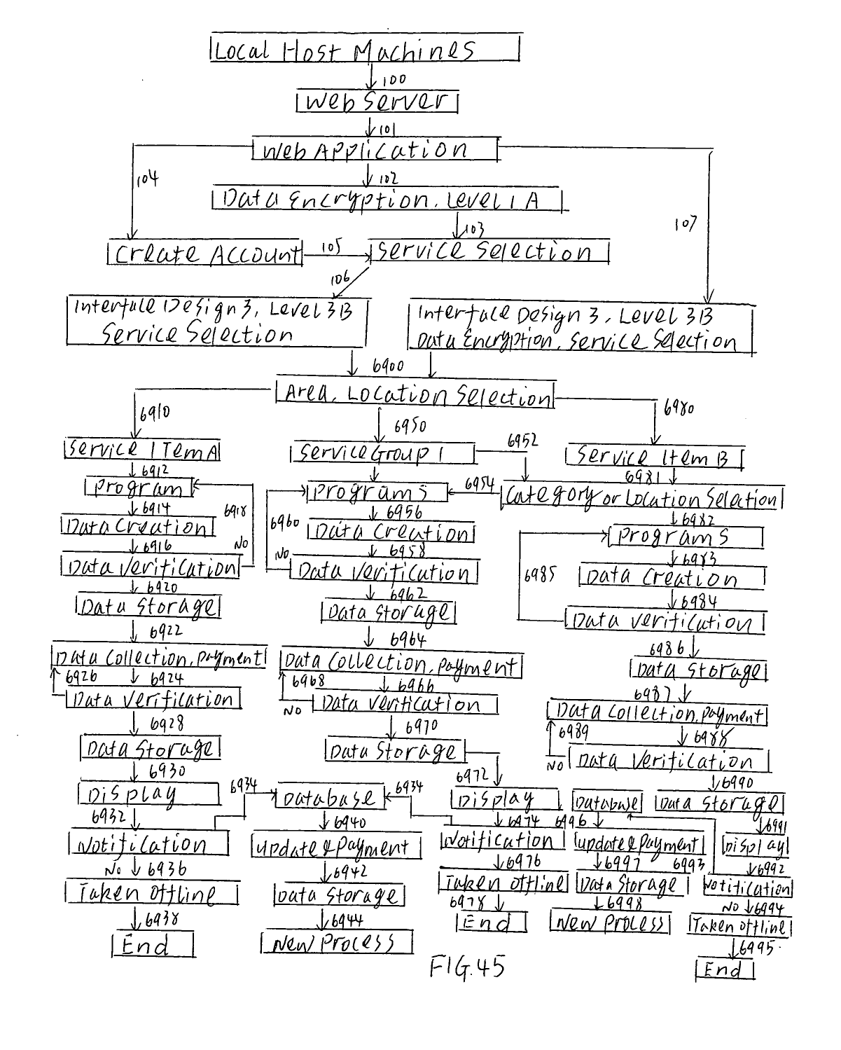

Referring to FIG. 45, this is a functional block diagram illustrating how Asian Square, Hispanic Town and European Market are designed at the fourth level (Metro area level). After the authentication is done through the step 102 at the first level or 107 at the third level, the user takes the step 6900. Step 6900 is the step that the user chooses an area and a location. An area refers to a metro area located in each state. A location refers to a shopping area either Asian Square, Hispanic Town or European Market.

The user has three options. Step 6910 is selecting the service item. The service item is text related advertising. Java programs are developed for creating text advertising (Step 6912). The programs contain functions, procedures, packages and triggers. They are stored in the files on the server. The user follows each step before the data is created (Step 6914).

The created data needs to be verified (Step 6916). During the verification, a java function is invoked. It provides a default verification routine to verify the validity of the data. The procedure returns the value TRUE for success and FALSE for failure. If the verification raises an exception, the data becomes invalid, an error is returned. The process goes back until the data provided is good and valid (Step 6918). After the verification is done, the server records the data and writes it to the data blocks in the data files from database buffer cache (Step 6920).

The next step (Step 6922) is collecting information. The collected information needs to be verified (Step 6924). If it is not valid, it goes back to the step 6922 for valid information by taking the step 6926. The verified data is submitted and saved in the database on the server (Step 6928). And the results are displayed (Step 6930). The results refer to the text advertisement being created and the sales module being implemented.

The user receives notification in the step 6932 before the advertisement expires. If he or she ignores it, the advertisement will be taken offline (Step 6936). The process ends at the step 6938 when the advertisement expires.

If the user takes action, he or she goes to the database to update (Step 6934, 6940). After the update, the new results are saved in the database on the server (Step 6942). A new process begins when advertisement is expired (Step 6944).

Option 2, step 6950 is selecting a service item in the service group 1. Services in the service group Tare different advertising categories made up of image and video advertising. The user chooses an advertising category and selects either to use his or her own created advertisement or creates the advertisement using the free tools developed by java (Step 6954).

If the user chooses to use his or her own advertisement, the user originates a request. If the query is successful, it returns data as result from the user's local machine. If the data is good and valid, the process moves to the next step.

If the user chooses to uses the tools to create advertising, programs and tools help him or her walk through the steps. The tools include templates, background colors, patterns, the editor and canvas etc. The programs are java stored program units. They help the user finish the work and manipulate database information using procedural schema object. After each step is taken, the data is created (Step 6956). The data needs to be verified (Step 6958).

During the verification, a java function is invoked. It provides a default verification routine to verify the validity of the data. The procedure returns the value TRUE for success and FALSE for failure. If the verification raises an exception, the data becomes invalid, an error is returned. The process goes back until the data provided is good and valid (Step 6960). After the verification is done, the server records the data and writes it to the data blocks in the data files from database buffer cache (Step 6962).

The next step (Step 6964) is collecting information. The collected information needs to be verified (Step 6966). If it is not valid, it goes back to the step 6964 for valid information by taking the step 6968. The verified data is submitted and saved in the database on the server (Step 6970). And the results are displayed (Step 6972). The results refer to the advertisement being created and the sales module being implemented.

The user receives notification in the step 6974 before the advertisement expires. If he or she ignores it, the advertisement will be taken offline (Step 6976). The process ends at the step 6978 when the advertisement expires.

If the user takes action, he or she goes to the database to update (the same process for the route from Step 6910). After the update (Step 6940), the new results are saved in the database on the server (Step 6942). A new process begins when the updated advertisement is created (Step 6944).

Step 6980 is the step that the user chooses the other service item. The service item is related to help the user sell products online. The user chooses a space and provides necessary information in the step 6981. When the space is selected, the user uses the design tools and programs to create the storefront. The storefront can either be video or image format. The tools and programs include templates, editor, background colors patterns, canvas and Java developed program. In this step the user picks a template, chooses background color from the galleries, selects a canvas and a pattern or chooses to upload his or her own work from the local machine. Next, the user has the option to sell products in video or image format or both. If he or she chooses the image format to sell products, java compiled programs help finish it. If the user chooses the video format to sell products, he has the option to sell by clips or one clip. One clip includes all the products. Clips consist of different products. Java compiled programs help finish it. After the user follows each step (Step 6982), the data is created (Step 6983). The created data needs to be verified (Step 6984). If it is not valid, it goes back to the step 6982 for valid data (Step 6985). When the verification is done, the data is saved in the database on the server (Step 6986).

Step 6987 is collecting information. The user provides information. It includes the payment information. The information needs to be verified (Step 6988). If the information is not valid, the process goes back until it is valid (6989). The verified data is submitted and saved in the database on the server (Step 6990). And the results are displayed (Step 6991). The results refer to the advertisement being created and the sales module being implemented.

The user receives notification in the step 6992 before the contents expire. If he or she ignores it, the contents will be taken offline and the process stops (Step 6994, 6995).

If the user takes action, he or she goes to the database to update (Step 6993, 6996). Update could be create, modify, renew, and make payment etc. Updated information is saved in the database on the server (Step 6997). A new process begins when the updated contents continue to be displayed (Step 6998).

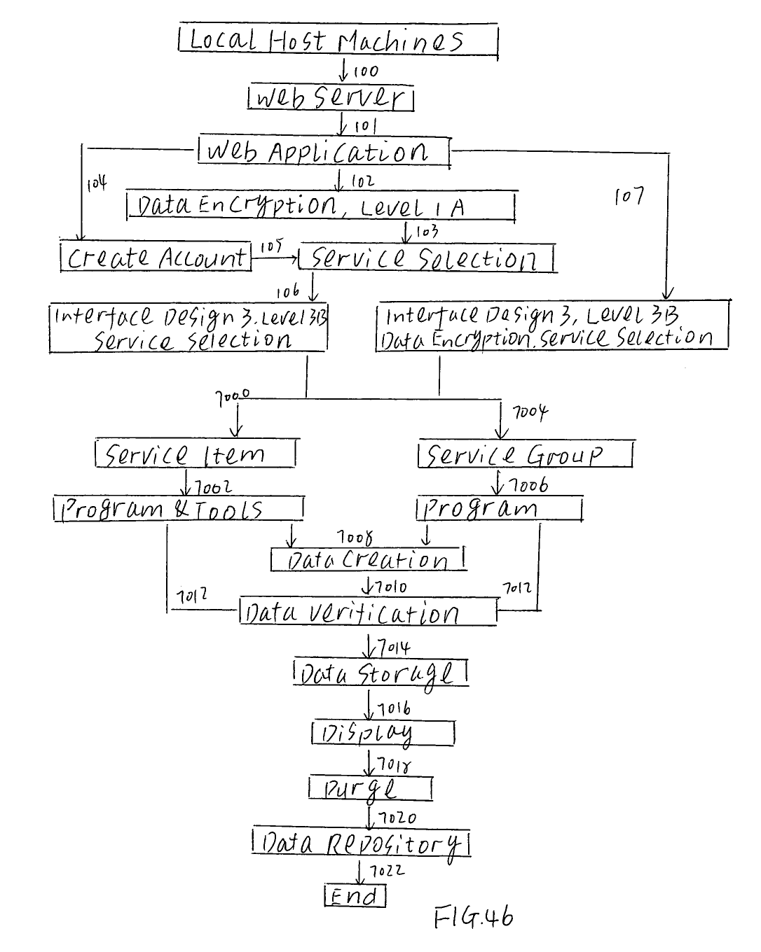

Referring to FIG. 46, this is a functional block diagram illustrating how Local Community is created. The user connects to the web server and access to the web application (Step 100, 101). The user needs to establish an account. After the authentication is made through the step 102 or 107 at the third level, the user chooses Local Community under Community.

7000 is the step that the user chooses the service item. The service item is related to business promotion or for introduction purpose. All the design work is put in a designated location for public view.

The user takes the step 7002 to upload the design work by himself or herself or to use the free online tools to create one. If the user chooses to use his or her design work, a java program helps the user locate the design work. Once the result is returned, it is brought up to the desktop to preview. If it is good, it is submitted. If the user chooses to create the design work using the online tools, java compiled programs and tools help him or her finish the work. The work refers to creating the design work for the business exposure and promotion purpose. The user follows each step before the work is done and the data is created (Step 7008).

If the user chooses a service in the service group, he or she takes the step 7004. The services in the service group are also for business exposure, introduction and promotion purpose. Each service format in the group is identical. It is developed by java (Step 7006). The user creates data for communication (Step 7008).

The data created from the step 7008 needs to be verified. If it is not valid, the process goes back to the step 7002 or 7006 until the valid data is provide (Step 7012). The data is shown in the display area (Step 7016) after the verified data is saved (Step 7014). The data will be purged and put in the repository area (Step 7018, 7020). The process ends at the new data being created (Step 7022).

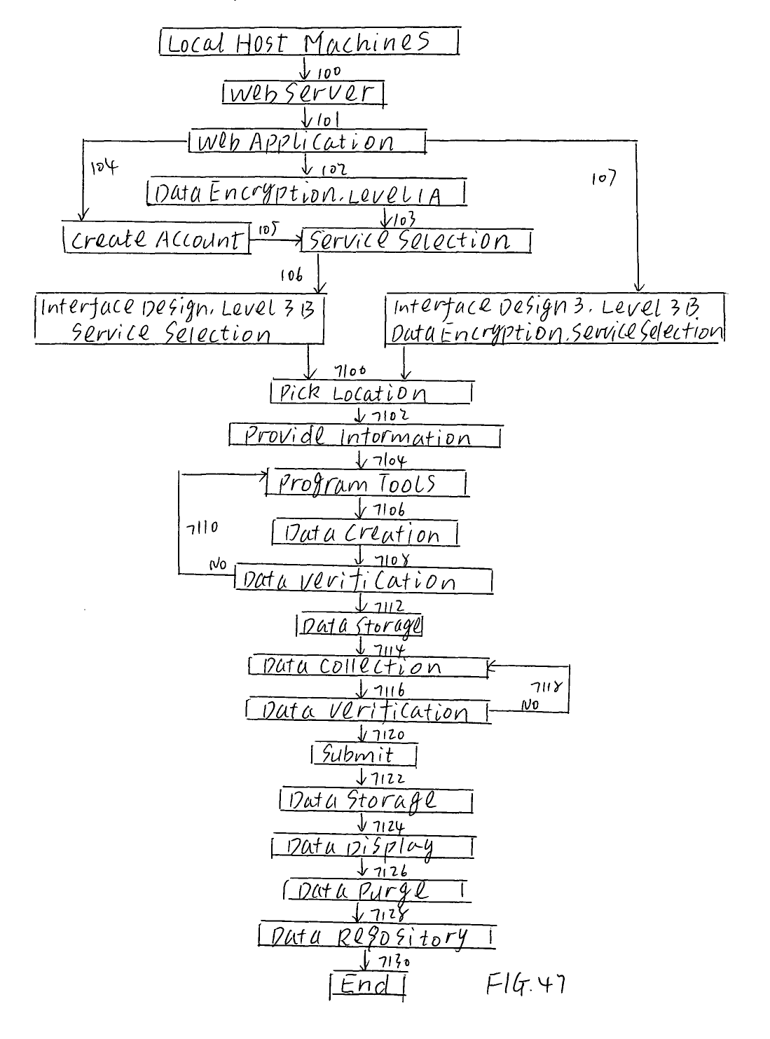

Referring to FIG. 47, this is a functional block diagram illustrating how Publisher's Classified Ads is designed. After the authentication is done through the step 102 or 107 at the third level, the user takes the step 7100. Step 7100 is the step that the user chooses an area. An area can be at national, metro area or a city level. The user provides information required before moving to the next step (Step 7102).

Step 7104 is a program developed for the user to create classified ads. The program is developed by java. It contains java codes stored on the server. The user follows each step until all the classified ads data is created (Step 7106). The created data needs to be verified (Step 7108). If it is not good, it goes back to the step 3104 through the step 7110. The data is saved after the verification (Step 7112). The next step is data collection (Step 7114). The data includes payment information. When it is done, the data needs to be verified. If it is not good, it takes the step 7118 until the valid data is provided. Verified data is submitted and stored in the database (Step 7120, 7122). The results are displayed (Step 7124). The results refer to the ad contents being posted at the level the user selects. The data is purged when post time expires (Step 7126). It is put in the repository for the user to manipulate in his or her account for future use (Step 7128). The process ends at that the new ad contents being created and posted (Step 7130).

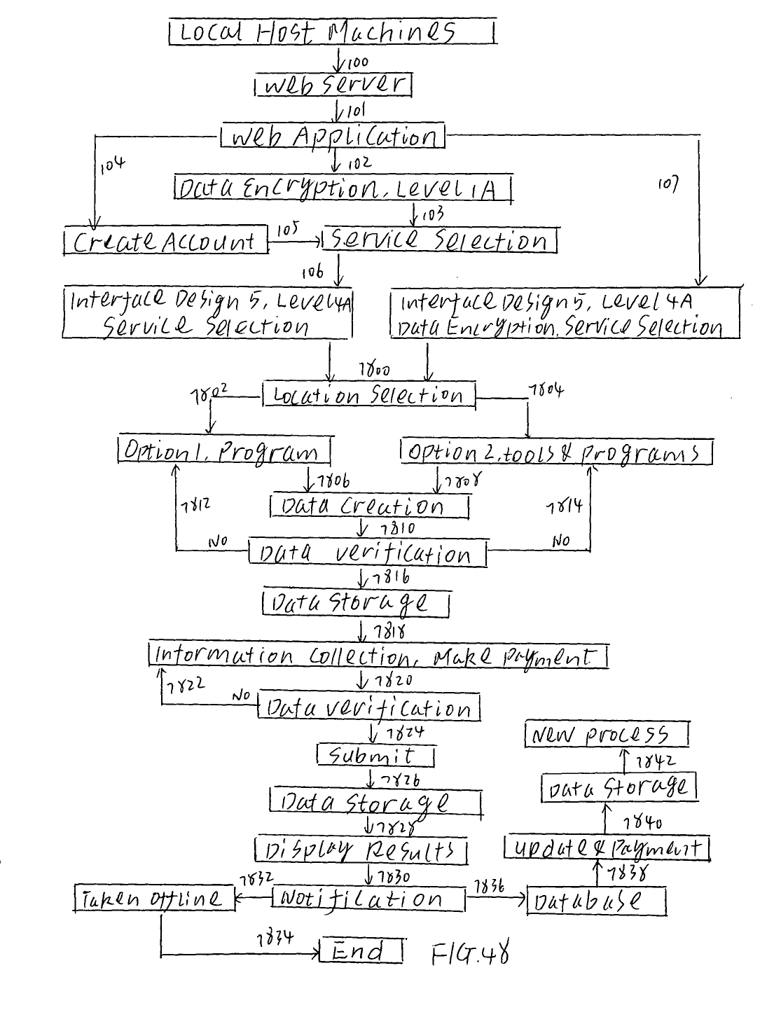

Referring to FIG. 48, this figure is a functional block diagram illustrating how the video and banner ads are created on the first page at the fourth level (City level). The user connects to the web server and access to the web application (Step 100,101). The user can create an account if he or she doesn't have one. If the user has an account, he or she provides data for encryption through the route 102 (from the step 102) or the step 107 at the fourth level. When the data is encrypted, the user selects an advertising spot.

Step 7800 is the step that the user selects a location or a service to create banner or video ad on the first page, interface design 5. Interface 5 is made up of items. Items are used to present information from the database or to act as control. The web application is event-driven. An event occurs and the application responds to it. An event is either an interface event, which corresponds to a user action, or an internal processing event, which corresponds to a system action. The interface design 5 is compiled by java. It provides the image and video solutions for displaying the ads on the first page at the fourth level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 10 advertising spots and other service categories on the first page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 7802 or the step 7804. Step 7804 has more steps before getting the results, while the step 7802 has fewer.

Step 7804 contains tools and programs. The tools include custom designed advertising templates, background colors, patterns, canvas and editor. The programs are java stored program units. They help the user finish creating the advertisement. In the step 7804 the user picks a template, chooses background color from Gallery 1 or Gallery 2, selects a canvas and a pattern, and uses the editor. The user follows the steps that are developed by java before getting the results (Step 7808). The results refer to the advertising location being picked; the advertisement being created; the data being created, verified and saved; and the payment being made etc. The data can be any image data types.

If the user chooses to go through the step 7802, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 7806), it is brought up to the desktop for preview. Triggers are fired if functions like preview, upload, reset, submit and cancel are requested.

The data created from the step 7806 and step 7808 need to be verified (Step 7810). During the verification, a java function is invoked. It provides a default verification routine to verify the validity of the data. The procedure returns the value TRUE for success and FALSE for failure. If the verification raises an exception, the data becomes invalid, an error is returned. The process goes back (Step 7812 or Step 7814) valid data is provided. If the data is good and complete, the server records the data and writes it to the data blocks in the database from database buffer cache (Step 7816). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 7818. After the data is collected, it needs to be verified (Step 7820). The verification includes company or personal information such as company or personal name, company address, credit card number, expiration date, security code, bank route number and account number etc. If the data is not valid, the process takes the step 7822 and goes back to the step 7818 until the valid data is provided. If the data is valid, it is submitted and saved in the database (Step 7824, 7826), and the results is displayed (Step 7828). The results refer to the advertising location being picked; the advertisement being created; the data being created, verified and saved; and the payment being made etc. The data can be any image and video data types.

Step 7830 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 7832 and 7834). The second choice is waiting and taking action in the database (Step 7836). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server'process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 7838), the new data is saved in the database on the server (Step 7840). A new process begins when the new advertisement is displayed for another period of time (Step 7842).

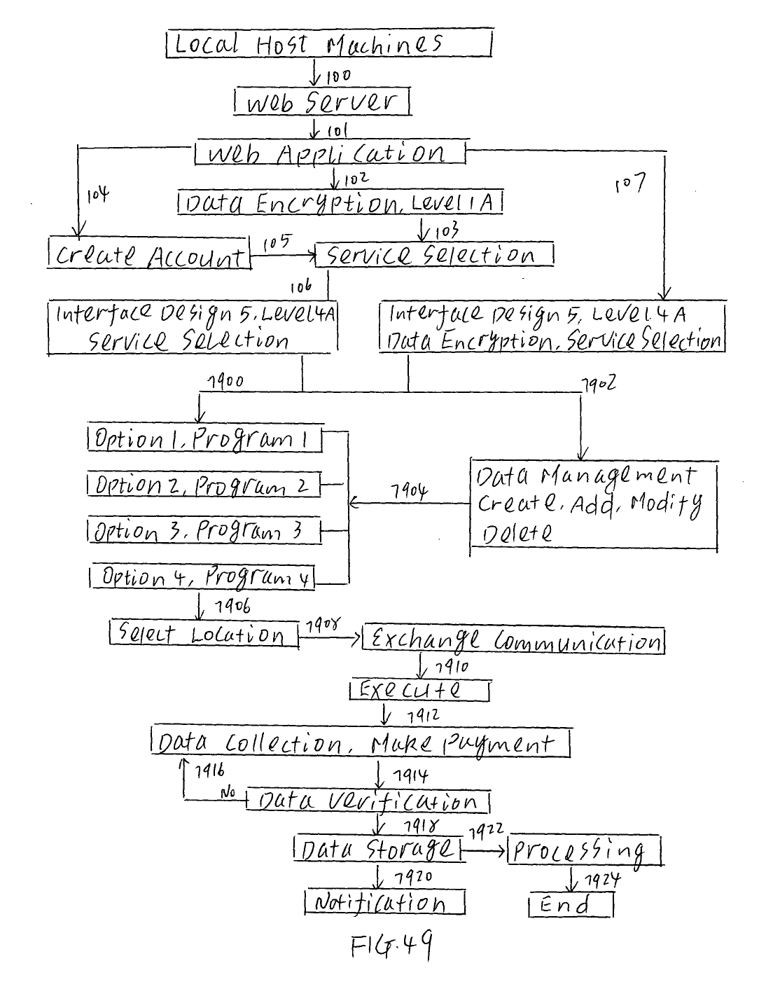

Referring to FIG. 49, this figure is a functional block diagram illustrating how the user invites his or her friend(s) to shop online together. The user connects to the web server and access to the web application (Step 100,101). The user can create an account if he or she doesn't have one. If the user has an account, he or she provides data for encryption through the route 102 (from the step 102) or the step 107 at the fourth level. When the data is encrypted, the user selects a service.

The user selects Shopping Together (Step 7900). Step 7900 is the step that the user invites his or her friend(s) to shop online together. There are several different ways to invite. The first way is inviting through online.

The second way is inviting through email. The third way is inviting through text message over the phone. The fourth way is inviting by voice communication. The methods of inviting are developed using java. The programs are stored in the data files on the server. They are launched when the triggers are pulled.

7902 is the step that the user manages the contact information. The user maintains the contact list including add, modify, delete, upload, preview, cancel, reset, and invite etc. He or she can invite his or her friend(s) from the contact list by taking the step 7904.

Step 7906 is the step to select a shopping area. Step 7908 is the step to communicate with each other through online texting or voice communication. The next step 7910 is the step to ‘Execute’. ‘Execute’ refers to a series of action related to online purchasing.

After the user and his or her friend(s) buy things online, the data needs to be collected (Step 7912). Once the data is collected, it needs to be verified (Step 7914). During the verification, a java function is invoked. It provides a default verification routine to verify the validity of the data. The procedure returns the value TRUE for success and FALSE for failure. If the verification raises an exception, the data becomes invalid, an error is returned. Verified information includes company or personal information such as company or personal name, company address, credit card number, expiration date, security code, bank route number and account number etc. If the information is not valid, the process takes the step 7916 and goes back to the step 7912 until the information is valid. If the information is valid, it is submitted and saved in the database (Step 7918). The notification is sent out to the shoppers. Step 7910 ‘Execute’ needs to be processed (Step 7922). Shop together ends (Step 7924) when the user and his or her friend(s) finish shopping together session.

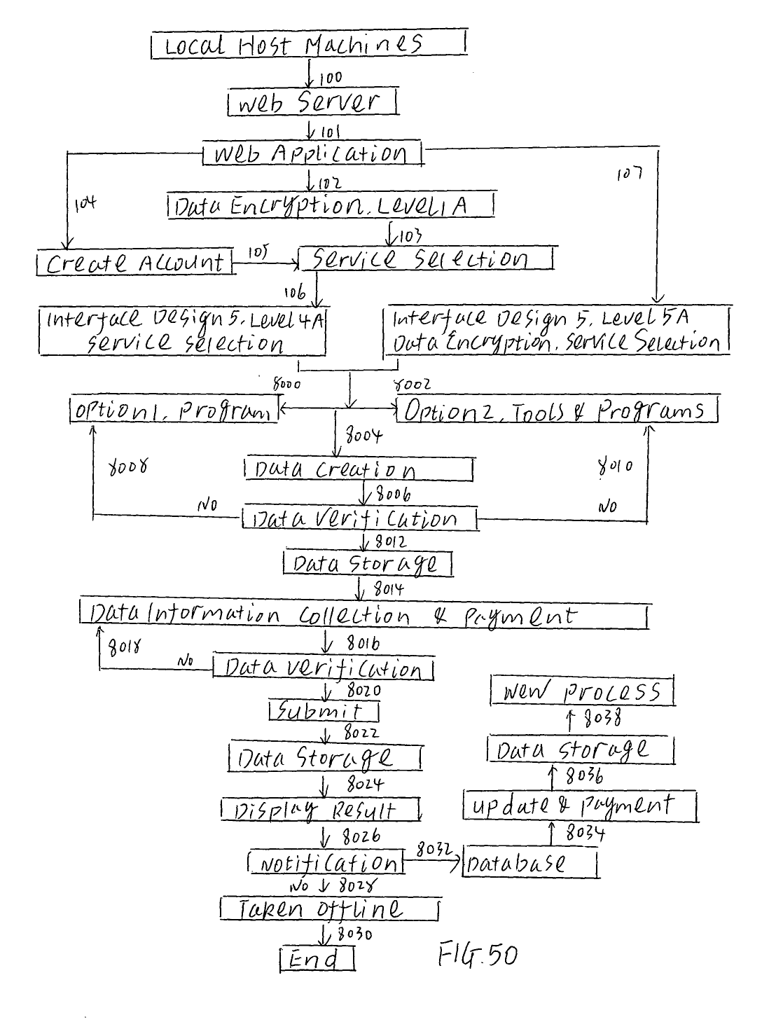

Referring FIG. 50, this figure is a functional block diagram illustrating how Service Group 1 are designed at the fourth level (City level). The service group 1 includes On Sale, Special Deals, Overstock, Clearance, Closeouts, Products & Services Promotion, Business Opportunities, Events, and Announcements. The user connects to the web server and access to the web application. The user can create an account if he or she doesn't have one. If the user has an account, he or she provides data for encryption through the route 102 (from the step 102) or the step 107 at the first level. When the data is encrypted, the user selects a service on the first page.

8000 is the step that the user chooses Option 1. Option 1 is related to video or image advertisement and the user chooses to upload the advertisement by himself or herself on the local machine. A program is developed to help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

8002 is the step that the user chooses Option 2. Option 2 is related to creating image advertisement using the tools and programs compiled by java. The tools include templates, background colors, patterns, editor and canvas etc. The java program units enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database for the as a unit. Packaged procedures and functions can be called explicitly the applications or users. The package usually has two parts stored separately in the database: A). The specification is the interface to the application and declares the types, variables, constraints, exceptions, cursors, and subprograms available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

When the step 8000 and 8002 are done, the data is created (Step 8004). The created data needs to be verified (Step 8006). If the verification raises an exception, the data becomes invalid, an error is returned. The process goes back to the step 8000 and 8002 by taking the step 8008 and step 8010. After the verification is done, the data is saved in the database on the server (Step 8012).

The next step is collecting information (Step 8014). It includes the payment information. The information needs to be verified (8016). If it is not valid, it goes back to the step 8014 for valid information (Step 8018). The new data is submitted and saved in the database on the server (Step 8020, 8022) and the results are displayed (Step 8024). The results refer to the image or video advertisement being created and posted.

Step 8026 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 8028 and 8030). The second choice is waiting and taking action in the database (Step 8032). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 8034), the new data is saved in the database on the server (Step 8036). A new process begins when the new advertisement is displayed for another period of time (Step 8038).

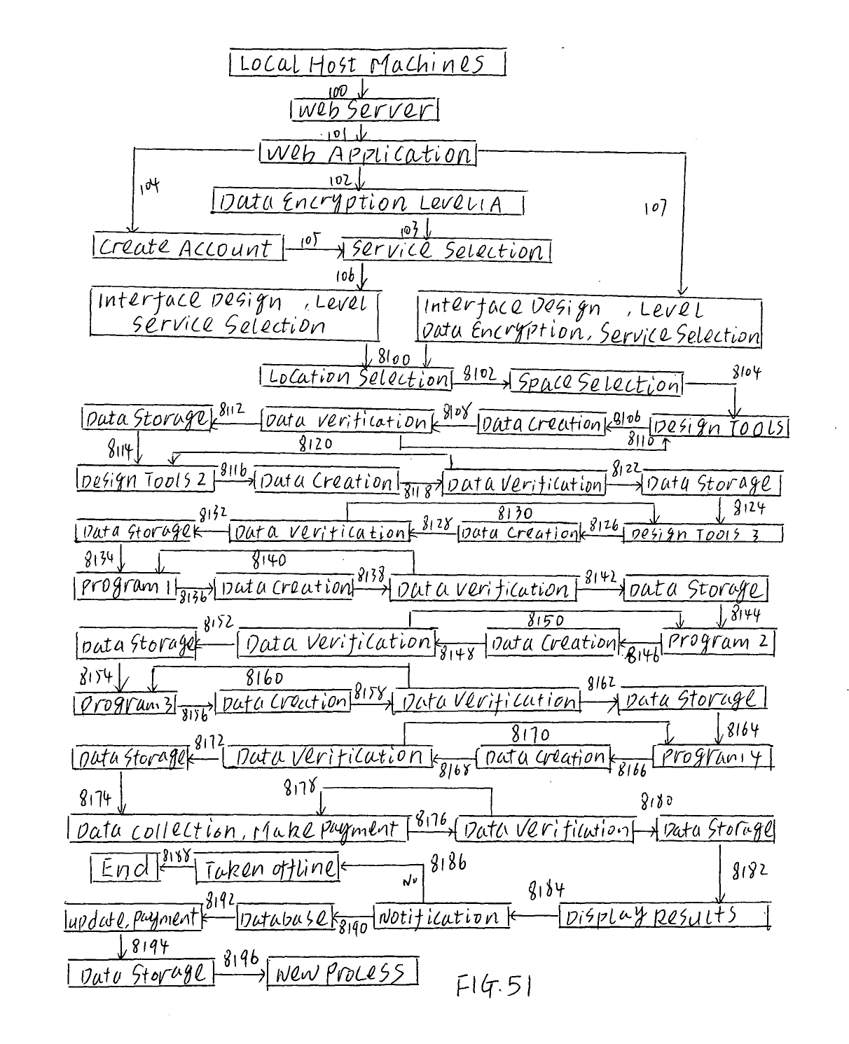

Referring to FIG. 51, this figure is a functional block diagram illustrating how the user sets up store at the city level under Service Group 2 in Module 1. Service Group 2 includes Local Online Store, Shopping Centers and Non-shopping Centers. The user connects to the web server and accesses to the web application (Step 100,101).

8100 is the step that the user chooses to set up a store at the city level. The user selects a location and a space (Step 8102). The service locations and space are complied with Java. The java program units are stored in the data file on the server. There are many divided space in every service in the Service Group 2. Each service location is graphically designed by graphic program which is also stored within the computer server. When a space is selected, the user uses the design tools and programs to create storefront (Step 8104). The storefront can be either video or image format. The tools and programs include templates, editor, background colors patterns, canvas and Java developed program. In this step the user picks a template, chooses background color from the galleries, selects a canvas and a pattern or chooses to upload his or her own work from the local machine. The user provides necessary information before the data is created (Step 8106). Data information can be any information of a company like company's logo, website, address, video clip etc. After the date is created, it needs to be verified (Step 8108). If it is not valid, it goes back to the step 8504 for valid information (Step 8110). When the verification is done, the data is saved (Step 8112).

The next step 8114 is creating the exterior 3D storefront used in the virtual 3D animation shopping environment. The user uses the tools and programs developed by java. The tools include templates, editor, background colors, and canvas. In this step the user picks a template, chooses a background color from galleries, and selects a canvas. The user provides necessary information before the data is created (Step 8116). After the date is created, it needs to be verified (Step 8118). If it is not valid, it goes back to the step 8116 for valid information (Step 8120). When the verification is done, the data is saved (Step 8122). The next step 8124 is creating 3D interior of the store used in the virtual 3D animation shopping environment. The user uses the tools and programs developed by java. The tools include templates, editor, background colors, and canvas. In this step the user picks a template, chooses a background color from the galleries, and selects a canvas. The user provides necessary information before the data is created (Step 8126). After the date is created, it needs to be verified (Step 8128). If it is not valid, it goes back to the step 8126 for valid information (Step 8130). When the verification is done, the data is saved in the database (Step 8132).

The user has the option to choose sell products in video or image format or both. If he or she chooses the image format to sell products, java compiled programs help set up (Step 8134). After the user follows each step which includes making selection, providing the products related information, uploading the products' images, and previewing etc., the data is created (Step 8136). The data created needs to be verified (Step 8138). If it is not valid, it goes back to the step 8134 for valid information (Step 8140). When the verification is done, the data is saved in the database (Step 8142).

If the user chooses the video format to sell products, he has the option to sell by clips or by one clip. One clip includes all the products. Clips consist of different product categories. Java compiled programs help set up (Step 8144). After the user follows each step which includes making selection, providing the products related information, uploading the products' images, and previewing etc, the data is created (Step 8146). The created data needs to be verified (Step 8148). If it is not valid, it goes back to the step 8144 for valid information (Step 8150). When the verification is done, the data is saved in the database (Step 8152).

If the user chooses to sell in both the video and image formats, he or she follows the steps developed by java before finishing setting up.

8154 is the next step that the user chooses to run promotion. The promotion module consists of text, image, video and coupons. It is compiled with java programs. These programs are stored in the data files on the server. The user follows each step before the data is created (Step 8156). The data created in the step 8156 needs to be verified (Step 8158). If it is not valid, it goes back to the step 8154 for valid information (Step 8160). When the verification is done, the data is saved in the database (Step 8162).

The user can introduce the business by video (Step 8164). The video needs to be uploaded for preview (Step 8166, 8168). If it is not good, the process goes back (Step 8170). If it is good, it is saved (Step 8172). The next step is collecting information and making payment (Step 8174). The collected information needs to be verified (Step 8176). If it is not good, it goes back to the step 8174 through the step 8178. The data is saved and the results are displayed (Step 8180, 8182) when the verification is done. The displayed results refer to the design of the store being finished, the products being uploaded, the promotions being ready to be displayed; and the business video introduction being ready to be broadcasted etc.

Notification is sent to remind the user of renewing the lease before it expires (Step 8184). If the user ignores it, the store is closed when the lease expires (Step 8186), however all the contents created in the store remain in the account. The user can re-open the business anytime if the space is available or any other space is available. The process ends at the user without taking action (Step 8188). If the user chooses to renew the lease, he or she goes to the database (Step 8190), makes payment and updates the account information (Step 8192). The new data is saved (Step 8194) and a new process begins when the new lease begins (Step 8196).

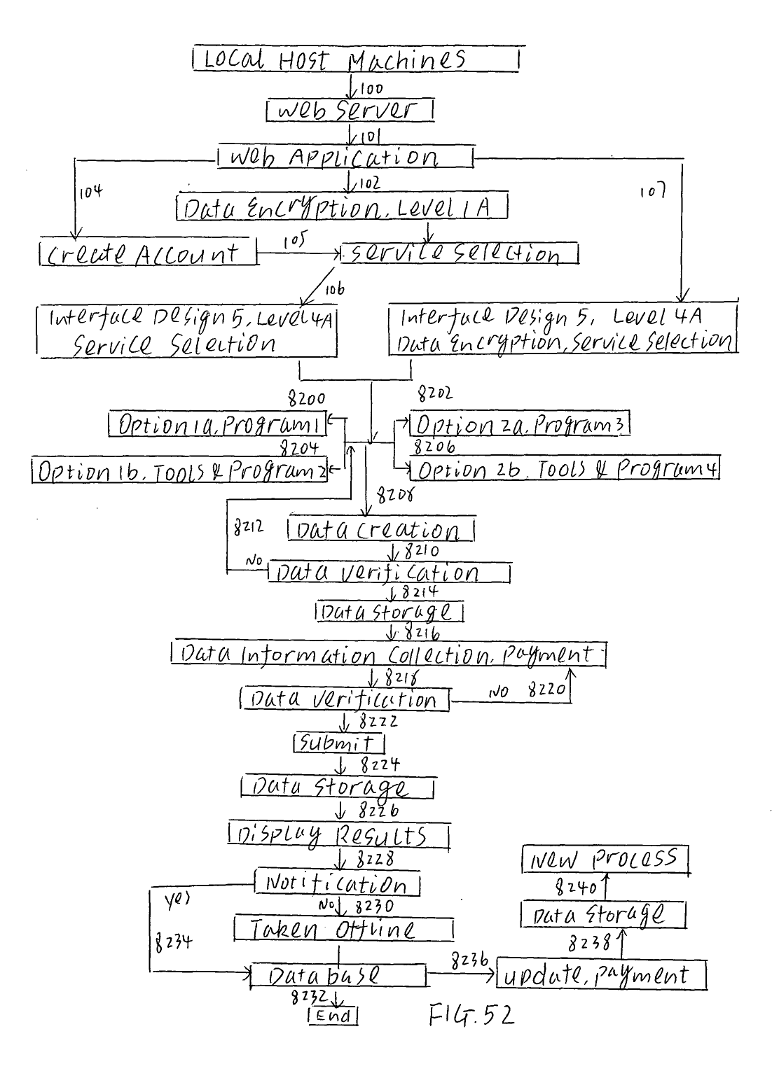

Referring to FIG. 52, this figure is a functional block diagram illustrating how Coupons, Coupon Books in Service Group 3 are designed at the fourth level. The user connects to the web server and access to the web application. The user can create an account if he or she doesn't have one. If the user has an account, he or she provides data for encryption through the route 102 (from the step 102) or the step 107 at the fourth level. When the data is encrypted, the user selects one of the services in the service group 3.

Option 1A (Step 8200) is the step that the user selects to use his or her own front cover page on the local machine. The user originates the request. The request is sent in the user process. The server parses the request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

Option 2A (Step 8202) followed by Option 1A is the step that the user selects to use his or her own catalog. The user initiates the query. If the query is successful, they return data as results. There are three main stages in the process of a query. A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched. After the data file is fetched, the data is brought up to the desktop for preview. If it is good, it is submitted. Or a new process begins until the valid data file is fetched.

Option 1B and 2B (Step 8204, 8206) are the steps that the user selects to create the front page and catalog using the free online tools. The user uses the tools and walks through the steps developed by java programs. The tools include templates, background colors, patterns, editor and canvas etc. The java programs are stored program units. They heir; the user finish the work and manipulate database information using procedural schema object. After each step is taken, the data is created (Step 8208). The created data needs to be verified (Step 8210).

During the verification, a java function program is invoked. It provides a default verification routine to verify the validity of the data. The procedure returns the value TRUE for success and FALSE for failure. If the verification raises an exception, the data becomes invalid, an error is returned. The process goes back until the data provided is good and valid (Step 8212). After the verification is done, the server records the data and writes it to the data blocks in the data files from database buffer cache (Step 8214).

The next step (Step 8216) is collecting information. The collected information needs to be verified (Step 8218). If it is not valid, it goes back to the step 8216 for valid information by taking the step 8220. Date verified is submitted and saved in the database on the server (Step 8222, 8224). And the results are displayed (Step 8226). The results refer to the advertisement being created and the sales module being implemented.

Step 8228 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 8230 and 8232). The second choice is waiting and taking action in the database (Step 8234). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 8236), the new data is saved in the database on the server (Step 8238). A new process begins when the advertisement begins to be displayed for another period of time (Step 8240).

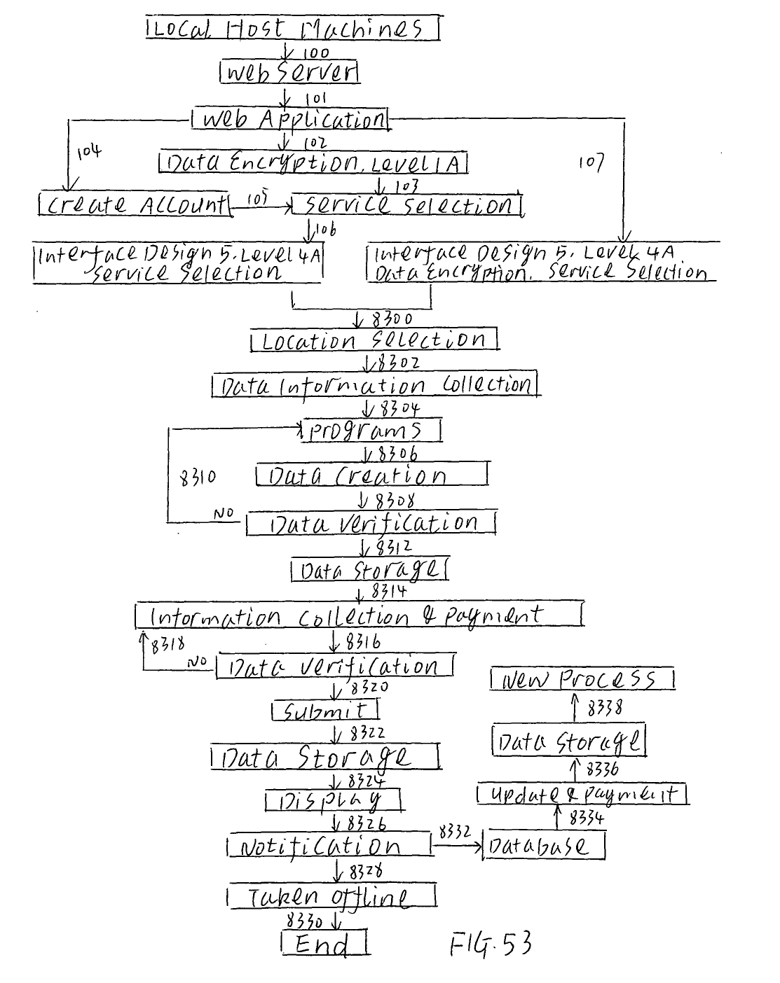

Referring to FIG. 53, this is a functional block diagram illustrating how Shopping Centers is designed. The user connects to the web server and access to the web application. He or she can choose a service category through the route 102 (From the step 102) at the first level or the step 107 at the fourth level. When the data is encrypted, the user selects Shopping Centers.

The user selects a location. A location refers to the shopping center in the city where the business is located (Step 8300). The user provides the information of the business before setting up the store (Step 8302). The layouts of the shopping centers in a city can be the same as the physical ones or they can be artificial. If the layouts are the same as the physical ones, pre-designed shopping center layouts are provided for the businesses. The user picks the spot where the business is located. If the shopping centers are artificial, pre-designed artificial shopping center layouts with limited store space are provided. Store space can be added if needed in this scenario.

Step 8304 is the step that the java programs are developed to help the user set up store. The process includes picking the store location or designing the storefront, uploading products, running promotions and business introduction etc. After the user finishes picking the storefront or creating the storefront using the template from the gallery, the user selects a 3D interior design among the templates in the gallery in the next step. When finishing, the user has the option to sell products in video or image format or both. If he or she chooses the image format to sell products, java compiled programs help finish it. After the user follows each step which includes uploading, providing information, and previewing etc, the data is created. If the user chooses the video format to sell products, he has the option to sell by clips or one clip. One clip includes all products. Clips consist of different products. If the user chooses both of the formats, he or she follows the steps that the programs developed. If the user has nothing to sell, he or she can take another route to promote the business.

The next step is the step the user chooses to run promotions. The promotion module consists of text, image, video and coupons. It is compiled with java programs. These programs are stored in the data files on the server. The user follows each step before the data is created.

The user can introduce the business by video if he or she would like to in the next step. The video is uploaded for preview before submission. All the data created (Step 8306) needs to be verified (Step 8308). If it is not valid, the user goes back to the programs (Step 8304) until the valid data is provided and saved (Step 8312).

The next step is collecting information and making payment (Step 8314). Collected information needs to be verified (Step 8316). If it is not good, the process goes back to the step 8314 through the step 8318. When the verification is done, the data is saved and the results are displayed (Step 8320, 8322). The displayed results refer to the store being set up, the promotions being ready to be displayed and business introduction video is ready to be broadcasted.

Step 8326 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 8328, 8330). The second choice is waiting and taking action in the database (Step 8332). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 8334), the new data is saved in the database on the server (Step 8336). A new process begins when the updated contents are displayed for another period of time (Step 8338).

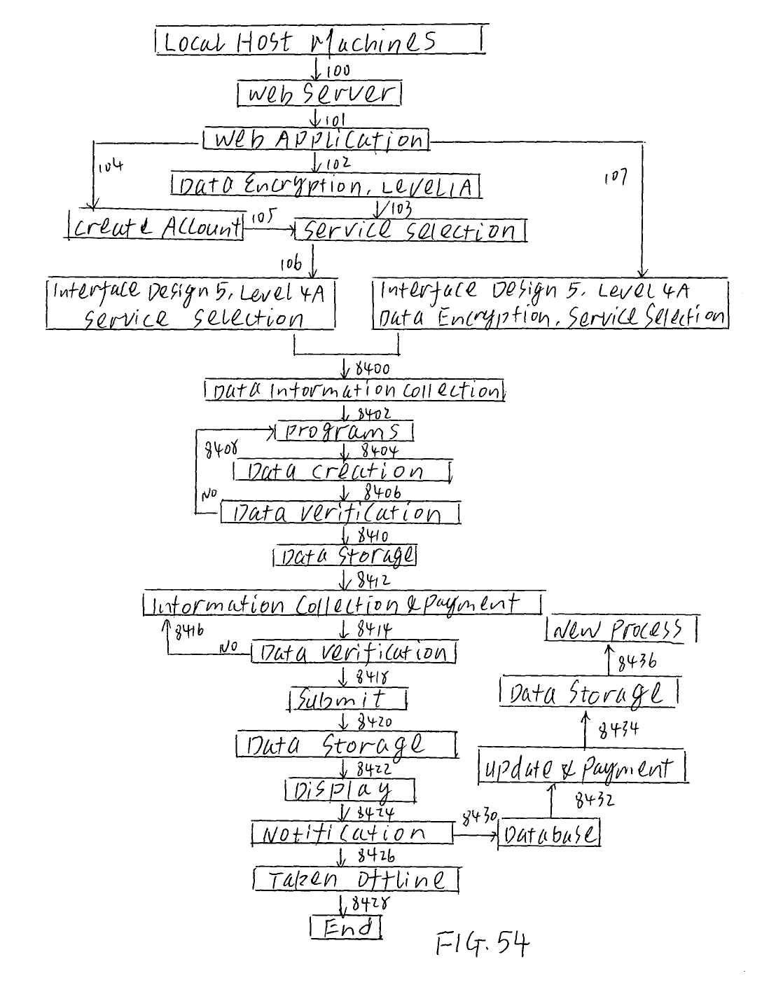

Referring to FIG. 54, this is a functional block diagram illustrating how Non-Shopping Centers is designed. The user connects to the web server and access to the web application. He or she chooses a service category through the route 102 (from the step 102) at the first level or the step 107 at the fourth level. When the data is encrypted, the user selects Non-Shopping Centers.

8400 is the step that the user provides necessary information. The next Step 8402 is the step the user uses to create the storefront, sell products and run promotion etc. The storefront can either be video or image format. The tools and programs include templates, editor, background colors patterns, canvas and Java developed programs. The user picks a template, chooses background color from galleries, selects a canvas and a pattern or chooses upload his or her own work from the local machine.

The user has the option to choose to sell products in either video or image format or both. If the user chooses the image format to sell products, java compiled programs help him or her do it. If the user chooses the video format to sell the products, he has the option to sell by clips or one clip. One clip includes all the products. Clips consist of different products. The user can choose to sell products in both image and video formats.

The user can run promotions and introduce the business in the next two steps. The promotion module consists of text, image, video and coupons. It is compiled with java programs. These programs are stored in the data files on the server. The user follows each step before the data is created (Step 8404). The created data from each step needs to be verified before moving to the next step (Step 8406). If the data is not good, the process goes back to the step 8402. If it is good, it is saved (Step 8410). The next step is collecting information and making payment (Step 8412). The collected information needs to be verified (Step 8414). If it is not good, it goes back to the step 8412 through the step 8416. When the verification is done, the data is submitted and saved (Step 8418, 8420). And the results are displayed (Step 8422). The displayed results refer to the store being set up, the promotions are ready to be displayed and the video business introduction is ready to be broadcasted.

Step 8424 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 8426, 8428). The second choice is waiting and taking action in the database (Step 8430). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 8432), the new data is saved in the database on the server (Step 8434). A new process begins when the updated contents are displayed for another period of time (Step 8436).

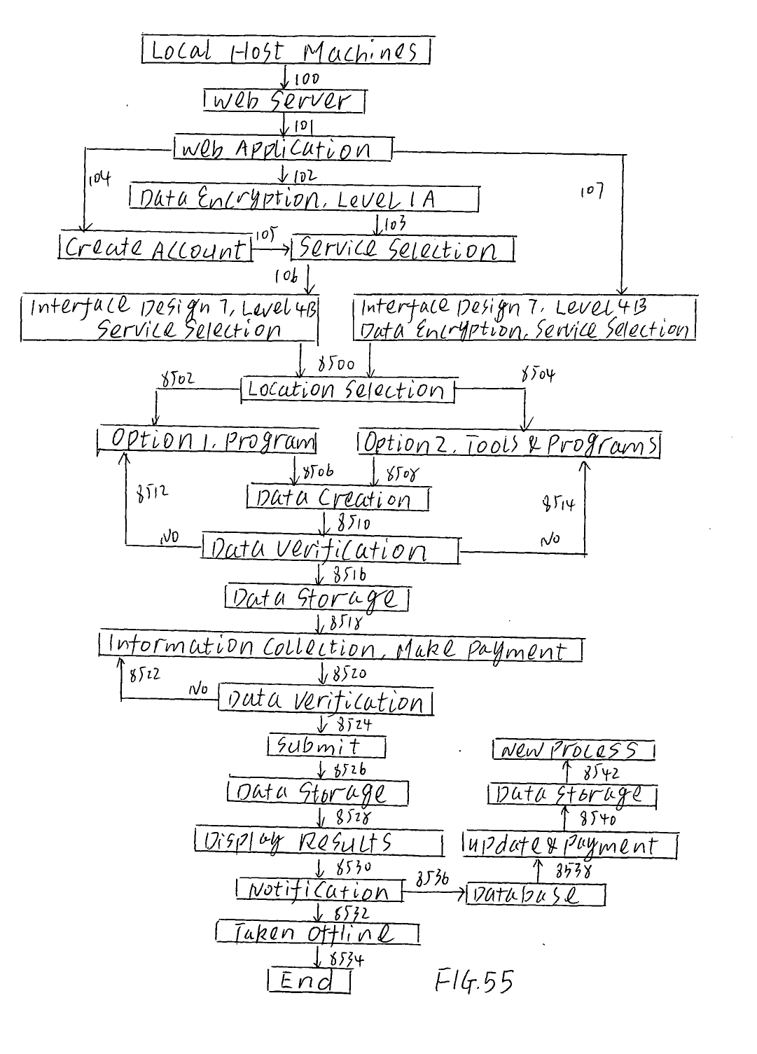

Referring to FIG. 55, this figure is a functional block diagram illustrating how the video and banner ads are created on the second page at the fourth level (City level). The user connects to the web server and access to the web application (Step 100,101). The user can create an account if he or she doesn't have one. If the user has an account, he or she provides data for encryption through the route 102 (from the step 102) or the step 107 at the fourth level. When the data is encrypted, the user selects an advertising spot.

Step 8500 is the step that the user selects a location to create banner or video ad on the first page, interface design 7. Interface 7 is made up of items. Items are used to present information from the database or to act as control. The web application is event-driven. An event occurs and the application responds to it. An event is either an interface event, which corresponds to a user action, or an internal processing event, which corresponds to a system action. The interface design 7 is compiled by java. It provides the image and video solutions for displaying the ads on the second page at the fourth level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 16 advertising spots and other service categories on the second page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 8502 or the step 8504. Step 8504 has more steps before getting the results, while the step 8502 has fewer.

Step 8504 contains tools and programs. The tools include custom designed advertising templates, background colors, patterns, canvas and editor. The programs are java stored program units. They help the user finish creating the advertisement. In the step 8504 the user picks a template, chooses background color from Gallery 1 or Gallery 2, selects a canvas and a pattern, and uses the editor. The user follows the steps that are developed by java before getting the results (Step 8508). The results refer to the advertising location being picked; the advertisement being created; the data being created, verified and saved; and the payment being made etc. The data can be any image data types.

If the user chooses to go through the step 8502, Program 1 initiates the server process. Program 1 is developed for helping the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 8506), it is brought up to the desktop for previewing. Triggers are fired if functions like preview, upload, reset, submit and cancel are requested.

The data created from the step 8506 and step 8508 need to be verified (Step 8510). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 8512 or the step 8514 until the valid data is provided. If the data is good and complete, the server records the data and writes it to the data blocks in the database from database buffer cache (Step 8516). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 8518. After the data is collected, it needs to be verified (Step 8520). The verification includes company or personal information such as company or personal name, company address, credit card number, expiration date, security code, bank route number and account number etc. If the data is not valid, the process takes the step 8522 and goes back to the step 8518 until the valid data is provided. If the data is valid, it is submitted and saved in the database (Step 8524, 8526), and the results is displayed (Step 8528). The results refer to the advertising location being picked; the advertisement being created; the data being created, verified and saved; and the payment being made etc. The data can be any image and video data types.

Step 8530 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 8532 and 8534). The second choice is waiting and taking action in the database (Step 8536). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 8538), the new data is saved in the database on the server (Step 8540). A new process begins when the new advertisement is displayed for another period of time (Step 8542).

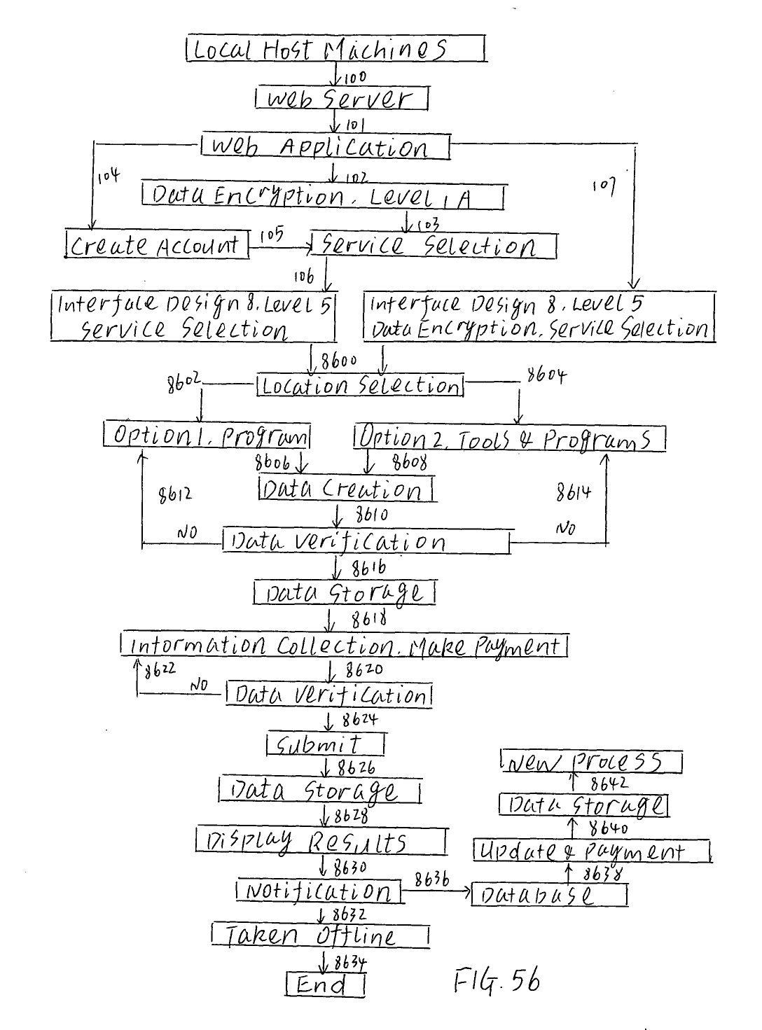

Referring to FIG. 56, this figure is a functional block diagram illustrating how video and banner ads are created on the first page at the fifth level (Business listing level). The user connects to the web server and access to the web application (Step 100,101). The user can create an account if he or she doesn't have one. If the user has an account, he or she provides data for encryption through the route 102 (from the step 102) or the step 107 at the fifth level. When the data is encrypted, the user selects an advertising spot.

Step 8600 is the step that the user selects a location to create banner or video ad on the first page, interface design 8. Interface 8 is made up of items. Items are used to present information from the database or to act as control. The web application is event-driven. An event occurs and the application responds to it. An event is either an interface event, which corresponds to a user action, or an internal processing event, which corresponds to a system action. The interface design 8 is compiled by java. It provides the image and video solutions for displaying the ads on the first page at the fifth level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 21 advertising spots and other service categories on the second page. The advertisement spots are pre-designed blocks. The advertising ad spots on the right side can be auto extended when all of them are occupied. They are developed and stored with other programs on the server. When a spot is picked, the user is asked to make selections. ‘Selections’ are the decisions that the user needs to make to complete the advertisement work. The user has the option to take the step 8602 or the step 8604. Step 8604 has more steps before getting the results, while the step 8602 has fewer.

Step 8604 contains tools and programs. The tools include custom designed advertising templates, background colors, patterns, canvas and editor. The programs are java stored program units. They help the user finish creating the advertisement. In the step 8604 the user picks a template, chooses background color from Gallery 1 or Gallery 2, selects a canvas and a pattern, and uses the editor. The user follows the steps that are developed by java before getting the results (Step 8608). The results refer to the advertising location being picked; the advertisement being created; the data being created, verified and saved; and the payment being made etc. The data can be any image data types.

If the user chooses to go through the step 8602, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 8606), it is brought up to the desktop for preview. Triggers are fired if functions like preview, upload, reset, submit and cancel are requested.

The data created from the step 8606 and step 8608 need to be verified (Step 8610). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 8612 or the step 8614 until the valid data is provided. If the data is good and complete, the server records the data and writes it to the data blocks in the database from database buffer cache (Step 8616). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 8618. After the data is collected, it needs to be verified (Step 8620). The verification includes company or personal information such as company or personal name, company address, credit card number, expiration date, security code, bank route number and account number etc. If the data is not valid, the process takes the step 8622 and goes back to the step 8618 until the valid data is provided. If the data is valid, it is submitted and saved in the database (Step 8624, 8626), and the results is displayed (Step 8628). The results refer to the advertising location being picked; the advertisement being created; the data being created, verified and saved; and the payment being made etc. The data can be any image and video data types.

Step 8630 is a program compiled with Java for notification. A notification is a Java program developed fore reminding the user that the ad contents he or she creates will be taken off line at the spot with time moving forward at the spot. The user has two options before the process ends. The first choice is ignoring it and no action is taken (Step 8632 and 8634). The second choice is waiting and taking action in the database (Step 8636). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 8638), the new data is saved in the database on the server (Step 8640). A new process begins when the new advertisement is displayed for another period of time (Step 8642).

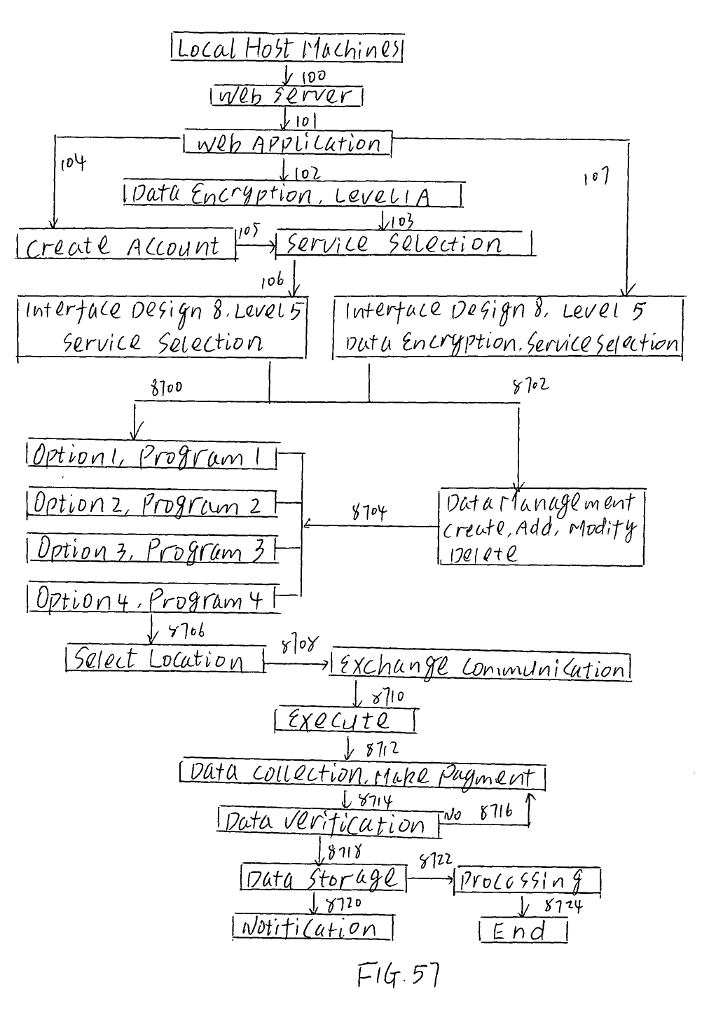

Referring to FIG. 57, this figure is a functional block diagram illustrating how the use invites his or her friend(s) to shop online together. The user connects to the web server and access to the web application (Step 100,101). The user can create an account if he or she doesn't have one. If the user has an account, he or she provides data for encryption through the route 102 (from the step 102) or the step 107 at the fifth level. When the data is encrypted, the user selects a service.

The user selects Shopping Together (Step 8700). Step 8700 is the step that the user invites his or her friend(s) to shop online together. There are several different ways to invite. The first way is inviting through online. The second way is inviting through email. The third way is inviting through text message over the phone. The fourth way is inviting by voice communication. The methods of inviting are developed using java. The programs are stored in the data files on the server. They are launched when the triggers are pulled.

8702 is the step that the user manages the contact information. The user maintains the contact list including add, modify, delete, upload, preview, cancel, reset, and invite etc. He or she can invite his or her friend(s) from the contact list by taking the step 8704.

Step 8706 is the step to select a shopping area. Step 8708 is the step to communicate with each other through online texting or voice communication. The next step 8710 is the step to ‘Execute’. ‘Execute’ refers to a series of action related to online purchasing.

After the user and his or her friend(s) buy things online, the data needs to be collected (Step 8712). Once the data is collected, it needs to be verified (Step 8714). During the verification, a java function is invoked. It provides a default verification routine to verify the validity of the data. The procedure returns the value TRUE for success and FALSE for failure. If the verification raises an exception, the data becomes invalid, an error is returned.

Verified information includes company or personal information such as company or personal name, company address, credit card number, expiration date, security code, bank route number and account number etc. If the information is not valid, the process takes the step 8716 and goes back to the step 8712 until the information is valid. If the information is valid, it is submitted and saved in the database (Step 8718). The notification is sent out to the shoppers. Step 1010 ‘Execute’ needs to be processed (Step 8722). Shop together ends (Step 8724) when the user and his or her friend(s) finish shopping together session.

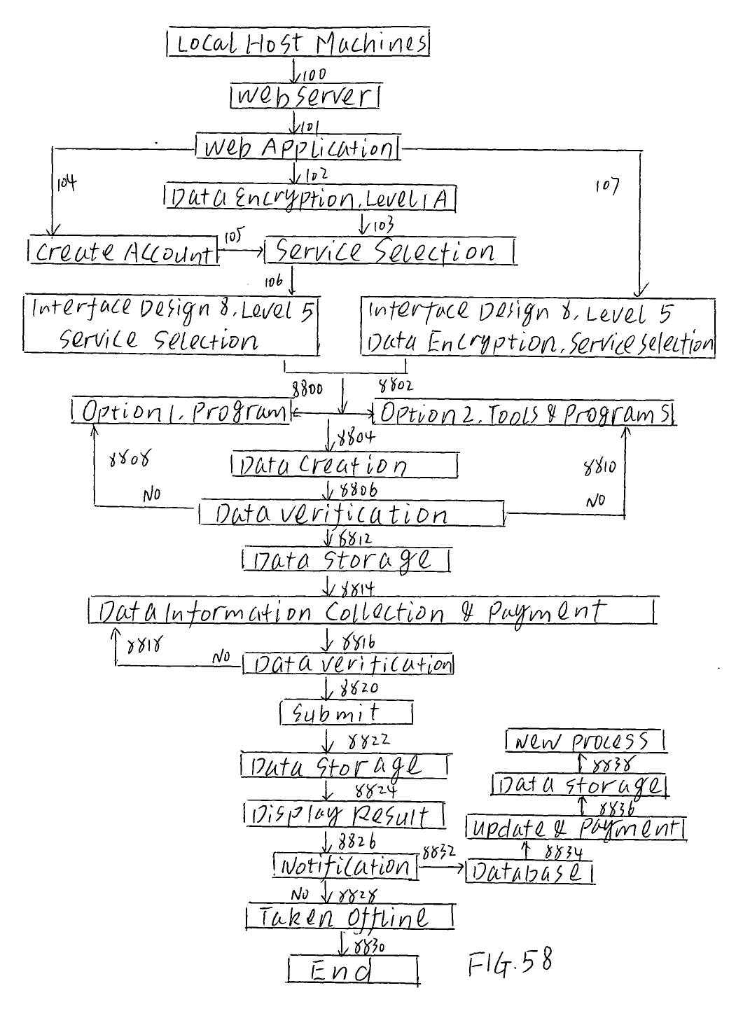

Referring to FIG. 58, this figure is a functional block diagram illustrating how Service Group 1 is designed at the fifth level (Business listing level). The service group 1 includes On Sale, Special Deals, Overstock, Clearance, and Closeouts. The user connects to the web server and access to the web application. The user can create an account if he or she doesn't have one. If the user has an account, he or she provides data for encryption through the route 102 (from the step 102) or the step 107 at the first level. When the data is encrypted, the user selects a service on the first page.

8800 is the step that the user chooses Option 1. Option 1 is related to video or image advertisement and the user chooses to upload the advertisement by himself or herself on the local machine. A program is developed to help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

8802 is the step that the user chooses Option 2. Option 2 is related to creating image advertisement using the online tools. The user uses the tools and programs compiled by java. The tools include templates, background colors, patterns, editor and canvas etc. The java program units enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database for the as a unit. Packaged procedures and functions can be called explicitly the applications or users. The package usually has two parts stored separately in the database: A). The specification is the interface to the application and declares the types, variables, constraints, exceptions, cursors, and subprograms available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

When the step 8800 and 8802 are done, the data is created (Step 8804). The created data needs to be verified (Step 8806). If the verification raises an exception, the data becomes invalid, an error is returned. The process goes back to the step 8800 and 8802 by taking the step 8808 and step 8810. After the verification is done, the data is saved in the database on the server (Step 8812).

The next step is collecting information (Step 8814). It includes the payment information. The information needs to be verified (8816). If it is not valid, it goes back to the step 8814 for valid information (Step 8818). The new data is submitted and saved in the database on the server (Step 8820, 8822) and the results are displayed (Step 8824). The results refer to the image or video advertisement being created and posted.

Step 8826 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 8828 and 8830). The second choice is waiting and taking action in the database (Step 8832). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 8834), the new data is saved in the database on the server (Step 8836). A new process begins when the new advertisement is displayed for another period of time (Step 8838).

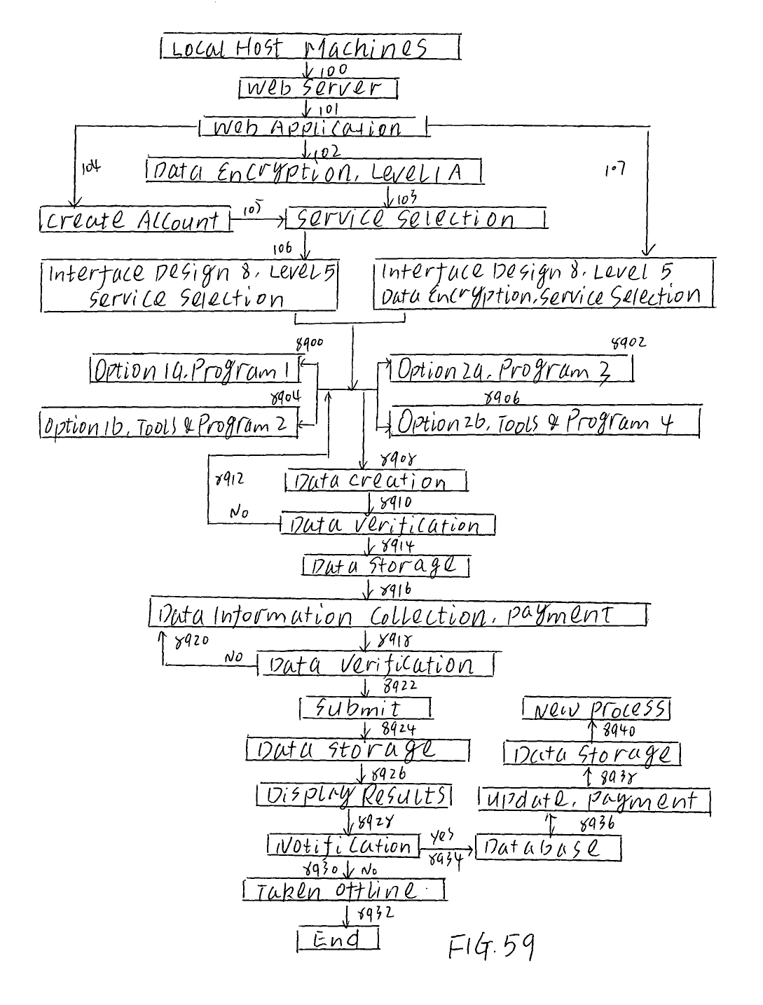

Referring to FIG. 59, this figure is a functional block diagram illustrating how Coupons and Coupon Books in service group 3 are designed at the fifth level. The user connects to the web server and access to the web application. The user can create an account if he or she doesn't have one. If the user has an account, he or she provides data for encryption through the route 102 (from the step 102) or the step 107 at the fifth level. When the data is encrypted, the user selects one of the services in the service group 3.

Option 1A (Step 8900) is the step that the user selects to use his or her own front cover page on the local machine. The user originates the request. The request is sent in the user process. The server parses the request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

Option 2A (Step 8902) followed by Option 1A is the step that the user selects to use his or her own catalog. The user initiates the query. If the query is successful, they return data as results. There are three main stages in the process of a query. A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched. After the data file is fetched, the data is brought up to the desktop for preview. If it is good, it is submitted. Or a new process begins until the valid data file is fetched.

Option 1B and 2B (Step 8904, 8906) are the steps that the user selects to create the front page and catalog using the free online tools. The user uses the tools and walks through the steps developed by java programs. The tools include templates, background colors, patterns, editor and canvas etc. The java programs are stored program units. They help the user finish the work and manipulate database information using procedural schema object. After each step is taken, the data is created (Step 8908). The created data needs to be verified (Step 8910).

During the verification, a java function program is invoked. It provides a default verification routine to verify the validity of the data. The procedure returns the value TRUE for success and FALSE for failure. If the verification raises an exception, the data becomes invalid, an error is returned. The process goes back until the data provided is good and valid (Step 8912). After the verification is done, the server records the data and writes it to the data blocks in the data files from database buffer cache (Step 8914).

The next step (Step 8916) is collecting information. The collected information needs to be verified (Step 8918). If it is not valid, it goes back to the step 8916 for valid information by taking the step 8920. Date verified is submitted and saved in the database on the server (Step 8922, 8924). And the results are displayed (Step 8926). The results refer to the advertisement being created and the sales module being implemented.

Step 8928 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 8930 and 8932). The second choice is waiting and taking action in the database (Step 8934). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 8936), the new data is saved in the database on the server (Step 8938). A new process begins when the advertisement begins to be displayed for another period of time (Step 8940).

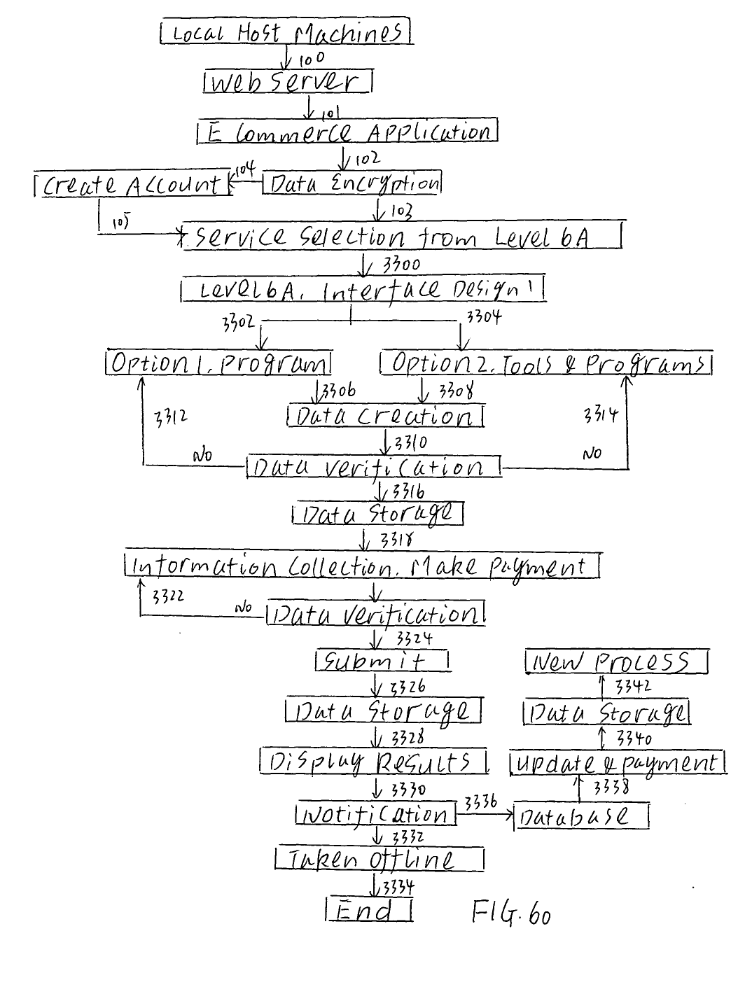

Referring to FIG. 60, this figure is a functional block diagram illustrating how the video and banner ads are created on the front page at the sixth level (Industrial national level). The user connects to the web server and access to the web application (Step 100,101). The connection is a communication pathway between a user process and a server process. The user logs onto the operating system on a local computer and connects over a network to the computer running web applications. The user originates the request. A process is created on the user. The process is called user process. The server listens, receives, parses and executes the request sent from the user process. This process is called a server process. The process communicates with the server on behalf of the user process. The server process executes the request. After the process finishes, the returned result is sent back to the user.

From the step 101, the user can create an account if he or she doesn't have one (Step 104). After creating an account, the user chooses a service he or she wants at the sixth level (Step 105). If the user has an account, he or she provides data for encryption (Step 102). Data encryption is a process of authentication for users to start up and shut down a session. It is set up to be authenticated by the operating system. The data files are located in the database directory. When the data is encrypted, the user selects a service (Step 103). A service refers to either set up store, create advertisement or update account. The next step is the step the user chooses a level, picks a page, selects a location and selects a service (Step 6). A service refers to an advertising category such as on sale, special deals etc.

Text advertising solution is relatively easy. The user selects a level, chooses a service category and provides advertising contents. When it is done and the payment is made online, the text ad is saved and shown on the screen.

Step 3300 is the step the user chooses to create banner or video ad on the front page, interface design 1. Interface Design 1 is made up of items. Items are used to present information from the database or to act as control. The web application is event-driven. An event occurs and the application responds to it. An event is either an interface event, which corresponds to a user action, or an internal processing event, which corresponds to a system action. The interface design 1 is compiled by java. It provides the image and video solutions for displaying the ads on the first page of industrial module.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are two advertising spots on the first page. One spot is for video advertisement. The other is for banner advertisement. The advertisement locations are pre-designed blocks. They are developed and stored with other programs on the server. When a spot is picked, the user is asked to make selections. ‘Selections’ are the decisions that the user needs to make to complete the advertisement work. The user has the option to take the step 3302 or the step 3304. Step 3304 has more steps before getting the results, while the step 3302 has fewer.

Step 3304 contains tools and programs. The tools include custom designed advertising templates, background colors, patterns, canvas and editor. The programs are java stored program units. They help the user finish creating the advertisement. In the step 3304 the user picks a template, chooses background color from Gallery 1 or Gallery 2, selects a canvas and a pattern, and uses the editor. The user follows the steps that are developed by java before getting the results (Step 3308). The results refer to the advertising location being picked; the advertisement is created; the data being created, verified and saved; and the payment being made etc. The data can be any image data types.

If the user chooses to go through the step 3302, Program 1 initiates the server process. Program 1 is developed for video advertising. The server process parses the request and locates where the video is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 3306), it is brought up to the desktop for preview. Triggers are fired if functions like preview, upload, reset, submit and cancel are requested.

The data created from the step 3306 and step 3308 needs to be verified (Step 3310). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 3312 or the step 3314 until the valid data is provided. If the data is good and complete, the server records the data and writes it to the data blocks in the database from database buffer cache (Step 3316). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 3318. After the data is collected, it needs to be verified (Step 3320). The verification includes company or personal information such as company or personal name, company address, credit card number, expiration date, security code, bank route number and account number etc. If the data is not valid, the process takes the step 3322 and goes back to the step 3318 until the valid data is provided. If the data is valid, it is submitted and saved in the database (Step 3324, 3326), and the results is displayed (Step 3328). The results refer to the advertising location being picked; the advertisement being created; the data being created, verified and saved; and the payment being made etc. The data can be any video data types.

Step 3330 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 3332 and 3334). The second choice is waiting and taking action in the database (Step 3336). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 3338), the new data is saved in the database on the server (Step 3340). A new process begins when the new advertisement is displayed for another period of time (Step 3342).

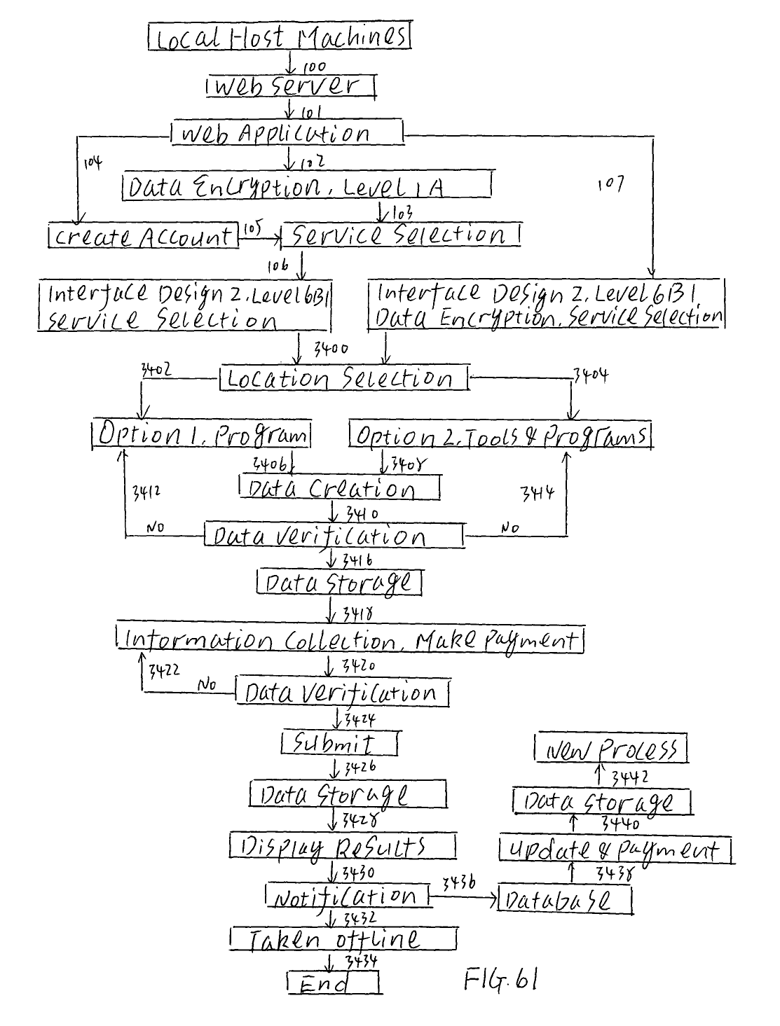

Referring to FIG. 61, this figure is a functional block diagram illustrating how video and banner ads are created on the second and third page at the sixth level (Industrial national level). The user connects to the web server and access to the web application (Step 100,101). The user can create an account if he or she doesn't have one. If the user has an account, he or she provides data for encryption through the route 102 (from the step 102) or the step 107 at the sixth level. When the data is encrypted, the user selects an advertising spot.

Step 3400 is the step that the user selects a location to create banner or video ad on the first page, interface design 2. Interface 2 is made up of items. Items are used to present information from the database or to act as control. The web application is event-driven. An event occurs and the application responds to it. An event is either an interface event, which corresponds to a user action, or an internal processing event, which corresponds to a system action. The interface design 2 is compiled by java. It provides the image and video solutions for displaying the ads on the second and third page at the sixth level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 24 advertising spots on the second and third page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 3402 or the step 3404. Step 3404 has more steps before getting the results, while the step 3402 has fewer.

Step 3404 contains tools and programs. The tools include custom designed advertising templates, background colors, patterns, canvas and editor. The programs are java stored program units. They help the user finish creating the advertisement. In the step 3404 the user picks a template, chooses background color from Gallery 1 or Gallery 2, selects a canvas and a pattern, and uses the editor. The user follows the steps that are developed by java before getting the results (Step 3408). The results refer to the advertising location being picked; the advertisement being created; the data being created, verified and saved; and the payment being made etc. The data can be any image data types.

If the user chooses to go through the step 3402, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 3406), it is brought up to the desktop for preview. Triggers are fired if functions like preview, upload, reset, submit and cancel are requested.

The data created from the step 3406 and step 3408 need to be verified (Step 3410). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 3412 or the step 3414 until valid. Data is provided. If the data is good and complete, the server records the data and writes it to the data blocks in the database from database buffer cache (Step 3416). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 3418. After the data is collected, it needs to be verified (Step 3420). The verification includes company or personal information such as company or personal name, company address, credit card number, expiration date, security code, bank route number and account number etc. If the data is not valid, the process takes the step 3422 and goes back to the step 3418 until the valid data is provided. If the data is valid, it is submitted and saved in the database (Step 3424, 3426), and the results is displayed (Step 3428). The results refer to that the advertising location being picked; the advertisement being created; the data being created, verified and saved; and the payment being made etc. The data can be any image and video data types.

Step 3430 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 3432 and 3434). The second choice is waiting and taking action in the database (Step 3436). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 3438), the new data is saved in the database on the server (Step 3440). A new process begins when the new advertisement is displayed for another period of time (Step 3442).

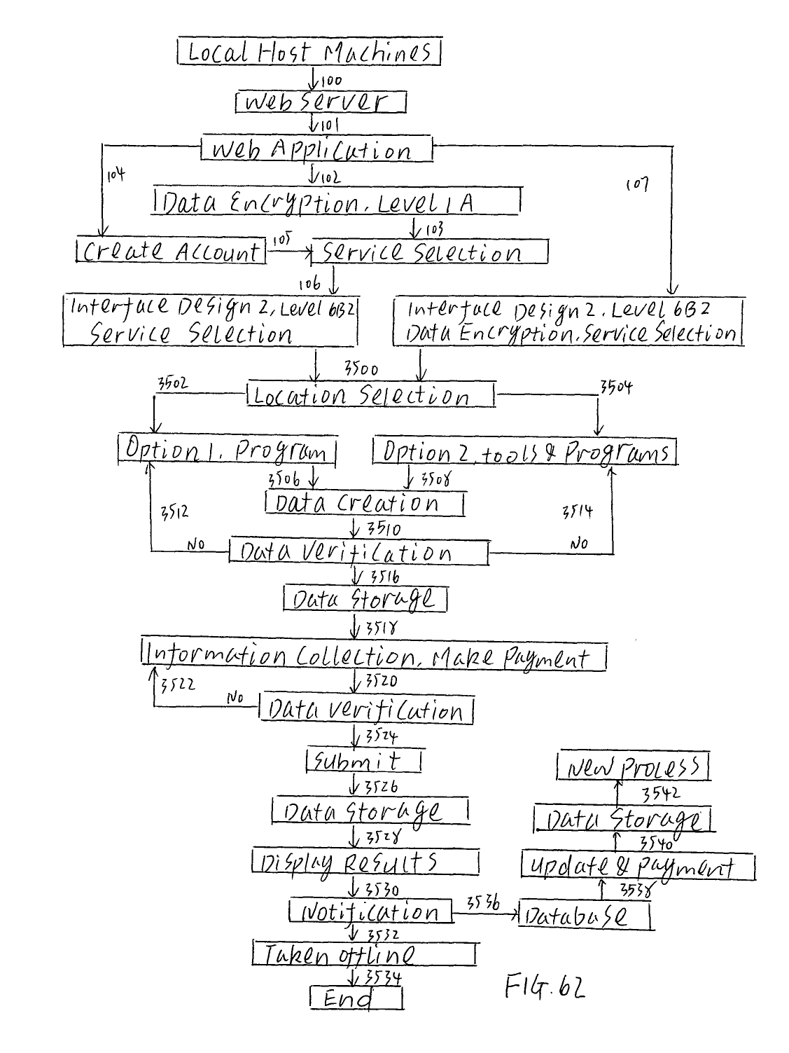

Referring to FIG. 62, this figure is a functional block diagram illustrating how the video and banner ads are created on the fourth page at the sixth level (Industrial national level). The user connects to the web server and access to the web application (Step 100,101). The user can create an account if he or she doesn't have one. If the user has an account, he or she provides data for encryption through the route 102 (from the step 102) or the step 107 at the sixth level. When the data is encrypted, the user selects an advertising spot.

Step 3500 is the step that the user selects a location to create banner or video ad on the first page, interface design 3. Interface 3 is made up of items. Items are used to present information from the database or to act as control. The web application is event-driven. An event occurs and the application responds to it. An event is either an interface event, which corresponds to a user action, or an internal processing event, which corresponds to a system action. The interface design 3 is compiled by Java. It provides the image and video solutions for displaying the ads on the fourth page at the sixth level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of Java constructs. Procedures and functions are identical except that functions always return a single value to the caller, while the procedures do not. The trigger is a Java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 8 advertising spots on the fourth page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 3502 or the step 3504. Step 3504 has more steps before getting the results, while the step 3502 has fewer.

Step 3504 contains tools and programs. The tools include custom designed advertising templates, background colors, patterns, canvas and editor. The programs are java stored program units. They help the user finish creating the advertisement. In the step 3504 the user picks a template, chooses background color from Gallery 1 or Gallery 2, selects a canvas and a pattern, and uses the editor. The user follows the steps that are developed by java before getting the results (Step 3508). The results refer to the advertising location being picked; the advertisement being created; the data being created, verified and saved; and the payment being made etc. The data can be any image data types.

If the user chooses to go through the step 3502, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 3506), it is brought up to the desktop for preview. Triggers are fired if functions like preview, upload, reset, submit and cancel are requested.

The data created from the step 3506 and step 3508 need to be verified (Step 3510). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 3512 or the step 3514 until the valid data is provided. If the data is good and complete, the server records the data and writes it to the data blocks in the database from database buffer cache (Step 3516). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 3518. After the data is collected, it needs to be verified (Step 3520). The verification includes company or personal information such as company or personal name, company address, credit card number, expiration date, security code, bank route number and account number etc. If the data is not valid, the process takes the step 3522 and goes back to the step 3518 until the valid data is provided. If the data is valid, it is submitted and saved in the database (Step 3524, 3526), and the results is displayed (Step 3528). The results refer to the advertising location being picked; the advertisement being created; the data being created, verified and saved; and the payment being made etc. The data can be any image and video data types.

Step 3530 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 3532 and 3534). The second choice is waiting and taking action in the database (Step 3536). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 3538), the new data is saved in the database on the server (Step 3540). A new process begins when the new advertisement is displayed for another period of time (Step 3542).

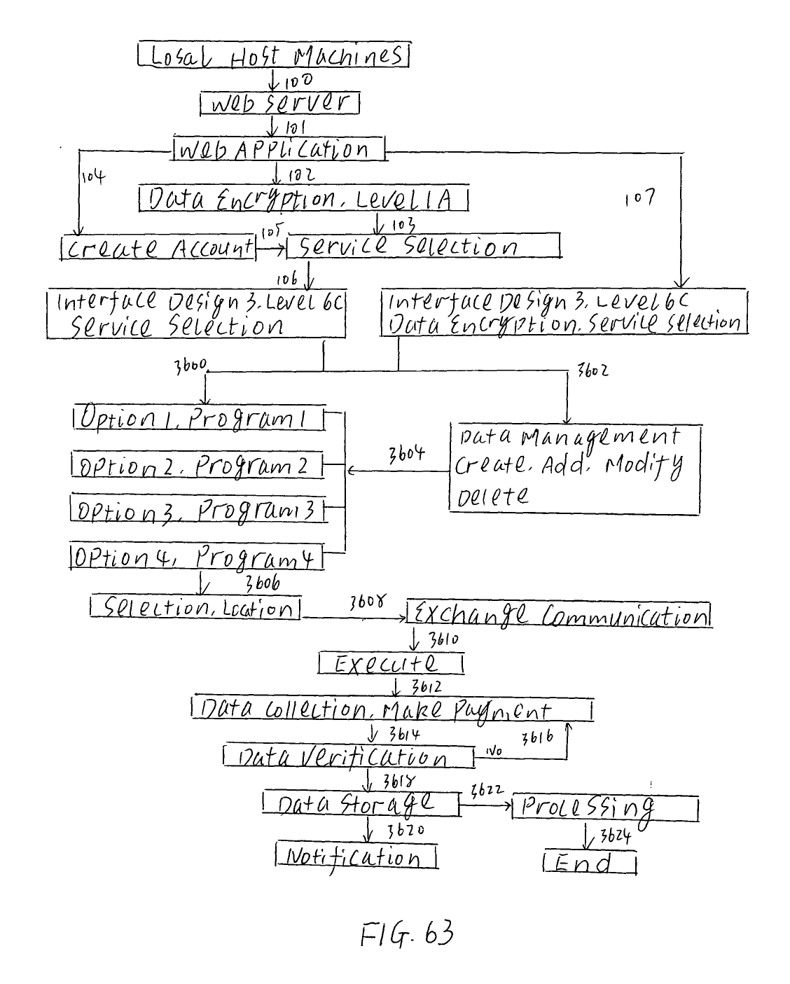

Referring to FIG. 63, this figure is a functional block diagram illustrating how the user invites his or her friend(s) to shop online together. The user connects to the web server and access to the web application (Step 100,101). The user can create an account if he or she doesn't have one. If the user has an account, he or she provides data for encryption through the route 102 (from the step 102) or the step 107 at the sixth level. When the data is encrypted, the user selects a service.

The user chooses Shopping Together (Step 3600). Step 3600 is the step that the user invites his or her friend(s) to shop online together. There are several different ways to invite. The first way is inviting through online. The second way is inviting through email. The third way is inviting through text message over the phone. The fourth way is inviting by voice communication. The methods of inviting are developed using java. The programs are stored in the data files on the server. They are launched when the triggers are pulled.

3602 is the step that the user manages the contact information. The user maintains the contact list including add, modify, delete, upload, preview, cancel, reset, and invite etc. He or she can invite his or her friend(s) from the contact list by taking the step 3604.

Step 3606 is the step to select a shopping area. Step 3608 is the step to communicate with each other through online texting or voice communication. The next step 3610 is the step to ‘Execute’. ‘Execute’ refers to a series of action related to online purchasing.

After the user and his or her friend(s) buy things online, the data needs to be collected (Step 3612). Once the data is collected, it needs to be verified (Step 3614). During the verification, a java function is invoked. It provides a default verification routine to verify the validity of the data. The procedure returns the value TRUE for success and FALSE for failure. If the verification raises an exception, the data becomes invalid, an error is returned.

Verified information includes company or personal information such as company or personal name, company address, credit card number, expiration date, security code, bank route number and account number etc. If the information is not valid, the process takes the step 3616 and goes back to the step 3612 until the information is valid. If the information is valid, it is submitted and saved in the database (Step 3618). The notification is sent out to the shoppers. Step 3610 ‘Execute’ needs to be processed (Step 3622). Shop together ends (Step 3624) when the user and his or her friend(s) finish the shopping together session.

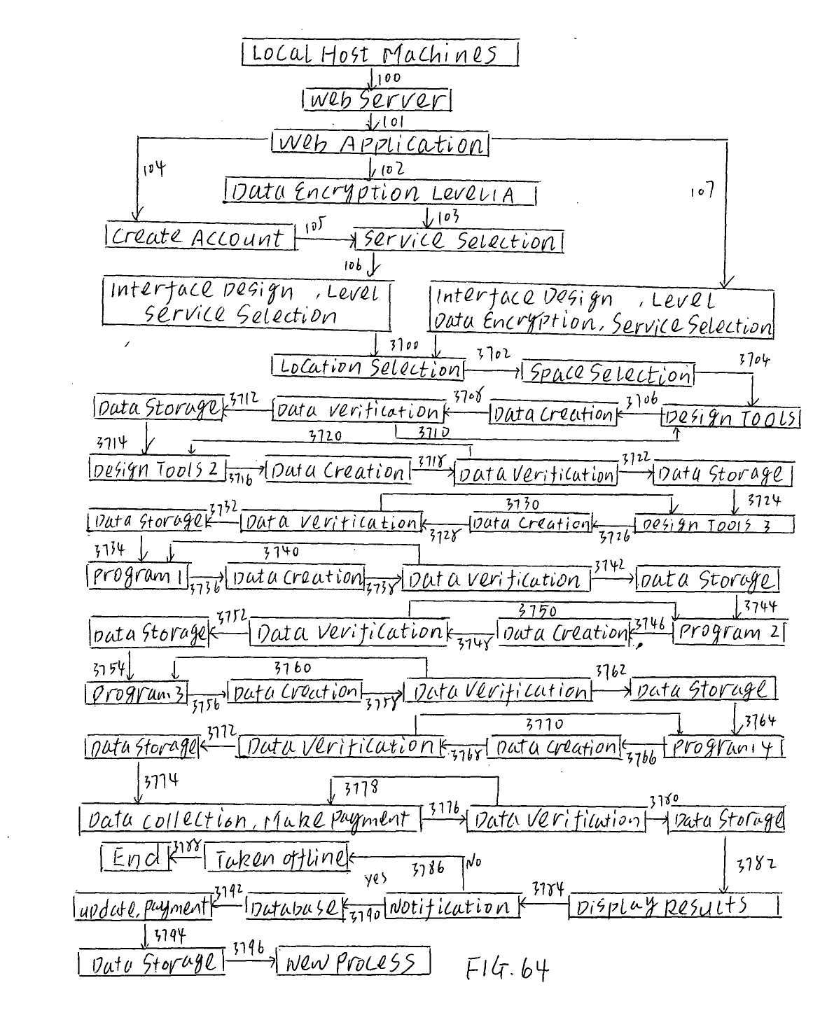

Referring to FIG. 64, this figure is a functional block diagram illustrating how the user sets up store at the industrial national level under Service Group 2 in Module 2. Service Group 2 includes Industrial Marketplace Mall, Four Season Expo, Wholesale Distributors, International Trade Show, My Showroom, Warehouse to The Public, Business Park, Technology Hub, Service Source Place, Window Shopping, and Video Shopping. The user connects to the web server and accesses to the web application (Step 100,101).

3700 is the step that the user chooses to set up a store at the industrial national level. The user selects a location and a space (Step 3702). The service locations and space are complied with Java. The java program units are stored in the data file on the server. There are many divided space in every service in the Service Group 2. Each service location is graphically designed by graphic program which is also stored within the computer server. When a space is selected, the user uses the design tools and programs to create storefront (Step 3704). The storefront can be either video or image format. The tools and programs include templates, editor, background colors patterns, canvas and Java developed program. In this step the user picks a template, chooses background color from the galleries, selects a canvas and a pattern or chooses to upload his or her own work from the local machine. The user provides necessary information before the data is created (Step 3706). Data information can be any information of a company like company's logo, website, address, video clip etc. After the date is created, it needs to be verified (Step 3708). If it is not valid, it goes back to the step 3704 for valid information (Step 3710). When the verification is done, the data is saved (Step 3712).

The next step 3714 is creating the exterior 3D storefront used in the virtual 3D animation shopping environment. The user uses the tools and programs developed by java. The tools include templates, editor, background colors, and canvas. In this step the user picks a template, chooses a background color from galleries, and selects a canvas. The user provides necessary information before the data is created (Step 3716). After the date is created, it needs to be verified (Step 3718). If it is not valid, it goes back to the step 3716 for valid information (Step 3720). When the verification is done, the data is saved (Step 3722).

The next step 3724 is creating 3D interior of the store used in the virtual 3D animation shopping environment. The user uses the tools and programs developed by java. The tools include templates, editor, background colors, and canvas. In this step the user picks a template, chooses a background color from the galleries, and selects a canvas. The user provides necessary information before the data is created (Step 3726). After the date is created, it needs to be verified (Step 3728). If it is not valid, it goes back to the step 3726 for valid information (Step 3730). When the verification is done, the data is saved in the database (Step 3732).

The user has the option to choose sell products in video or image format or both. If he or she chooses the image format to sell products, java compiled programs help set up (Step 3734). After the user follows each step which includes making selection, providing the products related information, uploading the products' images, and previewing etc., the data is created (Step 3736). The data created needs to be verified (Step 3738). If it is not valid, it goes back to the step 3734 for valid information (Step 3740). When the verification is done, the data is saved in the database (Step 3742).

If the user chooses the video format to sell products, he has the option to sell by clips or by one clip. One clip includes all the products. Clips consist of different product categories. Java compiled programs help set up (Step 3744). After the user follows each step which includes making selection, providing the products related information, uploading the products' images, and previewing etc, the data is created (Step 3746). The data created needs to be verified (Step 3748). If it is not valid, it goes back to the step 3744 for valid information (Step 3750). When the verification is done, the data is saved in the database (Step 3752).

If the user chooses to sell in both the video and image formats, he or she follows the steps developed by java before finishing setting up.

3754 is the next step that the user chooses to run promotion. The promotion module consists of text, image, video and coupons. It is compiled with java programs. These programs are stored in the data files on the server. The user follows each step before the data is created (Step 3756). The data created in the step 3756 needs to be verified (Step 3758). If it is not valid, it goes back to the step 3754 for valid information (Step 3760). When the verification is done, the data is saved in the database (Step 3762).

The user can introduce the business by video (Step 3764). The video needs to be uploaded for preview (Step 3766, 3768). If it is not good, the process goes back (Step 3770). If it is good, it is saved (Step 3772). The next step is collecting information and making payment (Step 3774). The collected information needs to be verified (Step 3776). If it is not good, it goes back to the step 3774 through the step 3778. The data is saved and the results are displayed (Step 3780, 3782) when the verification is done. The displayed results refer to the design of the store being finished, the products being uploaded, the promotions being ready to be displayed, and the business video introduction being ready to be broadcasted etc.

Notification is sent to remind the user of renewing the lease before it expires (Step 3784). If the user ignores it, the store is closed when the lease expires (Step 3786), however all the contents created in the store remain in the account. The user can re-open the business anytime if the space is available or any other space is available. The process ends at the user without taking action (Step 3788). If the user chooses to renew the lease, he or she goes to the database (Step 3790), makes payment and updates the account information (Step 3792). The new data is saved (Step 3794) and a new process begins when the new lease begins (Step 3796).

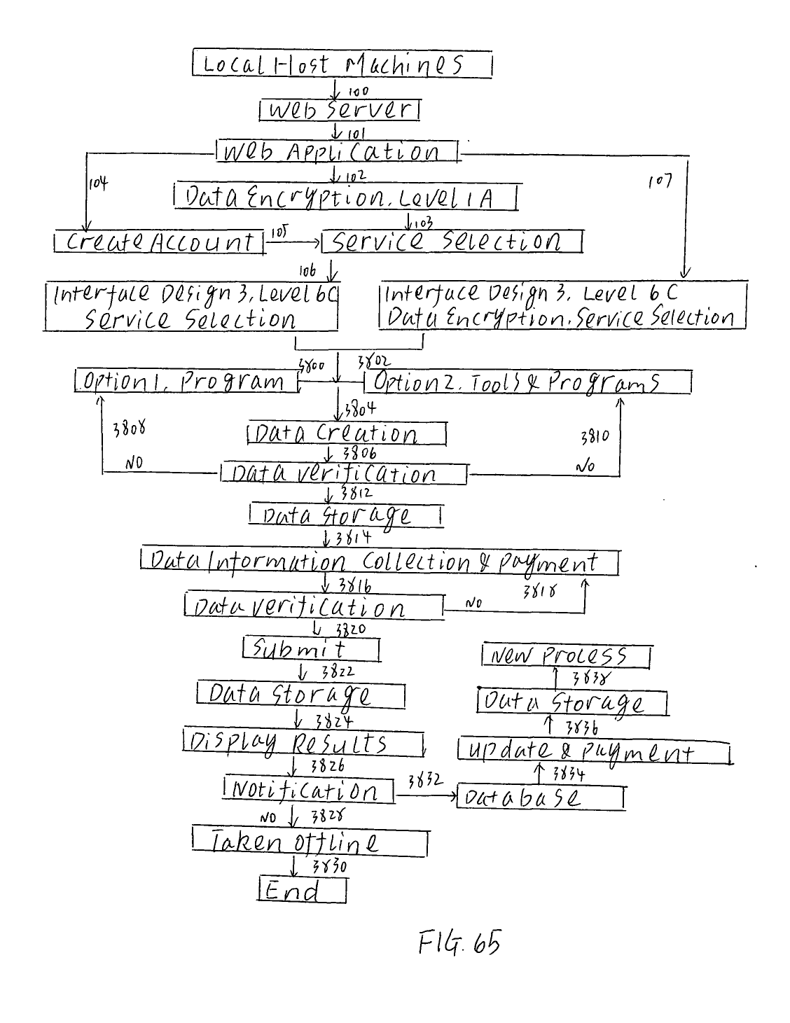

Referring to FIG. 65, this figure is a functional block diagram illustrating how Service Group 1 is designed at the first level (Industrial national level). The service group 1 includes Aftermarket parts, Aftermarket products, Wholesale to All, On Sale, Special Deals, Clearance, Closeouts, Access Inventory, Liquidation Sales, National Tent Events, New & Unique Products, Discount Products, Fresh Produce, Raw Materials, OEM Parts, OEM Products, Quality Products, Hot Products, Refurbished Products, Products & Services Promotion, Business Opportunities, Finance-Investment, Franchises, Events, Trade Shows-Conventions, Workshops-Seminars, Auctions, and Announcements. The user connects to the web server and access to the web application. The user can create an account if he or she doesn't have one. If the user has an account, he or she provides data for encryption through the route 102 (from the step 102) or the step 107 at the sixth level. When the data is encrypted, the user selects a service on the fourth page.

3800 is the step that the user chooses Option 1. Option 1 is related to video or image advertisement and the user chooses to upload the advertisement by himself or herself on the local machine. A program is developed to help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

3802 is the step that the user chooses Option 2. Option 2 is related to creating image advertisement and the use uses the tools and programs compiled by java. The tools include templates, background colors, patterns, editor and canvas etc. The java program units enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database for the as a unit. Packaged procedures and functions can be called explicitly the applications or users. The package usually has two parts stored separately in the database: A). The specification is the interface to the application and declares the types, variables, constraints, exceptions, cursors, and subprograms available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

When the step 3800 and 3802 are done, the data is created (Step 3804). The created data needs to be verified (Step 3806). If the verification raises an exception, the data becomes invalid, an error is returned. The process goes back to the step 3800 and 3802 by taking the step 1308 and step 3810. After the verification is done, the data is saved in the database on the server (Step 1312).

The next step is collecting information (Step 3814). It includes the payment information. The information needs to be verified (3816). If it is not valid, it goes back to the step 3814 for valid information (Step 3818). The new data is submitted and saved in the database on the server (Step 3820, 3822) and the results are displayed (Step 3824). The results refer to the image or video advertisement being created and posted.

Step 3826 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 3828 and 3830). The second choice is waiting and taking action in the database (Step 3832). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 3834), the new data is saved in the database on the server (Step 3836). A new process begins when the new advertisement is displayed for another period of time (Step 3838).

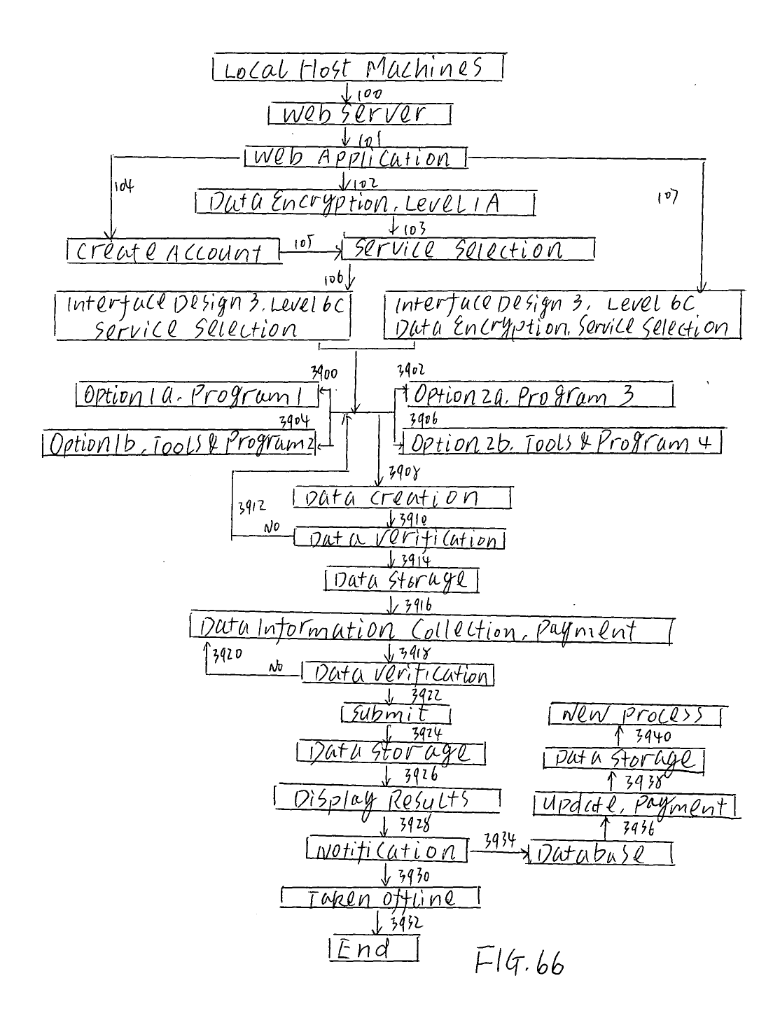

Referring to FIG. 66, this figure is a functional block diagram illustrating how VIP Ads Showroom is designed at the industrial national level. The user connects to the web server and access to the web application. The user can create an account if he or she doesn't have one. If the user has an account, he or she provides data for encryption through the route 102 (from the step 102) or the step 107 at the sixth level. When the data is encrypted, the user selects VIP Ads Showroom.

Step 3900 is the step to create the front cover page. The front cover page can either be in video or image format. The tools include templates, editor, background colors, patterns and canvas. The programs are java stored program units. The user picks a template, chooses background color from galleries, selects a canvas and a pattern and follows the steps before the front cover page is created. If the user chooses to use his or her own design work as the front cover page, a java function program is invoked to help him or her to locate the design work from the local machine. If the query is successful, the design work is brought up to the desktop for preview. It is submitted if the data is valid.

The next step 3902 is the step to create text and video advertisement. The user types the text ad contents in the block. Video advertisement is uploaded. The text and video advertisement need to be verified before they are submitted.

3904 is the step to create online image advertisement. The user uses the tools and programs. The tools include templates, background colors, patterns, editor and canvas etc. The programs include the steps and choices to help the user finish the advertisement. The user follows each step which includes providing ad content information, making selection, editing, previewing and correction etc. If the user chooses to provide his or her own image ad work, the java program helps search the data file from the local machine. The user originates the request. The server process parses the request and sends to the local machine. The local machine receives the request and begins to search. If the criteria are matched, the result is sent back. It is brought up to the desktop for preview. The advertisement is submitted if it is good. Or another process begins until the query is successfully returned.

If the user sells products (Step 3906), he or she chooses which format to sell: image, video or both. If the user chooses the image format to sell products, java compiled programs help him or her do it. The user follows each step which includes providing products' information, uploading products images, making payment and previewing etc. If the user chooses the video format to sell products, he or she has the option to sell by clips or one clip. One clip includes all products. Clips consist of different product categories. Java programs help the user do it. All the clips need to be viewed before they are submitted.

After the step 3900, 3902, 3904 and 3906 are taken, the data is created (Step 3908). The data needs to be verified (Step 3910). If it is not valid, it goes back until the valid data is provided (Step 3912). After the verification is done, the data is saved in the database on the server (Step 3914).

Step 3916 is collecting information. It includes the payment information. The collected information needs to be verified (Step 3918). If the information is not valid, the process goes back until the valid data is provided (3920). Data verified is submitted and saved in the database on the server (Step 3922, 3924). The results are displayed (Step 3926). The results refer to the advertisement being created, the products being ready to be sold and the sales module being implemented etc.

Step 3928 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 3930 and 3932). The second choice is waiting and taking action in the database (Step 3934). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 3936), the new data is saved in the database on the server (Step 3938). A new process begins when the contents under VIP Ads Showroom begin to be displayed for another period of time (Step 3940).

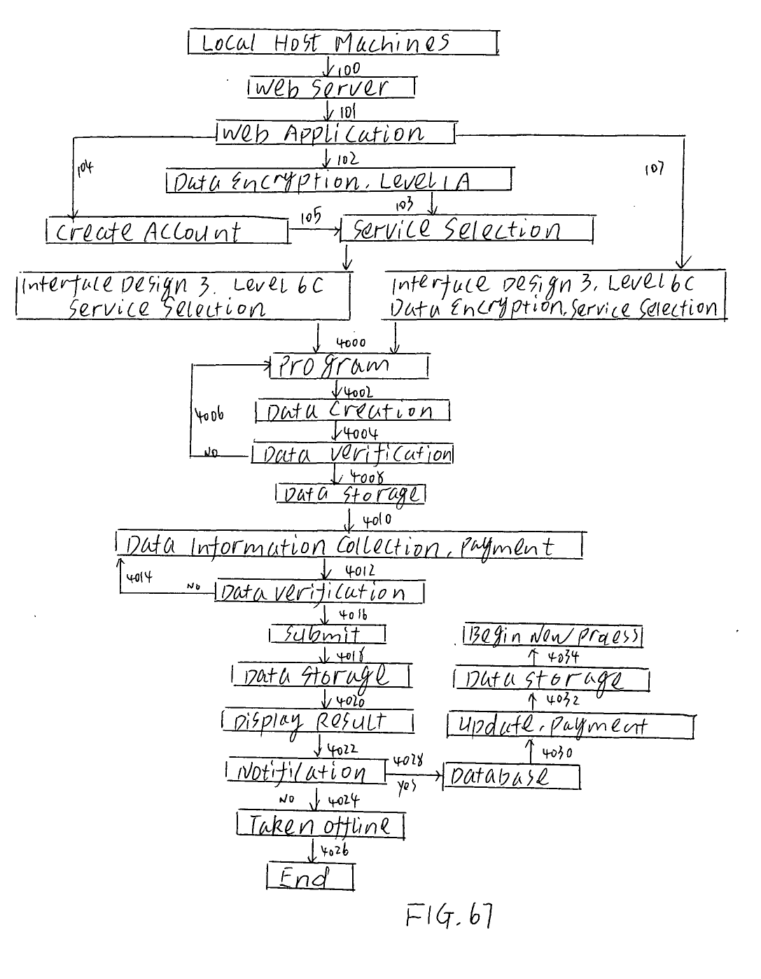

Referring to FIG. 67, this figure is a functional block diagram illustrating how Products Shown on TV is designed at the sixth level (Industrial national level). The user connects to the web server and access to the web application. The user can create an account if he or she doesn't have one. If the user has an account, he or she provides data for encryption through the route 102 (from the step 102) or the step 107 at the sixth level. When the data is encrypted, the user selects Products Shown on TV.

4000 is the step that the java program helps the user upload the advertisement by himself or herself on the local machine. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

After the file is fetched, it is brought up to the desktop for preview (Step 4002) and verified (Step 4004). During the verification, a Java function program is invoked. It provides a default verification routine to verify the validity of the data. The procedure returns the value TRUE for success and FALSE for failure. If the verification raises an exception, the data becomes invalid, an error is returned. It goes back the step 4000 until the data is good and valid (Step 4006). After the verification is done, the data is saved in the database on the server (Step 4008).

The next step is collecting information and data verification (Step 4010, 4012). If the information is good, it is submitted and saved (Step 4016, 4018). If the information is not good and valid, it goes back to the step 4010 through the step 4014 until the valid data is provided. The information refers to company, or personal information including the payment information. The results are displayed (Step 4020) after the steps are correctly taken.

Step 4022 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 4024 and 4026). The second choice is waiting and taking action in the database (Step 4028). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 4030), the new data is saved in the database on the server (Step 4032). A new process begins when the advertisement begins to be displayed for another period of time (Step 4034).

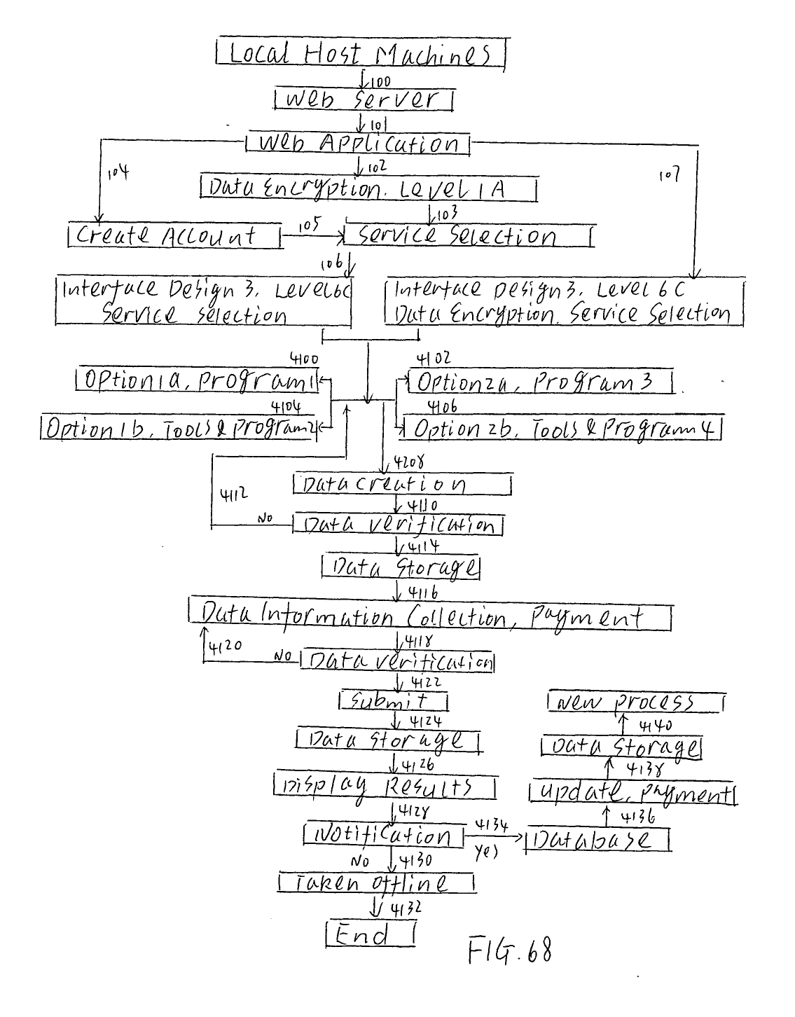

Referring to FIG. 68, this figure is a functional block diagram illustrating how Monthly Ads Catalog, Quarterly Products Brochure, Coupons, Coupon Books, Export Products, and Import Products in service group 3 are designed at the sixth level. The user connects to the web server and access to the web application. The user can create an account if he or she doesn't have one. If the user has an account, he or she provides data for encryption through the route 102 (from the step 102) or the step 107 at the fourth level. When the data is encrypted, the user selects one of the services in the service group 3.

Option 1A (Step 4100) is the step that the user selects to use his or her own front cover page on the local machine. The user originates the request. The request is sent in the user process. The server parses the request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

Option 2A (Step 4102) followed by Option 1A is the step that the user selects to use his or her own catalog. The user initiates the query. If the query is successful, they return data as results. There are three main stages in the process of a query. A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched. After the data file is fetched, the data is brought up to the desktop for preview. If it is good, it is submitted. Or a new process begins until the valid data file is fetched.

Option 1B and 2B (Step 4104, 4106) are the steps that the user selects to create the front page and catalog using the free online tools. The user uses the tools and walks through the steps developed by java programs. The tools include templates, background colors, patterns, editor and canvas etc. The java programs are stored program units. They help the user finish the work and manipulate database information using procedural schema object. After each step is taken, the data is created (Step 4108). The created data needs to be verified (Step 4110).

During the verification, a java function program is invoked. It provides a default verification routine to verify the validity of the data. The procedure returns the value TRUE for success and FALSE for failure. If the verification raises an exception, the data becomes invalid, an error is returned. The process goes back until the data provided is good and valid (Step 4112). After the verification is done, the server records the data and writes it to the data blocks in the data files from database buffer cache (Step 4114).

The next step (Step 4116) is collecting information. The collected information needs to be verified (Step 4118). If it is not valid, it goes back to the step 4116 for valid information by taking the step 4120. Date verified is submitted and saved in the database on the server (Step 4122, 4124). And the results are displayed (Step 4126). The results refer to the advertisement being created and the sales module being implemented.

Step 4128 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 4130 and 4132). The second choice is waiting and taking action in the database (Step 4134). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 4136), the new data is saved in the database on the server (Step 4138). A new process begins when the advertisement begins to be displayed for another period of time (Step 4140).

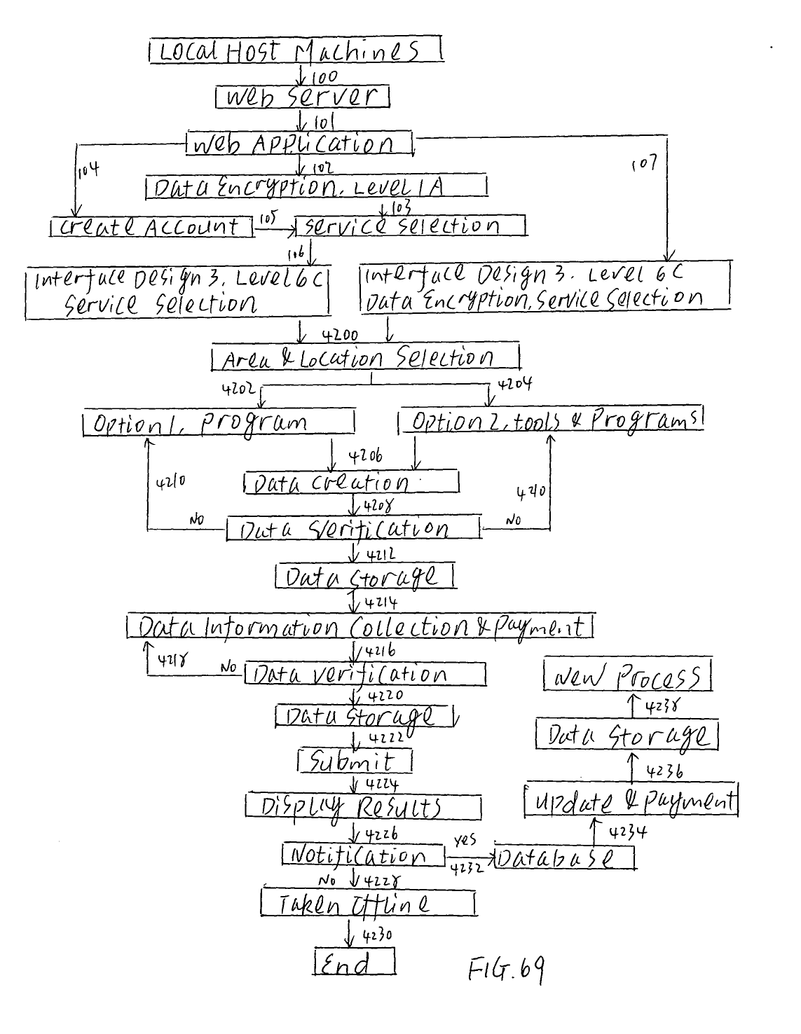

Referring to FIG. 69, this figure is a functional block diagram illustrating how Service Group 4 is designed at the sixth level. The service group 4 includes Office Space & Suites and Warehouses & Distribution Centers. The user connects to the web server and access to the web application. The user can create an account if he or she doesn't have one. If the user has an account, he or she provides data for encryption through the route 102 (from the step 102) or the step 107 at the first level. When the data is encrypted, the user selects one of the services in the service group 4.

4200 is the step that the user chooses an area. An area can be a city or a metro area in a state. If the user selects to upload the advertisement from the local machine (Step 4202), a Java program is invoked. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

If the user selects to create the commercial advertisement online (Step 4204), he or she uses the free online tools and programs. The tools include templates, background colors, patterns, editor and canvas etc. The programs are developed by Java. They are stored program units. They provide the steps and choices for the user to finish the design work and manipulate database information using procedural schema objects. The user follows each step including providing advertisement content information, making selection, creating, editing, preview and correction etc.

When the step 4202 and 4204 are done, the data is created (Step 4206). The created data needs to be verified (Step 4208). If the verification raises an exception, the data becomes invalid, an error is returned. The process goes back to the step 4202 and 4204 by taking the step 4210. After the verification is done, the data is saved in the database on the server (Step 4212).

The next step is collecting information (Step 4214). It includes the payment information. The information needs to be verified (4216). If it is not valid, it goes back to the step 4214 for valid information (Step 4218). The new data is submitted and saved in the database on the server (Step 4220, 4222) and the results are displayed (Step 4224). The results refer to the commercial advertisement being created and posted.

Step 4226 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 4228 and 4230). The second choice is waiting and taking action in the database (Step 4232). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 4234), the new data is saved in the database on the server (Step 4236). A new process begins when the advertisement begins to be displayed for another period of time (Step 4238).

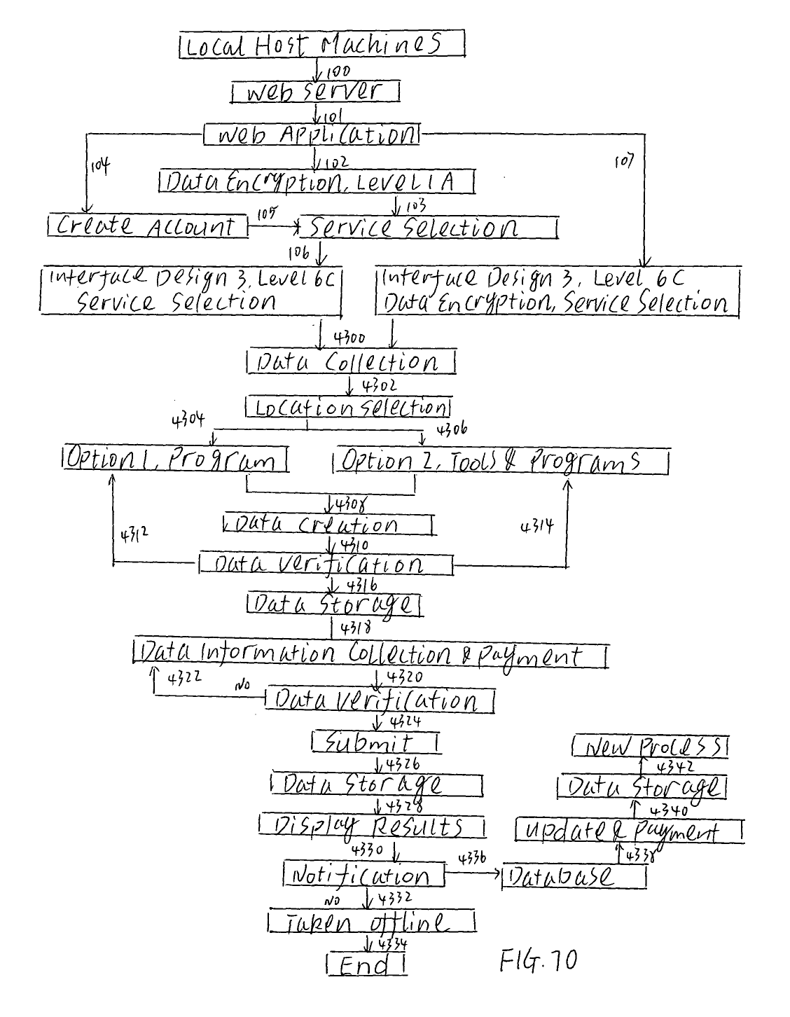

Referring to FIG. 70, this figure is a functional block diagram illustrating how Expose Business is designed at the sixth level. The user connects to the web server and access to the web application (Step 100, 101). The user can create an account if he or she doesn't have one. If the user has an account, he or she provides data for encryption through the route 102 (from the step 102) or the step 107 at the first level. When the data is encrypted, the user selects Expose Business.

Step 4300 is the step that the user provides data information of the business. The user selects an industry and a location in the step 4302. A location is a designated area where the user chooses to expose the business. If the user chooses the step 4304, he or she provides the advertisement by him or herself. Step 4304 invokes a program which helps the user locate the file on the local host machine. The user originates the request. The request is sent in the user process. The server parses the request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

If the user takes the step 4306, he or she creates the design work using the free online tools. The user uses the tools and walks through the steps developed by java. The tools include templates, background colors, patterns, editor and canvas etc. The programs are java stored program units. They help the business finish the work and manipulate database information using procedural schema object. After each step is taken, the data is created (Step 4308). The data needs to be verified (Step 4310).

During the verification, a java function is invoked. It provides a default verification routine to verify the validity of the data. The procedure returns the value TRUE for success and FALSE for failure. If the verification raises an exception, the data becomes invalid, an error is returned. The process goes back until the data provided is good and valid (Step 4312, 4314). After the verification is done, the server records the data and writes it to the data blocks in the data files from database buffer cache (Step 4316).

The next step (Step 4318) is collecting information. The collected information needs to be verified (Step 4320). If it is not valid, it goes back to the step 4318 for valid information by taking the step 4322. The verified data is submitted and saved in the database on the server (Step 4324, 4326). And the result is displayed (Step 4328). The result refers to that the design work related to expose the business is created.

Step 4330 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 4332 and 4334). The second choice is waiting and taking action in the database (Step 4336). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 4338), the new data is saved in the database on the server (Step 4340). A new process begins when the advertisement begins to be displayed for another period of time (Step 4342).

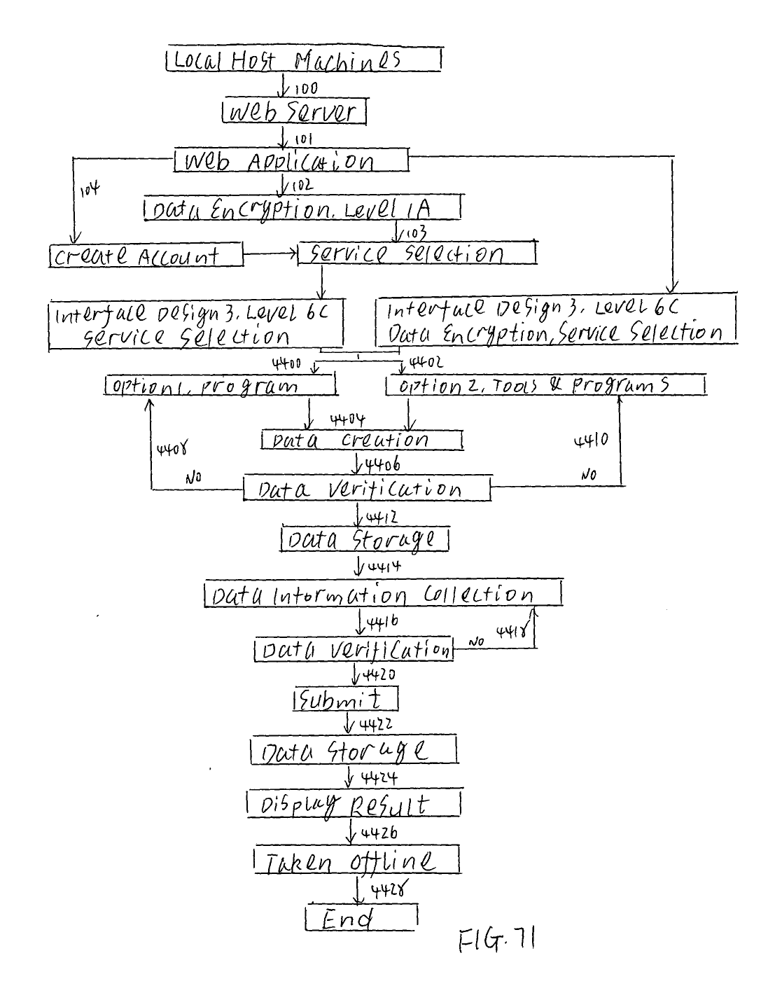

Referring to FIG. 71, this figure is a functional block diagram illustrating how Contest to Win is designed. The user connects to the web server and access to the web application. The user can create an account if he or she doesn't have one. If the user has an account, he or she provides data for encryption through the route 102 (from the step 102) or the step 107 at the sixth level. When the data is encrypted, the user selects Contest to Win on the fourth page.

Step 4400 is the step that the user chooses to upload the design work by himself or herself on the local machine. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

Step 4402 is the step the user uses the tools and programs to help finish the design work. The tools include templates, background colors, patterns, editor and canvas etc. The programs include steps developed to help the user finish the work. When the step 4400 and 4402 are done, the data is created (Step 4404). The created data needs to be verified (Step 4406). If the date is not good, the process goes back to the step 4400 and 4402 by taking the steps 4408 and 4410. After the verification is done, the data is saved on the server (Step 4412).

The next step is collecting information (Step 4414). The collected information needs to be verified (4416). If it is not valid, the process goes back to the step 4418. The new data is submitted and saved in the database on the server (Step 4420, 4422) and the result is displayed (Step 4424). The result refers to the art work is created and posted.

The art work is taken offline when context time period expires and a new process begins (Step 4426, 4428). If the results show positive (Step 4430), the process moves to the claim step (Step 4432). The results refer to the votes that the art work gets. The process ends at the messages being sent out to the winners (Step 4434).

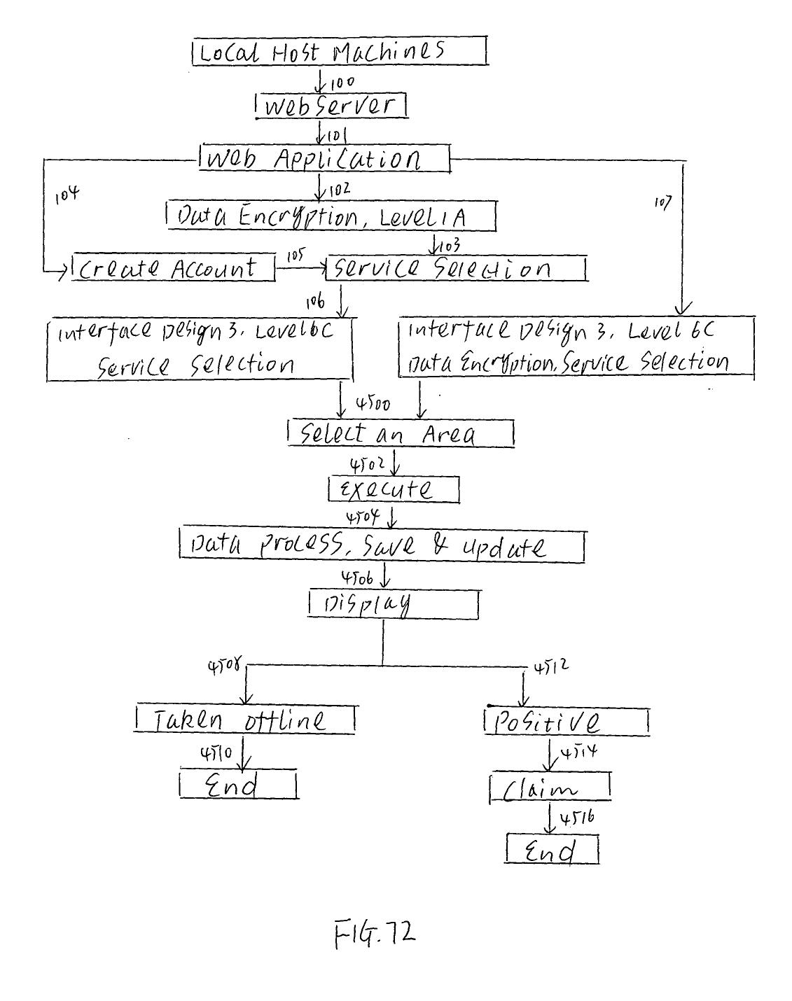

Referring to FIG. 72, this figure is a functional block diagram illustrating how Sweepstakes is designed. The user connects to the web server and access to the web application. The user needs to create account. After the account is created, he or she selects Sweepstakes on the fourth page at the sixth level.

The user chooses an area in the step 4500. An Area refers to a shopping area at different level. Step 4502 is the step the user executes. During the execution, the data is created and saved (Step 4504). Execute refers to activities that occur during shopping. Execute can be a repeat process. As long as ‘execute’ repeats, the data is created, saved and updated. The new date is displayed in the designated area for public view (Step 4506).

All the date is taken offline when Sweepskakes' time period expires and a new process begins (Step 4508, 4510). If the results show positive (Step 4512), the process moves to the claim step (Step 4514). The results refer to the chances of winning that the user gets. The process ends at the messages being sent out to the winners (Step 4516).

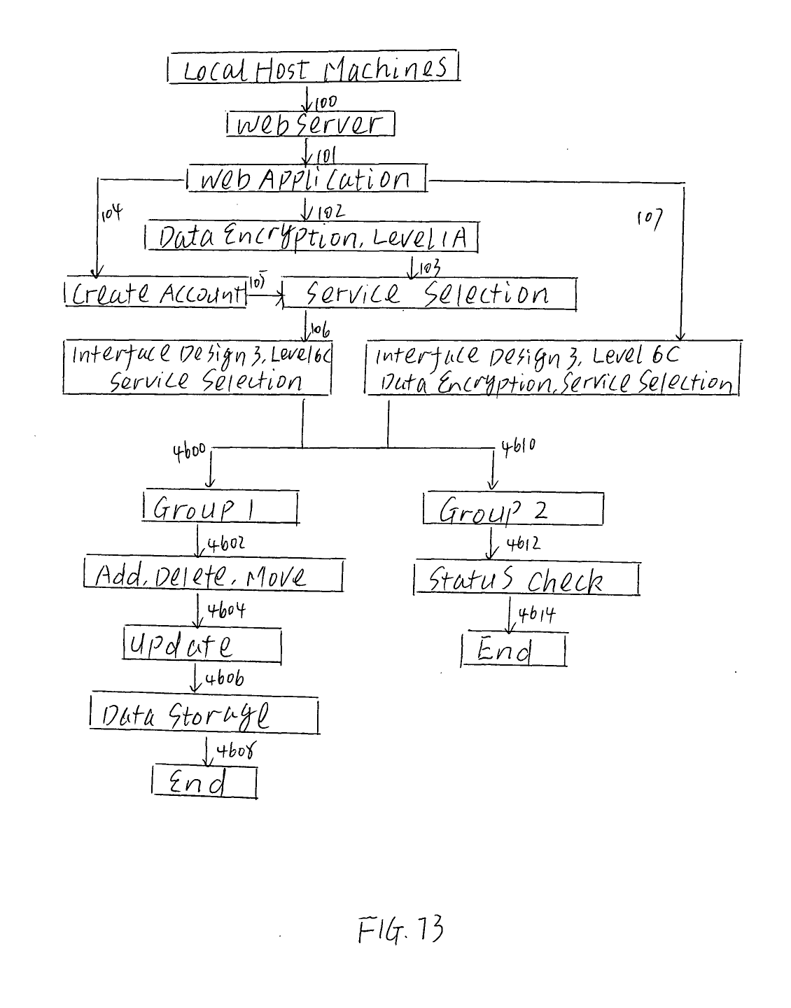

Referring to FIG. 73, this figure is a functional block diagram illustrating how My Stuff is designed. The user connects to the web server and access to the web application. The user needs to establish an account and have account activity history.

The user selects a service from the service group 1 (Step 4600). A service in the service group 1 is either a shopping area or a store that the user has the records in his or her account. If the user doesn't have one, he or she can create one anytime. The services in the group 1 are designed for the user to quickly access to the services he or she chooses. There is management function in the service group 1. The user can manipulate the records anytime (Step 4602). When it is done, the new records are updated and saved (Step 4604, 4606). The process ends at either the user choosing a service in the service group 2 or exiting My Stuff (Step 4608).

Step 4610 is the step that the user selects a service in the service group 2. Group 2 consists of different information collected and stored in the user's account. The user selects a service and checks the status (Step 4612). The process ends at either the user choosing a service in the group 2 or exiting My Stuff (4614).

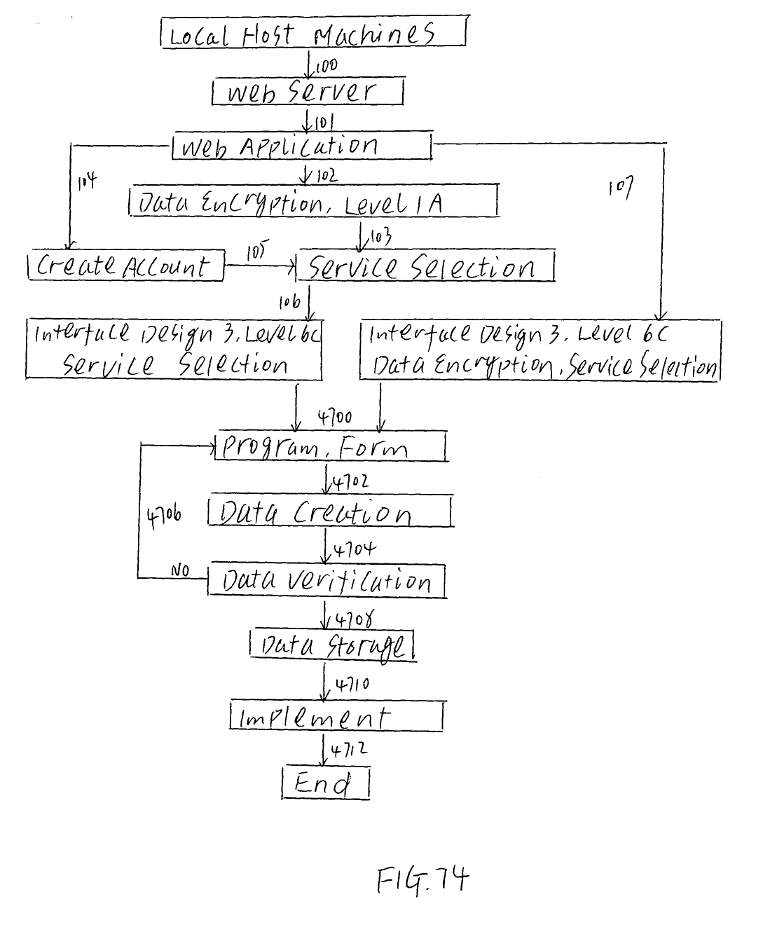

Referring to FIG. 74, this figure is a functional block diagram illustrating how Membership is implemented. The user provides all the necessary information and makes selection (Step 4700). After it is done, the data is created (Step 4702). The created data needs to be verified (Step 4704). If the data is not valid, it goes back until the valid data is provided (Step 4706). Membership data is saved in the database related to the user's account. When activities occur, membership is triggered. The process is implemented (Step 4710). The user takes the benefits of becoming a member. The process ends at the membership expires without renewal.

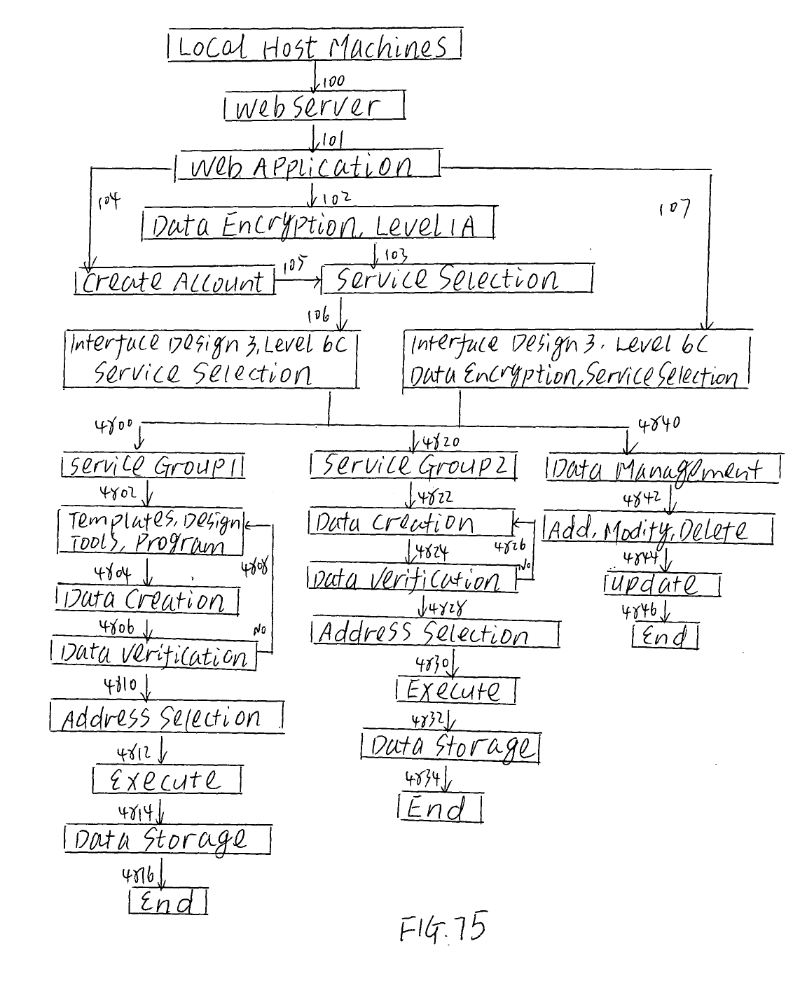

Referring to FIG. 75, this figure is a functional block diagram illustrating how the flow is designed for Market Tools. The user connects to the web server and access to the web application. The user can create an account if he or she doesn't have one. If the user has an account, he or she provides data for encryption through the route 102 (from the step 102) or the step 107 at the sixth level. When the data is encrypted, the user selects Marketing Tools on the fourth page at the sixth level.

There are three options. Option 1, Step 4800 is the step that the user selects a service from Service Group A. A service can be any type of promotion for a business in the graphic format. The user needs to choose whether to create the service on line using the free design tools or upload the design work by him or herself on the local machine. If the user chooses to upload the design work by himself or herself (Step 4802), a program is developed to help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

If the user chooses to use the online free tools, java complied programs help the user finish the work. Java programs are stored program units. They are a logically related set of language statements that perform a specific task. After the user follows each step, the data is created (Step 4804). The created data needs to be verified (Step 4806). If it is not good, it goes back until the valid data is provided (Step 4808). The user selects the user contacts (Step 4810), and execute (Step 4812). Execute refers to all the business promotions are sent out. The data is stored in the database for future use (Step 4814). The process ends at the user picking another service or logging out (Step 4816).

Option 2 is similar to Option 1. The services are a little different. They are designed for businesses to build and keep relationship with their clients in text format. The user selects a service in the service group B and creates promotion contents (Step 4820). After it is done, the data is created (Step 4822). The new data needs to be verified (Step 4824). If the data is not valid, the process goes back to the step 4820 for correct data (Step 4826). The user selects the user contacts (Step 4828), and execute (Step 4830). Execute refers to all the contents created are sent out. The data is stored in the database for future use (Step 4832). The process ends at the user picking another service or logging out (Step 4834).

Step 4840 is the step the user chooses to manage the user's accounts. The user can manipulate the records at anytime (Step 4842). When it is done, the new records are updated and saved (Step 4844). The process ends at either the user choosing another service in another group or exiting Marketing Tools (Step 4846).

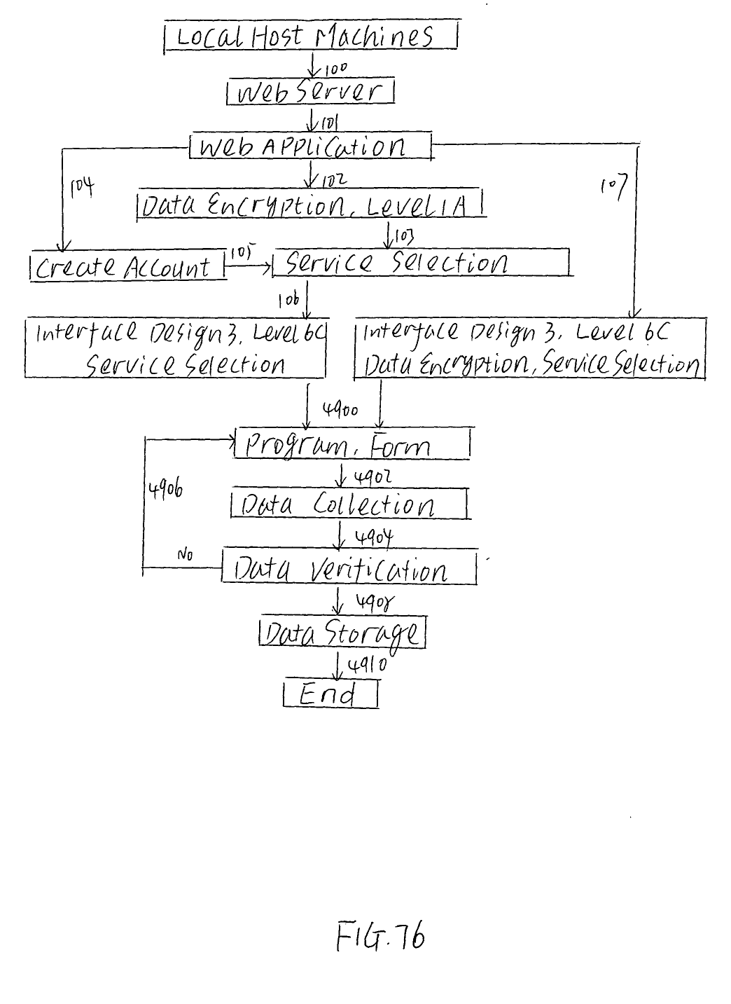

Referring to FIG. 76, this is a functional block diagram illustrating how Authorized Agents is designed. The user provides data information in the form (Step 4900). The form is created using java development tools. After the step 4900 is taken, the data is created (Step 4902). The date needs to be verified (Step 4904). If the data is not good, it goes back for correct data (Step 4906). If it is good, the data is saved on the server in the business's account (Step 4908). The process ends at the user picking another service (Step 4910).

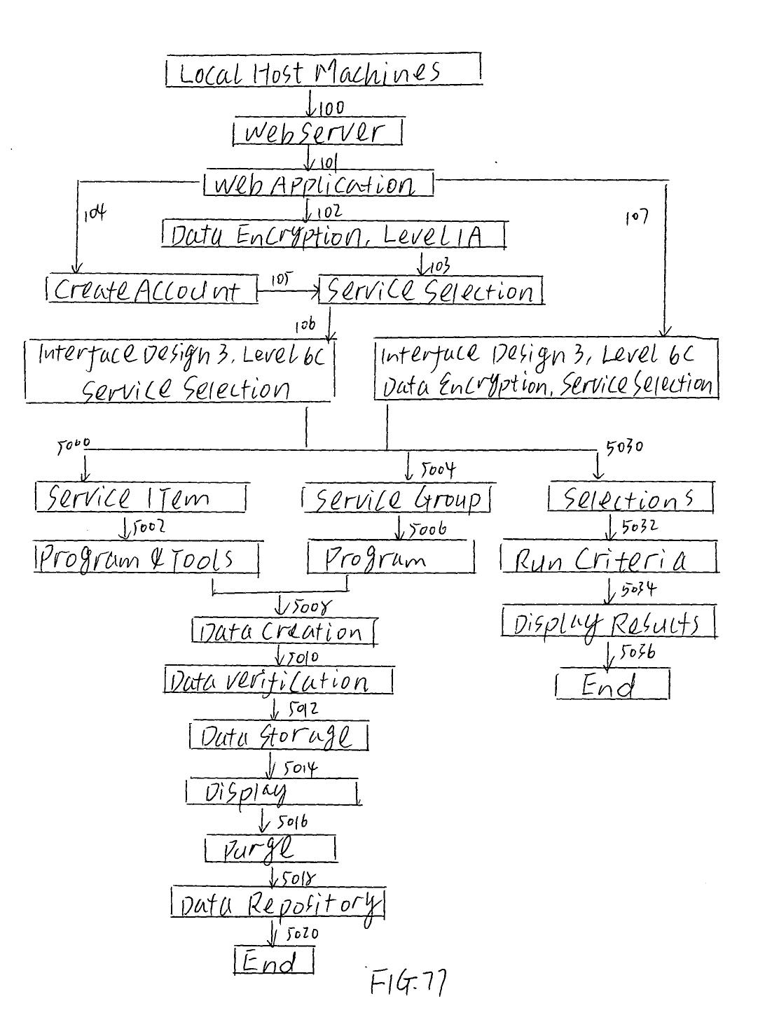

Referring to FIG. 77, this is a functional block diagram illustrating how Community is designed. The user connects to the interne on the local host machine and access to the web application (Step 100, 101). The user can create an account if he or she doesn't have one. If the user has an account, he or she provides data for encryption through the route 102 (from the step 102) or the step 107 at the sixth level. When the data is encrypted, the user selects Community.

Step 5000 is the step that the user selects the service. The service is designed for the business to do online market in the community. The user needs to choose whether to create and use his or her own design work or creates the design work using the online tools (Step 5002).

If the user selects to use his or her own design work from the local machine, he or she initiates request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

If the user selects the tools and programs to create the design work, he or she needs to follow all the steps (Step 5002). The tools include templates, background colors, patterns, editor and canvas etc. The programs include steps developed to help the user finish the work.

Step 5004 is the step that the user selects the service in the service group. The categories in the service group are different. But the format for each service in the group is identical. The services are developed by java.

After the step 5002 and 5006 are done, the data is created (Step 5008). The created data needs to be verified until correct data is provided (5010). After the verification, the data is saved in the database on the server (Step 5012) and the results are displayed (Step 5014). The results refer to that the contents being created and posted. The date will be purged in a period of time (Step 5016) but remain in the repository area for another period of time (Step 5018). The process ends at the user either picking another service or logging out (Step 5020).

In the step 5030, the user runs criteria to search people he or she likes to associate with. A java program is developed to define the criteria. The result(s) are displayed after the searching process is done (Step 5032, 5034). The process ends at the user either picking another service or logging out (Step 5036).

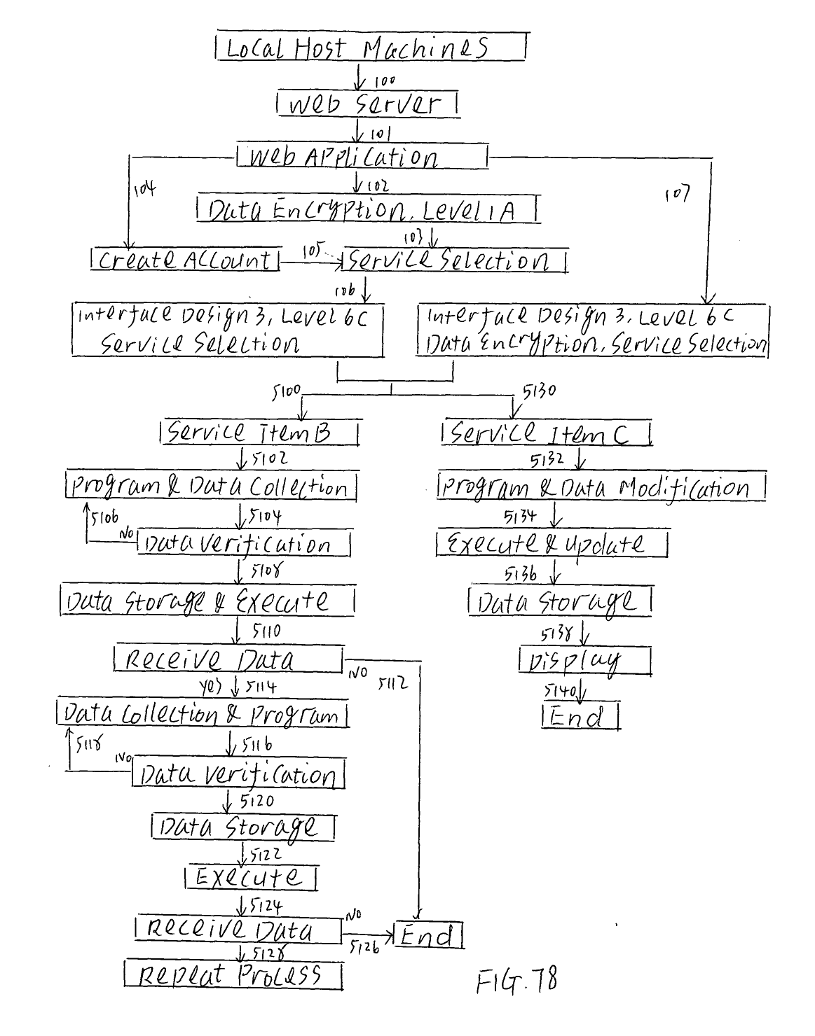

Referring to FIG. 78, this is a functional block diagram illustrating how Our Friends Group is designed. The user connects to the internet on the local host machine and access to the web application (Step 100, 101). The user can create an account if he or she doesn't have one. If the user has an account, he or she provides data for encryption through the route 102 (from the step 102) or the step 107 at the sixth level. When the data is encrypted, the user selects Our Friends Group under the Community.

The host user creates the group by establishing a public username and password for the group (Step 5100). He or she chooses a design among templates for the front page. When the design work is done, the user provides all the necessary information (Step 5102) before moving to the next step. Step 5102 is developed using java. It contains java codes saved in the data files on the server. The created data is brought up for verification (Step 5104). If it is not good, the user takes the step 5106 back until the valid data is provided. The verified date is saved and submitted in the step 5108. When the data is received (Step 5110), another java program is invoked, the other user either ignores it or provides all the necessary information before continuing. If the user ignores it, the process ends (Step 5112). If the user chooses to continue, he or she creates the data using the program invoked (Step 5114). The data could be any type. The created data needs to be verified (Step 5116). If the data is not valid, the user takes the step 5118 back until the valid data is provided. When this step is done, the data is saved (Step 5120). The user passes the data created to others (Step 5122). When the data is received (Step 5124), other users can choose to ignore it and the process ends (Step 5126). Or the other users repeats the process described above (Step 5128). The data refers to personal information including video and picture.

Step 5130 is the step that the user selects to communicate with each other and manages the account. The user creates data and posts it in the step 5132 for public view. The next step (Step 5134) is updating. The user updates his or her information at anytime. Once this step is done, the data is saved (Step 5136). The created data in the step 5132 is displayed in the designated area (Step 5138). The process ends at the new data being created (Step 5140).

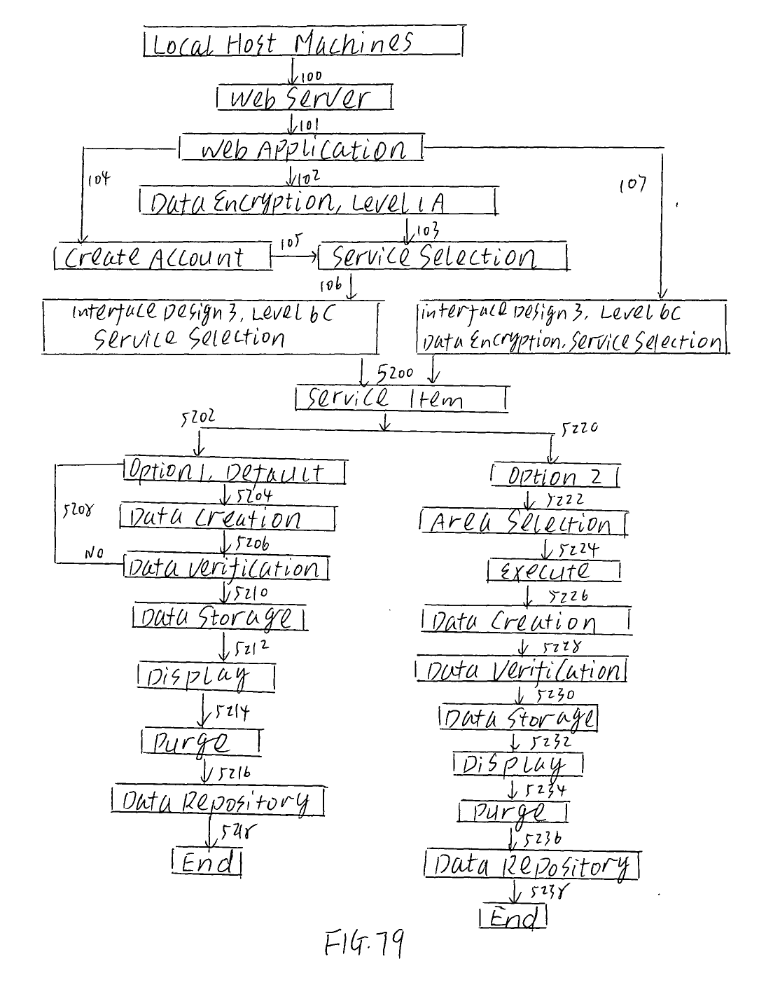

Referring to FIG. 79, this is a functional block diagram illustrating how Chatroom is designed under the Community. The user connects to the web server and access to the web application. The user needs to establish an account before entering the chat room (Step 5200). Step 5202 is the default setting for chatting in the public room. The chat room is designed using java for the user to create data communicating with each other. It is coded and stored in the data files on the server. The user creates the data in the chat room after the verification (Step 5204, 5206). If the data is not good, the process takes the step 5208 back until the valid data is provided. The verified data is stored and displayed (Step 5210, 5212). The data will be purged for a period of time but will remain in the repository area for another period of time. (Step 5214, 5216). The process ends at the new data being created (Step 5218).

If the user takes the step 5220, he or she picks a private room (Step 5222). Private rooms are auto extended if all are occupied. Only invited people can enter and chat in the private room. The private room is developed by java. The program is stored in the data file on the server. The user creates data communicating with each other (Step 5224). When the data is created, it needs to be verified before saving (Step 5226, 5228). The data is shown in the display area (Step 5232) after the verified data is saved (Step 5230). The data is purged and put in the repository area (Step 5234, 5236). The process ends at the new data being created (Step 5238).

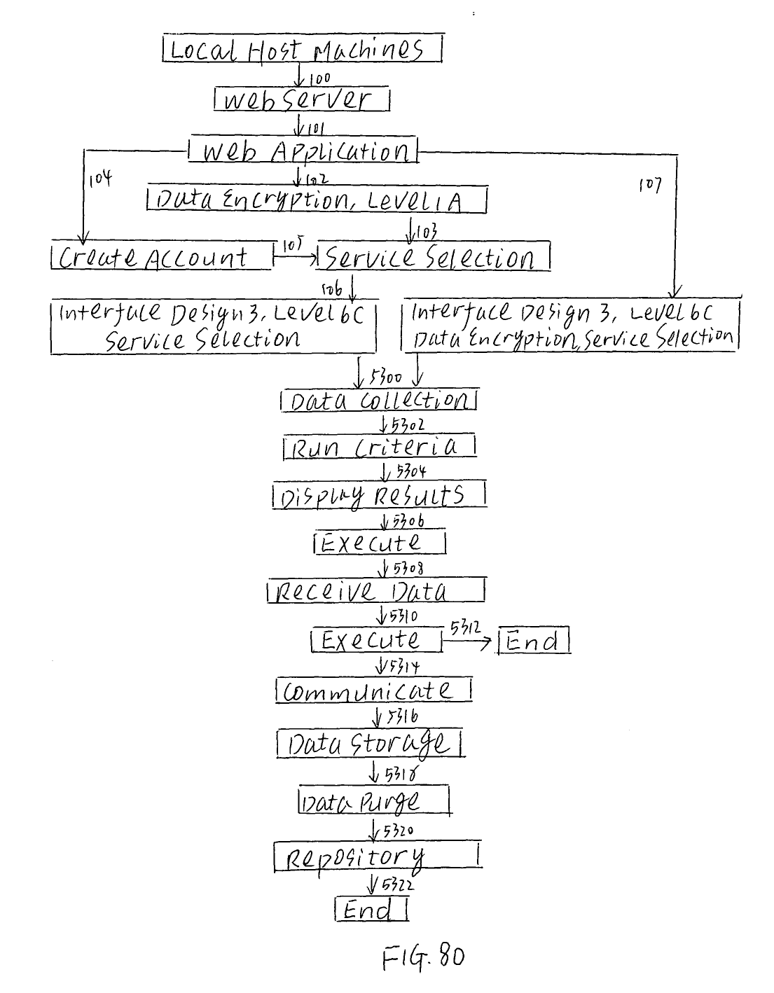

Referring to FIG. 80, this is a functional block diagram illustrating how people Become Friends under the Community. The user connects to the interne on the local host machine and access to the web application (Step 100, 101). The user can create an account if he or she doesn't have one. If the user has an account, he or she provides data for encryption through the route 102 (from the step 102) or the step 107 at the sixth level. When the data is encrypted, the user selects Become Friends under the Community.

The user begins with the step 5300 by providing all the necessary information. The information includes personal information, image and video. Step 5302 is run criteria. There are four main stages involved. A) Select, during this stage, the user make selections. The selections include age, gender and area location etc. B). Parse, during the parse, the server process searches for the existing request copy of the user request; validates the user request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache. The parse stage includes processing the requirement that needs to be done only once no matter how many times the statement is executed. The server usually translates each requirement only once, re-executing that parsed during subsequent references to the request. C). Executing the requirement, at this point, the local computer has all the resources and necessary information, so the requirement is executed; the server process prepares to retrieve the data. D). Fetching, in the fetching stage, all the valid data is returned by the server to the user.

After the fetching is done, the results are displayed (Step 5304). The results refer to other people's information data that the user needs to use and execute (Step 5306). During the execution, all the data is sent out. Step 5308 is the step when other people receive the data. The data is about invitation. Other people who receive the data respond (Step 5310). If they ignore it, the process ends at Step 5312. Or the process continues with communication (Step 5314). During the communication, the data is created and saved (Step 5316). The saved data will be purged in a period of time but remain in the repository area (Step 5318, 5320). The process ends at the new communication occurring (Step 5322).

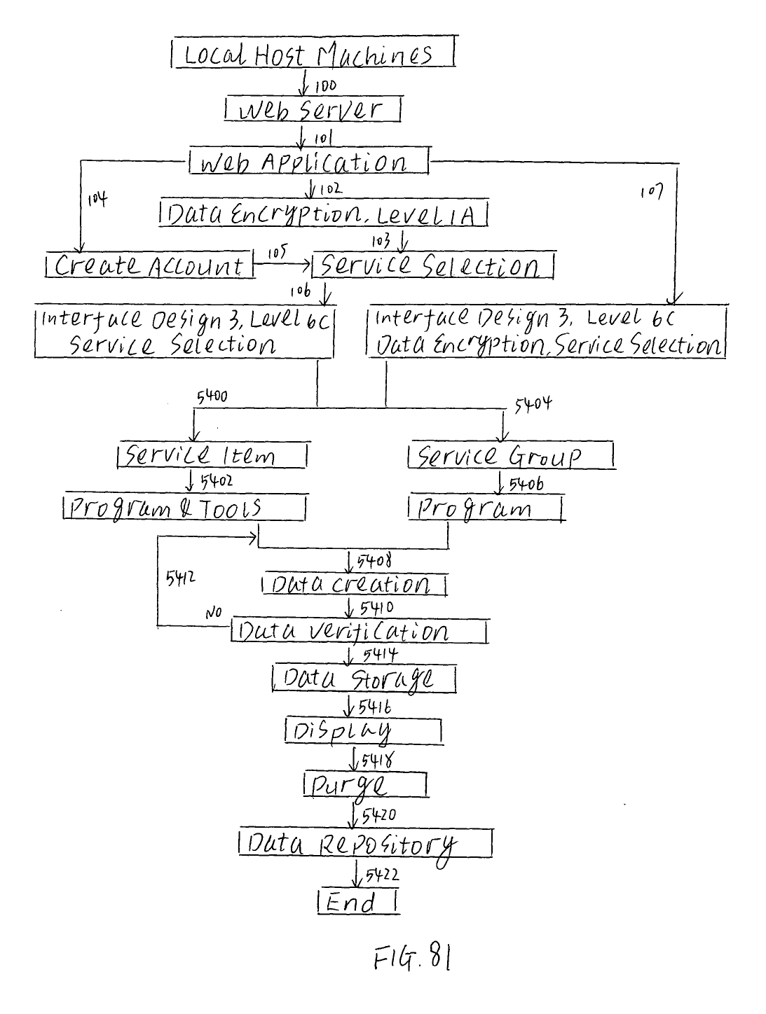

Referring to FIG. 81, this is a functional block diagram illustrating how Business Community is created. The user connects to the web server and access to the web application. The user can create an account if he or she doesn't have one. If the user has an account, he or she provides data for encryption through the route 102 (from the step 102) or the step 107 at the sixth level. When the data is encrypted, the user selects Business Community under the Community on the fourth page.

Step 5400 is the step that the user selects the service. The service is designed for the business to do online market in the business community. The user needs to choose whether to create and post his or her own design work or creates the design work using the online tools (Step 5402).

If the user selects to use his or her own design work from the local machine, he or she initiates request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

If the user selects the tools and programs to create the design work, he or she needs to follow all the steps (Step 5402). The tools include templates, background colors, patterns, editor and canvas etc. The programs include steps developed to help the user finish the work.

Step 5404 is the step that the user selects the service in the service group. The categories in the service group are different. But the format for each service in the group is identical. The services are developed by Java.

After the step 5402 and 5406 are done, the data is created (Step 5408). The created data needs to be verified until correct data is provided (5410). If the data is not good, the process goes back to get valid data (Step 5412). After the verification, the data is saved in the database on the server (Step 5414) and the results are displayed (Step 5416). The results refer to the contents being created and posted. The date will be purged in a period of time (Step 5418) but remain in the repository area for another period of time (Step 5420). The process ends at the user either picking another service or logging out (Step 5422).

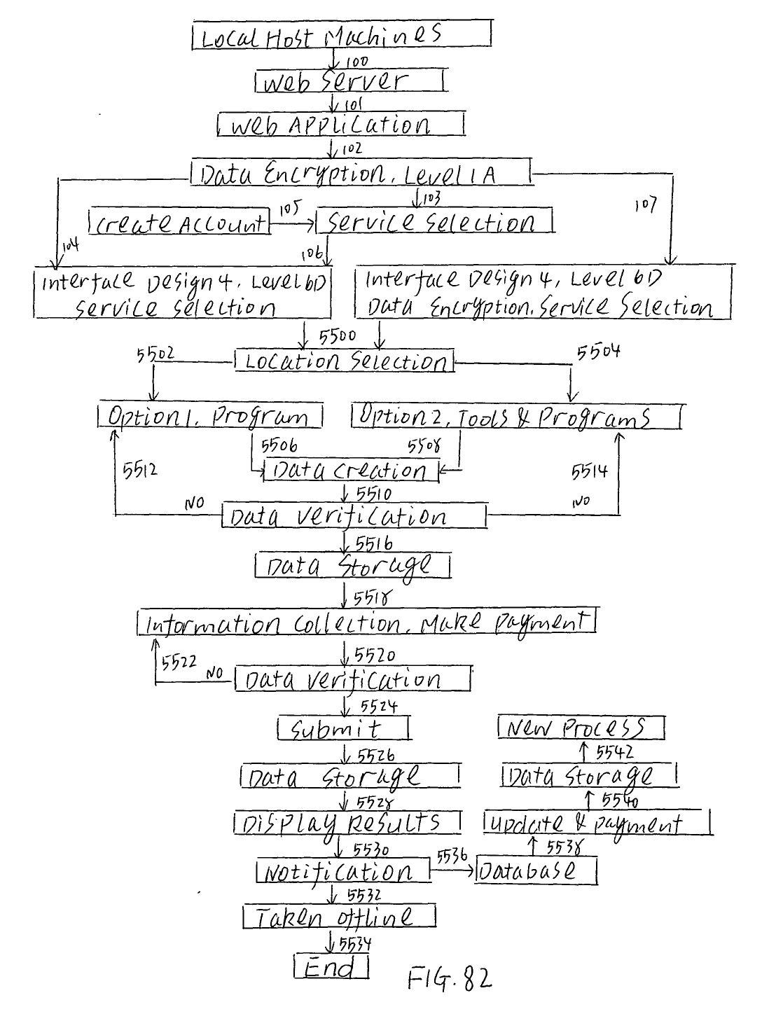

Referring to FIG. 82, this figure is a functional block diagram illustrating how the video and banner ads are created on the fifth page at the sixth level (Industrial national level). The user connects to the web server and access to the web application (Step 100,101). The user can create an account if he or she doesn't have one. If the user has an account, he or she provides data for encryption through the route 102 (from the step 102) or the step 107 at the sixth level. When the data is encrypted, the user selects an advertising spot.

Step 5500 is the step that the user selects a location on the fifth page, interface design 4. Interface 4 is made up of items. Items are used to present information from the database or to act as control. The web application is event-driven. An event occurs and the application responds to it. An event is either an interface event, which corresponds to a user action, or an internal processing event, which corresponds to a system action. The interface design 4 is compiled by java. It provides the image and video solutions for displaying the ads on the fifth page at the sixth level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 12 advertising spots on the fifth page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 5502 or the step 5504. Step 5504 has more steps before getting the results, while the step 5502 has fewer.

Step 5504 contains tools and programs. The tools include custom designed advertising templates, background colors, patterns, canvas and editor. The programs are java stored program units. They help the user finish creating the advertisement. In the step 5504 the user picks a template, chooses background color from Gallery 1 or Gallery 2, selects a canvas and a pattern, and uses the editor. The user follows the steps that are developed by java before getting the results (Step 5508). The results refer to the advertising location being picked; the advertisement being created; the data being created, verified and saved; and the payment being made etc. The data can be any image data types.

If the user chooses to go through the step 5502, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 5506), it is brought up to the desktop for preview. Triggers are fired if functions like preview, upload, reset, submit and cancel are requested.

The data created from the step 5506 and step 5508 need to be verified (Step 5510). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 5512 or the step 5514 until the valid data is provided. If the data is good and complete, the server records the data and writes it to the data blocks in the database from database buffer cache (Step 5516). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 5518. After the data is collected, it needs to be verified (Step 5520). The verification includes company or personal information such as company or personal name, company address, credit card number, expiration date, security code, bank route number and account number etc. If the data is not valid, the process takes the step 5522 and goes back to the step 5518 until the valid data is provided. If the data is valid, it is submitted and saved in the database (Step 5524, 5526), and the results is displayed (Step 5528). The results refer to the advertising location being picked; the advertisement being created; the data being created, verified and saved; and the payment being made etc. The data can be any image and video data types.

Step 5530 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 5532 and 5534). The second choice is waiting and taking action in the database (Step 5536). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 5538), the new data is saved in the database on the server (Step 5540). A new process begins when the new advertisement is displayed for another period of time (Step 5542).

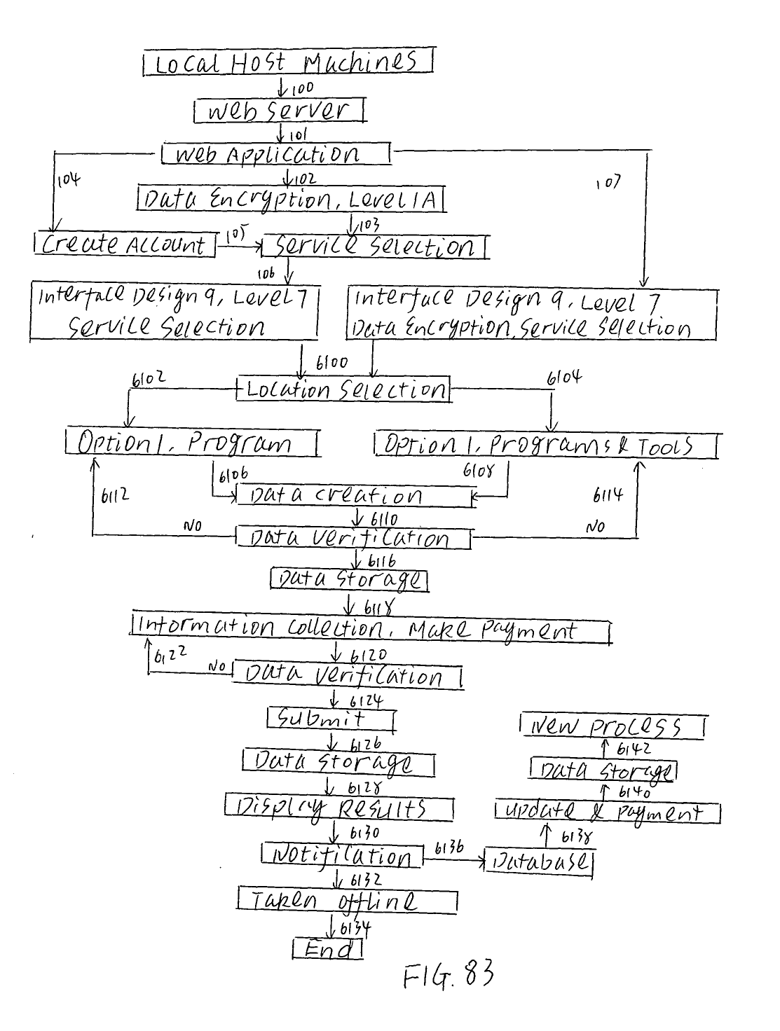

Referring to FIG. 83, this figure is a functional block diagram illustrating how video and banner ads are created at the seventh level (Industrial first level). The user connects to the web server and access to the web application (Step 100,101). The user can create an account if he or she doesn't have one. If the user has an account, he or she provides data for encryption through the route 102 (from the step 102) or the step 107 at the seventh level. When the data is encrypted, the user selects an advertising spot.

Step 6100 is the step that the user selects a location on the fifth page, interface design 9. Interface 9 is made up of items. Items are used to present information from the database or to act as control. The web application is event-driven. An event occurs and the application responds to it. An event is either an interface event, which corresponds to a user action, or an internal processing event, which corresponds to a system action. The interface design 9 is compiled by java. It provides the image and video solutions for displaying the ads on the seventh level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 4 advertising spots on the fifth page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 6102 or the step 6104. Step 6104 has more steps before getting the results, while the step 6102 has fewer.

Step 6104 contains tools and programs. The tools include custom designed advertising templates, background colors, patterns, canvas and editor. The programs are java stored program units. They help the user finish creating the advertisement. In the step 6104 the user picks a template, chooses background color from Gallery 1 or Gallery 2, selects a canvas and a pattern, and uses the editor. The user follows the steps that are developed by java before getting the results (Step 6108). The results refer to the advertising location being picked; the advertisement being created; the data being created, verified and saved; and the payment being made etc. The data can be any image data types.

If the user chooses to go through the step 6102, Program 1 initiates the server process. Program 1 is developed for helping the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 6106), it is brought up to the desktop for preview. Triggers are fired if functions like preview, upload, reset, submit and cancel are requested.

The data created from the step 6106 and step 6108 need to be verified (Step 6110). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 6112 or the step 6114 until valid data is provided. If the data is good and complete, the server records the data and writes it to the data blocks in the database from database buffer cache (Step 6116). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 6118. After the data is collected, it needs to be verified (Step 6120). The verification includes company or personal information such as company or personal name, company address, credit card number, expiration date, security code, bank route number and account number etc. If the data is not valid, the process takes the step 6122 and goes back to the step 6118 until the valid data is provided. If the data is valid, it is submitted and saved in the database (Step 6124, 6126), and the results is displayed (Step 6128). The results refer to the advertising location being picked; the advertisement being created; the data being created, verified and saved; and the payment being made etc. The data can be any image and video data types.

Step 6130 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 6132 and 6134). The second choice is waiting and taking action in the database (Step 6136). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 6138), the new data is saved in the database on the server (Step 6140). A new process begins when the new advertisement is displayed for another period of time (Step 6142).

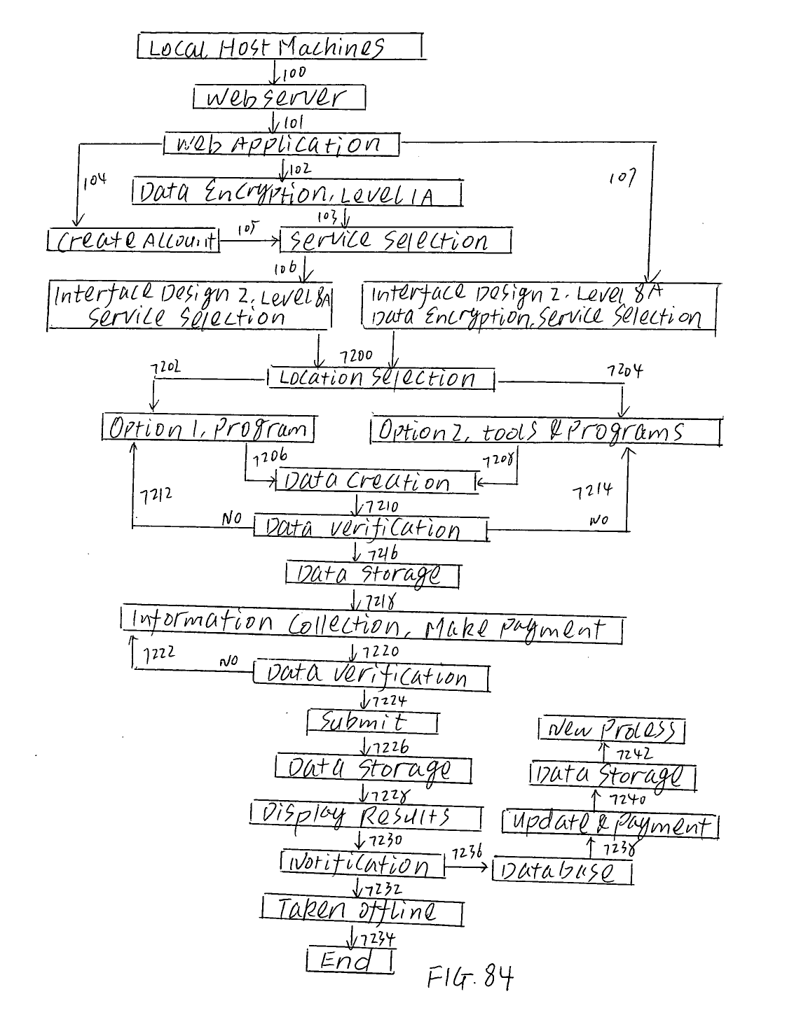

Referring to FIG. 84, this figure is a functional block diagram illustrating how the video and banner ads are created on the first and second page at the eighth level (Industrial second level). The user connects to the web server and access to the web application (Step 100,101). The user can create an account if he or she doesn't have one. If the user has an account, he or she provides data for encryption through the route 102 (from the step 102) or the step 107 at the eighth level. When the data is encrypted, the user selects an advertising spot.

Step 7200 is the step that the user selects a location to create banner or video ad on the first page at the third level, interface design 2. Interface 2 is made up of items. Items are used to present information from the database or to act as control. The web application is event-driven. An event occurs and the application responds to it. An event is either an interface event, which corresponds to a user action, or an internal processing event, which corresponds to a system action. The interface design 2 is compiled by java. It provides the image and video solutions for displaying the ads on the first and second page at the eighth level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users.

The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 24 advertising spots on each of the first and second page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 7202 or the step 7204. Step 7204 has more steps before getting the results, while the step 7202 has fewer.

Step 7204 contains tools and programs. The tools include custom designed advertising templates, background colors, patterns, canvas and editor. The programs are java stored program units. They help the user finish creating the advertisement. In the step 7204 the user picks a template, chooses background color from Gallery 1 or Gallery 2, selects a canvas and a pattern, and uses the editor. The user follows the steps that are developed by java before getting the results (Step 7208). The results refer to the advertising location being picked; the advertisement being created; the data being created, verified and saved; and the payment being made etc. The data can be any image data types.

If the user chooses to go through the step 7202, Program 1 initiates the server process. Program 1 is developed for helping the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 7206), it is brought up to the desktop for preview. Triggers are fired if functions like preview, upload, reset, submit and cancel are requested.

The data created from the step 7206 and step 7208 need to be verified (Step 7210). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 7212 or step 7214 until the valid data is provided. If the data is good and complete, the server records the data and writes it to the data blocks in the database from database buffer cache (Step 7216). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 7218. After the data is collected, it needs to be verified (Step 7220). The verification includes company or personal information such as company or personal name, company address, credit card number, expiration date, security code, bank route number and account number etc. If the data is not valid, the process takes the step 7222 and goes back to the step 7218 until the valid data is provided. If the data is valid, it is submitted and saved in the database (Step 7224, 7226), and the results is displayed (Step 7228). The results refer to the advertising location being picked; the advertisement being created; the data being created, verified and saved; and the payment being made etc. The data can be any image and video data types.

Step 7230 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 7232 and 7234). The second choice is waiting and taking action in the database (Step 7236). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 7238), the new data is saved in the database on the server (Step 7240). A new process begins when the new advertisement is displayed for another period of time (Step 7242).

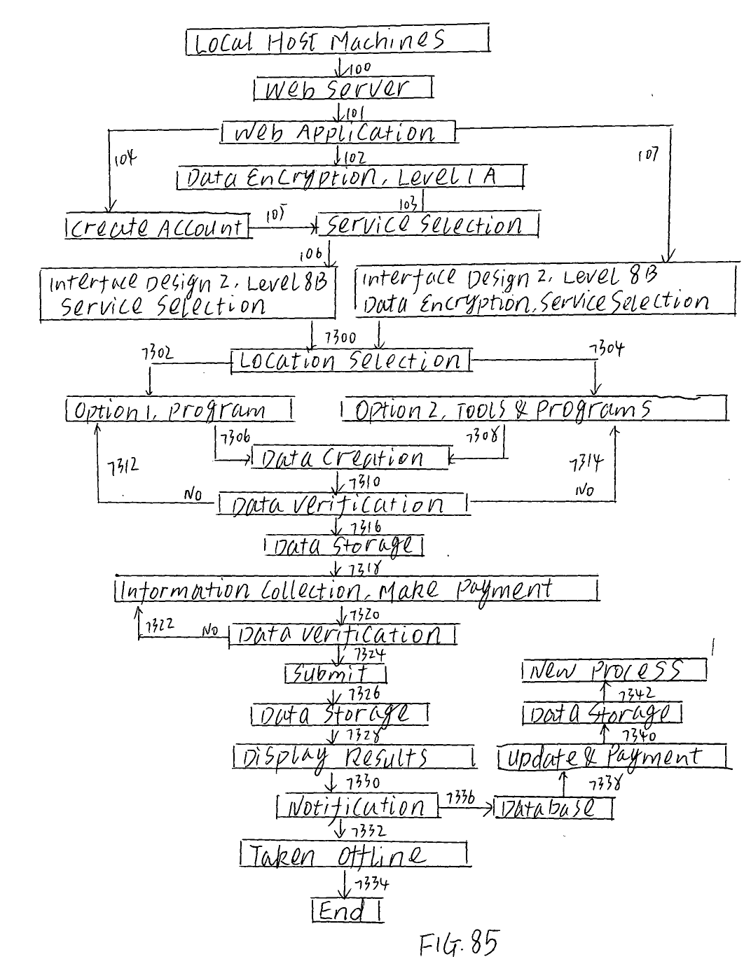

Referring to FIG. 85, this figure is a functional block diagram illustrating how the video and banner ads are created on the third page at the eighth level (Industrial second level). The user connects to the web server and access to the web application (Step 100,101). The user can create an account if he or she doesn't have one. If the user has an account, he or she provides data for encryption through the route 102 (from the step 102) or the step 107 at the eighth level. When the data is encrypted, the user selects an advertising spot.

Step 7300 is the step that the user selects a location or a service to create banner or video ad on the first page at the third level, interface design 3. Interface 3 is made up of items. Items are used to present information from the database or to act as control. The web application is event-driven. An event occurs and the application responds to it. An event is either an interface event, which corresponds to a user action, or an internal processing event, which corresponds to a system action. The interface design 3 is compiled by Java. It provides the image and video solutions for displaying the ads on the third page at the third level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 8 advertising spots on the third page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 7302 or the step 7304. Step 7304 has more steps before getting the results, while the step 7302 has fewer.

Step 7304 contains tools and programs. The tools include custom designed advertising templates, background colors, patterns, canvas and editor. The programs are java stored program units. They help the user finish creating the advertisement. In the step 7304 the user picks a template, chooses background color from Gallery 1 or Gallery 2, selects a canvas and a pattern, and uses the editor. The user follows the steps that are developed by java before getting the results (Step 7308). The results refer to the advertising location being picked; the advertisement being created; the data being created, verified and saved; and the payment being made etc. The data can be any image data types.

If the user chooses to go through the step 7302, Program 1 initiates the server process. Program 1 is developed to help the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 7306), it is brought up to the desktop for preview. Triggers are fired if functions like preview, upload, reset, submit and cancel are requested.

The data created from the step 7306 and step 7308 need to be verified (Step 7310). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 7312 or the step 7314 until the valid data is provided. If the data is good and complete, the server records the data and writes it to the data blocks in the database from database buffer cache (Step 7316). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 7318. After the data is collected, it needs to be verified (Step 7320). The verification includes company or personal information such as company or personal name, company address, credit card number, expiration date, security code, bank route number and account number etc. If the data is not valid, the process takes the step 7322 and goes back to the step 7318 until the valid data is provided. If the data is valid, it is submitted and saved in the database (Step 7324, 7326), and the results is displayed (Step 7328). The results refer to the advertising location being picked; the advertisement being created; the data being created, verified and saved; and the payment being made etc. The data can be any image and video data types.

Step 7330 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 7332 and 7334). The second choice is waiting and taking action in the database (Step 7336). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 7338), the new data is saved in the database on the server (Step 7340). A new process begins when new advertisement is displayed for another period of time (Step 7342).

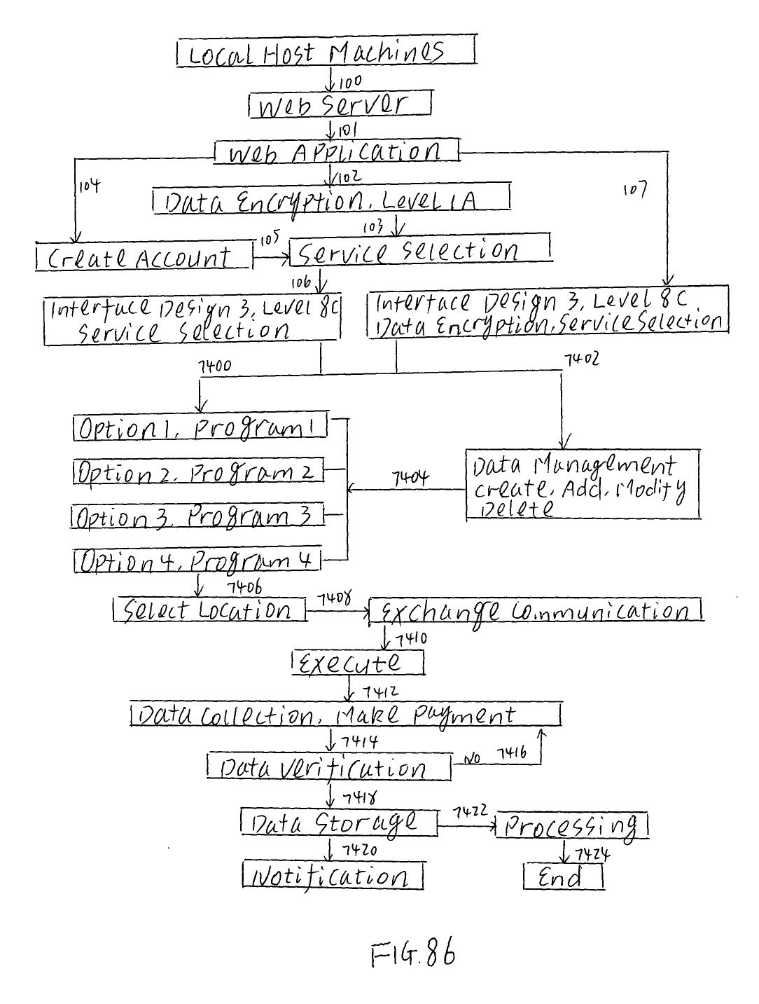

Referring to FIG. 86, this figure is a functional block diagram illustrating how the user invites his or her friend(s) to shop online together. The user connects to the web server and access to the web application (Step 100,101). The user can create an account if he or she doesn't have one. If the user has an account, he or she provides data for encryption through the route 102 (from the step 102) or the step 107 at the eight level. When the data is encrypted, the user selects a service.

The user selects Shopping Together (Step 7400). Step 7400 is the step that the user invites his or her friend(s) to shop online together. There are several different ways to invite. The first way is inviting through online. The second way is inviting through email. The third way is inviting through text message over the phone. The fourth way is inviting by voice communication. The methods of inviting are developed using java. The programs are stored in the data files on the server. They are launched when the triggers are pulled.

7402 is the step that the user manages the contact information. The user maintains the contact list including add, modify, delete, upload, preview, cancel, reset, and invite etc. He or she can invite his or her friend(s) from the contact list by taking the step 7404.

Step 7406 is the step to select a shopping area. Step 7408 is the step to communicate with each other through online texting or voice communication. The next step 7410 is the step to ‘Execute’. ‘Execute’ refers to a series of action related to online purchasing.

After the user and his or her friend(s) buy things online, the data needs to be collected (Step 7412). Once the data is collected, it needs to be verified (Step 7414). During the verification, a Java function is invoked. It provides a default verification routine to verify the validity of the data. The procedure returns the value TRUE for success and FALSE for failure. If the verification raises an exception, the data becomes invalid, an error is returned.

Verified information includes company or personal information such as company or personal name, company address, credit card number, expiration date, security code, bank route number and account number etc. If the information is not valid, the process takes the step 7416 and goes back to the step 7412 until the information is valid. If the information is valid, it is submitted and saved in the database (Step 7418). The notification is sent out to the shoppers. Step 7410 ‘Execute’ needs to be processed (Step 7422). Shop together ends (Step 7424) when the user and his or her friend(s) finish shopping together session.

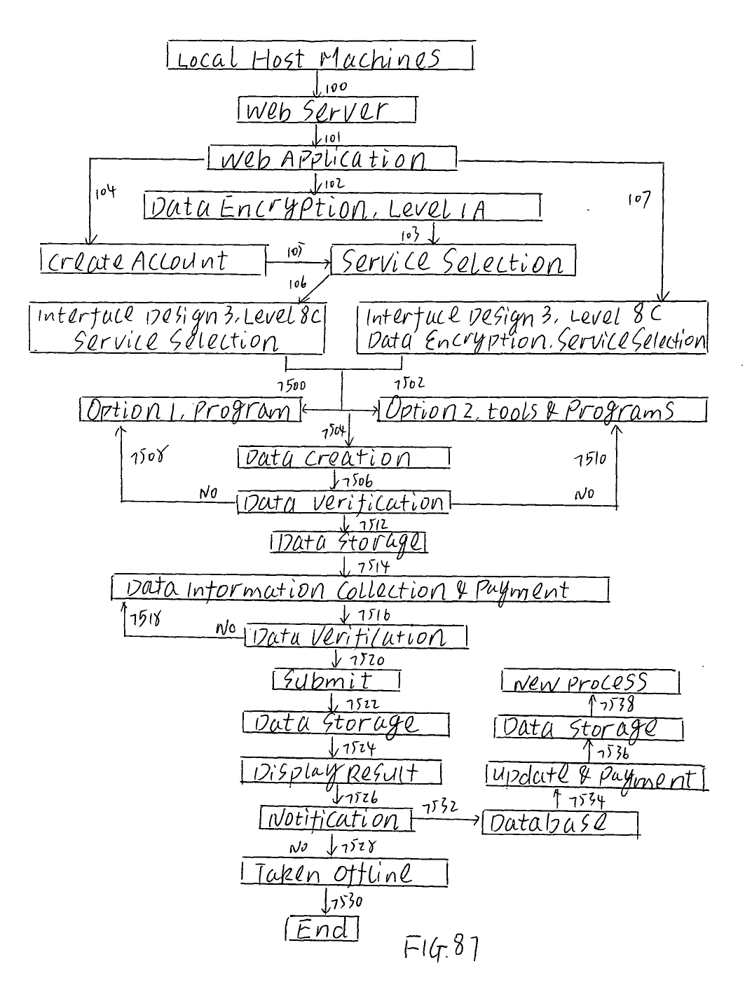

Referring to FIG. 87, this figure is a functional block diagram illustrating how Service Group 1 is designed at the eighth level (Industrial second level). The service group 1 includes Aftermarket parts, Aftermarket products, Wholesale to All, On Sale, Special Deals, Clearance, Closeouts, Access Inventory, Liquidation Sales, Discount Products, Fresh Produce, Raw Materials, OEM Parts, OEM Products, Refurbished Products, Products & Services Promotion, Business Opportunities, Auctions, and Announcements. The user connects to the web server and access to the web application. The user can create an account if he or she doesn't have one. If the user has an account, he or she provides data for encryption through the route 102 (from the step 102) or the step 107 at the sixth level. When the data is encrypted, the user selects a service on the third page.

7500 is the step that the user chooses Option 1. Option 1 related to video or image advertisement and the user chooses to upload the advertisement by himself or herself on the local machine. A program is developed to help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

7502 is the step that the user chooses Option 2. Option 2 is related to creating image advertisement using the tools and programs compiled by java. The tools include templates, background colors, patterns, editor and canvas etc. The java program units enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database for the as a unit. Packaged procedures and functions can be called explicitly the applications or users. The package usually has two parts stored separately in the database: A). The specification is the interface to the application and declares the types, variables, constraints, exceptions, cursors, and subprograms available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

When the step 7500 and 7502 are done, the data is created (Step 7504). The created data needs to be verified (Step 7506). If the verification raises an exception, the data becomes invalid, an error is returned. The process goes back to the step 7500 and 7502 by taking the step 7508 and step 7510. After the verification is done, the data is saved in the database on the server (Step 7512).

The next step is collecting information (Step 7514). It includes the payment information. The information needs to be verified (7516). If it is not valid, it goes back to the step 7514 for valid information (Step 7518). The new data is submitted and saved in the database on the server (Step 7520, 7522) and the results are displayed (Step 7524). The results refer to the image or video advertisement being created and posted.

Step 7526 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 7528 and 7530). The second choice is waiting and taking action in the database (Step 7532). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 7534), the new data is saved in the database on the server (Step 7536). A new process begins when the new advertisement is displayed for another period of time (Step 7538).

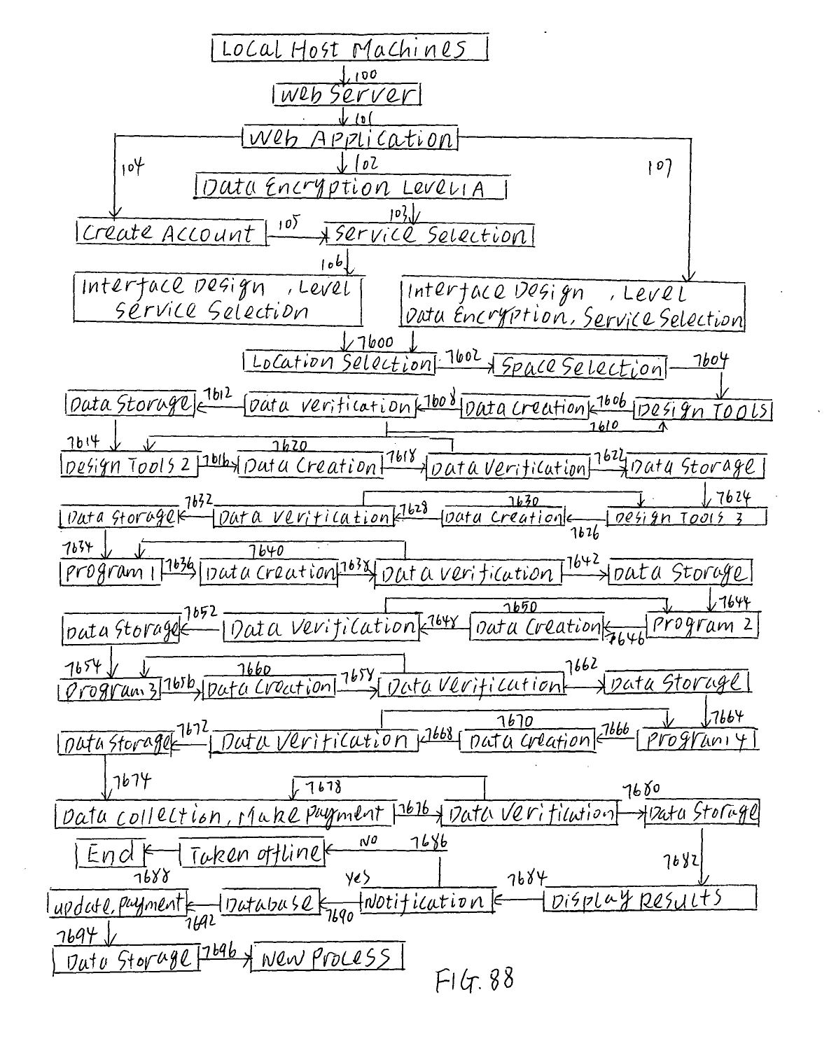

Referring to FIG. 88, this figure is a functional block diagram illustrating how the user sets up store at the industrial second level under Service Group 2 in Module 2. Service Group 2 includes Trade Center, My Booth, and Wholesale Suppliers. The user connects to the web server and accesses to the web application (Step 100,101).

7600 is the step that the user chooses to set up a store at the industrial second level. The user selects a location and a space (Step 7602). The service locations and space are complied with Java. The java program units are stored in the data file on the server. There are many divided space in every service in the Service Group 2. Each service location is graphically designed by graphic program which is also stored within the computer server. When a space is selected, the user uses the design tools and programs to create storefront (Step 7604). The storefront can be either video or image format. The tools and programs include templates, editor, background colors patterns, canvas and Java developed program. In this step the user picks a template, chooses background color from the galleries, selects a canvas and a pattern or chooses to upload his or her own work from the local machine. The user provides necessary information before the data is created (Step 7606). Data information can be any information of a company like company's logo, website, address, video clip etc. After the date is created, it needs to be verified (Step 7608). If it is not valid, it goes back to the step 7604 for valid information (Step 7610). When the verification is done, the data is saved (Step 7612). The next step 7614 is creating the exterior 3D storefront used in the virtual 3D animation shopping environment. The user uses the tools and programs developed by java. The tools include templates, editor, background colors, and canvas. In this step the user picks a template, chooses a background color from galleries, and selects a canvas. The user provides necessary information before the data is created (Step 7616). After the date is created, it needs to be verified (Step 7618). If it is not valid, it goes back to the step 7616 for valid information (Step 7620). When the verification is done, the data is saved (Step 7622).

The next step 7624 is creating 3D interior of the store used in the virtual 3D animation shopping environment. The user uses the tools and programs developed by java. The tools include templates, editor, background colors, and canvas. In this step the user picks a template, chooses a background color from the galleries, and selects a canvas. The user provides necessary information before the data is created (Step 7626). After the date is created, it needs to be verified (Step 7628). If it is not valid, it goes back to the step 7626 for valid information (Step 7630). When the verification is done, the data is saved in the database (Step 7632).

The user has the option to choose sell products in video or image format or both. If he or she chooses the image format to sell products, java compiled programs help set up (Step 7634). After the user follows each step which includes making selection, providing the products related information, uploading the products' images, and previewing etc., the data is created (Step 7636). The data created needs to be verified (Step 7638). If it is not valid, it goes back to the step 7634 for valid information (Step 7640). When the verification is done, the data is saved in the database (Step 7642).

If the user chooses the video format to sell products, he has the option to sell by clips or by one clip. One clip includes all the products. Clips consist of different product categories. Java compiled programs help set up (Step 7644). After the user follows each step which includes making selection, providing the products related information, uploading the products' images, and previewing etc, the data is created (Step 7646). The created data needs to be verified (Step 7648). If it is not valid, it goes back to the step 7644 for valid information (Step 7650). When the verification is done, the data is saved in the database (Step 7652).

If the user chooses to sell in both the video and image formats, he or she follows the steps developed by java before finishing setting up.

7654 is the next step that the user chooses to run promotion. The promotion module consists of text, image, video and coupons. It is compiled with java programs. These programs are stored in the data files on the server. The user follows each step before the data is created (Step 7656). The data created in the step 7656 needs to be verified (Step 7658). If it is not valid, it goes back to the step 3754 for valid information (Step 7660). When the verification is done, the data is saved in the database (Step 7662).

The user can introduce the business by video (Step 7664). The video needs to be uploaded for preview (Step 7666, 7668). If it is not good, the process goes back (Step 7670). If it is good, it is saved (Step 7672). The next step is collecting information and making payment (Step 7674). The collected information needs to be verified (Step 7676). If it is not good, it goes back to the step 7674 through the step 7678. The data is saved and the results are displayed (Step 7680, 7682) when the verification is done. The displayed results refer to the design of the store being finished, the products being uploaded, the promotions being ready to be displayed, and the business video introduction being ready to be broadcasted etc.

Notification is sent to remind the user of renewing the lease before it expires (Step 7684). If the user ignores it, the store is closed when the lease expires (Step 7686), however all the contents created in the store remain in the account. The user can re-open the business anytime if the space is available or any other space is available. The process ends at the user without taking action (Step 7688). If the user chooses to renew the lease, he or she goes to the database (Step 7690), makes payment and updates the account information (Step 7692). The new data is saved (Step 7694) and a new process begins when the new lease begins (Step 7696).

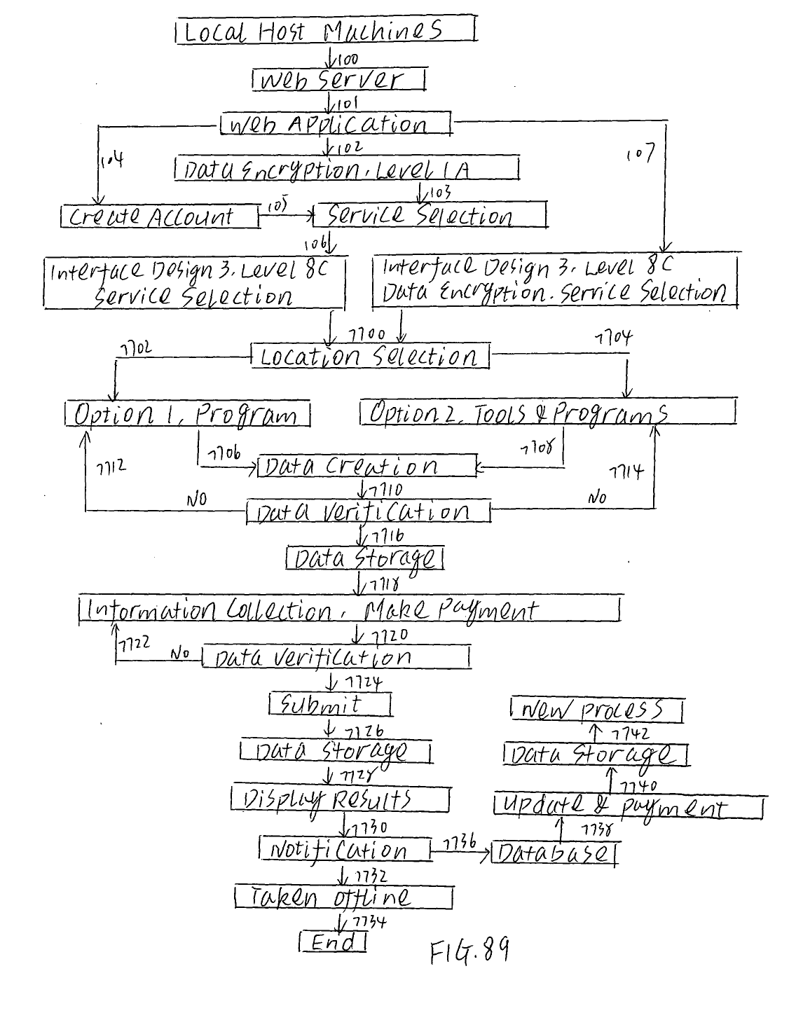

Referring to FIG. 89, this figure is a functional block diagram illustrating how the video and banner ads are created on the fourth page at the eighth level (Industrial second level). The user connects to the web server and access to the web application (Step 100,101). The user can create an account if he or she doesn't have one. If the user has an account, he or she provides data for encryption through the route 102 (from the step 102) or the step 107 at the eighth level. When the data is encrypted, the user selects an advertising spot.

Step 7700 is the step that the user selects a location to create banner or video ad on the first page, interface design 10. Interface 10 is made up of items. Items are used to present information from the database or to act as control. The web application is event-driven. An event occurs and the application responds to it. An event is either an interface event, which corresponds to a user action, or an internal processing event, which corresponds to a system action. The interface design 10 is compiled by java. It provides the image and video solutions for displaying the ads on the second page at the fourth level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are customized advertising spots on the fourth page. The advertisement spots are pre-designed blocks. They are developed and stored with other programs on the server. When a spot is picked, the user is asked to make selections. ‘Selections’ are the decisions that the user needs to make to complete the advertisement work. The user has the option to take the step 7702 or the step 7704. Step 7704 has more steps before getting the results, while the step 7702 has fewer.

Step 7704 contains tools and programs. The tools include custom designed advertising templates, background colors, patterns, canvas and editor. The programs are java stored program units. They help the user finish creating the advertisement. In the step 7704 the user picks a template, chooses background color from Gallery 1 or Gallery 2, selects a canvas and a pattern, and uses the editor. The user follows the steps that are developed by java before getting the results (Step 7708). The results refer to the advertising location being picked; the advertisement being created; the data being created, verified and saved; and the payment being made etc. The data can be any image data types.

If the user chooses to go through the step 7702, Program 1 initiates the server process. Program 1 is developed for helping the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 7706), it is brought up to the desktop for preview. Triggers are fired if functions like preview, upload, reset, submit and cancel are requested.

Data created from the step 7706 and step 7708 need to be verified (Step 7710). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 7712 or the step 7714 until the valid data is provided. If the data is good and complete, the server records the data and writes it to the data blocks in the database from database buffer cache (Step 7716). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 7718. After the data is collected, it needs to be verified (Step 7720). The verification includes company or personal information such as company or personal name, company address, credit card number, expiration date, security code, bank route number and account number etc. If the data is not valid, the process takes the step 7722 and goes back to the step 7718 valid data is provided. If the data is valid, it is submitted and saved in the database (Step 7724, 7726), and the results is displayed (Step 7728). The results refer to the advertising location being picked; the advertisement being created; the data being created, verified and saved; and the payment being made etc. The data can be any image and video data types.

Step 7730 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 7732 and 7734). The second choice is waiting and taking action in the database (Step 7736). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 8538), the new data is saved in the database on the server (Step 8540). A new process begins when the new advertisement is displayed for another period of time (Step 8542).

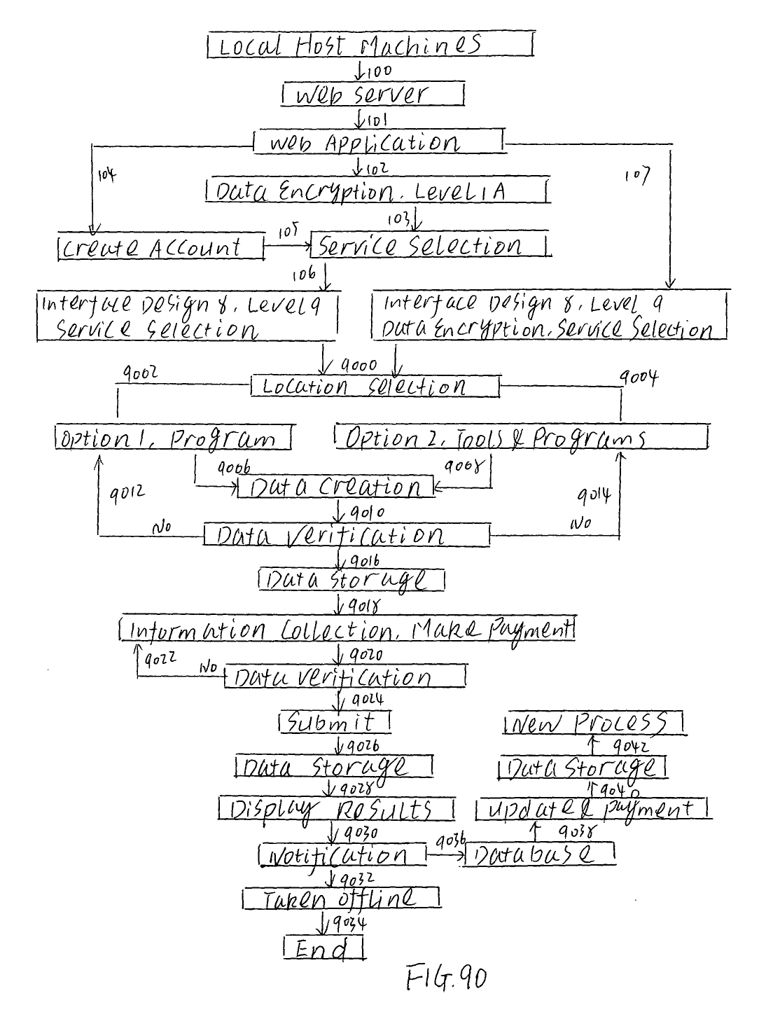

Referring to FIG. 90, this figure is a functional block diagram illustrating how video and banner ads are created on the first page at the ninth level (Industrial business listing level). The user connects to the web server and access to the web application (Step 100,101). The user can create an account if he or she doesn't have one. If the user has an account, he or she provides data for encryption through the route 102 (from the step 102) or the step 107 at the ninth level. When the data is encrypted, the user selects an advertising spot.

Step 9000 is the step that the user selects a location to create banner or video ad on the first page, interface design 8. Interface 8 is made up of items. Items are used to present information from the database or to act as control. The web application is event-driven. An event occurs and the application responds to it. An event is either an interface event, which corresponds to a user action, or an internal processing event, which corresponds to a system action. The interface design 8 is compiled by java. It provides image and video solutions for displaying ads on the first page at the ninth level.

Java is a language used for compiling programs. They are stored program units. They enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

There are 21 advertising spots and other service categories on the second page. The advertisement spots are pre-designed blocks. The advertising ad spots on the right side can be auto extended when all of them are occupied. They are developed and stored with other programs on the server. When a spot is picked, the user is asked to make selections. ‘Selections’ are the decisions that the user needs to make to complete the advertisement work. The user has the option to take the step 9002 or the step 9004. Step 9004 has more steps before getting the results, while the step 9002 has fewer.

Step 9004 contains tools and programs. The tools include custom designed advertising templates, background colors, patterns, canvas and editor. The programs are java stored program units. They help the user finish creating the advertisement. In the step 9004 the user picks a template, chooses background color from Gallery 1 or Gallery 2, selects a canvas and a pattern, and uses the editor. The user follows the steps that are developed by java before getting the results (Step 9008). The results refer to the advertising location being picked; the advertisement being created; the data being created, verified and saved; and the payment being made etc. The data can be any image or video data types.

If the user chooses to go through the step 9002, Program 1 initiates the server process. Program 1 is developed for helping the user post his or her own video or image advertisement. The server process parses the request and locates where the advertisement is on the local machine. If the query is successful, it returns data as result. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

Once the result is returned (Step 9006), it is brought up to the desktop for preview. Triggers are fired if functions like preview, upload, reset, submit and cancel are requested.

The data created from the step 9006 and step 9008 need to be verified (Step 9010). During the verification, a java function is invoked. It provides a default verification routine to verify the validity of the data. The procedure returns the value TRUE for success and FALSE for failure. If the verification raises an exception, the data becomes invalid, an error is returned. The process goes back to the step 9012 or the step 9014 until the valid data is provided. If the data is good and complete, the server records the data and writes it to the data blocks in the database from database buffer cache (Step 9016). The database is a collection of data. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

Data information needs to be collected in the step 9018. After the data is collected, it needs to be verified (Step 9020). The verification includes company or personal information such as company or personal name, company address, credit card number, expiration date, security code, bank route number and account number etc. If the data is not valid, the process takes the step 9022 and goes back to the step 9018 valid data is provided. If the data is valid, it is submitted and saved in the database (Step 9024, 9026), and the results is displayed (Step 9028). The results refer to the advertising location being picked; the advertisement being created; the data being created, verified and saved; and the payment being made etc. The data can be any image and video data types.

Step 9030 is a program compiled with Java for notification. A notification is a Java program developed for reminding the user that the ad contents he or she creates will be taken off line at the spot with time moving forward at the spot. The user has two options before the process ends. The first choice is ignoring it and no action is taken (Step 9032 and 9034). The second choice is waiting and taking action in the database (Step 9036). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 9038), the new data is saved in the database on the server (Step 9040). A new process begins when the new advertisement is displayed for another period of time (Step 9042).

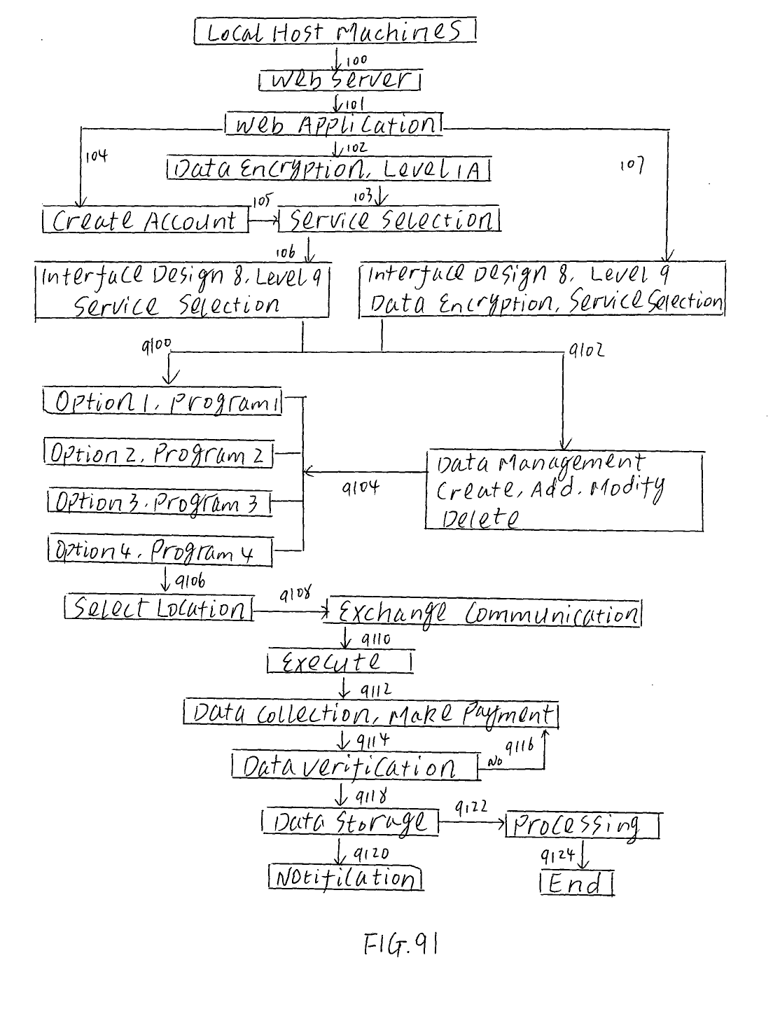

Referring to FIG. 91, this figure is a functional block diagram illustrating how the user invites his or her friend(s) to shop online together. The user connects to the web server and access to the web application (Step 100,101). The user can create an account if he or she doesn't have one. If the user has an account, he or she provides data for encryption through the route 102 (from the step 102) or the step 107 at the ninth level. When the data is encrypted, the user selects a service.

The user chooses Shopping Together (Step 9100). Step 9100 is the step that the user invites his or her friend(s) to shop online together. There are several different ways to invite. The first way is inviting through online. The second way is inviting through email. The third way is inviting through text message over the phone. The fourth way is inviting by voice communication. The methods of inviting are developed using java. The programs are stored in the data files on the server. They are launched when the triggers are pulled.

9102 is the step that the user manages the contact information. The user maintains the contact list including add, modify, delete, upload, preview, cancel, reset, and invite etc. He or she can invite his or her friend(s) from the contact list by taking the step 9104.

Step 9106 is the step to select a shopping area. Step 9108 is the step to communicate with each other through online texting or voice communication. The next step 9110 is the step to ‘Execute’. ‘Execute’ refers to a series of action related to online purchasing.

After the user and his or her friend(s) buy things online, the data needs to be collected (Step 9112). Once the data is collected, it needs to be verified (Step 9114). During the verification, a java function is invoked. It provides a default verification routine to verify the validity of the data. The procedure returns the value TRUE for success and FALSE for failure. If the verification raises an exception, the data becomes invalid, an error is returned.

Verified information includes company or personal information such as company or personal name, company address, credit card number, expiration date, security code, bank route number and account number etc. If the information is not valid, the process takes the step 9116 and goes back to the step 9112 until the information is valid. If the information is valid, it is submitted and saved in the database (Step 9118). The notification is sent out to the shoppers. Step 9110 ‘Execute’ needs to be processed (Step 9122). Shop together ends (Step 9124), when the user and his or her friend(s) finish shopping together session.

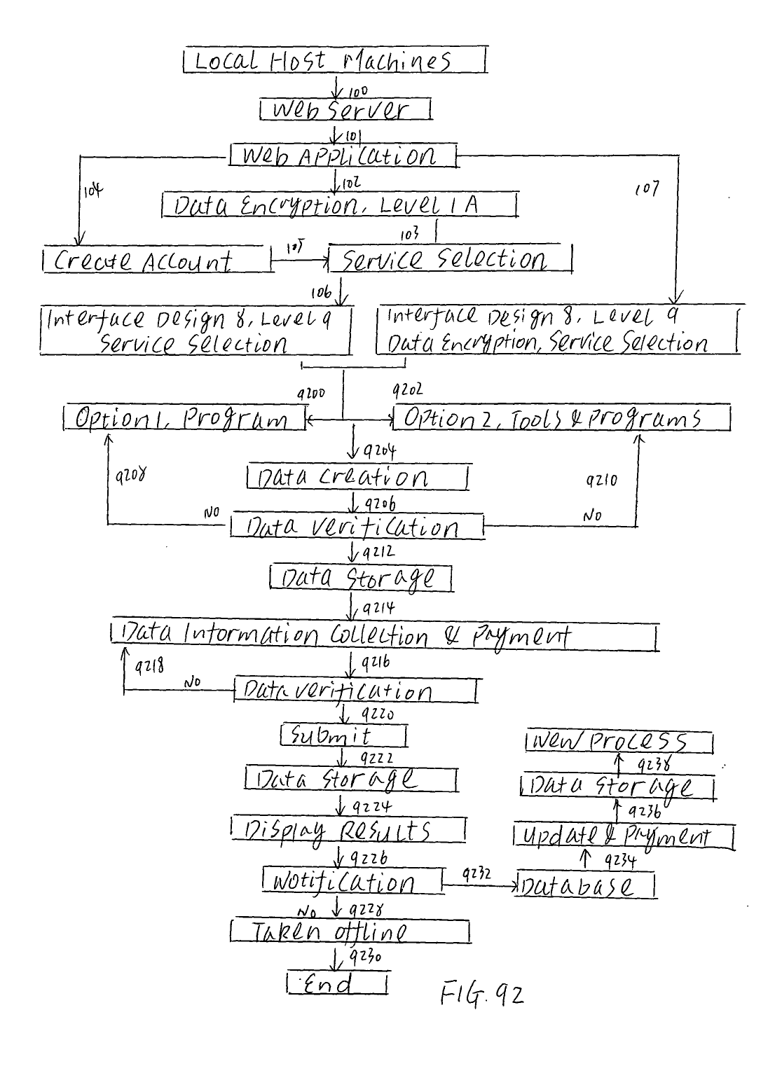

Referring to FIG. 92, this figure is a functional block diagram illustrating how Service Group 1 is designed at the ninth level (Industrial business listing level). The service group 1 includes On Sale, Special Deals, Overstock, Clearance, and Closeouts. The user connects to the web server and access to the web application. The user can create an account if he or she doesn't have one. If the user has an account, he or she provides data for encryption through the route 102 (from the step 102) or the step 107 at the first level. When the data is encrypted, the user selects a service on the first page.

9200 is the step that the user chooses Option 1. Option 1 is related to video or image advertisement and the user chooses to upload the advertisement by himself or herself on the local machine. A program is developed to help the user do it. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user.

9202 is the step that the user chooses Option 2. Option 2 is related to creating image advertisement using the online tools and the user uses the tools and programs compiled by java. The tools include templates, background colors, patterns, editor and canvas etc. The java program units enable the user to access and manipulate database information using procedural schema objects. Stored program units are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database for the as a unit. Packaged procedures and functions can be called explicitly the applications or users. The package usually has two parts stored separately in the database: A). The specification is the interface to the application and declares the types, variables, constraints, exceptions, cursors, and subprograms available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

When the step 9200 and 9202 are done, the data is created (Step 9204). The created data needs to be verified (Step 9206). If the verification raises an exception, the data becomes invalid, an error is returned. The process goes back to the step 9200 and 9202 by taking the step 8808 and step 8810. After the verification is done, the data is saved in the database on the server (Step 9212).

The next step is collecting information (Step 9214). It includes the payment information. The information needs to be verified (9216). If it is not valid, it goes back to the step 8814 for valid information (Step 9218). The new data is submitted and saved in the database on the server (Step 9220, 9222) and the results are displayed (Step 9224). The results refer to the image or video advertisement being created and posted.

Step 9226 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 9228 and 9230). The second choice is waiting and taking action in the database (Step 9232). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 9234), the new data is saved in the database on the server (Step 9236). A new process begins when the new advertisement is displayed for another period of time (Step 9238).

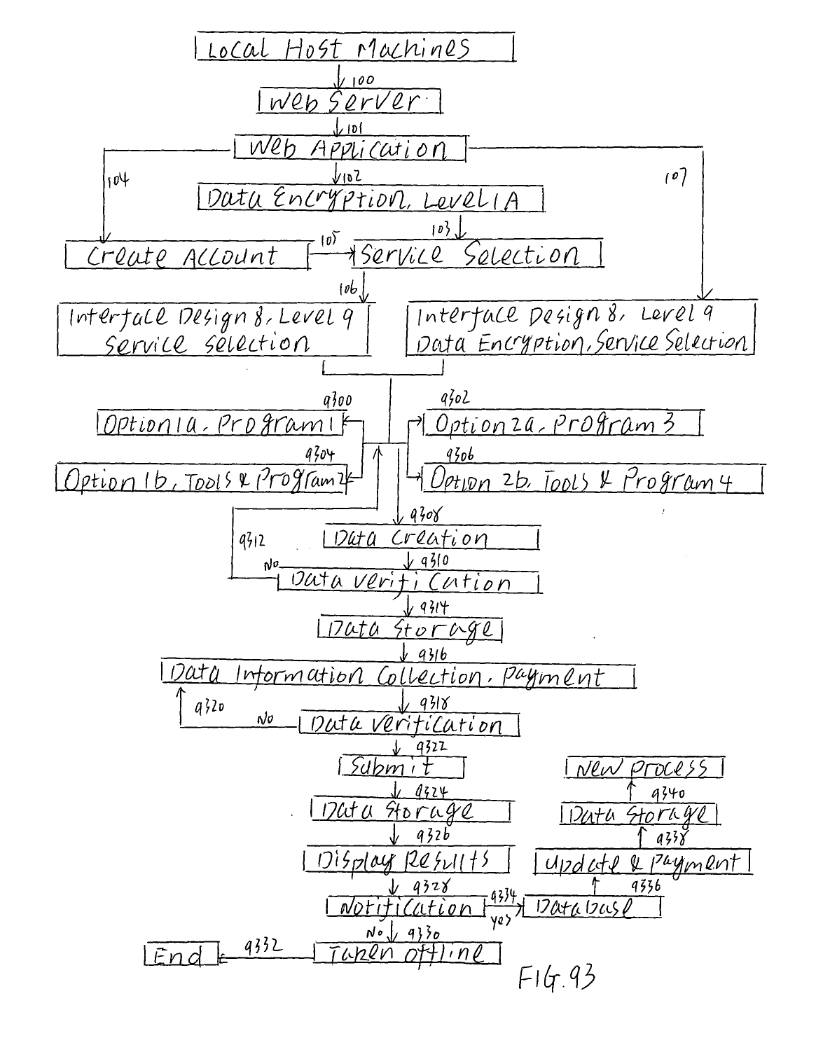

Referring to FIG. 93, this figure is a functional block diagram illustrating how Coupons and Coupon Books in service group 3 are designed at the ninth level. The user connects to the web server and access to the web application. The user can create an account if he or she doesn't have one. If the user has an account, he or she provides data for encryption through the route 102 (from the step 102) or the step 107 at the fifth level. When the data is encrypted, the user selects one of the services in the service group 3.

Option 1A (Step 9300) is the step that the user selects to use his or her own front cover page on the local machine. The user originates the request. The request is sent in the user process. The server parses the request. There are three main stages in the process A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched.

Option 2A (Step 9302) followed by Option 1A is the step that the user selects to use his or her own catalog. The user initiates the query. If the query is successful, they return data as results. There are three main stages in the process of a query. A). Parse, during the parse stage, the request is passed from the user process, and a parsed representation of the request is loaded into the local computer. During the parse, the server process searches for the existing request copy of the request in the local computer; validates the request by checking its syntax; performs data dictionary lookups to validate file definitions; acquires parse locks on the object so that the definition doesn't change during the parsing of the request; checks the user's privileges to access the referenced schema object; determines the optimal execution plan for the request; loads the request and execution plan into the buffer cache and send back to the server for processing. The parse stage includes processing the requirement that needs to be done only once. The server usually translates each requirement only once, re-executing that parsed during subsequent references to the request. Although parsing requirement validates that require, parsing only identifies errors that can be found before requirement execution. B). Executing the requirement, at this point, the local computer has all the resources and necessary information, so the requirement is executed; the user process prepares to retrieve the data. C). Fetching, in the fetching stage, the file is selected and returned by the user to the server. One or more fetches may be required to transfer the result of a query to the user. After the data file is fetched, the data is brought up to the desktop for preview. If it is good, it is submitted. Or a new process begins until the valid data file is fetched. After the data file is fetched, the data is brought up to the desktop for preview. If it is good, it is submitted. Or a new process begins until the valid data file is fetched.

Option 1B and 2B (Step 9304, 9306) are the steps that the user selects to create the front page and catalog using the free online tools. The user uses the tools and walks through the steps developed by java programs. The tools include templates, background colors, patterns, editor and canvas etc. The java programs are stored program units. They help the user finish the work and manipulate database information using procedural schema object. After each step is taken, the data is created (Step 9308). The created data needs to be verified (Step 9310).

During the verification, a java function program is invoked. It provides a default verification routine to verify the validity of the data. The procedure returns the value TRUE for success and FALSE for failure. If the verification raises an exception, the data becomes invalid, an error is returned. The process goes back until the data provided is good and valid (Step 9312). After the verification is done, the server records the data and writes it to the data blocks in the data files from database buffer cache (Step 9314).

The next step (Step 9316) is collecting information. The collected information needs to be verified (Step 9318). If it is not valid, it goes back to the step 8916 for valid information by taking the step 8920. Date verified is submitted and saved in the database on the server (Step 9322, 9324). And the results are displayed (Step 8926). The results refer to the advertisement being created and the sales module being implemented.

Step 9328 is a program compiled with Java for notification. A notification is a Java program developed for reminding the user that the ad or the store contents he or she creates will be taken off line at the spot with time moving forward at the spot. The user has two options before the process ends. The first choice is ignoring it and no action is taken (Step 9330 and 9332). The second choice is waiting and taking action in the database (Step 9334). Action can be that the user modifies, updates, deletes, creates, renews or adds etc. There are two phases in the process: parse is the same as the parse phase used for processing a query; execute requires additional processing to make data available and change. 1). If the data and rollback bocks are not already in the buffer cache, the server process reads them from the data files into the buffer cache. 2). The server process places locks on the rows that are to be modified, updated, deleted, created and added. 3). In the redo log buffer, the server process records the changes to be made to the rollback and data: A). the rollback block changes record the values of the data before it is modified, updated, deleted, created and added. The rollback is used to store the before-image of the data, so that modify, update, delete, create and add can be rolled back if necessary; B). The data blocks changes record the new values of the data. 4). the server process records the before-image to the rollback block and updates the data block. Both of these changes are done in the database buffer cache. After the data is updated and the payment is made (Step 9336), the new data is saved in the database on the server (Step 9338). A new process begins when the advertisement begins to be displayed for another period of time (Step 9340).

Referring to FIG. 94, this figure is a functional block illustrating how reservation, bid and auction are applied on ad spots and store space. The user connects to the web server and access to the web application. He or she can choose a service category through the route 102 (From the step 102) or the step 107. When the data is encrypted, the user selects a service.

A service refers to picking an advertising spot or store space at different levels (Step 9400). The user creates the data in the next step (Step 9402). The data refers to reservation; bid or auction information that is recorded in the database under his or her account. The data needs to be verified (Step 9404). If it is not satisfactory, the user goes back to the step 9402 until satisfactory data is provided (Step 9406). The data is saved before a notification is issued (Step 9408, 9410). The notification confirms whether the action of reservation, bid or auction is good or not. If the user ignores it, another notification is issued (Step 9414). If the user ignores it again, reservation, bid or auction is aborted or other people get it. Abort refers to reserved, bid or auctioned space is released (Step 9416). The process ends at either a space being taken or not being taken (Step 9418).

If the user responds to the notification, data needs to be collected (Step 9412). Data collection includes creation of data such as posting advertisement or setting up a store and payment. information etc. The collected data needs to verified (Step 9424). The data is saved in the database on the server (Step 9426) after the verification. The process ends at the results being displayed (Step 9428). The results refer to the store being open to the public or the ads being successfully posted.

1). Online retail and wholesale stores nationalization and localization refer to regularly and graphically designing and building online retail and wholesale store space at the national level, state level, metro area level, city level and industrial levels for users to conduct online business.

2). Set up online retail and wholesale stores refer to creating programs and tools that help users to select store location, create storefront and store inside, upload products, run promotions, and sell products etc.

3). Online space rental refers to creating programs that users can rent retail and wholesale space online for a period of time.

4). Online store space reservation refers to creating programs that users can reserve retail and wholesale space online for a period of time.

5). Online store space bid refers to creating programs that users can bid retail and wholesale space online based on the space has been reserved.

6). Online store space auction refers to creating programs that some online retail and wholesale space can be auctioned.

7). Online commercial text, banner and video ads nationalization and localization refer to logically designing and creating online advertising areas and locations at the national level, state level, metro area level, city level and industrial levels for users to create text, image and video commercial ads.

8). Online commercial ads (text, image and video) self-creation methods refer to creating free online design tools and programs so that users can use them to create and post commercial text, banner and video ads by themselves.

9). Video Shopping refers to creating programs that users can sell products through video display format in an online retail and wholesale environment or under other services categories.

10). Window Shopping refers to creating programs that customers can buy and have virtual window shopping experience in an online retail and wholesale environment.

11). Shop Together refers to users inviting their friends to shop online together in an online retail and wholesale environment. When shopping together, users can see each other, talk and text to each other online.

12). 3D virtual animation shop together refers to users with their friends artificially designed and created to shop together in an 3D online virtual retail and wholesale environment.

13). Billboards is designed and created by programs for users to sell products or market their businesses online in their state along major interstate highways.

14). Skyways is created for users to sell products or market their businesses between big cities.

15). Street Vendors is created for users to sell their products online.

16). Malls is created for users in the malls to sell their products online.

17). Outlet Centers is created for users in the outlets to sell their products online.

18). Shop in Downtowns is created for users to sell their products or market their businesses in the downtown area online.

19). Shopping Centers is created for users in the shopping centers locally to sell their products or market their businesses online.

20). Non-Shopping Centers is created for users in the non-shopping center areas locally to sell their products or market their businesses online.

21). Contest to Win is created for anyone to win a prize by sending their banner and video commercial art work online through competition.

22). Sweepstakes is a program created for shoppers to participate to win a prize based on their spending online.

23). Holiday Shopping is created for users to upload, run promotions and sell their products online during the holidays and holiday season.

24). Online advertising spots reservation refers to creating programs that users can reserve online advertising spot space for a period of time.

25). Online advertising spots bid refers to creating programs that users can bid online advertising spot space based on the space that has been reserved.

26). Online advertising auction refers to creating programs for users to auction online advertising spot space.

27). Publishers' classified advertising refers to creating programs for the media publishers to create and transfer classified ad contents on the website.
